(19) United States
(12) Patent Application Publication
(10) Pub. No.: US 2023/0384907 A1
(43) Pub. Date: Nov. 30, 2023

(54) METHODS FOR RELATIVE MANIPULATION OF A THREE-DIMENSIONAL ENVIRONMENT

(71) Applicant: Apple Inc., Cupertino, CA (US)

(72) Inventors: Benjamin H. BOESEL, Cornelius, NC (US); Jonathan RAVASZ, Sunnyvale, CA (US); Shih-Sang CHIU, Menlo Park, CA (US); Jordan A. CAZAMIAS, Conroe, TX (US); Stephen O. LEMAY, Palo Alto, CA (US); Christopher D. MCKENZIE, Burlingame, CA (US); Dorian D. DARGAN, Danville, CA (US); David H. HUANG, San Mateo, CA (US)

(21) Appl. No.: 18/298,994

(22) Filed: Apr. 11, 2023

Related U.S. Application Data
(60) Provisional application No. 63/362,816, filed on Apr. 11, 2022.

(51) Int. Cl. G06F 3/04815; G06F 3/01; G06F 3/04845

(52) U.S. Cl. CPC G06F 3/04815; G06F 3/013; G06F 3/04845

(57) ABSTRACT

In some embodiments, a computer system facilitates manipulation of a three-dimensional environment relative to a viewpoint of a user of the computer system. In some embodiments, a computer system facilitates manipulation of virtual objects in a virtual environment. In some embodiments, a computer system facilitates manipulation of a three-dimensional environment relative to a reference point determined based on attention of a user of the computer system.

### CROSS-REFERENCE TO RELATED APPLICATIONS

This application claims the benefit of U.S. Provisional Application No. 63/362,816, filed Apr. 11, 2022, the content of which is incorporated herein by reference in its entirety for all purposes.

### TECHNICAL FIELD

This relates generally to computer systems that provide computer-generated experiences, including, but no limited to, electronic devices that provide virtual reality and mixed reality experiences via a display generation component.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with content in a three-dimensional environment. Such methods and interfaces may complement or replace conventional methods for interacting with content in a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates manipulation of a three-dimensional environment relative to a viewpoint of a user of the computer system. In some embodiments, a computer system facilitates manipulation of virtual objects in a virtual environment. In some embodiments, a computer system facilitates manipulation of a three-dimensional environment relative to a reference point determined based on attention of a user of the computer system.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing XR experiences in accordance with some embodiments.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7I illustrate examples of a computer system facilitating interactions with a plurality of objects in a three-dimensional environment in accordance with some embodiments.

FIGS. 8A-8I is a flowchart illustrating an exemplary method of facilitating interactions with a plurality of objects in a three-dimensional environment in accordance with some embodiments.

FIGS. 9A-9I illustrate examples of a computer system facilitating manipulation of virtual objects in a virtual environment in accordance with some embodiments.

FIGS. 10A-10H is a flowchart illustrating a method of facilitating manipulation of virtual objects in a virtual environment in accordance with some embodiments.

FIGS. 11A-11G illustrate examples of a computer system facilitating interactions with a plurality of objects relative to a reference point in a three-dimensional environment in accordance with some embodiments.

FIGS. 12A-12J is a flowchart illustrating an exemplary method of facilitating interactions with a plurality of objects relative to a reference point in a three-dimensional environment in accordance with some embodiments.

FIGS. 13A-13G illustrate examples of a computer system facilitating manipulation of virtual objects in a virtual environment in accordance with some embodiments.

FIGS. 14A-14K is a flowchart illustrating a method of facilitating manipulation of virtual objects in a virtual environment in accordance with some embodiments.

### DESCRIPTION OF EMBODIMENTS

The present disclosure relates to user interfaces for providing a computer generated (CGR) experience to a user, in accordance with some embodiments.

The systems, methods, and GUIs described herein provide improved ways for an electronic device to facilitate interaction with and manipulate objects in a three-dimensional environment.

In some embodiments, a computer system displays a three-dimensional environment including a plurality of objects. In some embodiments, in response to detecting a first interaction input directed toward the three-dimensional environment provided by a first predefined portion of a user of the computer system, in accordance with a determination that a second predefined portion of the user is providing a second interaction input when the first interaction input was detected, the computer system manipulates the three-dimensional environment, including repositioning the plurality of objects in the three-dimensional environment, relative to a viewpoint of the user in accordance with the first interaction input. In some embodiments, in accordance with a determination that the second predefined portion of the user is not providing the second interaction input when the first interaction input was detected, the computer system performs an operation different from manipulating the three-dimensional environment relative to the viewpoint of the user in accordance with the first interaction input. In some embodiments, the computer system moves a single object of the plurality of objects in the three-dimensional environment relative to the viewpoint of the user in accordance with the first interaction input. In some embodiments, the computer system activates a selectable option in the three-dimensional environment in response to detecting the first interaction input.

In some embodiments, a computer system facilitates manipulation of virtual objects in a virtual environment. For example, in response to detecting an interaction input provided by the user, the computer system manipulates the virtual objects in the environment in accordance with the input. In some embodiments, in response to detecting a first movement pattern included in the interaction input, the computer system manipulates the virtual objects in a first manner and in response to detecting a second movement pattern included in the interaction input, the computer system manipulates the virtual objects in a second manner. In some embodiments, the computer system manipulates the virtual objects with a direction and amount corresponding to the direction and amount of movement included in the interaction input.

In some embodiments, a computer system displays a three-dimensional environment including a plurality of objects. In some embodiments, in response to detecting an interaction input directed toward the three-dimensional environment provided by a predefined portion of a user of the computer system, in accordance with a determination that attention of the user is directed toward a first object of the plurality of objects when the first interaction input was detected, the computer system manipulates the three-dimensional environment, including repositioning the plurality of objects in the three-dimensional environment, relative to a first reference point that is based on a location associated with the first object in accordance with the first interaction input. In some embodiments, in accordance with a determination that the attention of the user is directed toward a second object when the first interaction input was detected, the computer system manipulates the three-dimensional environment, including repositioning the plurality of objects in the three-dimensional environment, relative to a second reference point that is based on a location associated with the second object in accordance with the first interaction input.

In some embodiments, a computer system facilitates manipulation of virtual objects in a virtual environment. In some embodiments, in response to detecting an interaction input corresponding to a request to manipulate virtual objects in the virtual environment while the attention of the user is directed to a portion of the environment that is empty of virtual objects that can be manipulated, the computer system manipulates the objects relative to a reference point based on the positions of one or more virtual objects displayed in the environment. In some embodiments, if no objects are displayed in the environment, the computer system displays and manipulates a reference object in response to the interaction input and manipulates one or more virtual objects in the environment that are not displayed in the environment.

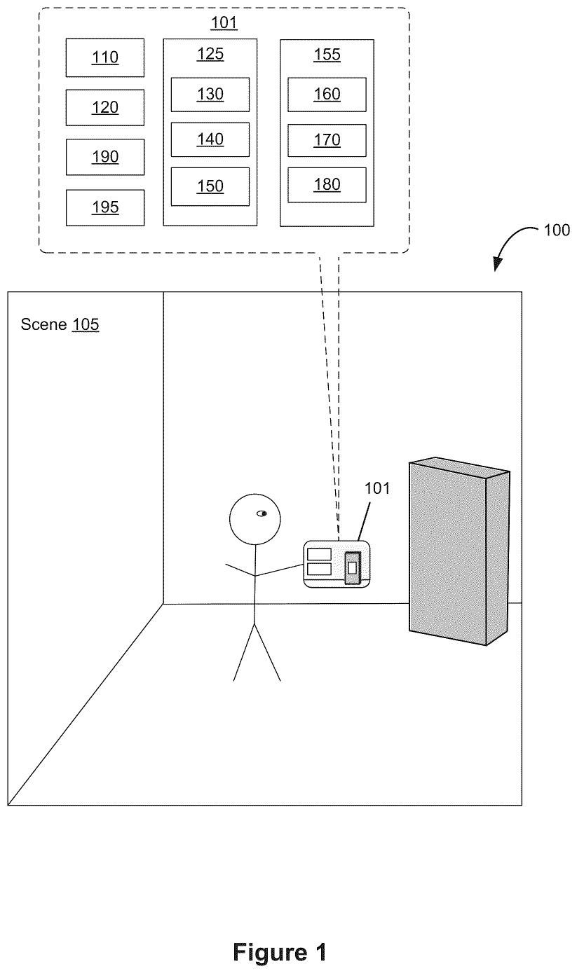

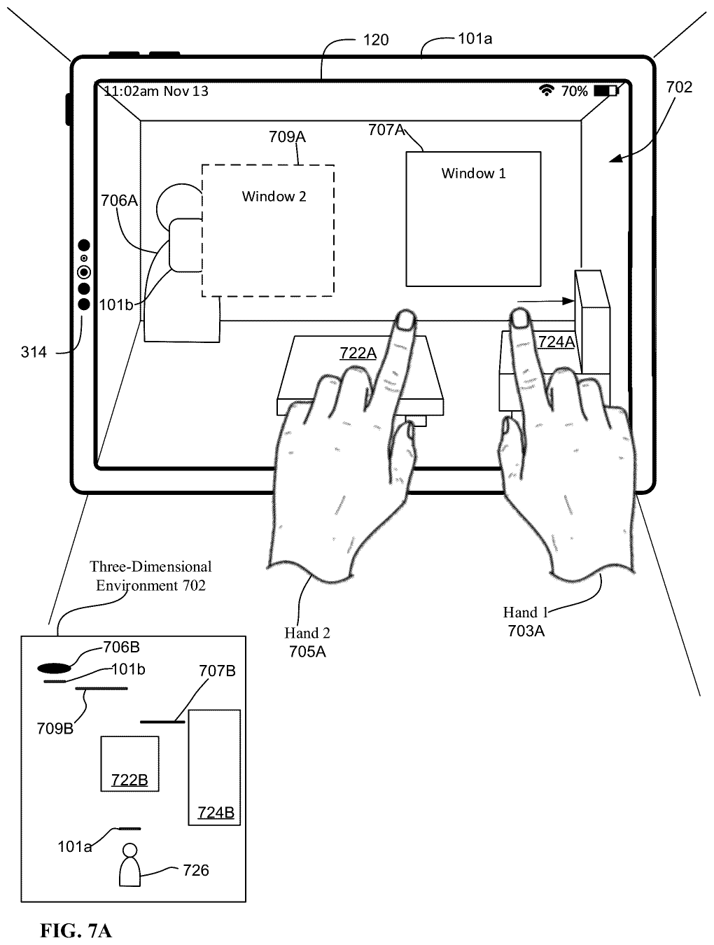

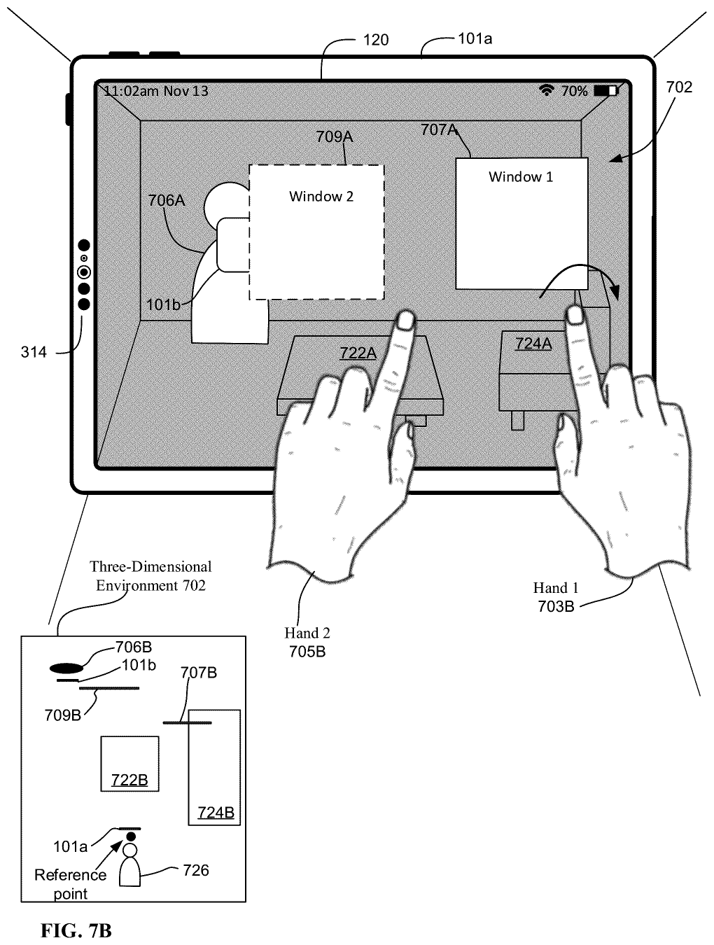

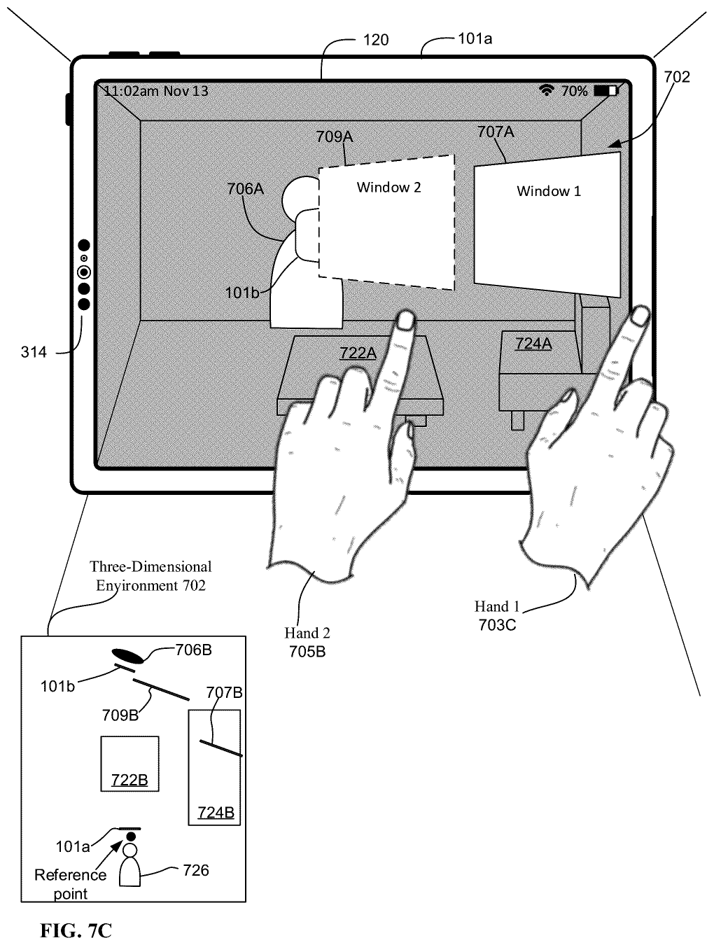

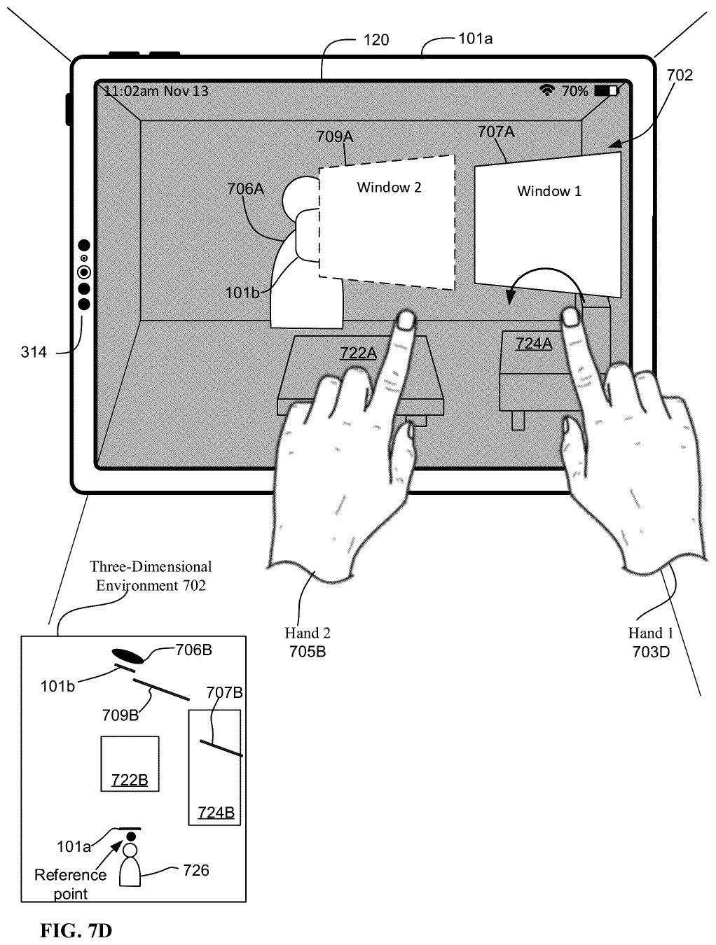

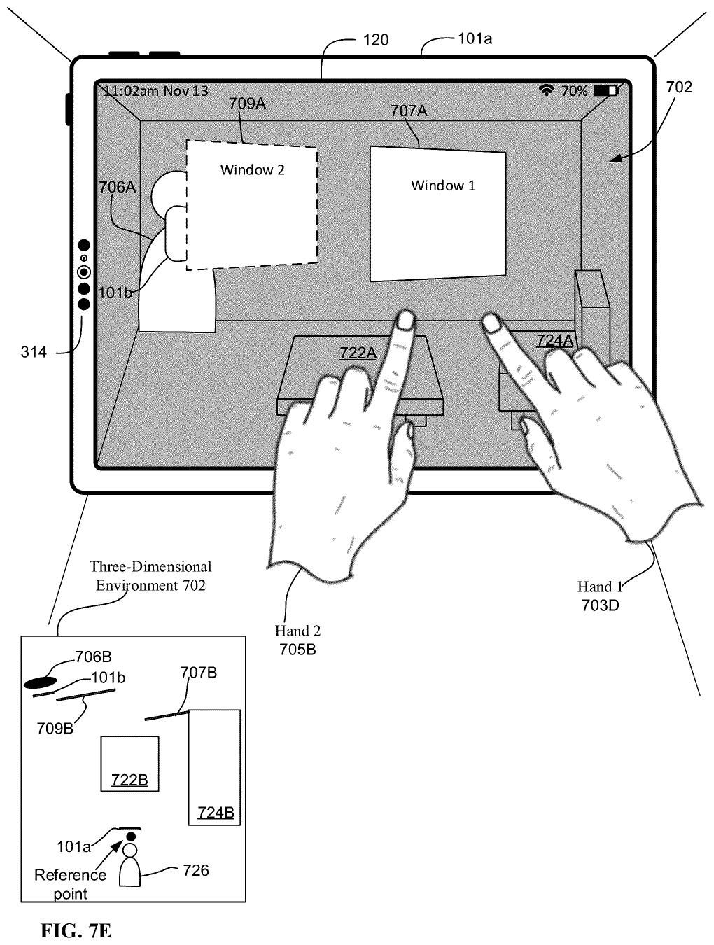

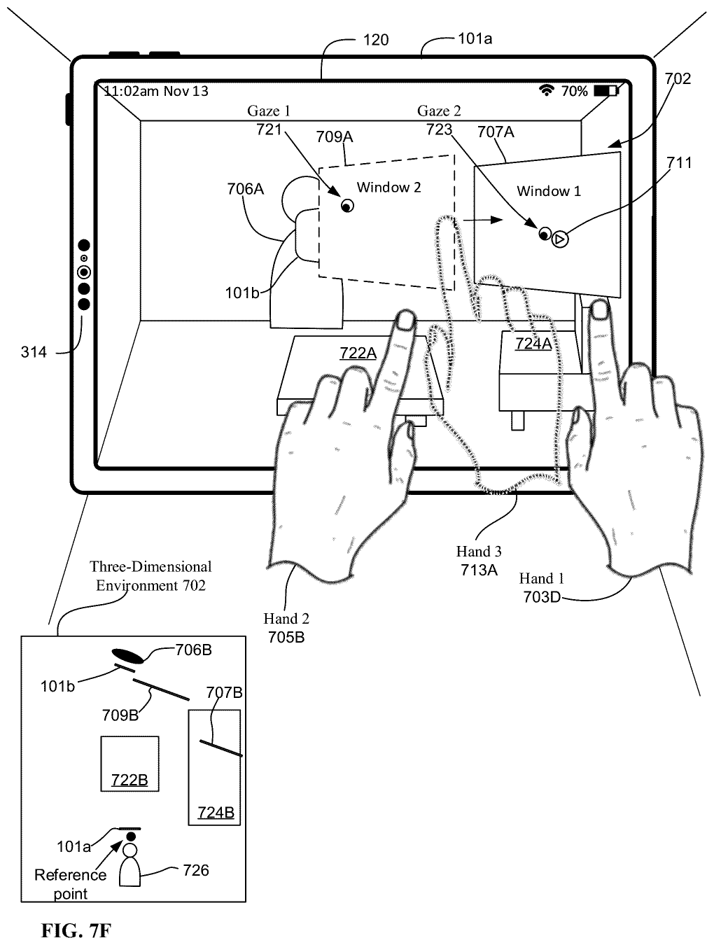

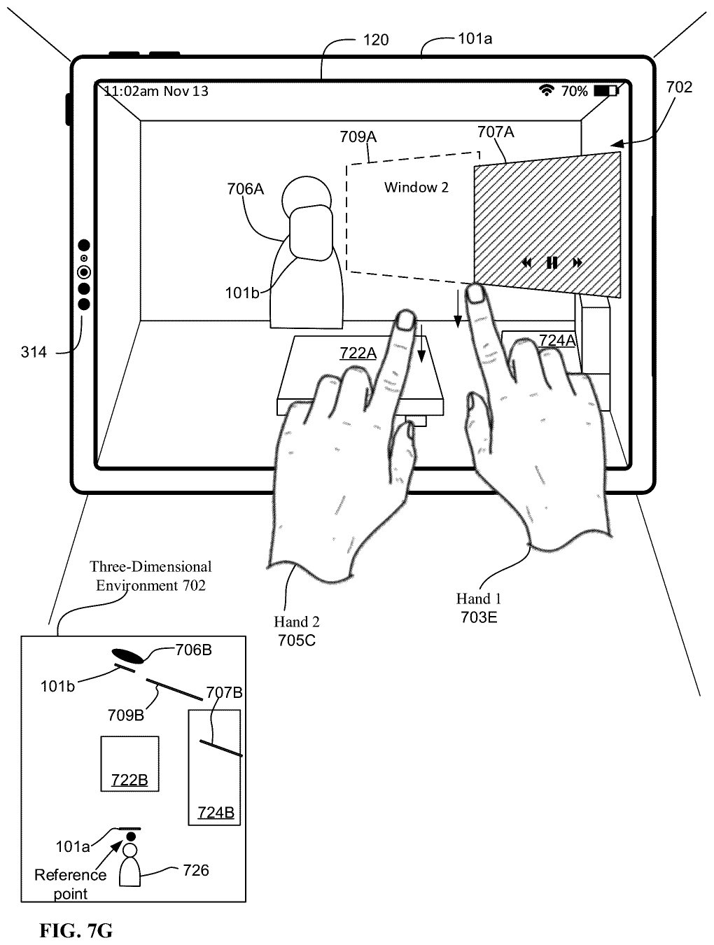

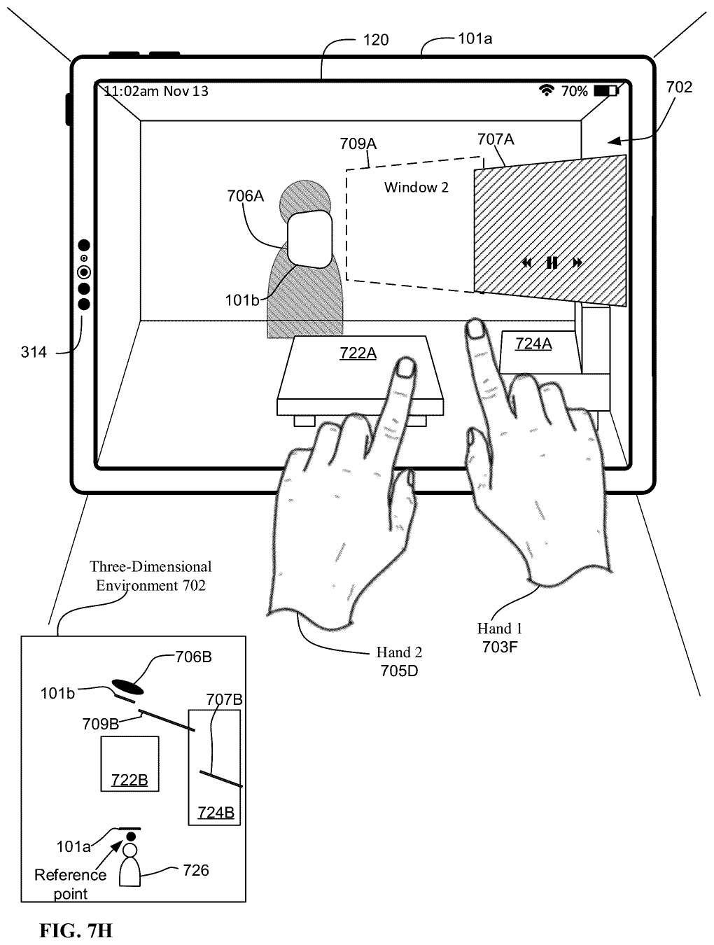

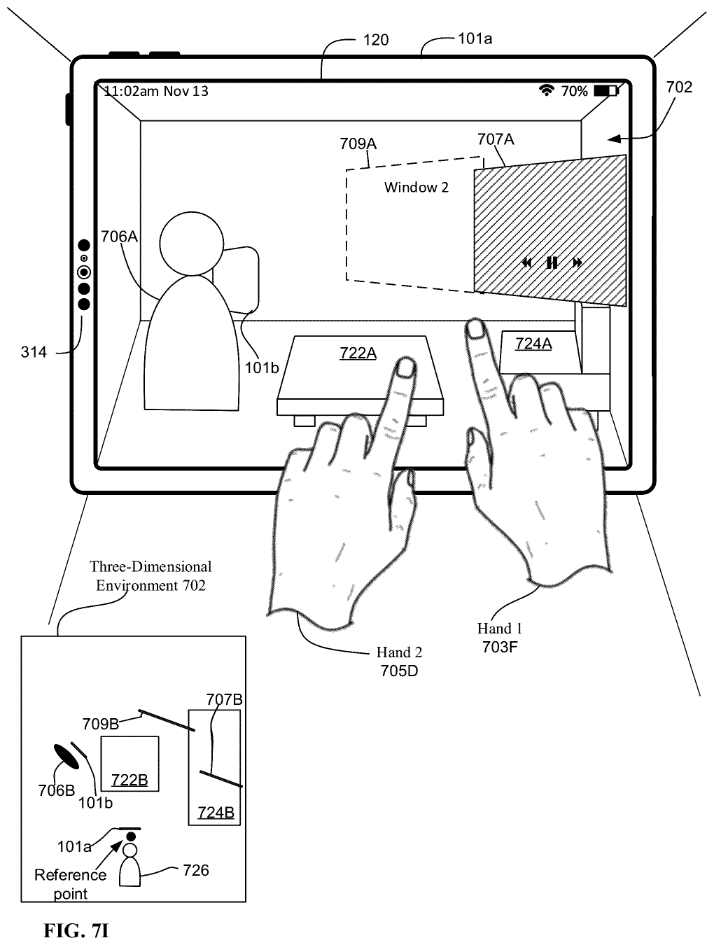

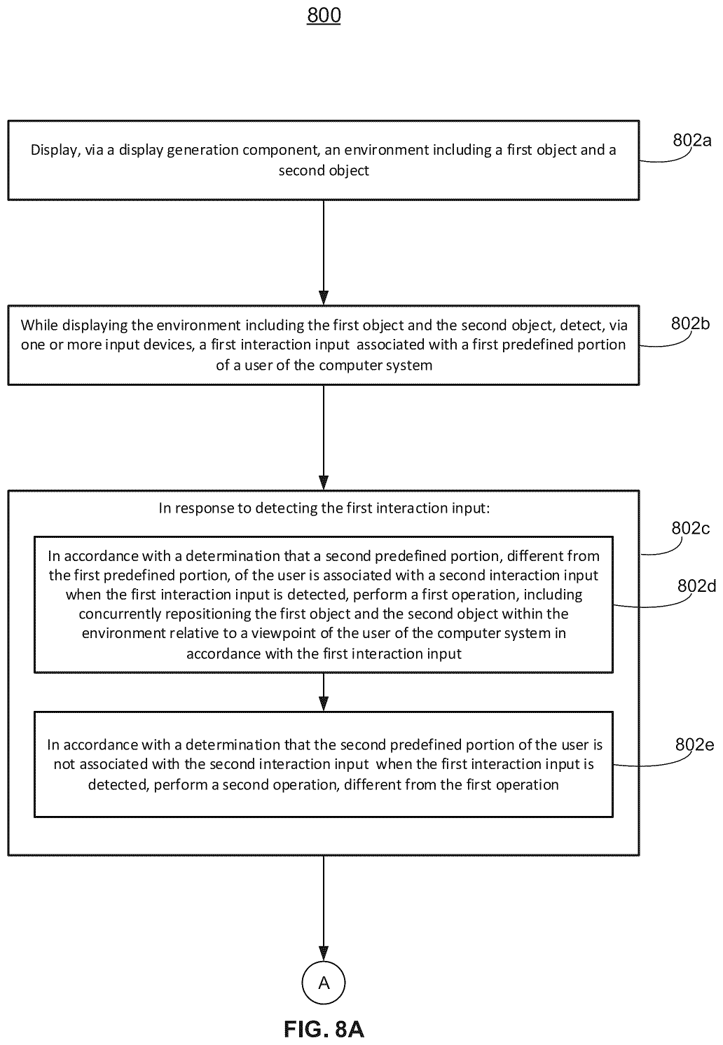

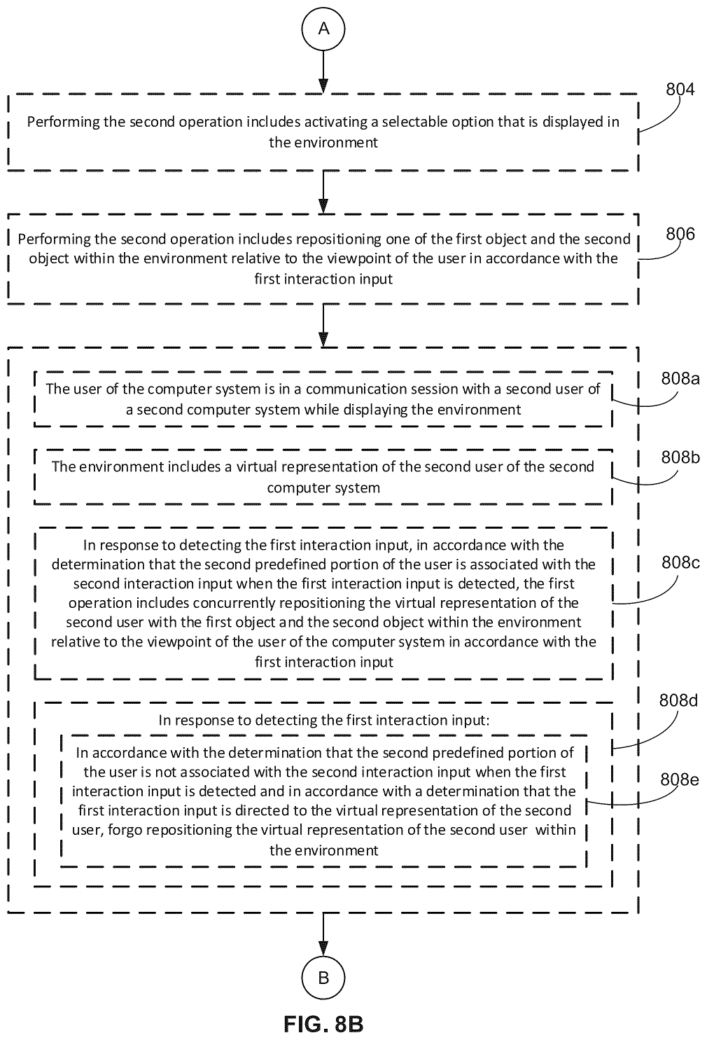

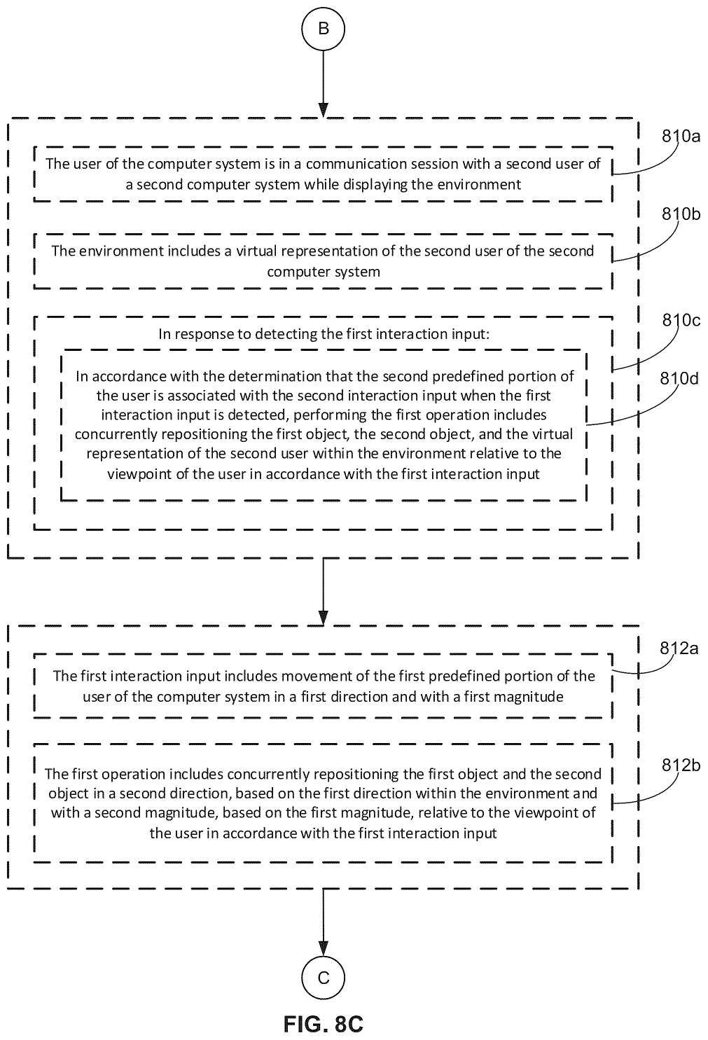

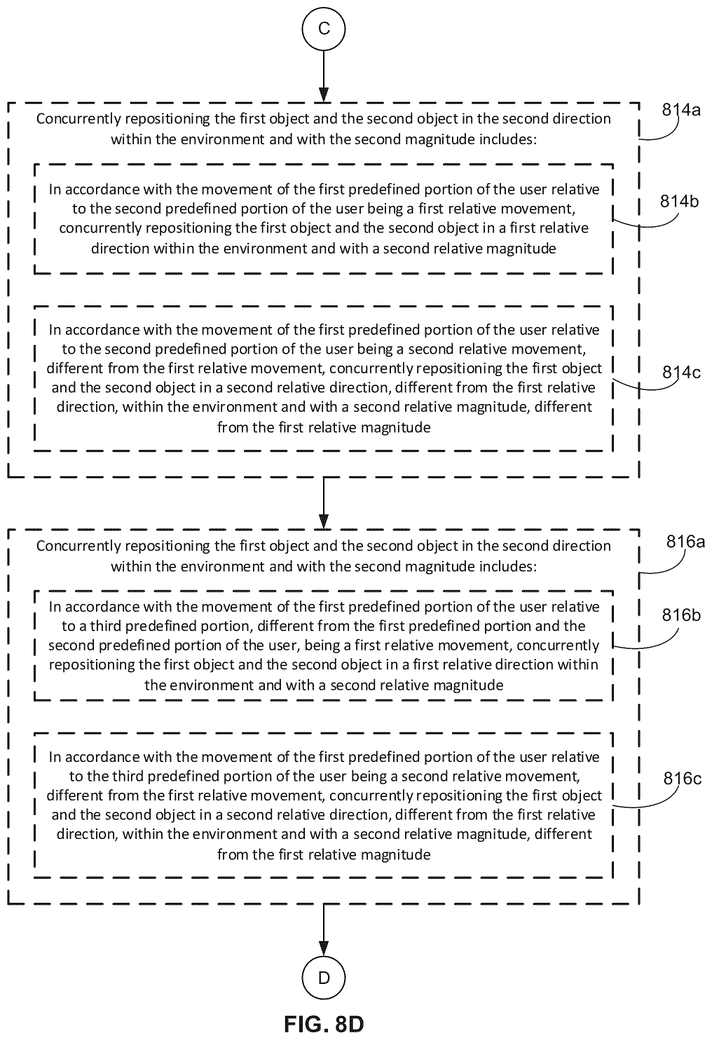

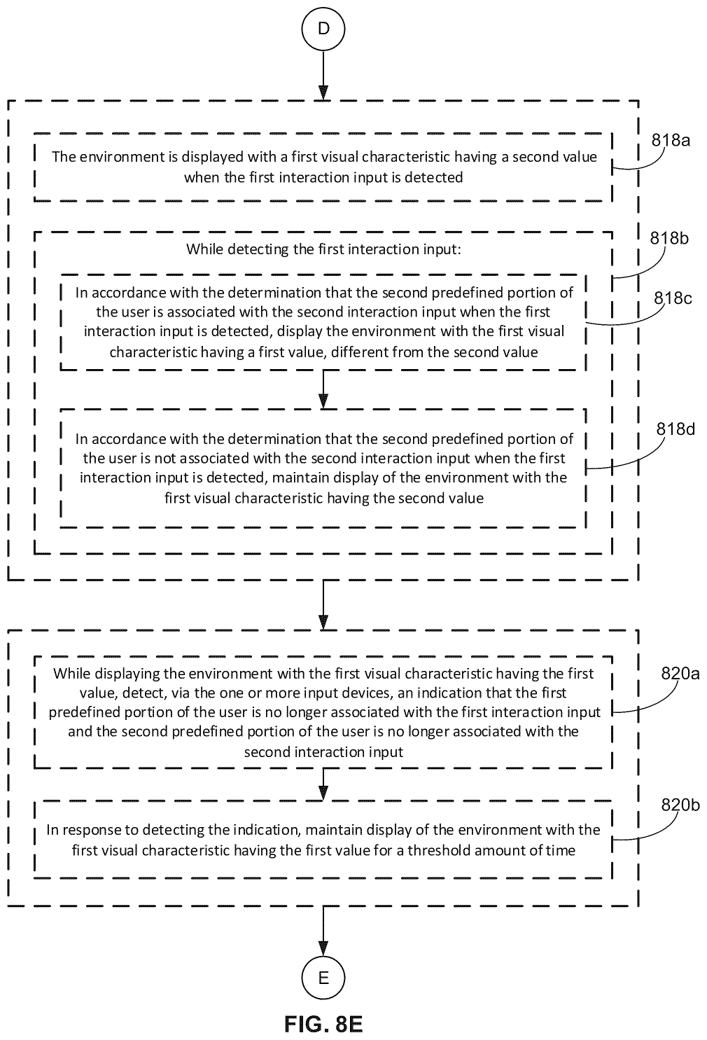

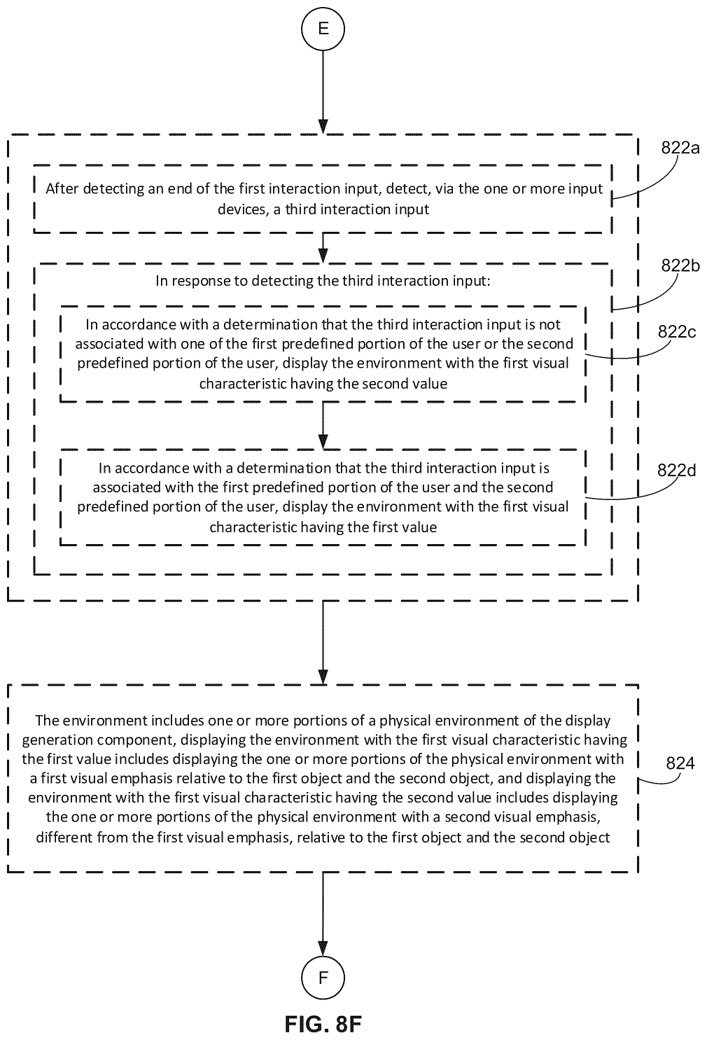

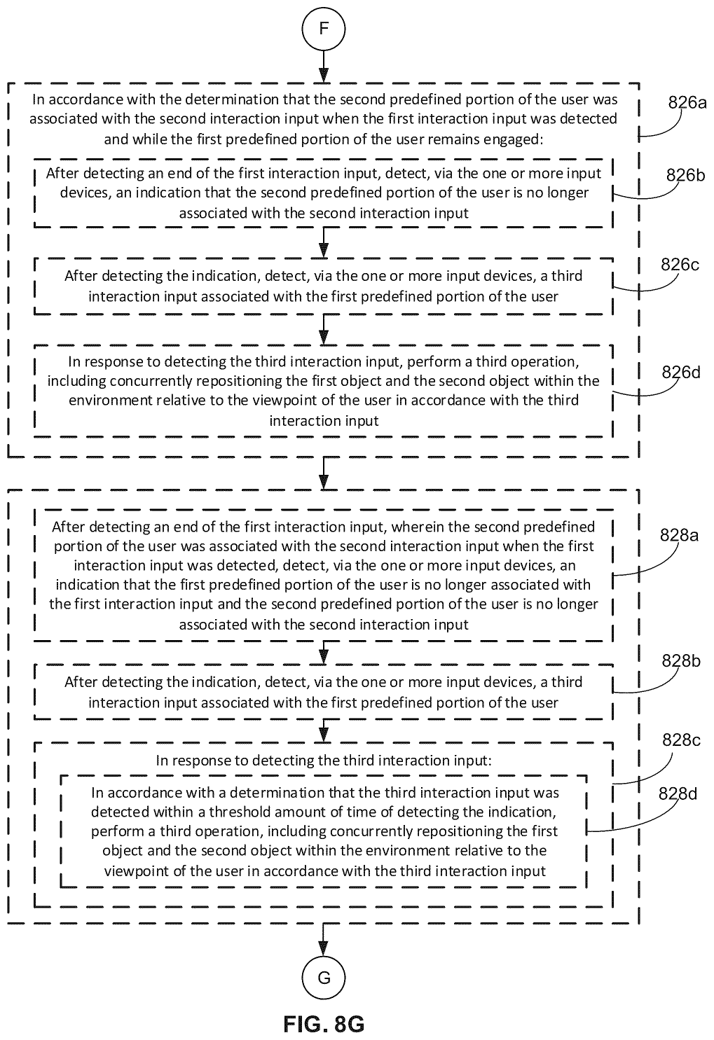

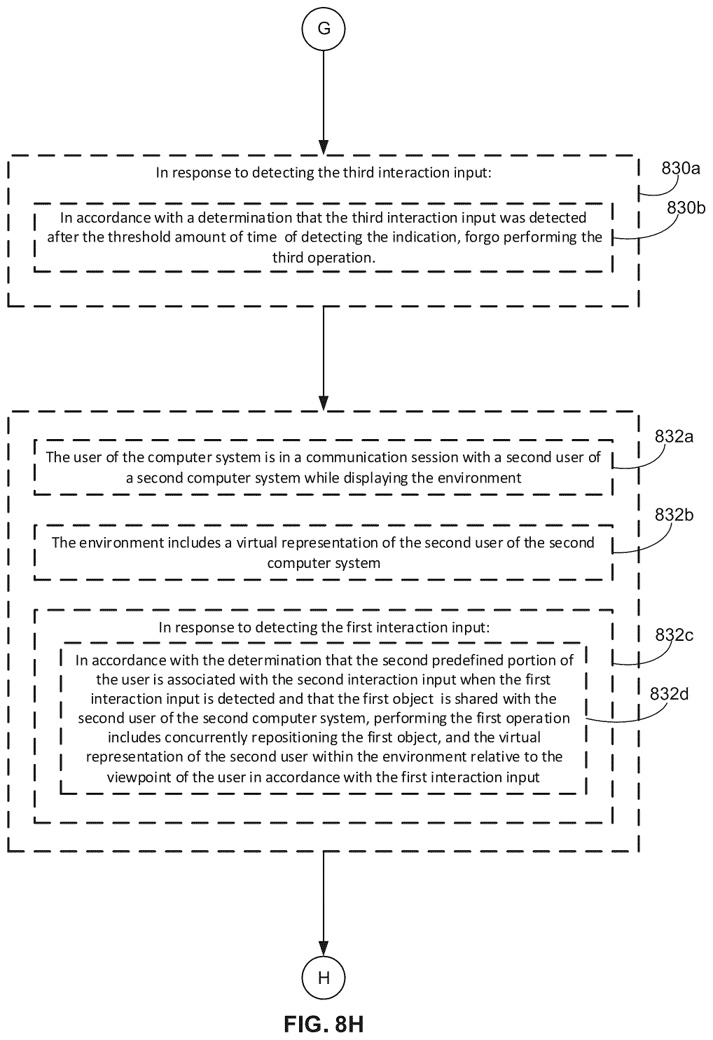

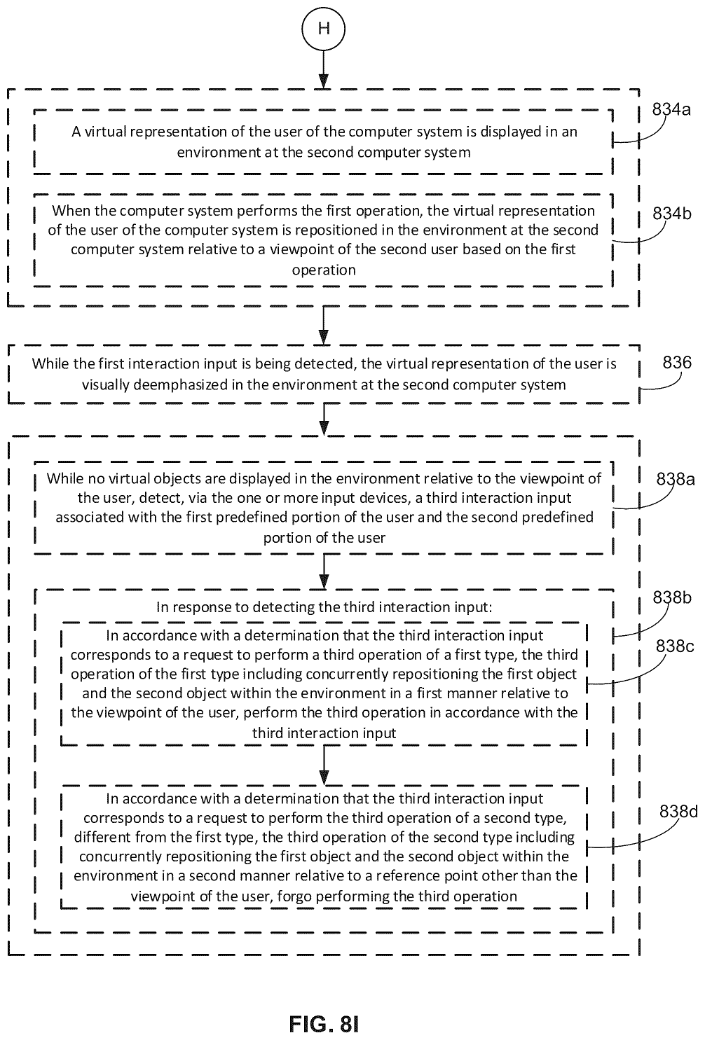

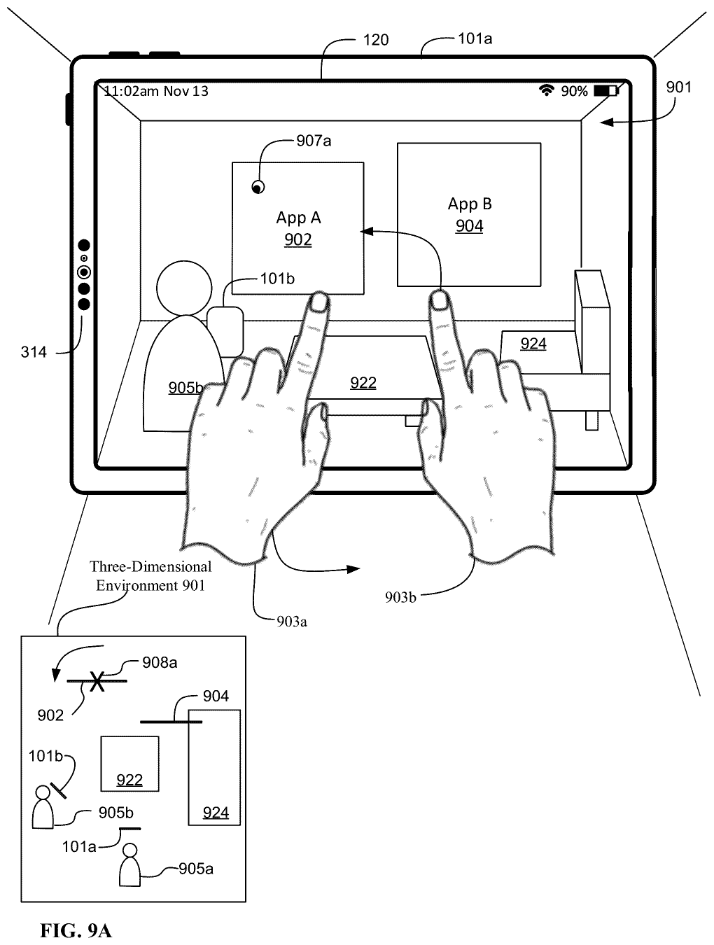

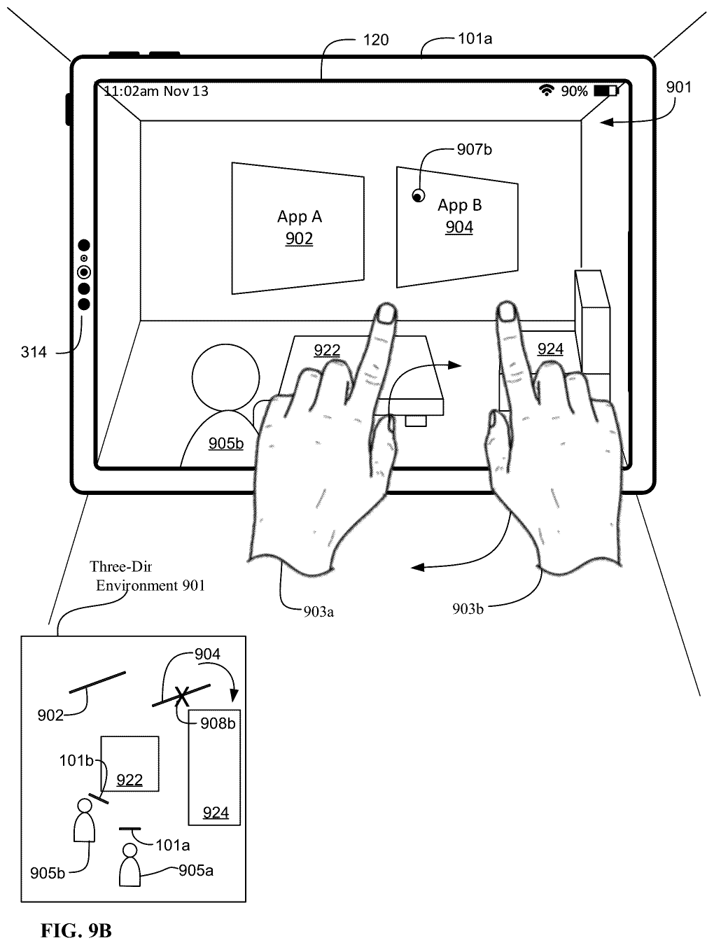

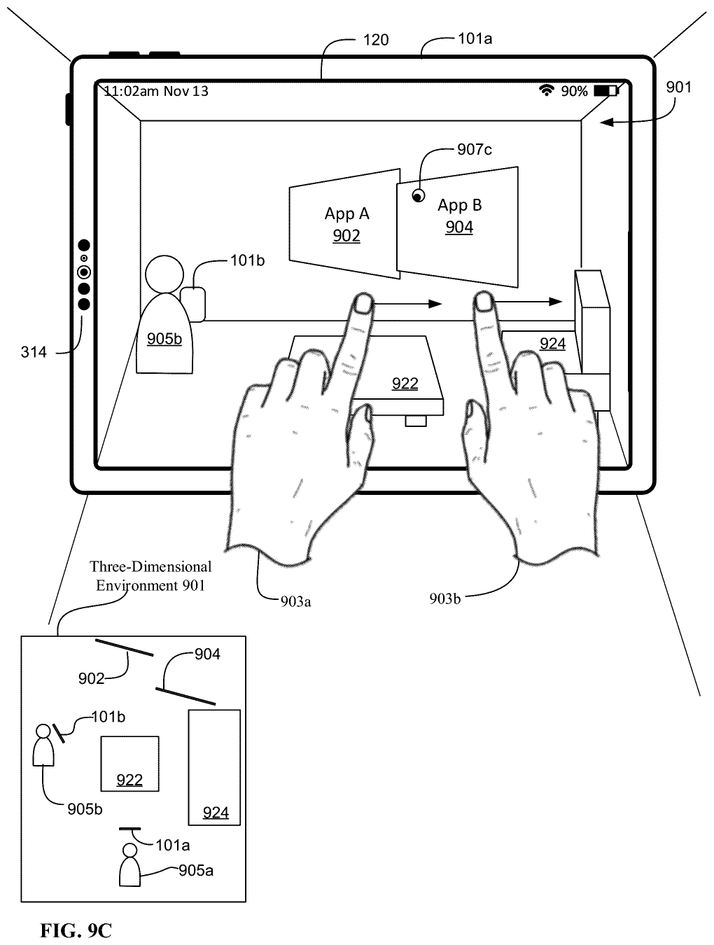

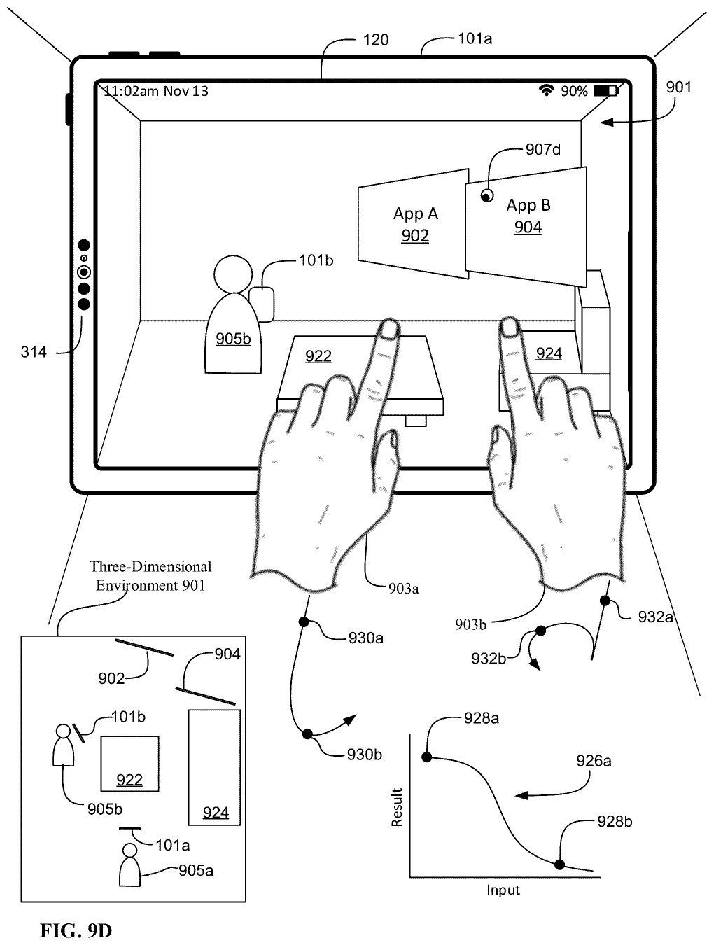

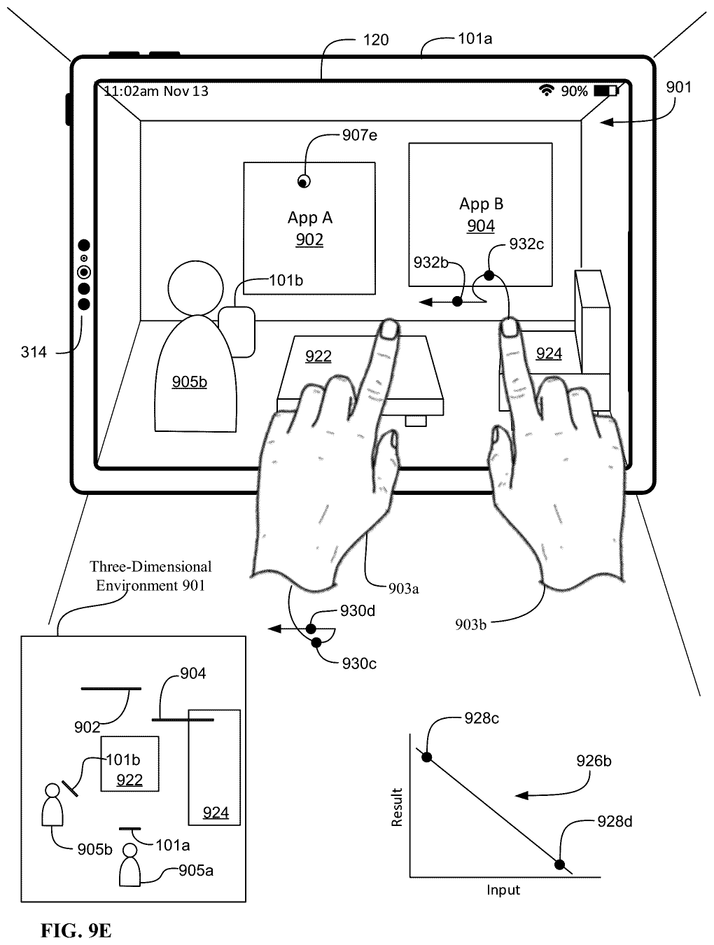

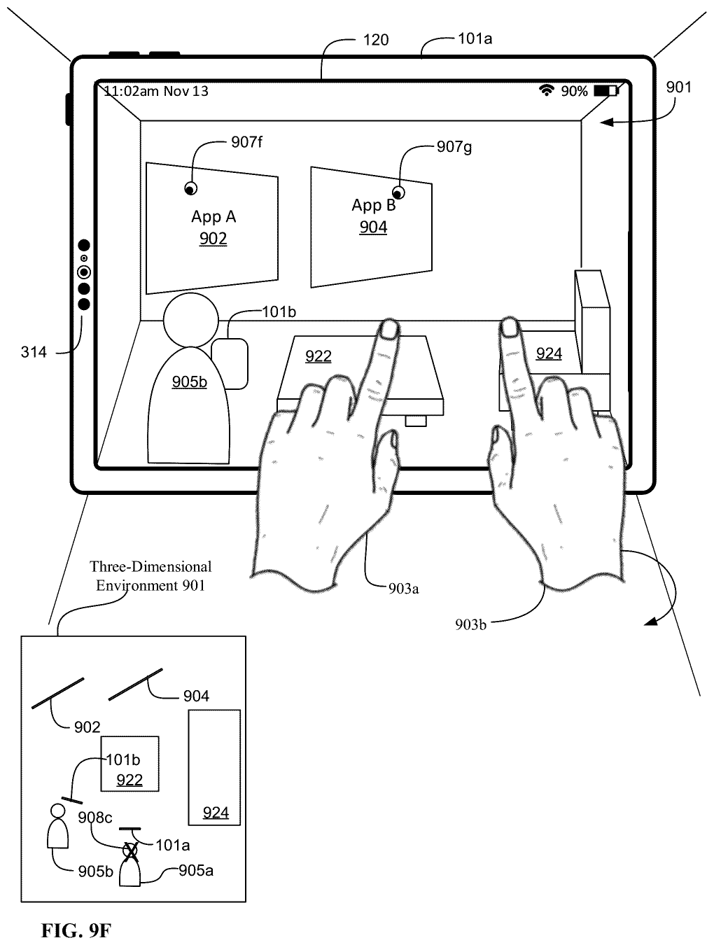

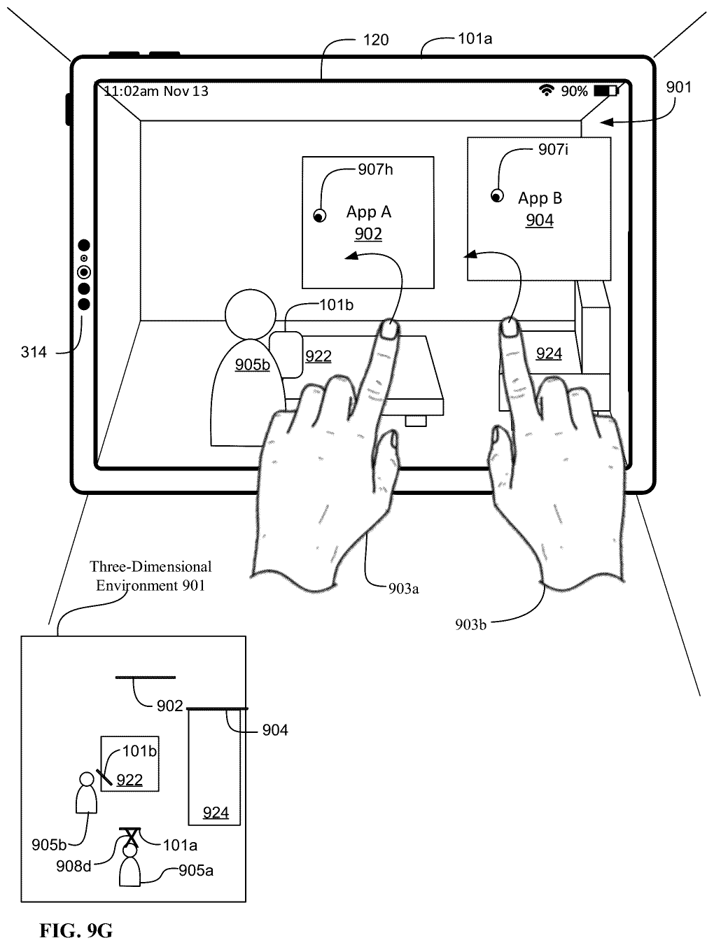

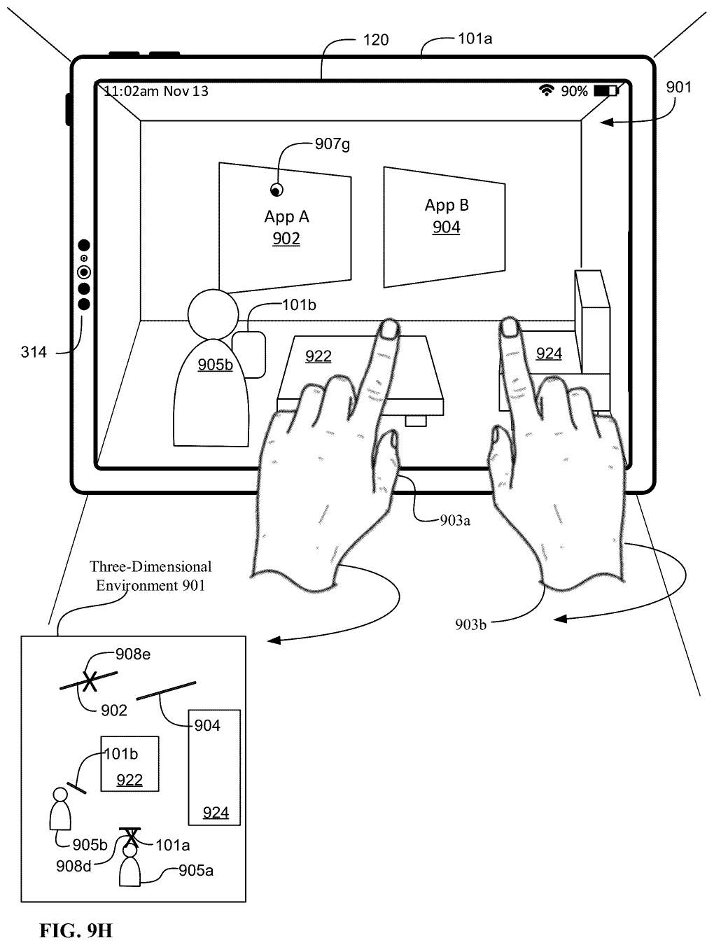

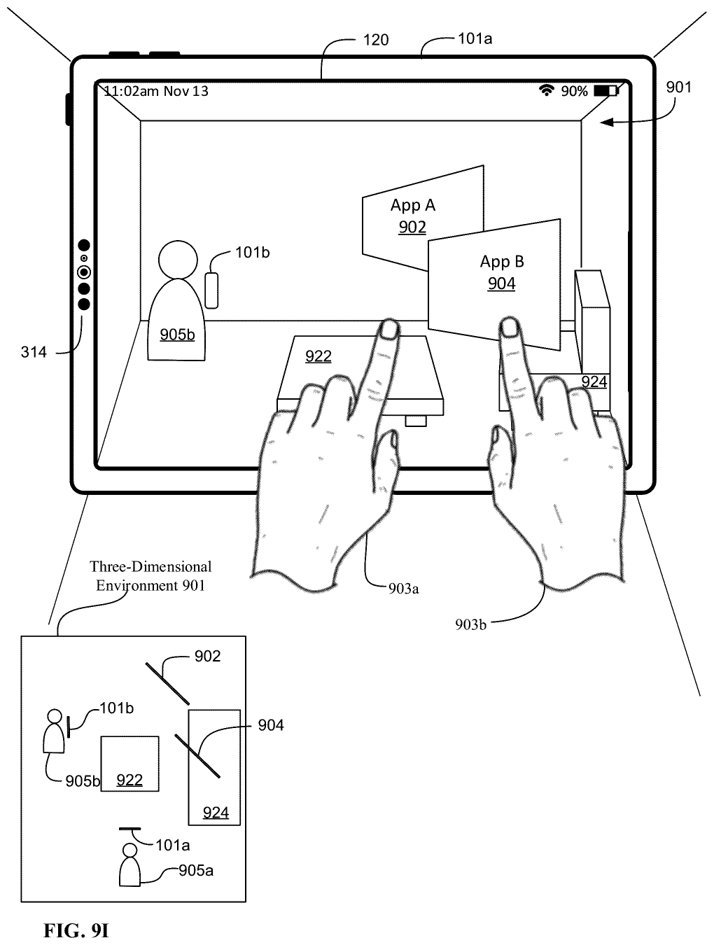

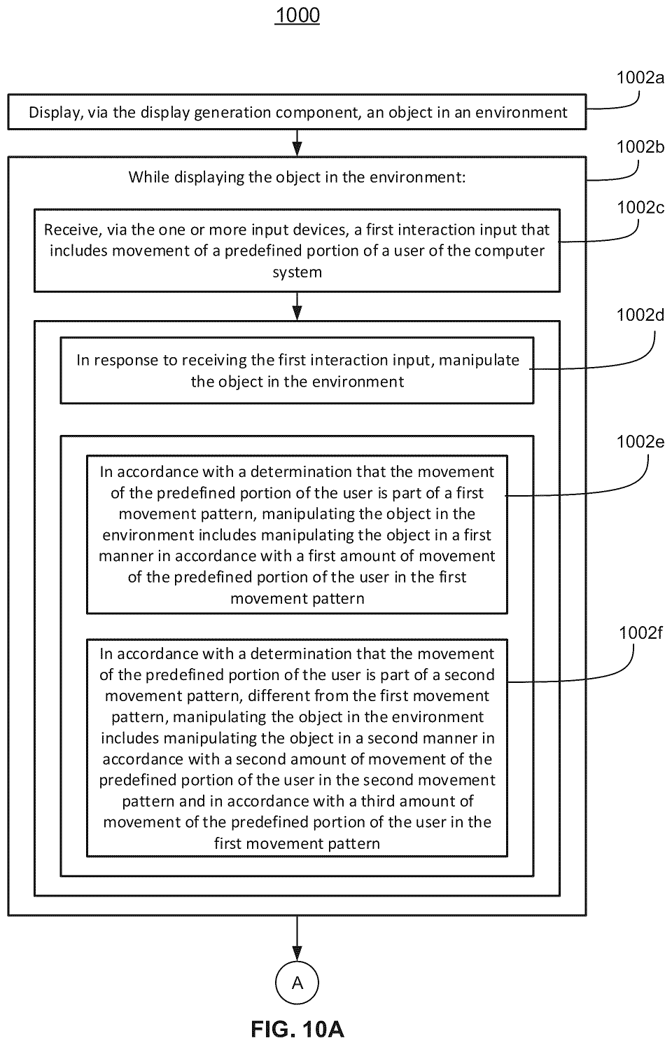

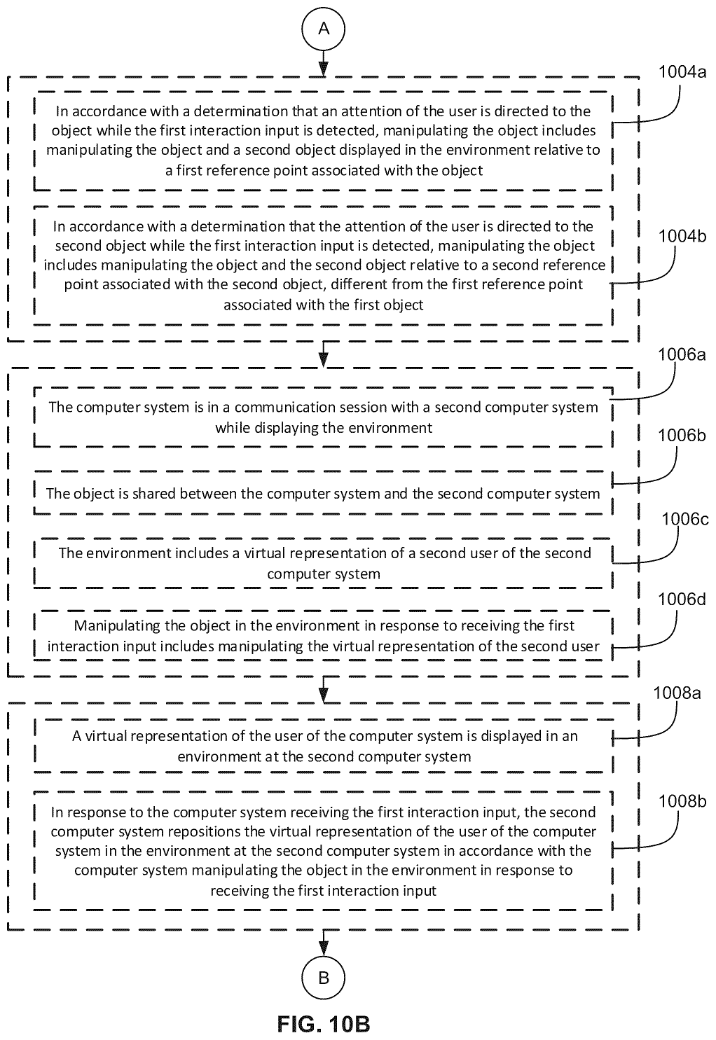

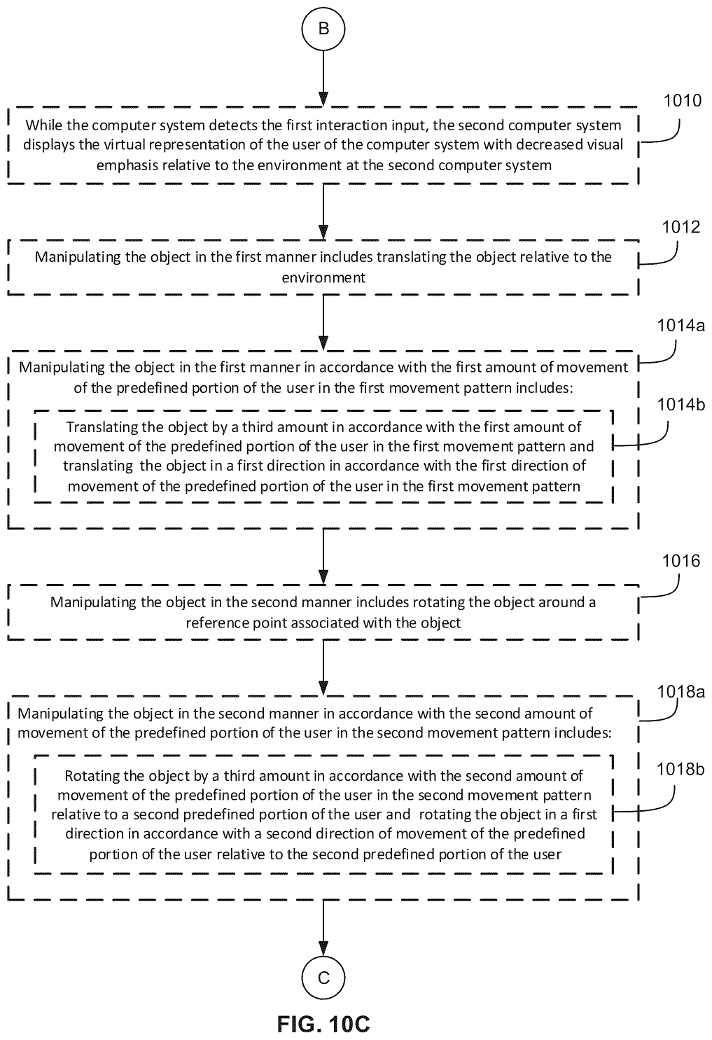

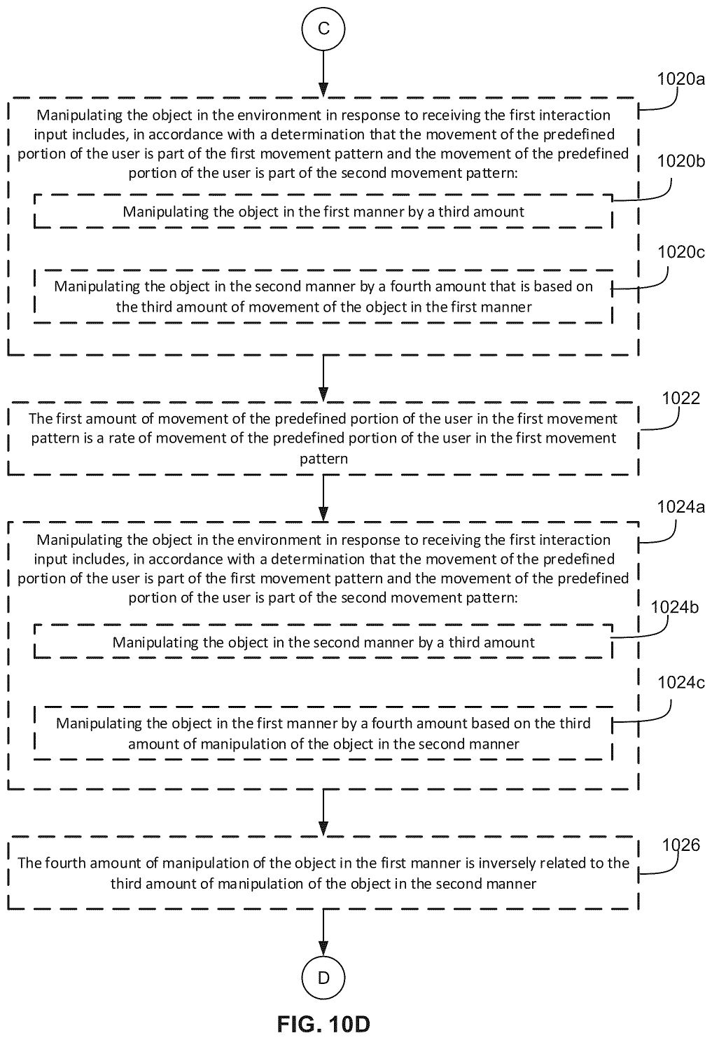

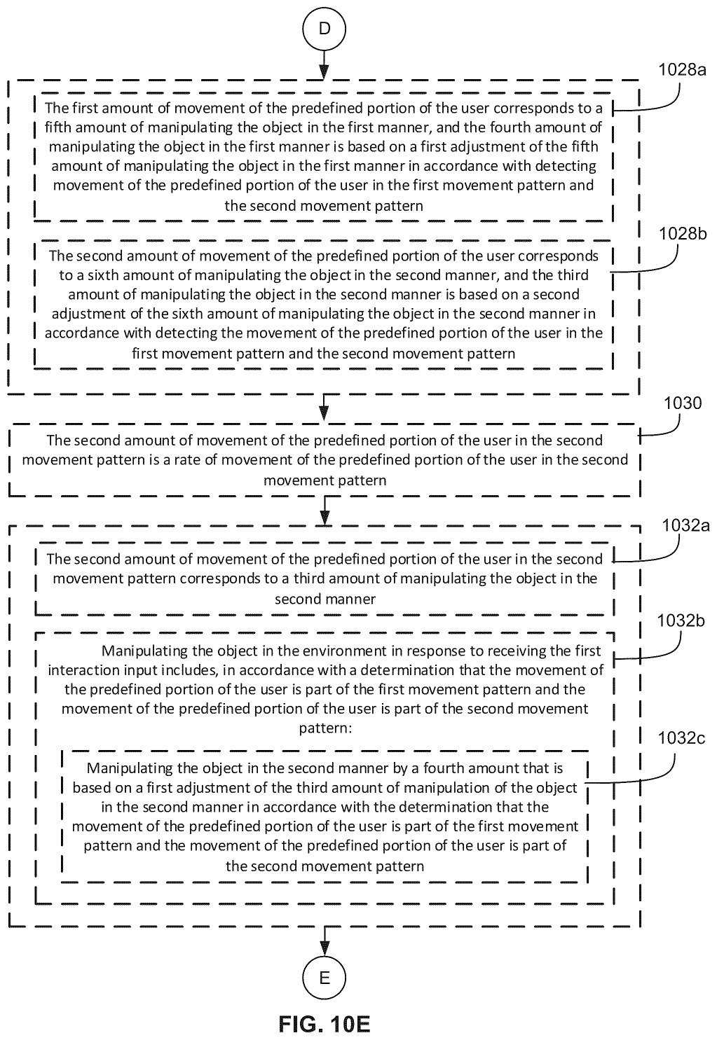

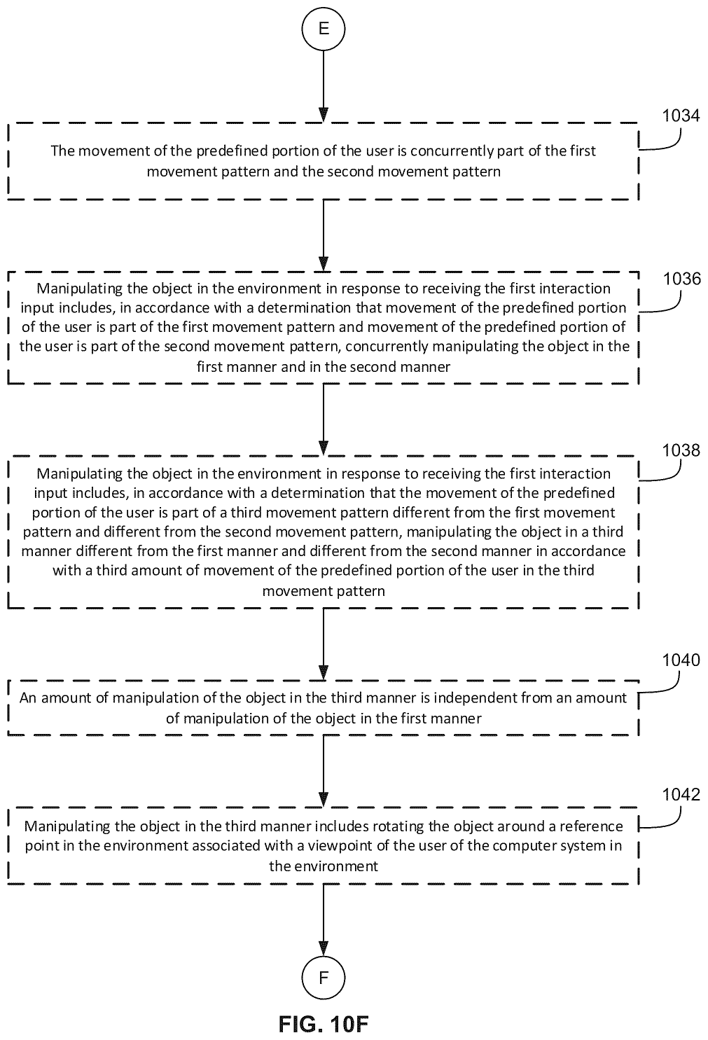

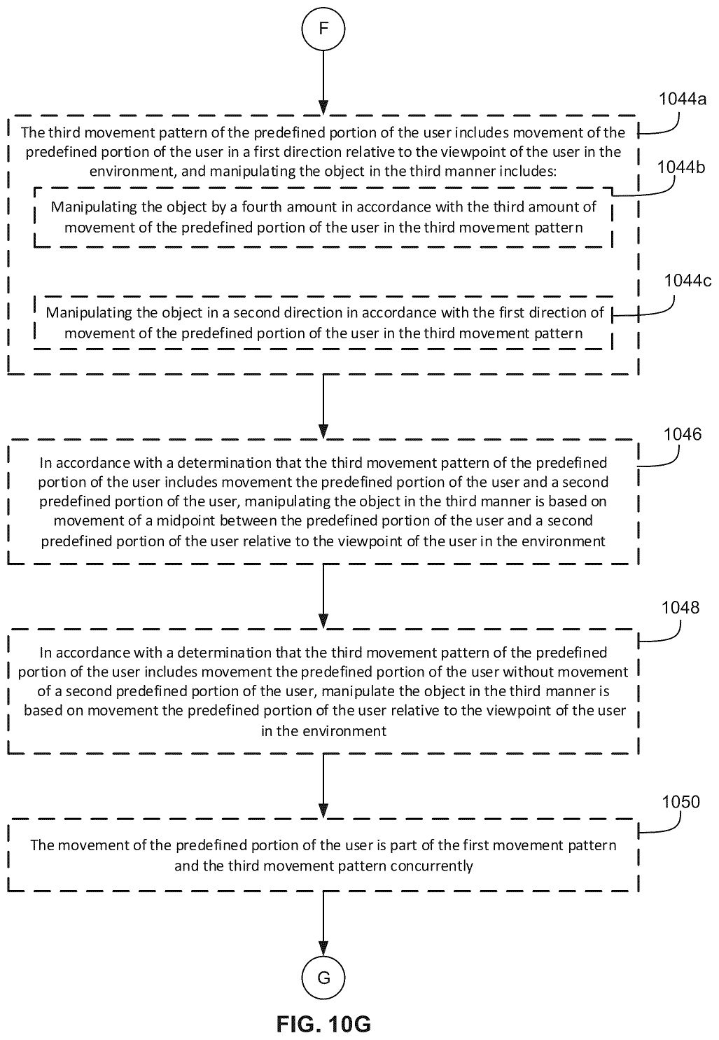

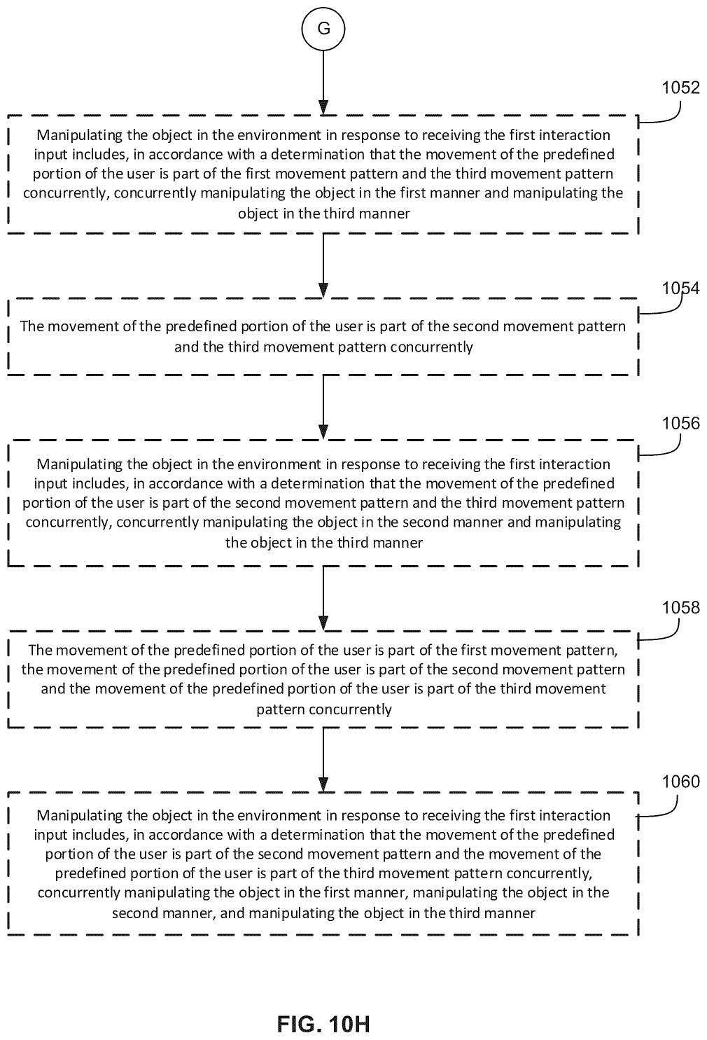

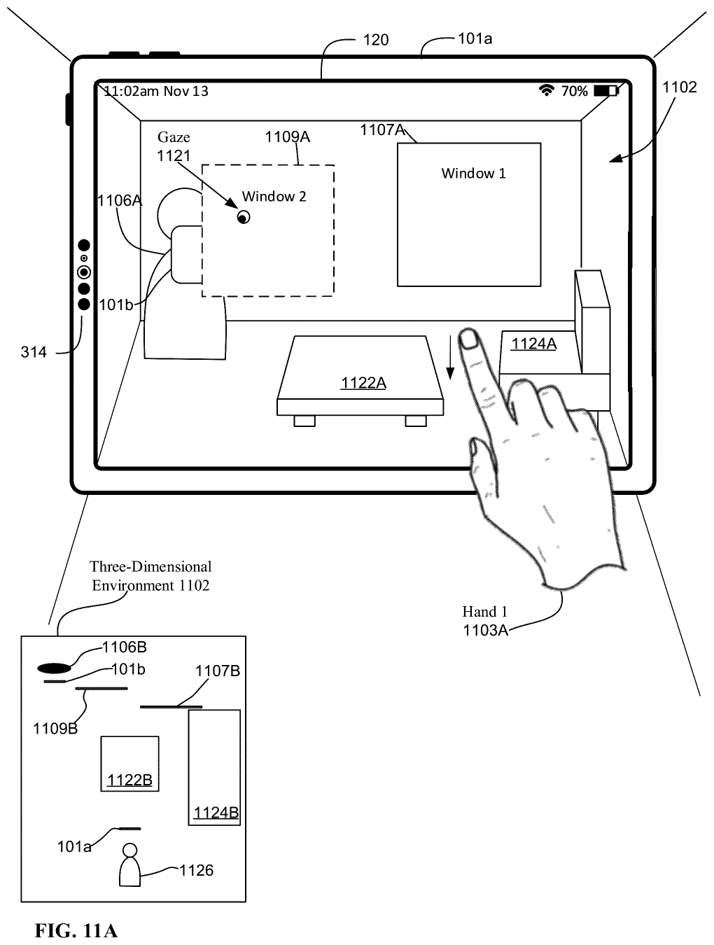

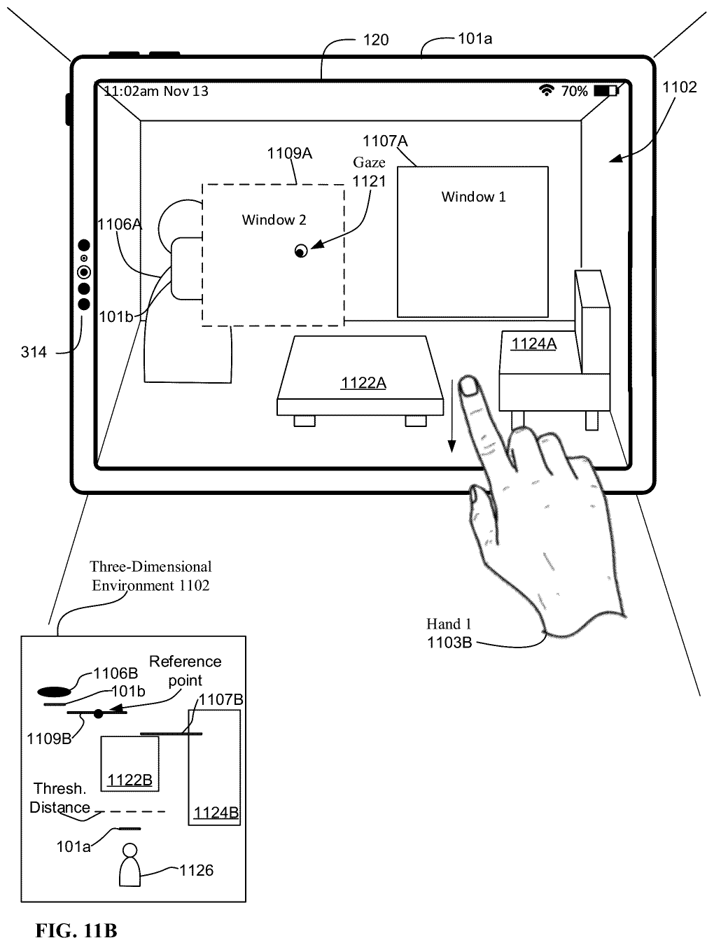

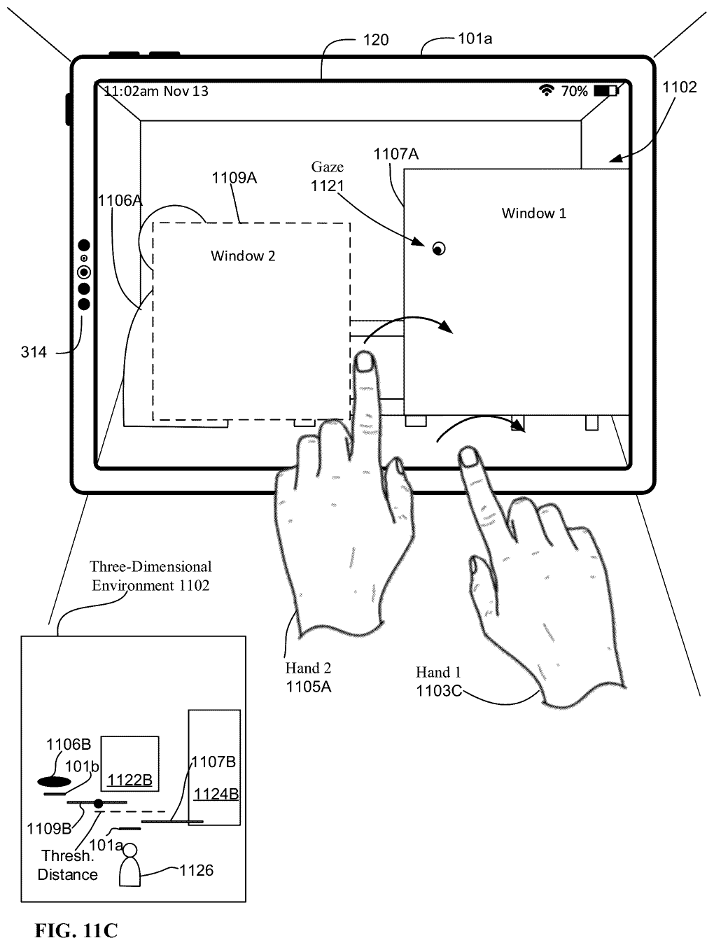

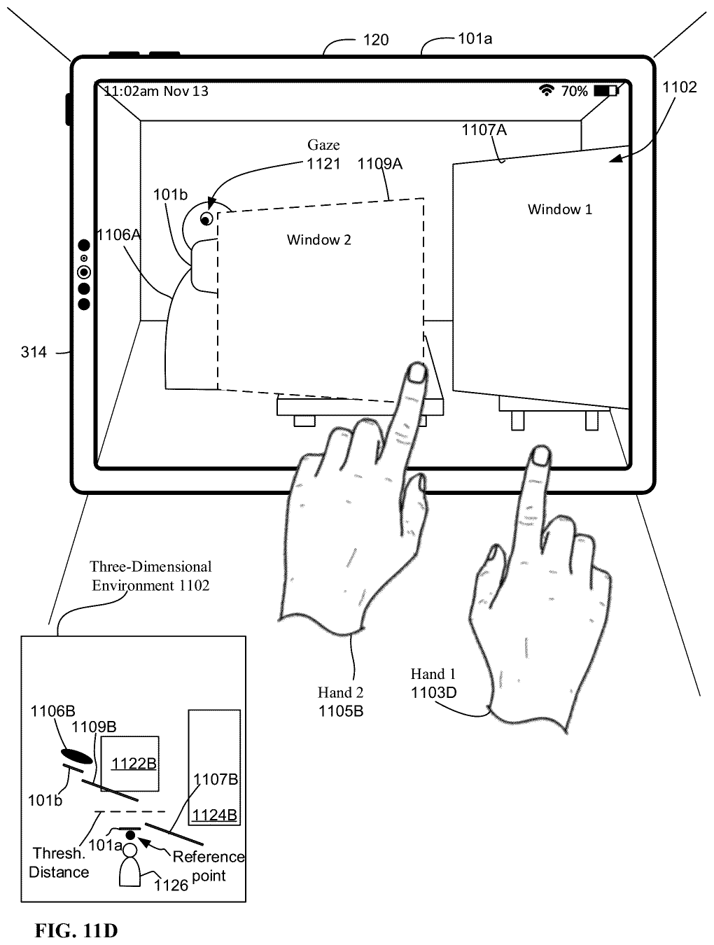

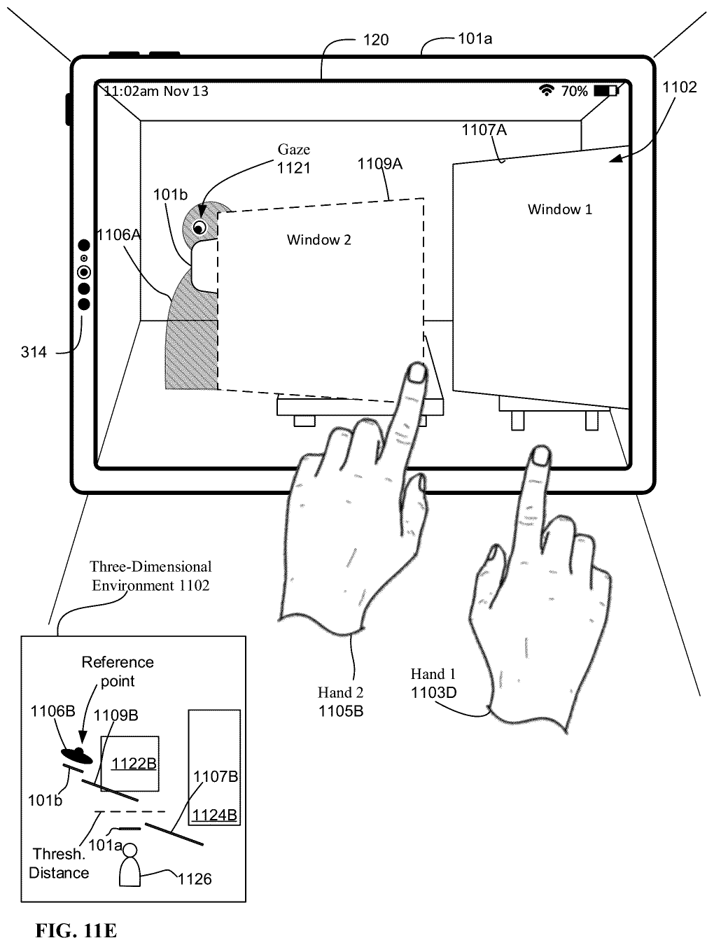

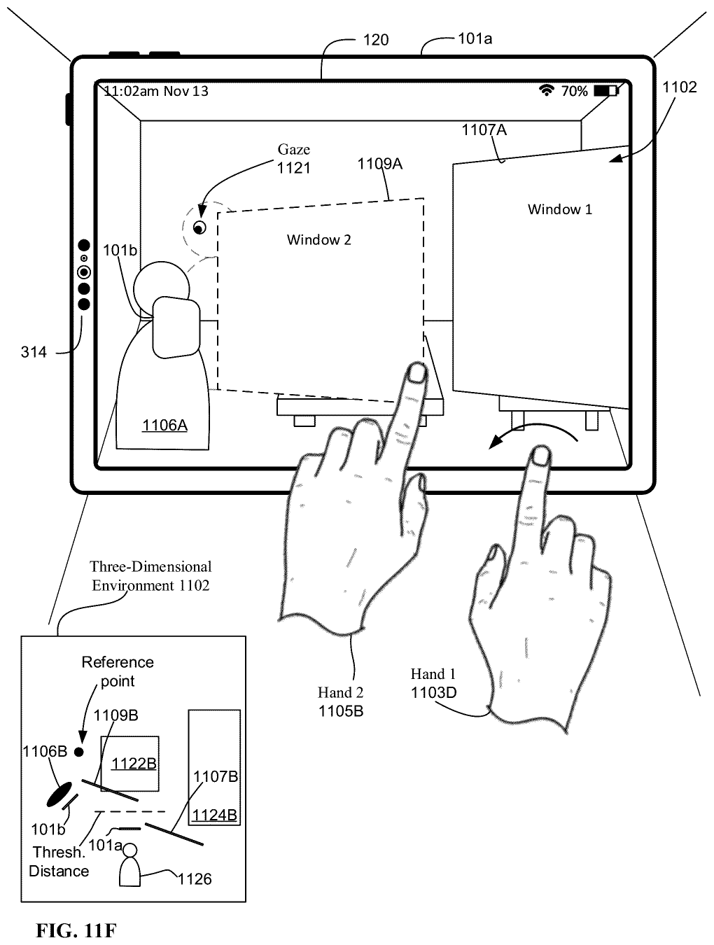

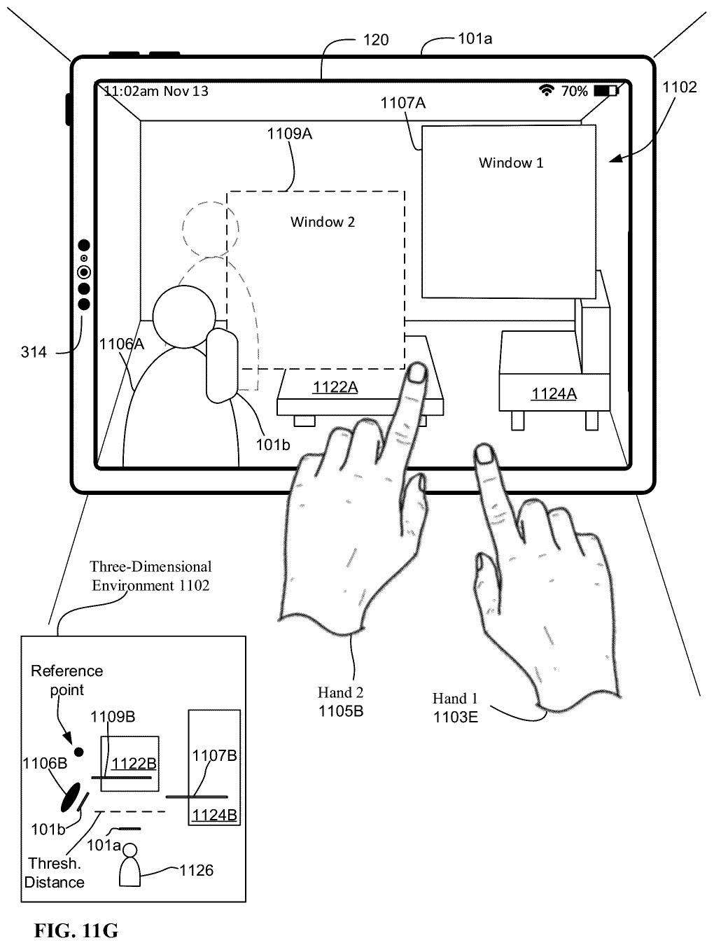

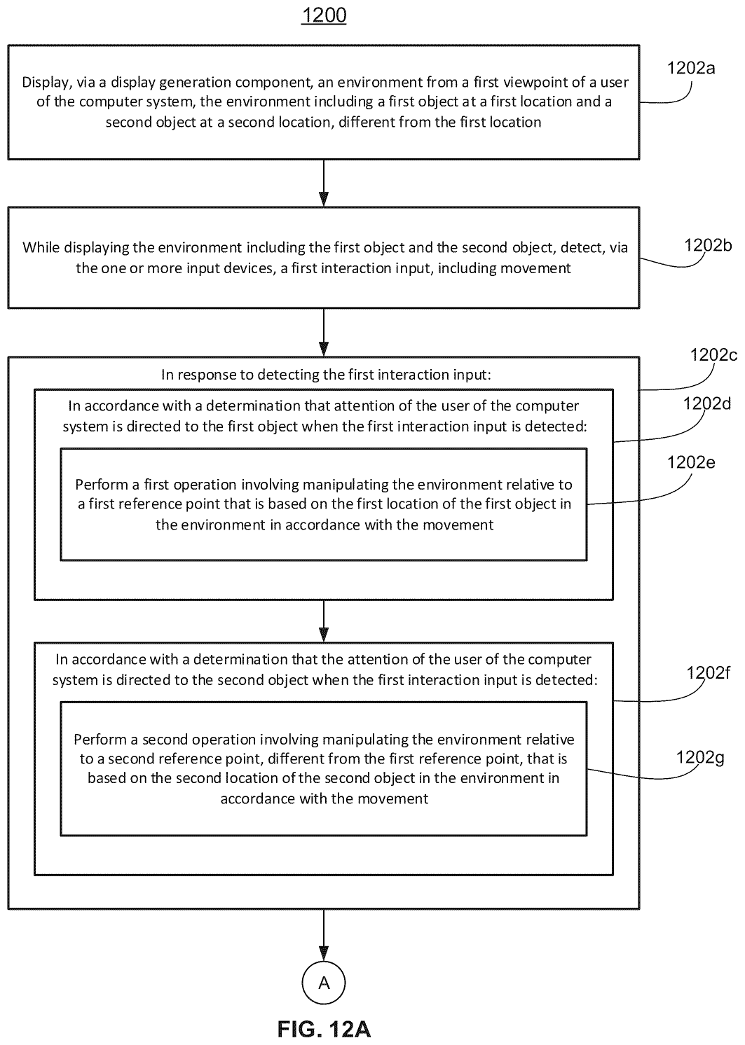

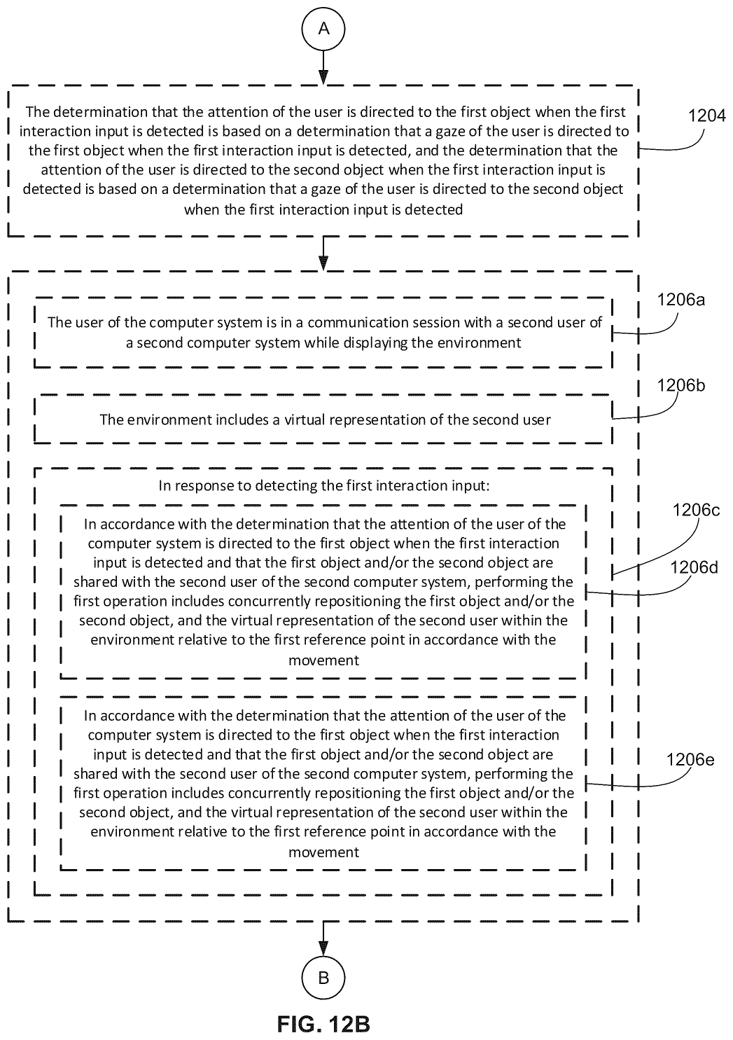

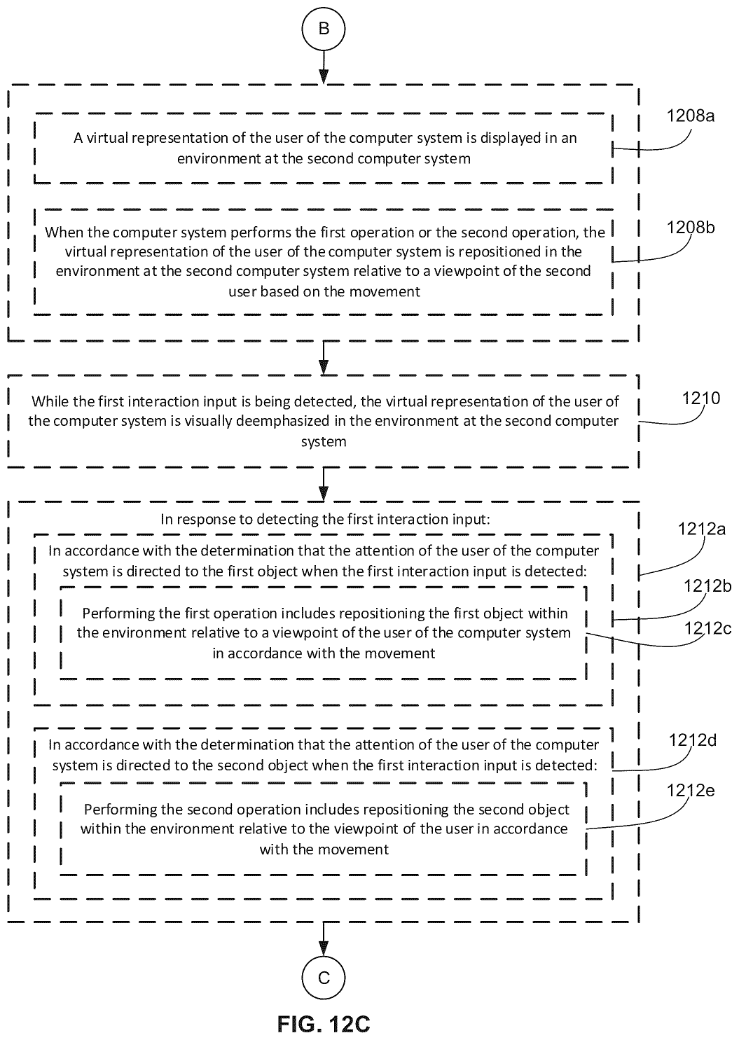

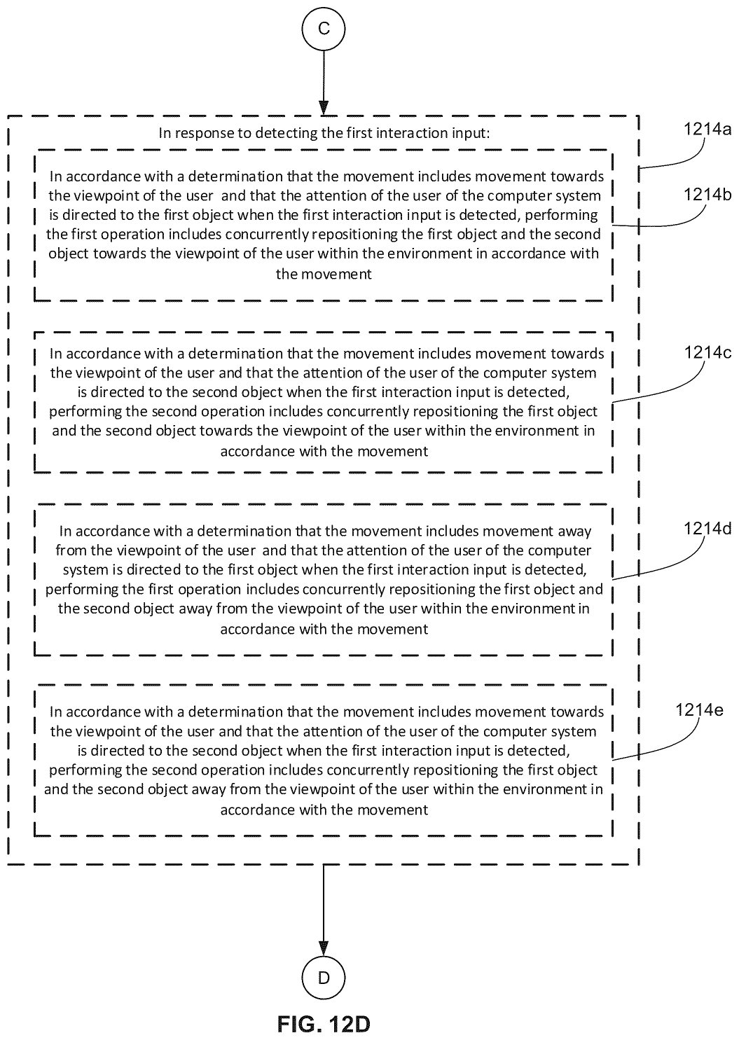

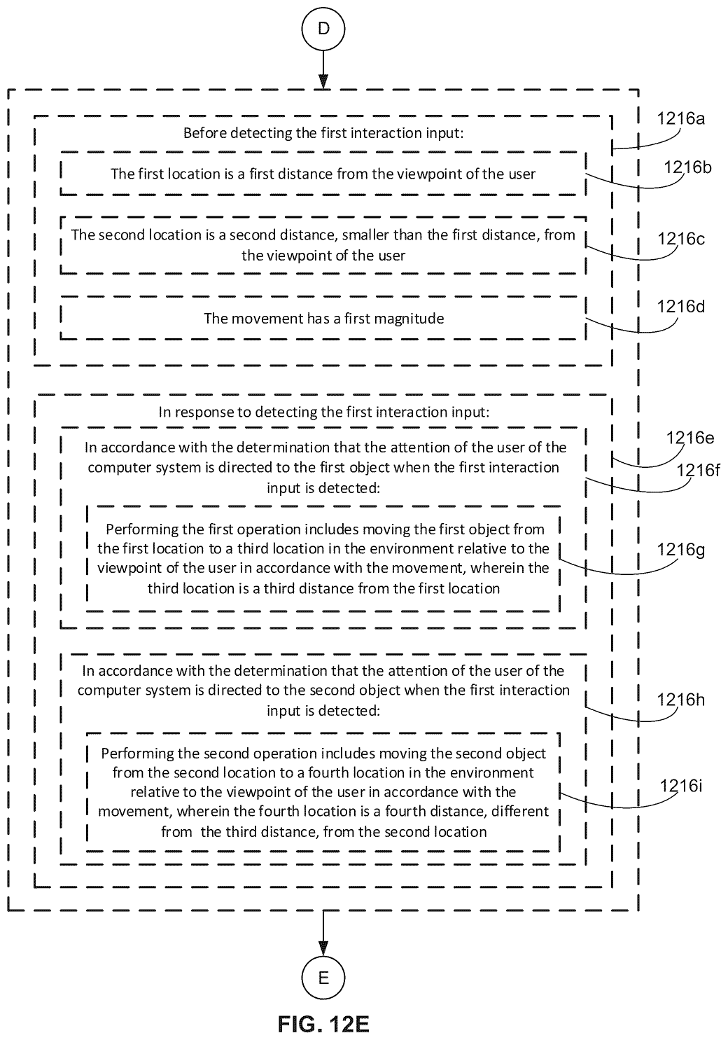

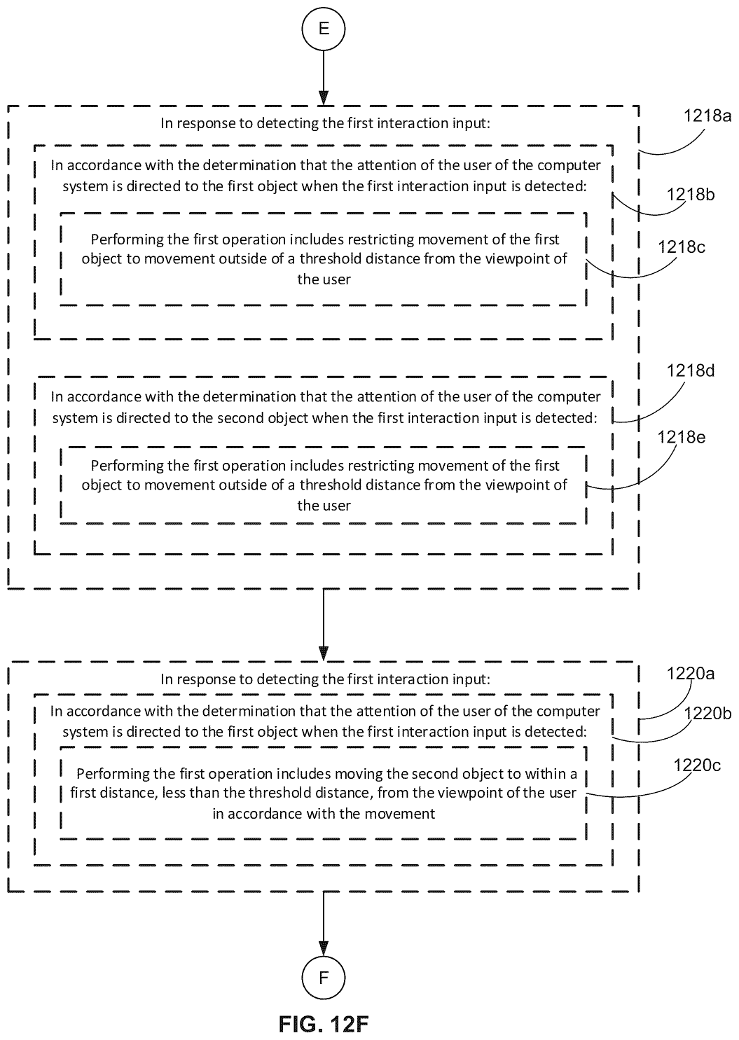

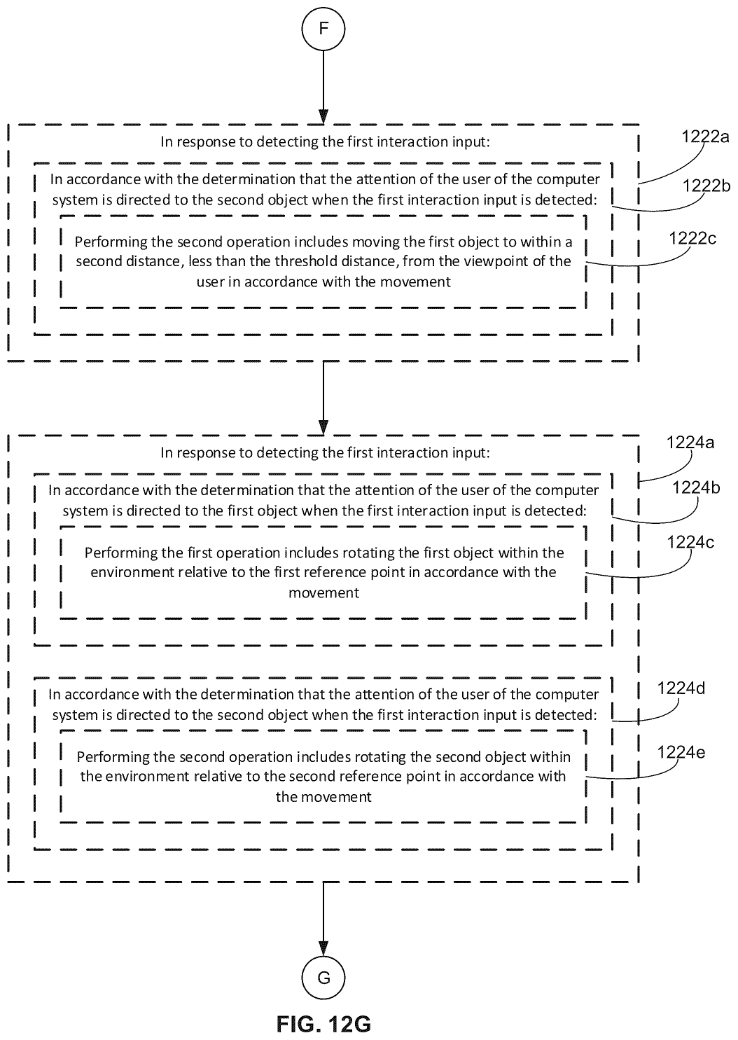

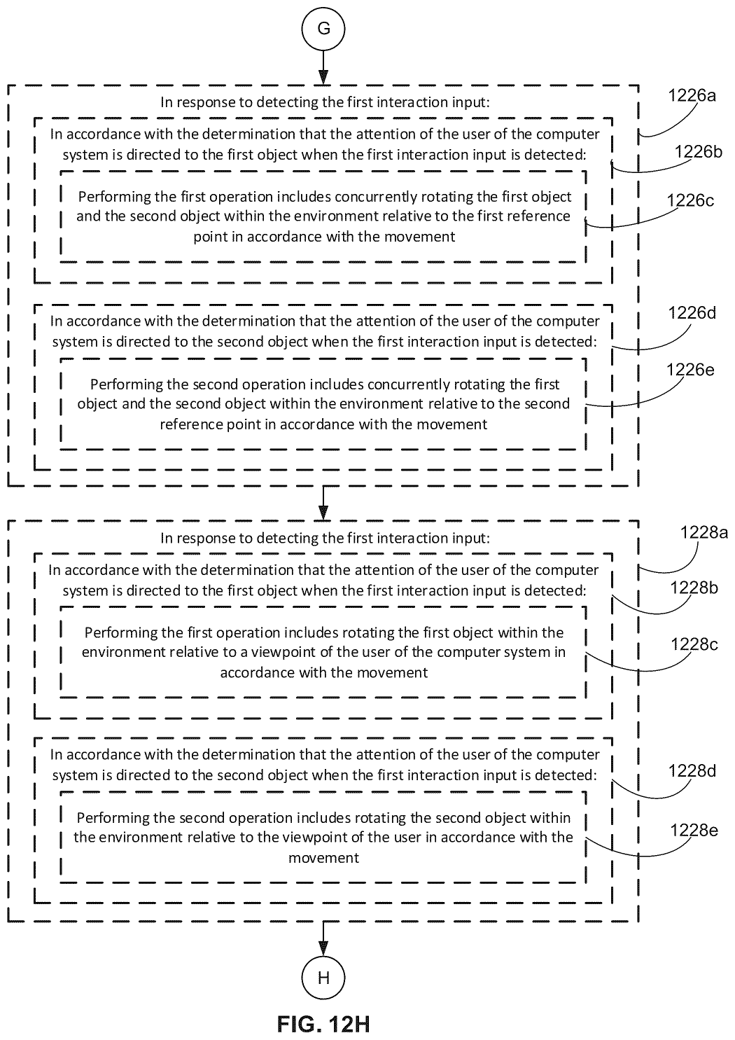

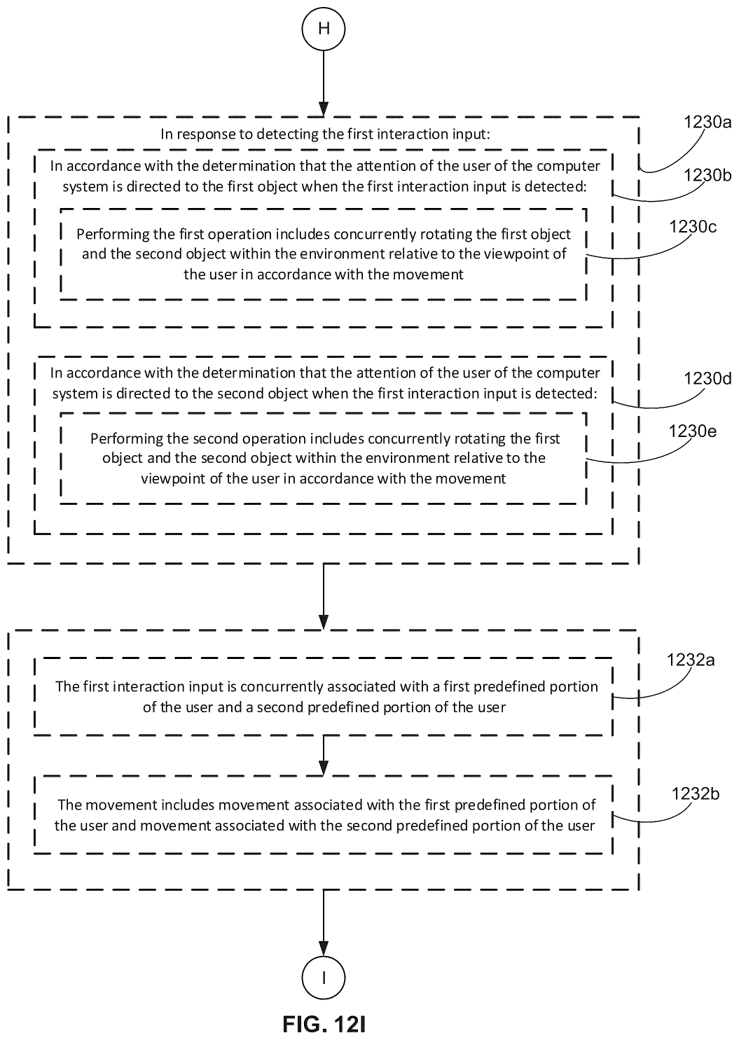

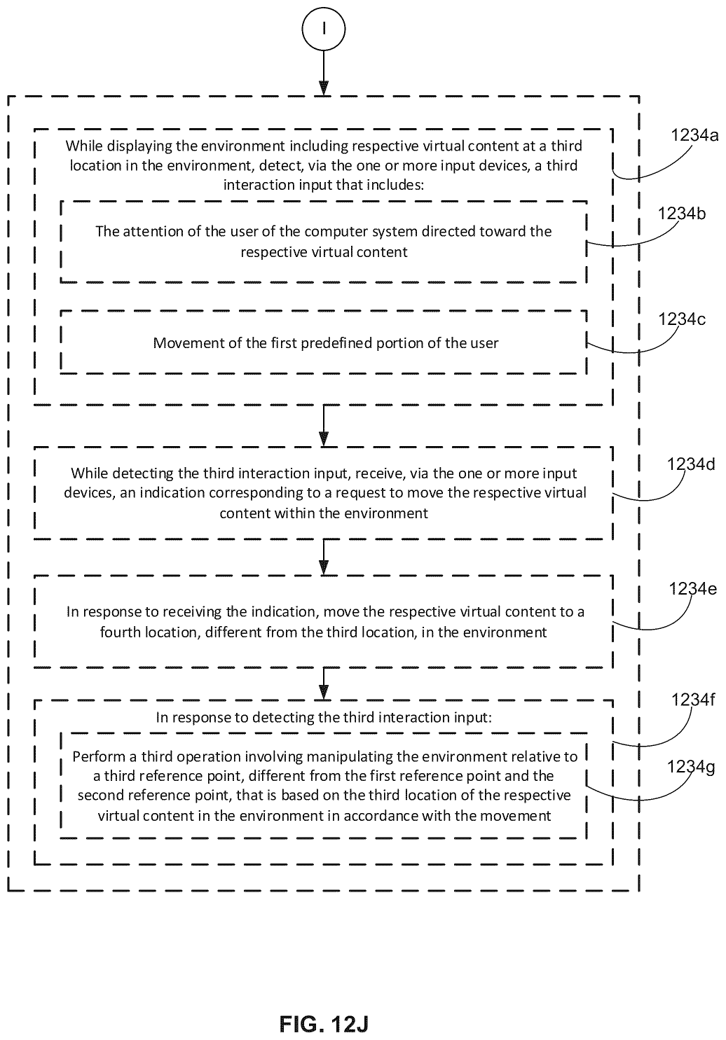

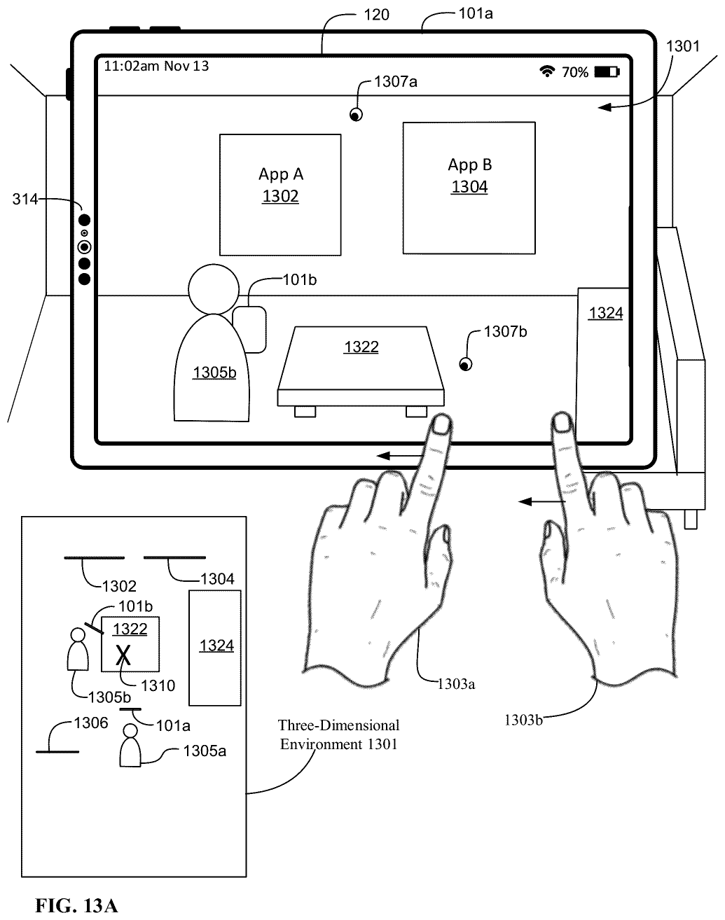

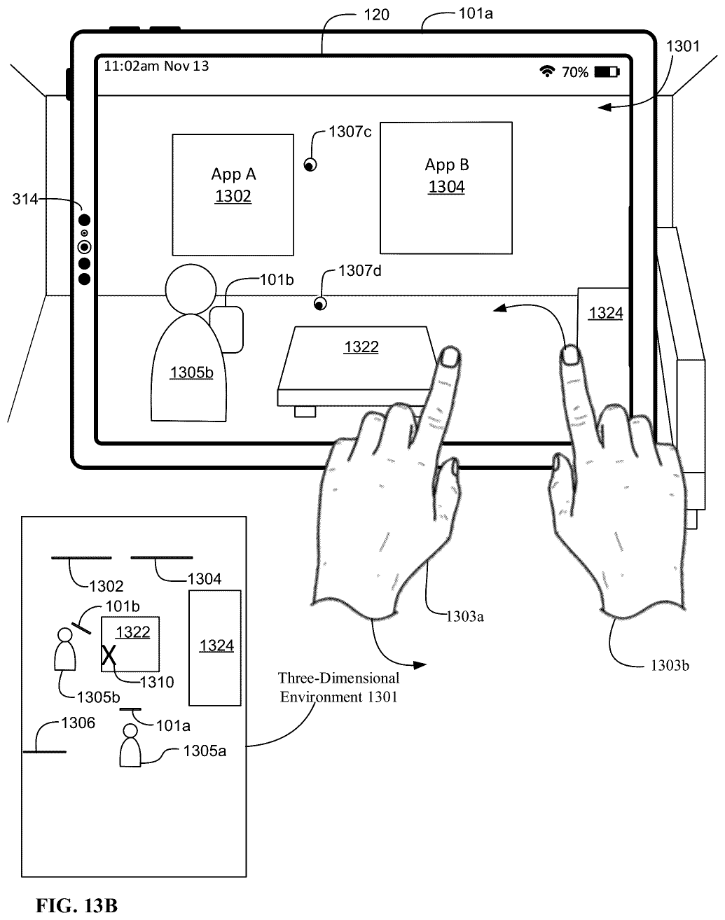

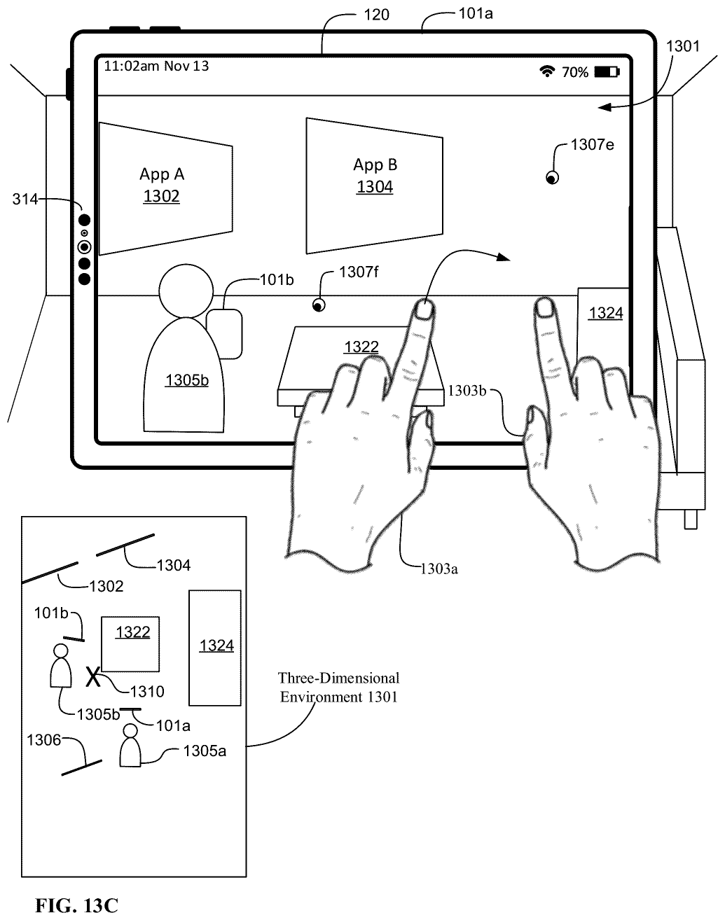

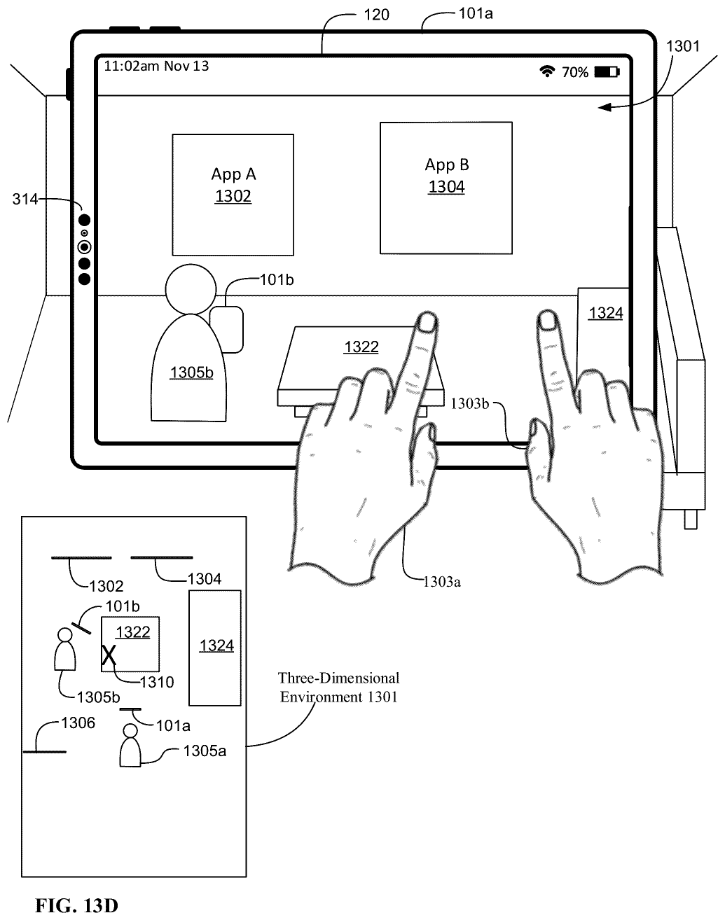

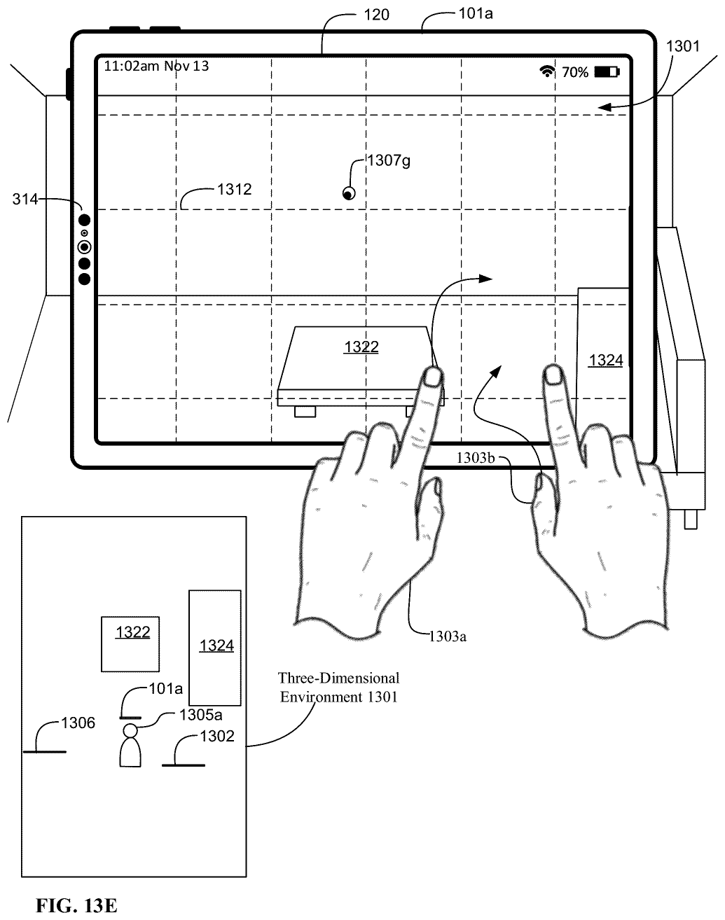

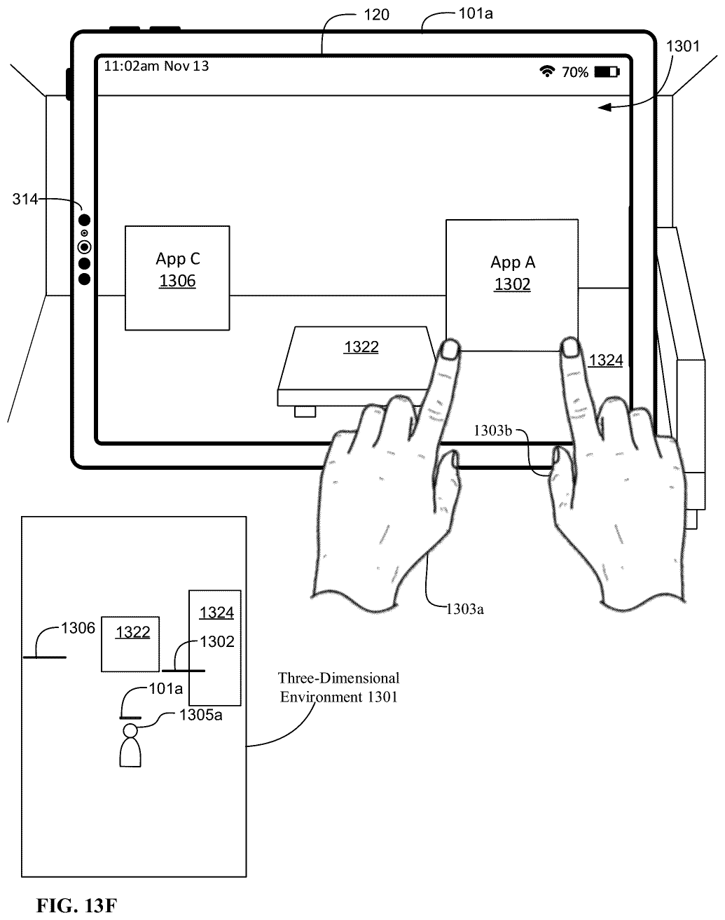

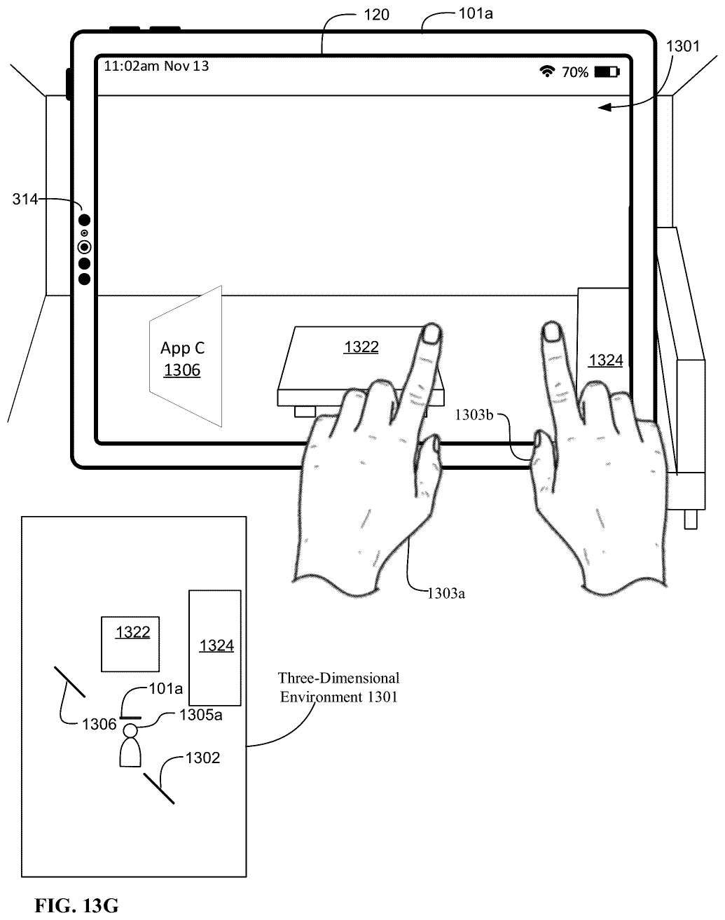

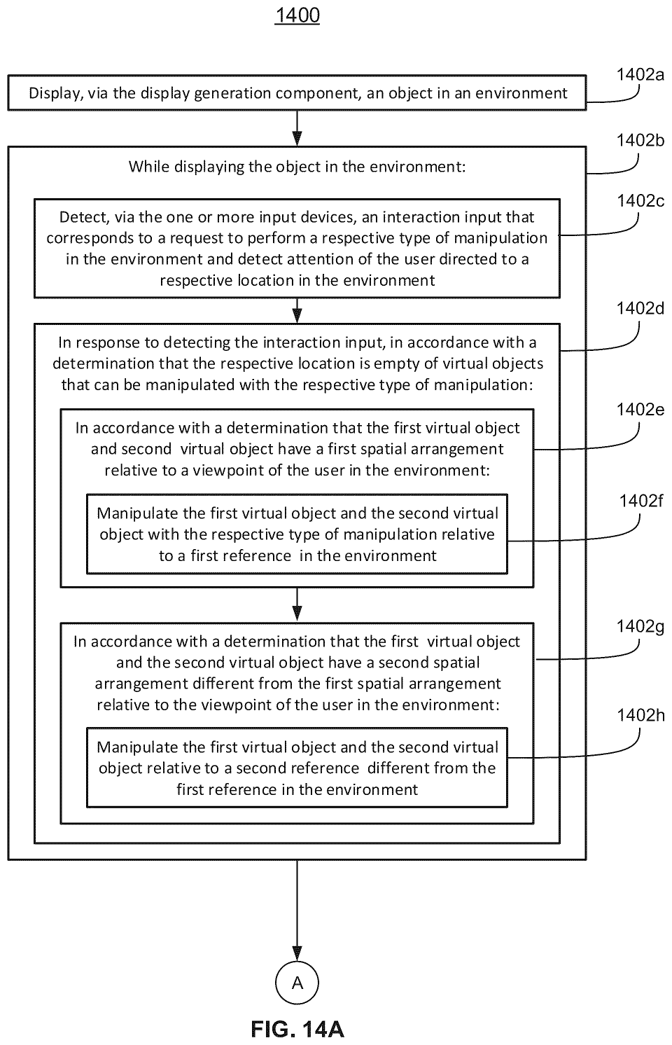

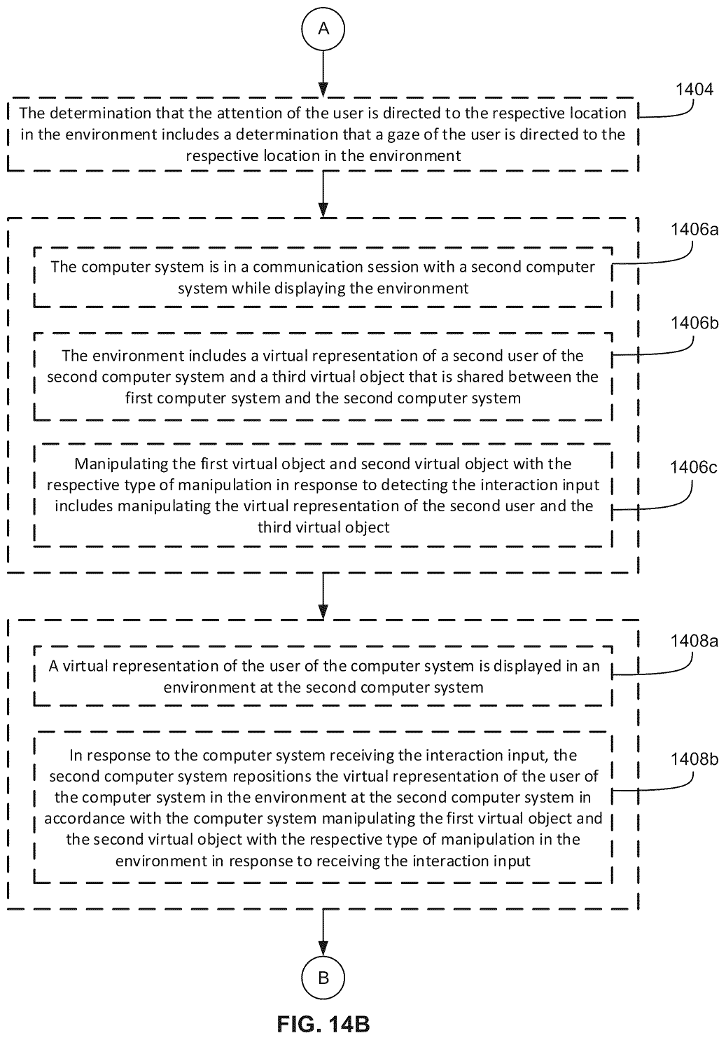

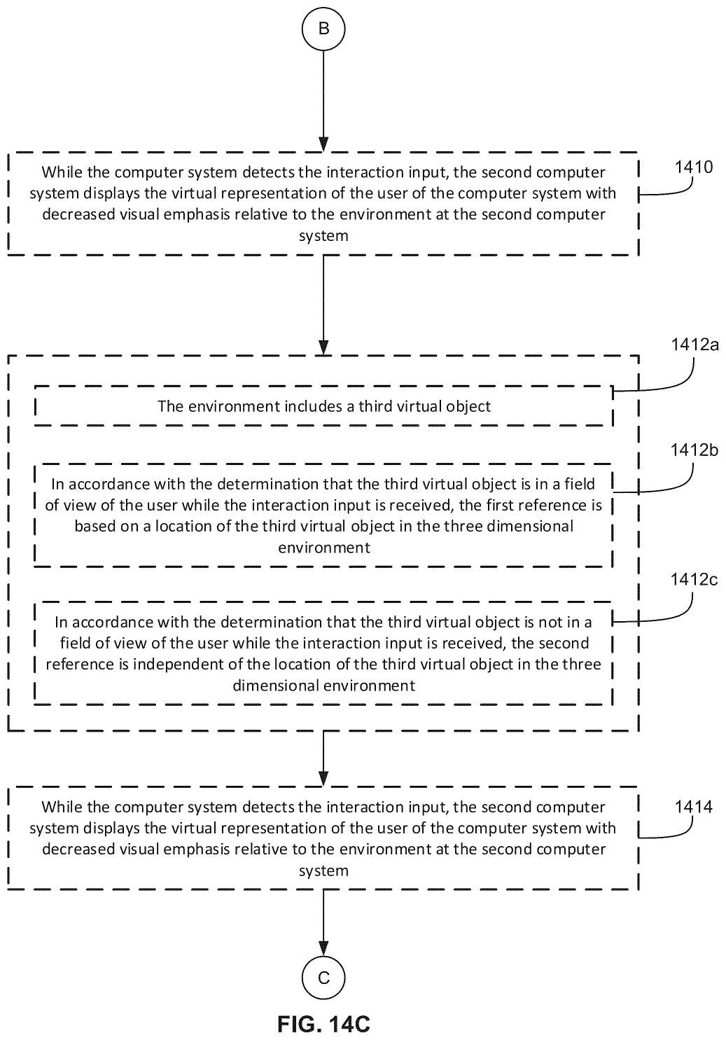

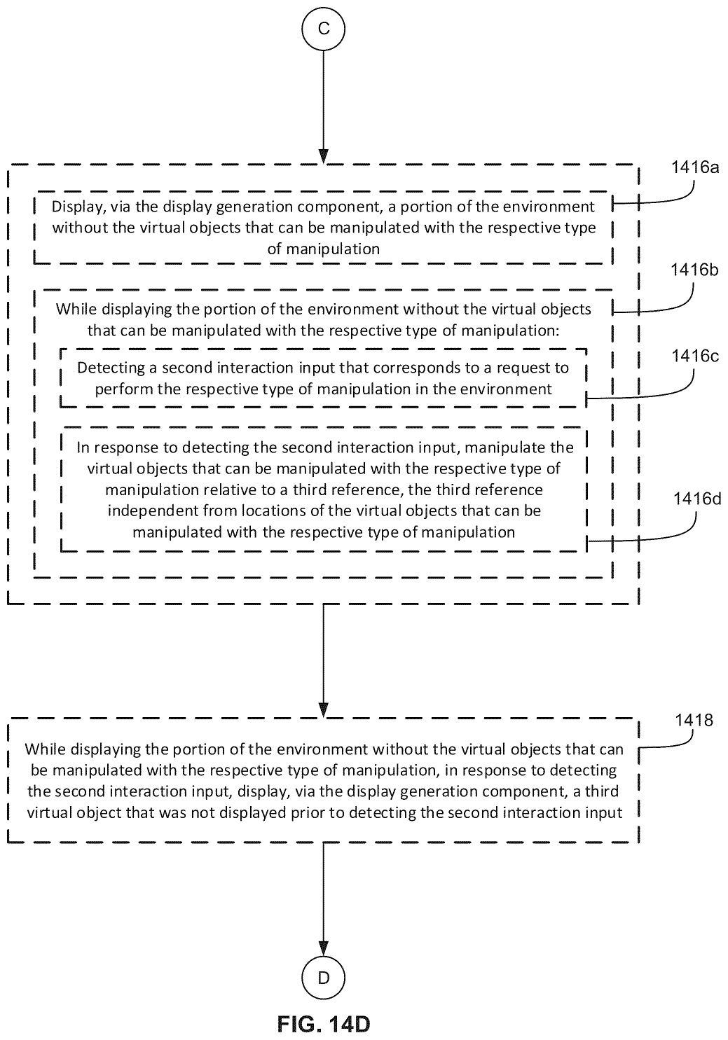

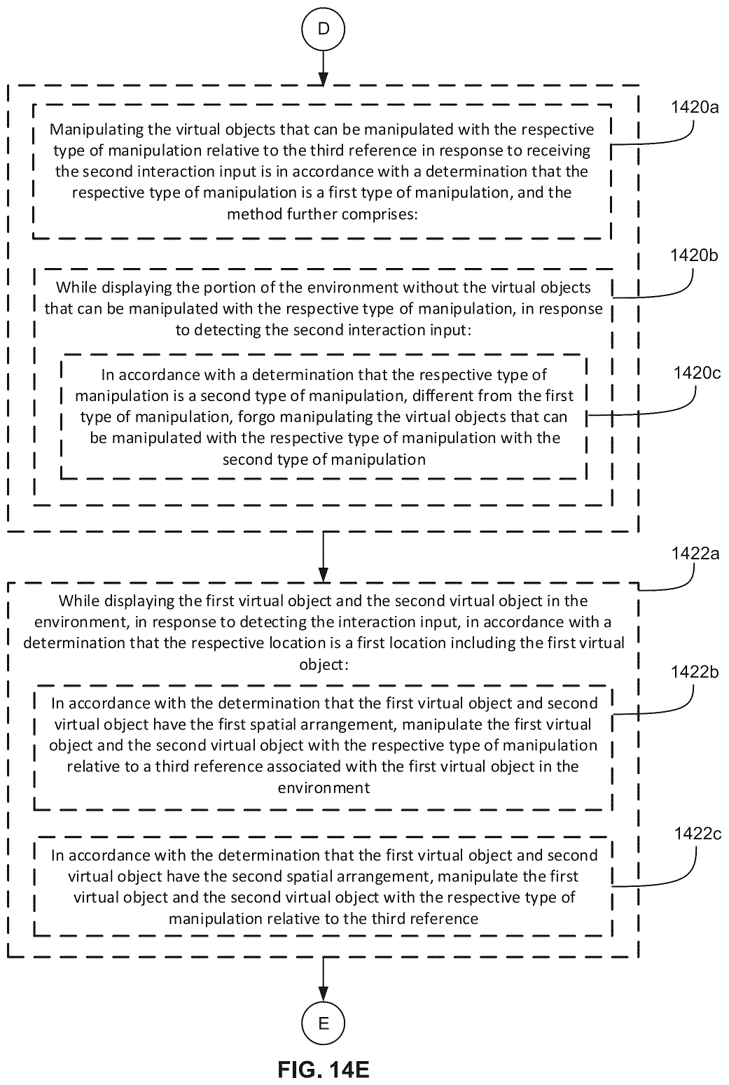

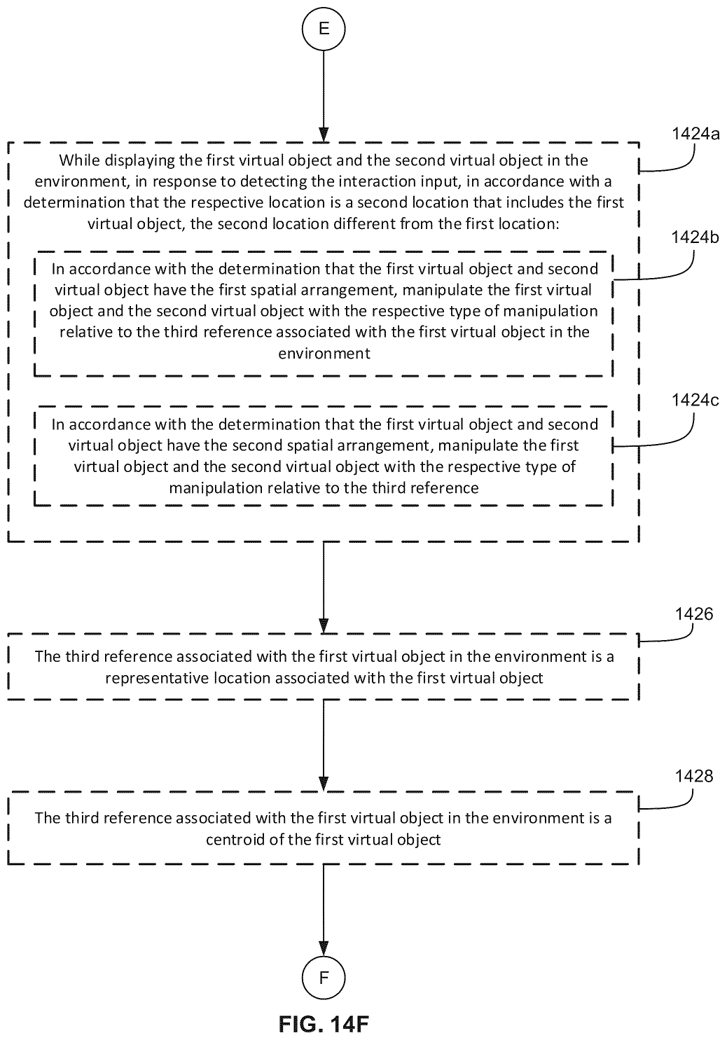

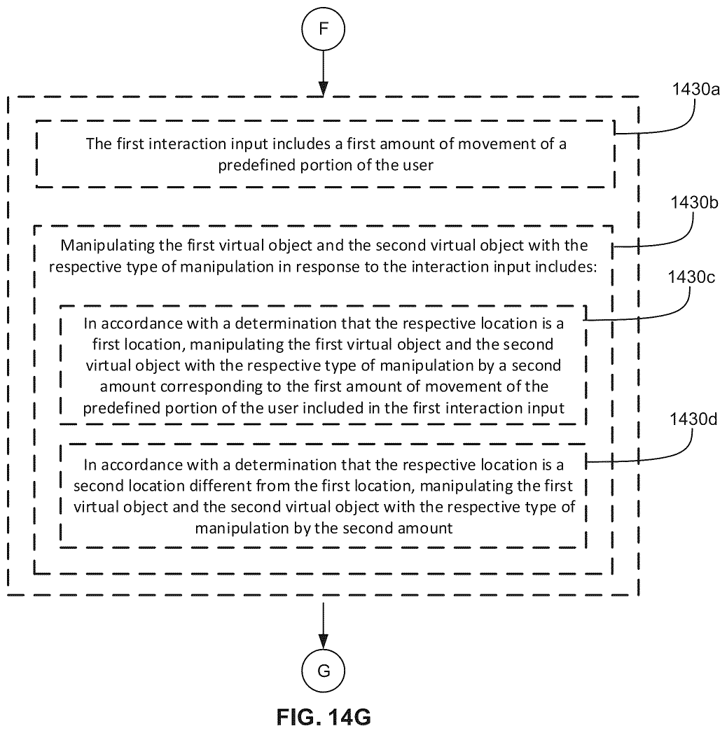

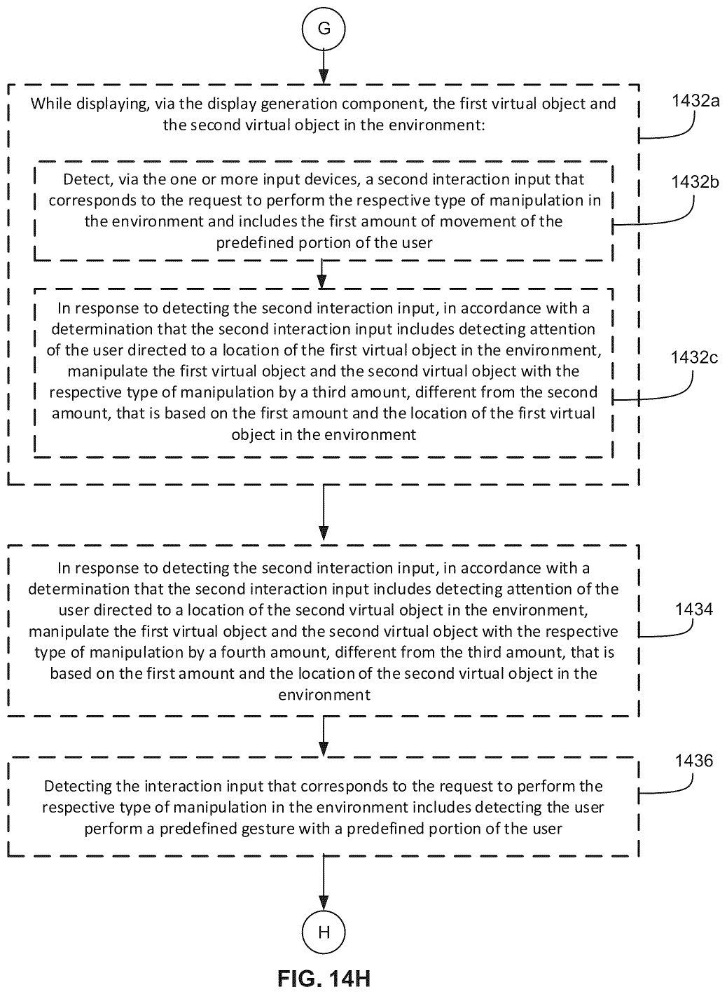

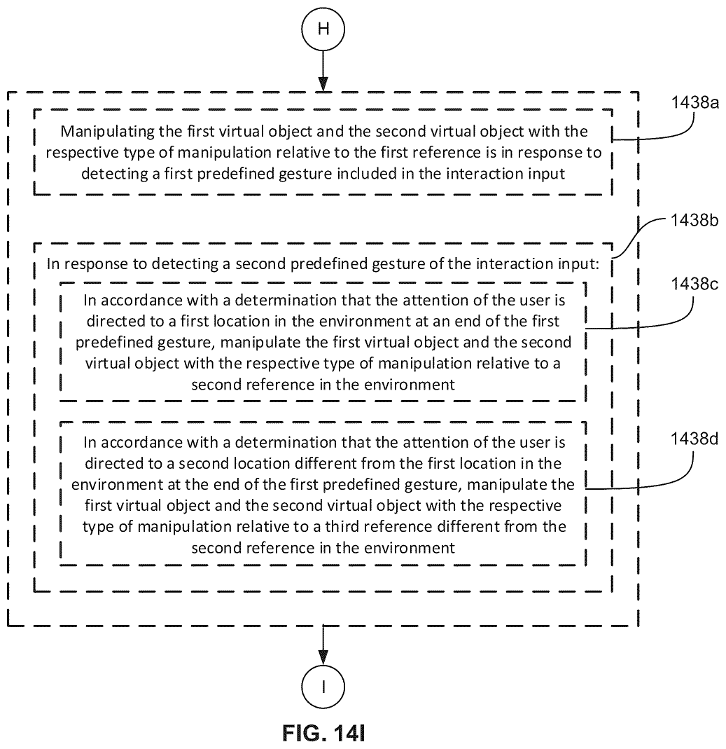

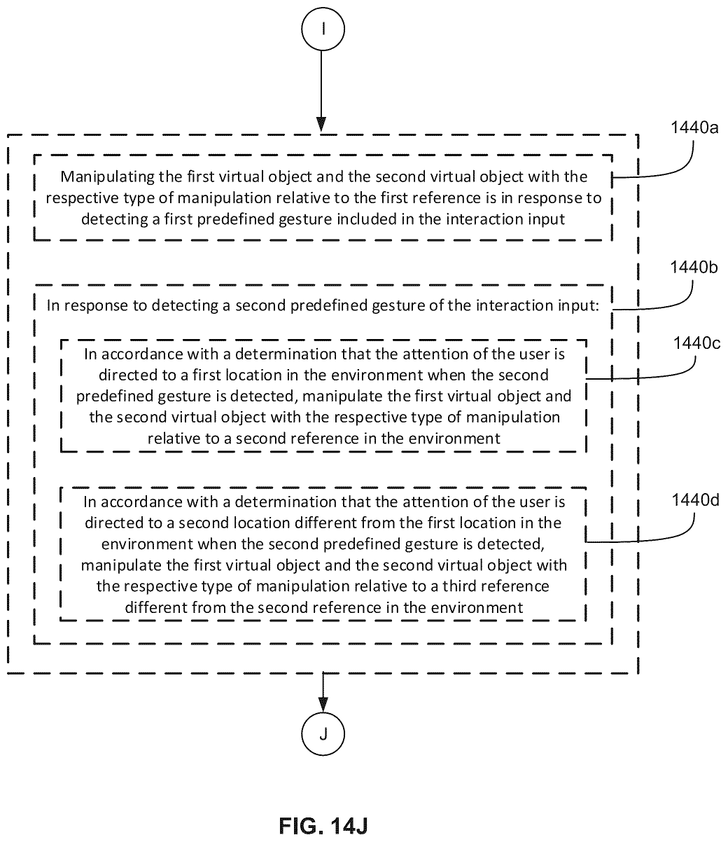

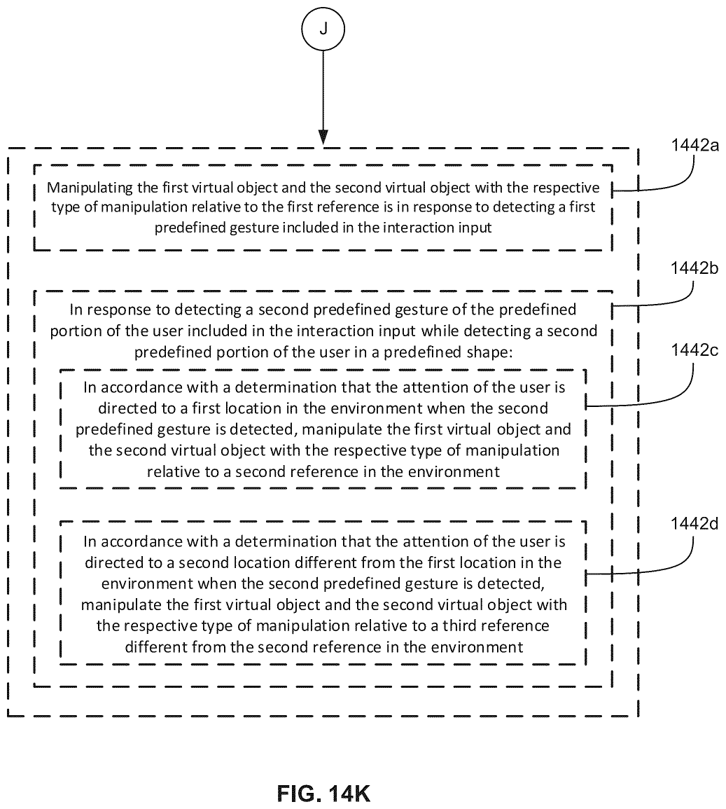

FIGS. 1-6 provide a description of example computer systems for providing XR experiences to users (such as described below with respect to methods 800, 1000, 1200, and/or 1400). FIGS. 7A-7I illustrate example techniques for facilitating interactions with a plurality of objects in a three-dimensional environment in accordance with some embodiments. FIGS. 8A-8I is a flow diagram of methods of facilitating interactions with a plurality of objects in a three-dimensional environment in accordance with some embodiments. The user interfaces in FIGS. 7A-7I are used to illustrate the processes in FIGS. 8A-8I. FIGS. 9A-9I illustrate example techniques for facilitating manipulation of virtual objects in a virtual environment in accordance with some embodiments. FIGS. 10A-10H is a flow diagram of methods of facilitating manipulation of virtual objects in a virtual environment in accordance with various embodiments. The user interfaces in FIGS. 9A-9I are used to illustrate the processes in FIGS. 10A-10H. FIGS. 11A-11G illustrate example techniques for facilitating interactions with a plurality of objects relative to a reference point in a three-dimensional environment in accordance with some embodiments. FIGS. 12A-12J is a flow diagram of methods of facilitating interactions with a plurality of objects relative to a reference point in a three-dimensional environment in accordance with some embodiments. The user interfaces in FIGS. 11A-11G are used to illustrate the processes in FIGS. 12A-12J. FIGS. 13A-13G illustrate example techniques for facilitating manipulation of virtual objects in a virtual environment in accordance with some embodiments. FIGS. 14A-14K is a flow diagram of methods of facilitating manipulation of virtual objects in a virtual environment in accordance with some embodiments. The user interfaces in FIGS. 13A-13G are used to illustrate the processes in FIGS. 14A-14K.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, and/or a touch-screen), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, and/or velocity sensors), and optionally one or more peripheral devices 195 (e.g., home appliances, wearable devices). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

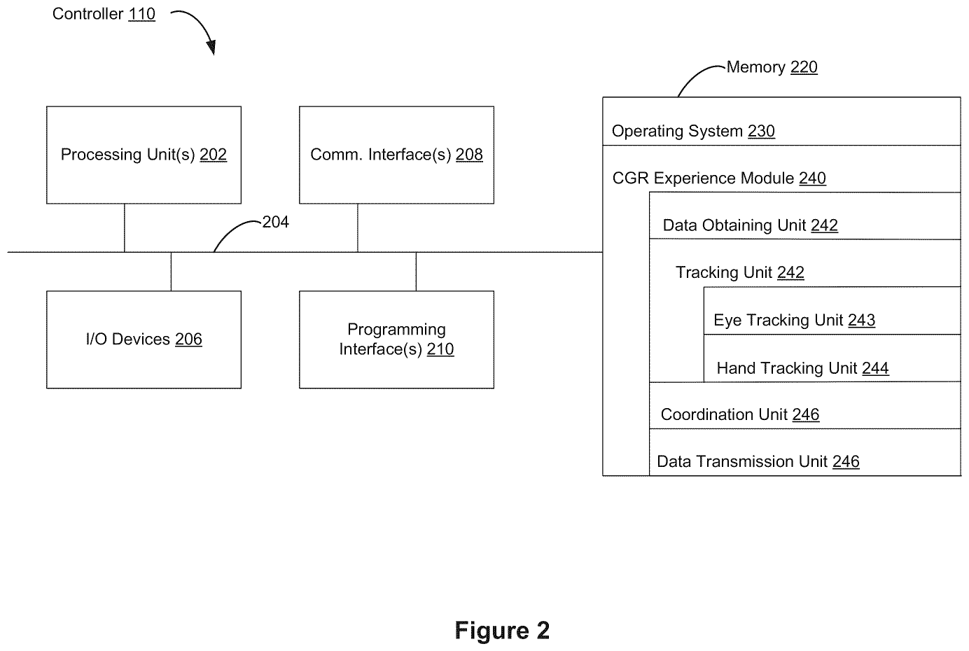

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server and/or a central server). In some embodiments, the controller 110 is communicatively coupled with the display generation component 120 (e.g., an HMD, a display, a projector, and/or a touch-screen) via one or more wired or wireless communication channels 144 (e.g., BLUETOOTH, IEEE 802.11x, IEEE 802.16x, and/or IEEE 802.3x). In another example, the controller 110 is included within the enclosure (e.g., a physical housing) of the display generation component 120 (e.g., an HMD, or a portable electronic device that includes a display and one or more processors), one or more of the input devices 125, one or more of the output devices 155, one or more of the sensors 190, and/or one or more of the peripheral devices 195, or share the same physical enclosure or support structure with one or more of the above.

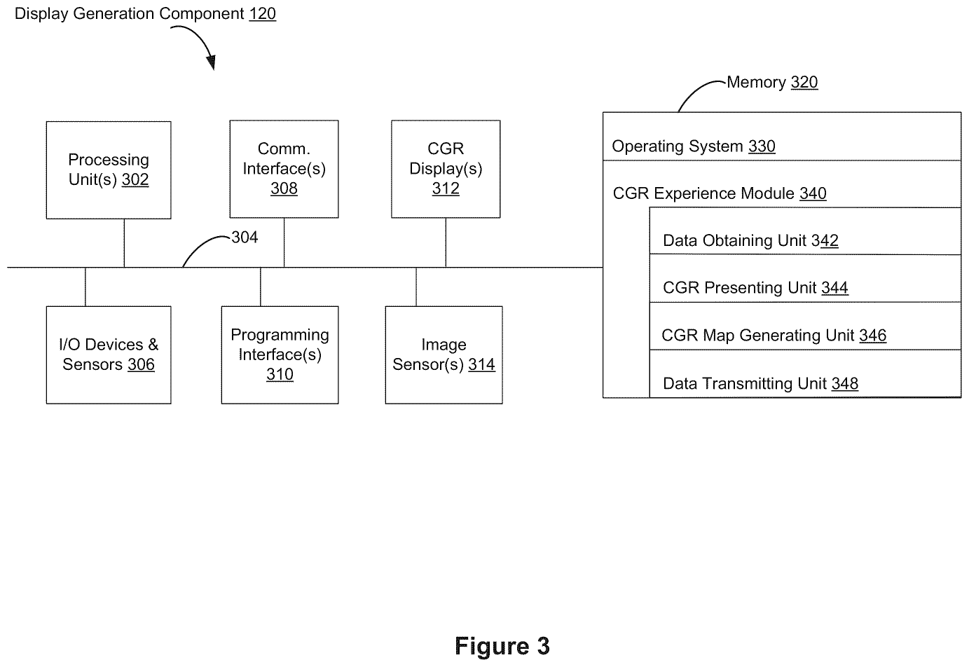

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head and/or on his/her hand). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, and/or location data) from at least the display generation component 120 of FIG. 1, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

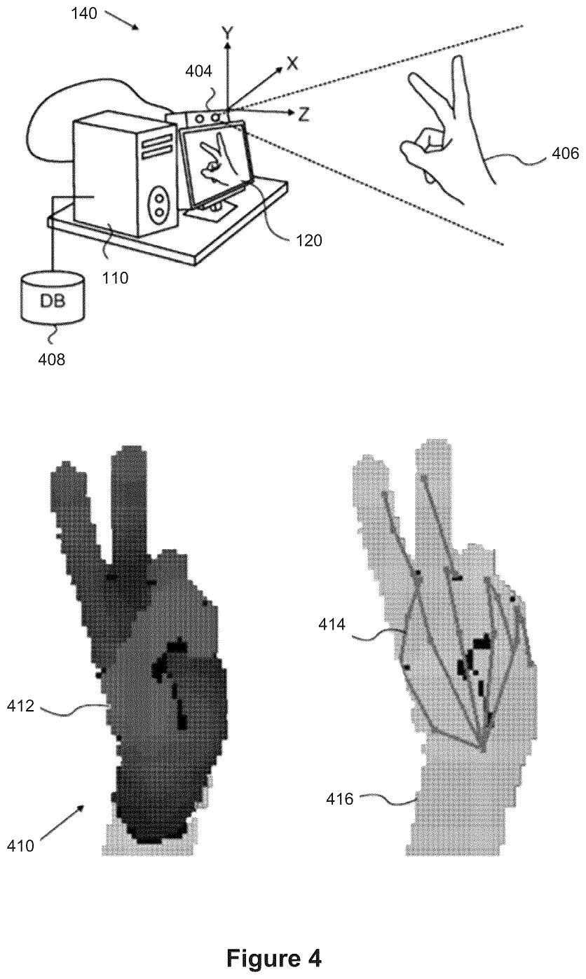

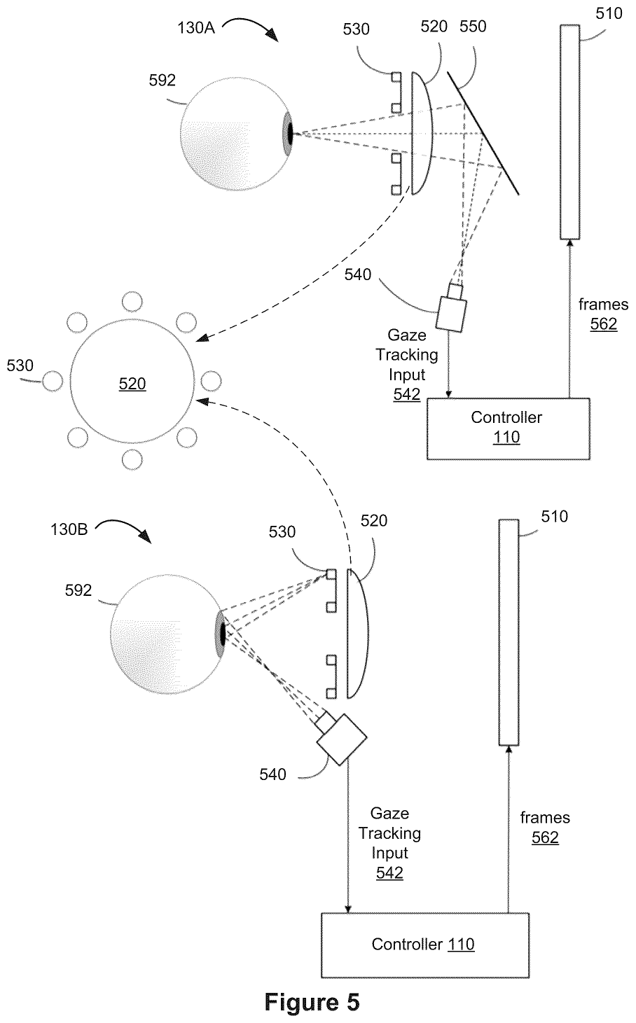

In some embodiments, the tracking unit 242 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data and/or location data) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, and/or blood glucose sensor), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, and/or holographic waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, and/or location data) from at least the controller 110 of FIG. 1. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data and/or location data) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 244 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands)

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, and/or end of the hand connecting to wrist) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, and/or eye spacing. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, and/or a projector) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

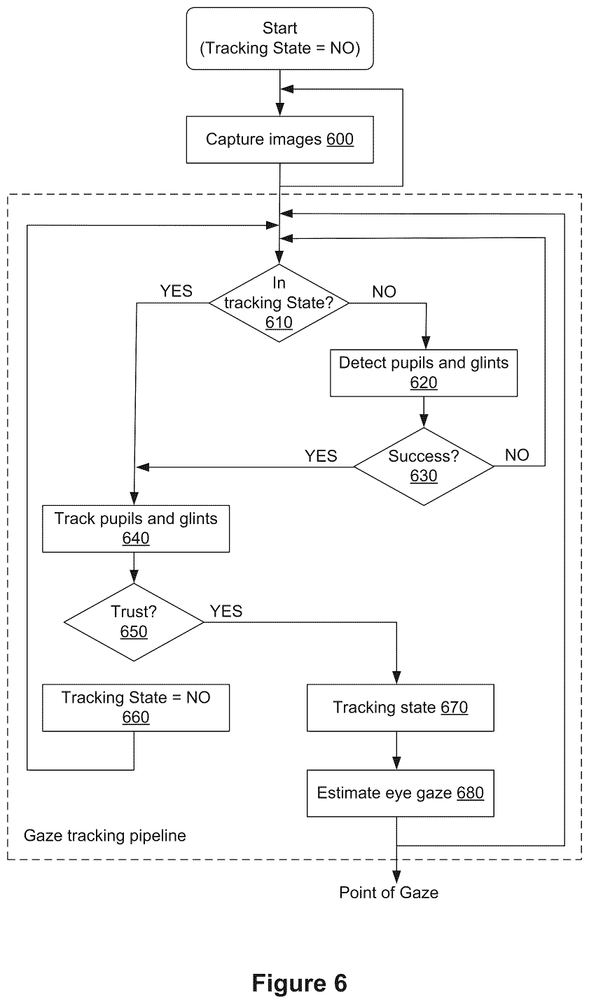

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, and/or holding a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7I illustrate examples of a computer system facilitating interactions with a plurality of objects in a three-dimensional environment in accordance with some embodiments.

FIG. 7A illustrates a computer system (e.g., an electronic device) 101a displaying, via a display generation component (e.g., display generation component 120 of FIG. 1), a three-dimensional environment 702 from a viewpoint of the user 726 illustrated in the overhead view (e.g., facing the back wall of the physical environment in which computer system 101a is located). In some embodiments, computer system 101a includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101a would be able to use to capture one or more images of a user or a part of the user (e.g., one or more hands of the user) while the user interacts with the computer system 101a. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 7A, computer system 101a captures one or more images of the physical environment around computer system 101a (e.g., operating environment 100), including one or more objects in the physical environment around computer system 101a. In some embodiments, computer system 101a displays representations of the physical environment in three-dimensional environment 702. For example, three-dimensional environment 702 includes a representation 722a of a coffee table (corresponding to table 722b in the overhead view), which is optionally a representation of a physical coffee table in the physical environment, and three-dimensional environment 702 includes a representation 724a of sofa (corresponding to sofa 724b in the overhead view), which is optionally a representation of a physical sofa in the physical environment.

In FIG. 7A, three-dimensional environment 702 also includes virtual objects 707a (“Window 1,” corresponding to object 707b in the overhead view), and 709a (“Window 2,” corresponding to object 709b in the overhead view). Virtual objects 707a and 709a are optionally at different distances from the viewpoint of user 726 in three-dimensional environment 702. For example, in FIG. 7A, virtual object 707a is located at a first location that is closer to the viewpoint of user 726 than a second location at which virtual object 709a is located in three-dimensional environment 702, as reflected in the overhead view. In some embodiments, virtual objects 707a and 709a are optionally one or more of user interfaces of applications containing content (e.g., quick look windows displaying photographs), three-dimensional objects (e.g., virtual clocks, virtual balls, and/or virtual cars) or any other element displayed by computer system 101a that is not included in the physical environment of display generation component 120.

In some embodiments, the computer system 101a is in a communication session with a second computer system 101b (shown in the overhead view). For example, the virtual objects 707a and 709a within the three-dimensional environment 702 and/or the three-dimensional environment 702 are being displayed by both the computer system 101a and the second computer system 101b, concurrently, but from different viewpoints associated with their respective users. In some embodiments, in the communication session, the user 726 of the computer system 101a has a first viewpoint of the three-dimensional environment 702, and a second user of the second computer system 101b has a second viewpoint of the three-dimensional environment 702. For example, a field of view of the three-dimensional environment 702 from the first viewpoint of the user 726 of the computer system 101a, as shown in FIG. 7A, includes a first portion of the three-dimensional environment 702 (including the virtual objects 707a and 709a), and a field of view of the three-dimensional environment 702 from the second viewpoint of the second user of the second computer system 101b includes a second portion of the three-dimensional environment 702. In some embodiments, the second portion of the three-dimensional environment 702 includes the virtual object 707a and/or the virtual object 709a, or neither the virtual object 707a nor the virtual object 709a. In some embodiments, the computer system 101a and the second computer system 101b are in the same physical environment (e.g., at different locations in the same room of FIG. 7A). In some embodiments, the computer system 101a and the second computer system 101b are located in different physical environments (e.g., different cities, different rooms, different states and/or different countries).

In some embodiments, while the computer system 101a is in the communication session with the second computer system 101b, the three-dimensional environment 702 includes a virtual representation of the second user of the second computer system 101b. For example, as shown in FIG. 7A, the three-dimensional environment 702 includes an avatar 706a (corresponding to avatar 706b in the overhead view) corresponding to the second user of the second computer system 101b. In FIG. 7A, the avatar 706a corresponding to the second user is optionally displayed at a third location in the three-dimensional environment 702 that is furthest (e.g., among the locations of virtual objects 707a and 709a) from the viewpoint of the user 726, as illustrated in the overhead view. In some embodiments, the avatar 706a includes a three-dimensional representation (e.g., rendering) of the second user. In some embodiments, the avatar 706a corresponding to the second user includes a representation of the second computer system 101b of which the second user is a user. In some embodiments, the second portion of the three-dimensional environment 702 from the second viewpoint of the second user displayed at the second computer system 101b includes a virtual representation of the user 726 of the computer system 101a.

In some embodiments, virtual objects are displayed in three-dimensional environment 702 with respective orientations relative to the viewpoint of user 726 (e.g., prior to receiving input interacting with the virtual objects, which will be described later, in three-dimensional environment 702). As shown in FIG. 7A, virtual objects 707a and 709a and the avatar 706a corresponding to the second user of the second computer system 101b have first orientations in three-dimensional environment 702. For example, the front-facing surfaces/portions of virtual objects 707a and 709a and the avatar 706a that face the viewpoint of user 726 are flat/level (or parallel) relative to the viewpoint of user 726, as shown by 707b, 709b, and 706b, respectively, in the overhead view of FIG. 7A. It should be understood that the orientations of the virtual objects in FIG. 7A are merely exemplary and that other orientations are possible; for example, the virtual objects are optionally displayed with different orientations in three-dimensional environment 702.

In some embodiments, the virtual object 707a and/or the virtual object 709a are shared between the user 726 of the computer system 101a and the second user of the second computer system 101b (e.g., while the computer system 101a and the second computer system 101b are in a communication session). For example, the user interfaces and/or contents (e.g., text, images, video, files, icons, and/or control elements) of the virtual objects 707a and/or 709a are displayed in the first portion and/or the second portion of the three-dimensional environment 702, such that the user interfaces and/or contents of the virtual objects 707a and/or 709a are accessible by (e.g., viewable by and/or interactable (e.g., selectable or scrollable) by) the user 726 of the computer system 101a and the second user of the second computer system 101b. In some embodiments, as described below, when the virtual objects 707a and 709a are shared between the user 726 and the second user, changes in relative positions of the virtual objects 707a and/or 709a in three-dimensional environment 702 due to user input received at the computer system 101a are reflected in the second portion of the three-dimensional environment 702 at the second computer system 101b relative to the second viewpoint of the second user. In some embodiments, the virtual object 707a and the virtual object 709a are not shared between the user 726 of the computer system 101a and the second user of the second computer system 101b. For example, the computer system 101a displays the virtual object 707a and the virtual object 709a in three-dimensional environment 702 and/or provides the user 726 access to the contents of the virtual object 707a and the virtual object 709a, and the second computer system 101b forgoes displaying the virtual object 707a and the virtual object 709a in the portion of the three-dimensional environment 702 at the second computer system 101b and/or forgoes providing the second user access to the contents of the virtual object 707a and the virtual objects 709a. In some embodiments, when the virtual objects 707a and 709a are not shared between the user 726 and the second user, changes in relative positions of the virtual objects 707a and/or 709a in three-dimensional environment 702 due to user input received at the computer system 101a are not reflected in the second portion of the three-dimensional environment at the second computer system 101b relative to the second viewpoint of the second user.

In some embodiments, the computer system 101a and the second computer system 101b are in communication with each other such that the display of the virtual objects 707a and 709a within the three-dimensional environment 702 and/or the display of the three-dimensional environment 702 by the computer systems 101a and 101b is coordinated. For example, as described below, changes to (e.g., in positions of) the virtual objects 707a and/or 709a and the avatar 706a corresponding to the second user within the three-dimensional environment 702 and/or the three-dimensional environment 702 made in response to inputs from the user 726 of the computer system 101a are reflected in the display of the virtual objects 707a and/or 709a and the avatar 706a within the portion of the three-dimensional environment 702 and/or the three-dimensional environment 702 by the second computer system 101b. In some embodiments, as described below, in response to detecting one or more interaction inputs of a first type, the computer system 101a performs a first operation, including concurrently repositioning the virtual objects 707a and 709a and the avatar 706a corresponding to the second user within the three-dimensional environment 702 relative to the viewpoint of the user 726, in accordance with the interaction input. In response to detecting an interaction input of a second type, different from the first type, the computer system 101a optionally performs a second operation, different from the first operation.

In FIG. 7A, the computer system detects a first interaction input provided by hand 703a (“Hand 1”). In some embodiments, the first interaction input corresponds to a request to move one or more virtual objects displayed in three-dimensional environment 702. For example, from FIGS. 7A-7B, the computer system 101a detects hand 703a provide a selection input directed to the three-dimensional environment 702, followed by movement. In some embodiments, computer system 101a detects hand 703a move away from the body of the user 726 and provide a pinch directed to the three-dimensional environment 702 (e.g., and/or the virtual object 707a, virtual object 709a, or avatar 706a), followed by movement of the hand 703a in a first direction (e.g., rightward) with a first magnitude (e.g., of speed or distance) while remaining in the pinch hand shape. Additionally, as shown in FIG. 7A, the computer system 101 optionally detects hand 705a (“Hand 2”) providing a second interaction input when the computer system 101a detects the first interaction input provided by the hand 703a. For example, from FIGS. 7A-7B, the computer system 101a detects hand 705a in an engaged pose (e.g., in which the hand 703a is elevated/raised with respect to a portion of a torso of the user 726 and/or with respect to a surface on which the user 726 is positioned) when the hand 703a provides the first interaction input. In some embodiments, hand 705a is maintaining an air pinch gesture and/or is in a ready state when the computer system 101a detects the first interaction input provided by the hand 703a. In some embodiments, the computer system 101a detects the hand 703a and the hand 705a provide the first interaction input and the second interaction input, respectively, concurrently. For example, the computer system 101a detects the hand 703a and the hand 705a concurrently provide a selection input directed to the three-dimensional environment 702, followed by movement of the hand 703a in the first direction with the first magnitude. In some embodiments, the inputs from hands 703a and/or 705a are air gesture inputs, as described above. It should be understood that while multiple hands and corresponding inputs are illustrated in FIGS. 7A-7I, such hands and inputs need not be detected by computer system 101a concurrently; rather, in some embodiments, computer system 101a independently responds to the hands and/or inputs illustrated and described in response to detecting such hands and/or inputs independently.

In some embodiments, in response to detecting the first interaction input and the second interaction input in FIG. 7A, the computer system 101a manipulates the three-dimensional environment 702 in accordance with the first interaction input. For example, as shown in FIG. 7B, in response to detecting the movement of the hand 703a in a rightward direction relative to the viewpoint of the user 726 while the hand 705a was engaged, the computer system 101a concurrently moves (e.g., translates) the virtual objects 707a and 709a and the avatar 706a rightward in the three-dimensional environment 702 relative to the viewpoint of the user 726 (e.g., the reference point in the overhead view) in accordance with the rightward movement of the hand 703a. In some embodiments, a direction and/or a magnitude of the movement of the virtual objects 707a and 709a and the avatar 706a within the three-dimensional environment is based on a direction and/or magnitude of the movement of the hand 703a and/or hand 705a relative to one or more portions of a body of the user 726. For example, the computer system 101a detects the hand 703a move rightward relative to the hand 705a and/or relative to a predefined portion of an upper body (e.g., torso, shoulders or head) and/or the viewpoint of the user 726 in FIG. 7A, which causes the computer system 101a to concurrently move the virtual objects 707a and 709a and the avatar 706a rightward in the three-dimensional environment 702 in FIG. 7B. Additionally, the computer system 101a detects the hand 703a move a first magnitude (e.g., of a first speed, for a first duration, and/or a first distance) relative to the hand 705a and/or relative to the predefined portion of the upper body and/or the viewpoint of the user 726 in FIG. 7A, which causes the computer system to concurrently move the virtual objects 707a and 709a and the avatar 706a with a second magnitude (e.g., of a second speed and/or a second distance), based on the first magnitude, in the three-dimensional environment 702. In some embodiments, as discussed below, if the hand 705a was not engaged when the computer system 101a detected the first interaction input provided by hand 703a in FIG. 7A, the computer system 101a would forgo concurrently moving the virtual objects 707a and 709a and the avatar 706a in the three-dimensional environment 702 relative to the viewpoint of the user 726 in accordance with the movement of the hand 703a.

Further, in some embodiments, in response to detecting the first interaction input and the second interaction input in FIG. 7A, the computer system 101a changes an appearance of the three-dimensional environment 702, as shown in FIG. 7B. For example, with reference to FIG. 7A, before the computer system 101a detects the first interaction input provided by the hand 703a, the three-dimensional environment 702 is displayed with a first visual appearance. As shown in FIG. 7A, the portions of the three-dimensional environment 702 surrounding the virtual objects 707a and 709a and the avatar 706a corresponding to the second user are optionally displayed with without a visual effect (e.g., without a blurring effect, a shading/darkening effect, and/or a discoloration effect). In some embodiments, as shown in FIG. 7B, when the computer system 101a detects the first interaction input provided by the hand 703a when the second hand 705a is engaged, the computer system 101a displays the three-dimensional environment 702 with a second visual appearance, different from the first visual appearance. For example, as shown in FIG. 7B, the portions of the three-dimensional environment 702 surrounding the virtual objects 707a and 709a and the avatar 706a are displayed with a visual effect (e.g., with a blurring effect, a shading/darkening effect, and/or a discoloration effect), while the virtual objects 707a and 709a and the avatar 706a remain displayed without the visual effect. In some embodiments, the change in the visual effect of the environment 702 includes applying the visual effect to representations 722a and 724a of real objects, surfaces, and other features in the physical environment of the computer system 101a and/or display generation component 120. In some embodiments, the display of the three-dimensional environment 702 with the second visual appearance indicates that the virtual objects 707a and 709a and the avatar 706a are able to be concurrently repositioned (e.g., translated and/or rotated) within the three-dimensional environment 702 when the computer system 101a detects interaction input from the hand 703a and/or the hand 705a.

In some embodiments, while the user 726 of the computer system 101a is in the communication session with the second user of the second computer system 101b, when the computer system 101a detects the first interaction input and/or the second interaction input provided by the hands 703a and/or 703a in FIG. 7A, the second computer system 101b changes an appearance of the avatar corresponding to the user 726 in the portion of the three-dimensional environment 702 displayed at the second computer system 101b, as described in more detail with reference to FIGS. 7H-7I. Additionally, if the virtual objects 707a and 709a are shared between the user 726 and the second user of the second computer system 101b, when the computer system 101a moves the virtual objects 707a and 709a and the avatar 706a within the three-dimensional environment 702 relative to the viewpoint of the user 726 in accordance with the movement of hand 703a as shown in FIG. 7B, the second computer system 101b moves the avatar corresponding to the user 726 in the portion of the three-dimensional environment 702 displayed at the second computer system 101b, without moving the virtual objects 707a and 709a in the portion of the three-dimensional environment 702 displayed at the second computer system 101b, as described in more detail with reference to FIGS. 7H-7I.

In some embodiments, in response to detecting movement of the hand directed to the three-dimensional environment 702 that corresponds to movement of the virtual objects 707a and 709a and the avatar 706a (e.g., in a rightward direction, as similarly discussed above) outside of a field of view of the user 726, the computer system 101a would move the virtual objects 707a and 709a and the avatar 706a (e.g., in a rightward direction) outside of the field of view of the user 726 relative to the viewpoint of the user 726. In some embodiments, if the computer system 101a were to detect interaction input (e.g., provided by hands 703b and/or 705b) directed to the three-dimensional environment 702 while no objects are in the field of view, the computer system 101a would restrict the manipulation of the three-dimensional environment 702 performed in response to detecting the interaction input. For example, if the interaction input provided corresponds to rotation of the three-dimensional environment 702 relative to a reference point (e.g., based on a location of the attention of the user 726 in the three-dimensional environment 702) other than the viewpoint of the user 726, the computer system 101a would forgo rotating the three-dimensional environment 702 relative to the viewpoint of the user 726. Rather, the computer system 101a would optionally manipulate (e.g., translate and/or rotate) the three-dimensional environment 702 relative to the viewpoint of the user 726, and/or would optionally perform no operation manipulating the three-dimensional environment 702. Additional details regarding manipulation of the three-dimensional environment 702 while no objects are in the field of view of the user 726 are provided with reference to FIGS. 13A-13G and/or method 1400.

In some embodiments, the computer system 101a is able to further manipulate the three-dimensional environment 702 in response to detecting continuation of the interaction input with one hand if the user initiated the manipulation of the three-dimensional environment using two hands in the manner discussed above and as shown in FIG. 7A. In FIG. 7B, the computer system 101a detects hand 703b provide movement input directed to the three-dimensional environment 702 while the three-dimensional environment 702 is displayed with the second visual appearance described above. For example, the computer system 101a detects the hand 703b (e.g., while maintaining the air pinch gesture of FIG. 7A) move in a clockwise direction corresponding to a request to rotate the virtual objects displayed in the three-dimensional environment in a clockwise direction around a reference point (labeled in the overhead view) relative to the viewpoint of user 726. Additionally, in FIG. 7B, the computer system 101a detects hand 705b cease to provide the second interaction input of FIG. 7A. For example, the computer system 101a detects the hand 705b release the air pinch gesture and/or detects that the hand 705b is no longer in the engaged pose (e.g., the hand 705b relaxes and/or lowers with respect to the surface on which the user 726 is positioned). The computer system 101a optionally detects the movement of the hands 703b and/or 705b irrespective of a location of attention, including gaze, of the user in three-dimensional environment 702. For example, the computer system 101a manipulates the three-dimensional environment 702 in response to the movements of the hands 703b and/or 705b irrespective of the location of the attention in the three-dimensional environment 702.

In some embodiments, in response to detecting the movement of the hand 703b when the hand 705b is no longer engaged in FIG. 7B, the computer system 101a manipulates the three-dimensional environment 702 in accordance with the movement of the hand 703b. For example, as shown in FIG. 7C, in response to detecting the clockwise movement of the hand 703b in FIG. 7B, the computer system 101a concurrently repositions (e.g., rotates) the virtual objects 707a and 709a and the avatar 706a in a clockwise direction (e.g., around the reference point labeled in the overhead view in FIG. 7C) in three-dimensional environment 702 relative to the viewpoint of the user 726 in accordance with the movement of the hand 703b. As shown, in response to detecting the movement of the hand 703b, the computer system 101a displays the virtual objects 707a and 709a and the avatar 706a with second orientations, different from the first orientations discussed above. For example, the front-facing surfaces/portions of the virtual objects 707a and 709a and the avatar 706a are tilted/slightly angled leftward relative to the viewpoint of the user 726, as shown by 707b, 709b, and 706b, respectively, in the overhead view of three-dimensional environment 702 in FIG. 7C. Additionally, in some embodiments, the computer system 101a maintains display of the three-dimensional environment 702 (e.g., the portions of the three-dimensional environment surrounding the virtual objects 707a and 709a and the avatar 706a) with the second visual appearance.

As discussed above, in FIG. 7B, the computer system 101a detects the movement of the hand 703b when the hand 705b is no longer engaged (e.g., is no longer providing the second interaction input). Because the hand 705a was engaged in FIG. 7A when the computer system 101a detected the movement input provided by hand 703a, in some embodiments, the computer system 101a recognizes the movement input provided by hand 703b in FIG. 7B as movement input manipulating the three-dimensional environment 702, rather than as movement input directed to a single object (e.g., the virtual object 707a or the virtual object 709a), as described in more detail with reference to FIGS. 7F-7G. Accordingly, if the user 726 initiates the manipulation of the three-dimensional environment 702 using two hands, as shown in FIG. 7A, and provides additional manipulation input using one hand, as shown in FIG. 7B, the computer system 101a optionally manipulates the three-dimensional environment 702 in accordance with the one-handed input, as shown in FIG. 7C.

In some embodiments, the computer system 101a maintains display of the three-dimensional environment 702 with the second visual appearance for a predefined period of time after detecting an end of an interaction input. In FIG. 7C, hand 703c ceases providing the movement input directed to the three-dimensional environment 702. For example, the computer system 101a detects the hand 703c release the pinch gesture and/or detects the hand 703c no longer in the engaged pose (e.g., the hand 703c relaxes and/or lowers with respect to the surface on which the user 726 is positioned). Additionally, in FIG. 7C, computer system 101a detects the hand 705b remaining in the disengaged pose (e.g., relaxed and/or while not providing an air pinch gesture). For example, as discussed above, the computer system 101a detects that the hand 705b is positioned adjacent to the torso of the user 726 while the index finger and the thumb of the hand 705b are not in contact.

In some embodiments, in response to detecting the hand 703c release the pinch gesture in FIG. 7C, the computer system 101a maintains display of the three-dimensional environment 702 with the second visual appearance for a threshold amount of time. For example, in FIG. 7D, the computer system 101a maintains the shading/darkening effect, blurring effect, and/or discoloration effect applied to the portions of the three-dimensional environment 702 surrounding the virtual objects 707a and 709a and the avatar 706a corresponding to the second user relative to the viewpoint of the user 726 for the threshold amount of time. Examples of the threshold amount of time are provided below in the description of method 800. In some embodiments, after detecting the threshold amount of time has elapsed, the computer system 101a redisplays the three-dimensional environment 702 with the first visual appearance, as shown previously in FIG. 7A. In some embodiments, if the computer system 101a detects an interaction input provided by a hand 705b or 703c of the user 726 before the threshold amount of time elapses (e.g., while the three-dimensional environment 702 is displayed with the second visual appearance), the computer system 101a will manipulate the three-dimensional environment 702 in accordance with the interaction input, as described below. In some embodiments, if the computer system 101a detects an interaction input provided by a hand 705b or 703c of the user 726 after the threshold amount of time elapses (e.g., after the three-dimensional environment 702 transitions from being displayed with the second visual appearance shown in FIG. 7C to being redisplayed with the first visual appearance as shown in FIG. 7A), the computer system 101a will forgo manipulating the three-dimensional environment 702 and will perform an alternative operation, as described in more detail with reference to FIGS. 7F-7G.

In FIG. 7D, the hand 703d is providing an interaction input while the three-dimensional environment 702 is displayed with the second visual appearance. For example, the computer system 101a detects the hand 703d provide a selection input (e.g., provide a pinch) followed by movement of the hand 703d in a counterclockwise direction (e.g., while remaining in the pinch hand shape) before the threshold amount of time discussed above elapses. Additionally, in FIG. 7C, the hand 705b continues to remain in the disengaged pose (e.g., relaxed and/or while not providing an air pinch gesture and/or not in a pinch hand shape).

In some embodiments, in response to detecting the interaction input before the threshold amount of time elapses in FIG. 7D, the computer system 101a manipulates the three-dimensional environment 702 in accordance with the interaction input as shown in FIG. 7E. For example, in FIG. 7E, in response to detecting the hand 703d move in a counterclockwise direction while in the pinch hand shape while the three-dimensional environment 702 is displayed with the second visual appearance in FIG. 7D, the computer system 101a concurrently repositions (e.g., rotates) the virtual objects 707a and 709a and the avatar 706a in a counterclockwise direction around the reference point indicated in the overhead view in FIG. 7D within the three-dimensional environment 702 relative to the viewpoint of the user 726 in accordance with the movement of the hand 703d in FIG. 7D. As shown in FIG. 7E, in response to detecting the movement of the hand 703d in FIG. 7D, the computer system 101a displays the virtual objects 707a and 709a and the avatar 706a with third orientations in FIG. 7E, different from the first and the second orientations discussed above and as shown in FIG. 7D. For example, the front-facing surfaces/portions of the virtual objects 707a and 709a and the avatar 706a are tilted/slightly angled rightward relative to the viewpoint of the user 726, as shown by 707b, 709b, and 706b, respectively, in the overhead view of FIG. 7E. Additionally, in some embodiments, the computer system 101a maintains display of the three-dimensional environment 702 (e.g., the portions of the three-dimensional environment surrounding the virtual objects 707a and 709a and the avatar 706a) with the second visual appearance described above. Additionally, as shown in FIG. 7E, because the interaction input provided by the hand 703d was detected before the threshold amount of time described above elapsed, the computer system 101a optionally maintains display of the three-dimensional environment 702 with the second visual appearance (e.g., and/or ceases/resets the elapsing of the threshold amount of time).

In some embodiments, as described with reference to FIGS. 7D-7E, if the computer system 101a detects a continuation of the interaction input within a threshold amount of time of detecting the end of the interaction input provided by hand 703c in FIG. 7C, the computer system 101a maintains the second visual appearance and manipulates the virtual objects 707a and 709a and the avatar 706a in accordance with the interaction input. In some embodiments, if the computer system 101a does not detect a continuation of the interaction input within the threshold time of detecting the end of the interaction input provided by hand 703c in FIG. 7C, the computer system 101a updates the three-dimensional environment 702 to be displayed with the first visual appearance, as will now be described with reference to FIG. 7F.

In some embodiments, after detecting the threshold amount of time has elapsed since detecting the end of the interaction input provided by hand 703C in FIG. 7C, the computer system 101a redisplays the three-dimensional environment 702 with the first visual appearance, as shown in FIG. 7F. For example, as shown in FIG. 7F, the portions of the three-dimensional environment 702 surrounding the virtual objects 707a and 709a and the avatar 706a are no longer displayed with the darkening/shading effect, the blurring effect, and/or the discoloration effect.

In FIG. 7F, hand 703d provides a selection input (e.g., an air pinch gesture) directed to the virtual object 707a and alternate hand 713a (“Hand 3”) provides a movement input (e.g., provides a pinch followed by movement of the hand while remaining in the pinch hand shape) directed to virtual object 709a after the threshold amount of time has elapsed. For example, the computer system 101a detects the hand 713a move rightward relative to the viewpoint of the user 726 while attention of the user 726 (e.g., including a first gaze (“Gaze 1”) 721) is directed toward the virtual object 709a, and detects the hand 703d provide a pinch gesture while the attention (e.g., including a second gaze (“Gaze 2”) 723) is directed to a play option 711 in the virtual object 707a, while the three-dimensional environment 702 is displayed with the first visual appearance. Additionally, in FIG. 7F, the hand 705b continues to remain in the disengaged pose (e.g., relaxed and/or while not providing an air pinch gesture). It should be understood that, while multiple gaze points are illustrated in FIG. 7F, such gaze points need not be detected by computer system 101 concurrently; rather, in some embodiments, computer system 101 independently responds to the gaze points illustrated and described in response to detecting such gaze points independently.

In some embodiments, in response to detecting the inputs provided by hands 703d and/or 713a in FIG. 7F after the threshold amount of time has elapsed, the computer system 101a performs one or more corresponding operations involving the virtual objects 707a and 709a. For example, as shown in FIG. 7G, the computer system 101a forgoes manipulating the three-dimensional environment 702 (e.g., concurrently repositioning the virtual objects 707a and 709a and the avatar 706a relative to the viewpoint of the user in accordance with movement of one or more hands 703b, 703d, and/or 713a) in accordance with the inputs provided by the hands 703d and/or 713a. Rather, as shown in FIG. 7G, in some embodiments, the computer system 101a activates the play option 711 of virtual object 707a (e.g., which causes playback of content in virtual object 707a) in response to detecting the selection input provided by the hand 713a while the attention of the user, including gaze 723, is directed to play option 711 in FIG. 7F. Additionally or alternatively, in some embodiments, the computer system 101a repositions (e.g., shifts) the virtual object 709a rightward in the three-dimensional environment 702 relative to the viewpoint of the user 726 in accordance with the rightward movement of the hand 703d while the attention of the user, including gaze 721, is directed to virtual object 709a, without repositioning the virtual object 707a and/or the avatar 706a in three-dimensional environment 702 relative to the viewpoint of the user 726.

In some embodiments, the computer system 101a restricts the individual movement of certain types of virtual elements displayed in the three-dimensional environment 702. As shown in FIG. 7G, the computer system 101a individually moves the virtual object 709a within the three-dimensional environment 702 in response to detecting the movement of the hand 713a in FIG. 7F. As described previously herein, the virtual object 709a is optionally an application window that is shared between the user 726 of the computer system 101a and the second user of the second computer system 101b. Thus, shared virtual objects that include application windows, three-dimensional objects (e.g., three-dimensional balls, cars, tables, models, and the like), and/or content (e.g., images, video, files, contacts, and the like) are able to be individually moved in the three-dimensional environment 702 in response to input directed to the shared virtual objects individually. With reference to FIG. 7F, had the attention (e.g., the first gaze 721), been directed toward the avatar 706a, rather than the virtual object 709a, the computer system 101a would optionally forgo individually moving the avatar 706a corresponding to the second user in three-dimensional environment 702 in response to detecting the movement of the hand 713a. For example, as discussed above, while the computer system 101a and the second computer system 101b are in the communication session, the user 726 has a first viewpoint of the three-dimensional environment 702 and the second user has a second viewpoint, different from the first viewpoint, of the three-dimensional environment 702. Therefore, the user 726 has a respective spatial relationship with the second user in the communication session, which is optionally reflected by the relative positioning of the avatars corresponding to the users in the three-dimensional environment 702. Providing the ability to individually move an avatar corresponding to another user (e.g., avatar 706a) would optionally disrupt (i.e., violate) the respective spatial relationship with the other user in the three-dimensional environment, which would thus break the spatial truth between the users in the communication session. Accordingly, as discussed above, the computer system 101a optionally restricts (i.e., prevents) the individual movement of avatars of other users in the three-dimensional environment 702.

In some embodiments, after the threshold amount of time has elapsed since detecting the end of the interaction input provided by the hand 703c in FIG. 7C, the user 726 is able to initiate manipulation of three-dimensional environment 702 by providing a two-handed interaction input. For example, as shown in FIG. 7G, the hand 703e and the hand 705c are providing movement inputs directed to the three-dimensional environment 702. In FIG. 7G, the computer system 101a concurrently detects the hand 703e form a pinch hand shape and the hand 705c form a pinch hand shape, followed by movement of the hands 703e and 705c toward the body of the user 726 while maintaining the pinch hand shapes. In some embodiments, the movement inputs concurrently provided by the hands 703e and 705c are optionally detected irrespective of a location of the attention (e.g., the gaze) of the user 726 in the three-dimensional environment 702. For example, the computer system 101a manipulates the three-dimensional environment 702 in response to the movements of the hands 703e and/or 705c irrespective of the location of the attention in the three-dimensional environment 702.

In some embodiments, in response to detecting the interaction input concurrently provided by the hands 703e and 705c in FIG. 7G, the computer system 101a manipulates the three-dimensional environment 702 in accordance with the interaction input, as shown in FIG. 7H. In some embodiments, the computer system 101a manipulates the virtual objects 709a and 707a and the avatar 706a in FIG. 7H in a direction corresponding to the direction of the movement of hands 705c and 703e and by an amount that corresponds to an amount of (e.g., speed, distance, or duration of) movement of hands 705c and 703e in FIG. 7G. For example, in FIG. 7H, in response to detecting the concurrent movement of the hands 703e and 705c toward the user 726 (e.g., while the hands 703e and 705c are in the pinch hand shape) in FIG. 7G, the computer system 101a concurrently repositions (e.g., translates) the virtual objects 707a and 709a and the avatar 706a toward the viewpoint of the user 726 within the three-dimensional environment 702 relative to the viewpoint of the user 726 (e.g., the reference point labeled in the overhead view in FIG. 7G) in accordance with the movement of the hands 703e and 705c. In some embodiments, the amount of movement of the virtual objects 709a and 707a and the avatar 706a in FIG. 7H corresponds to an amount of the movement of hands 705c and 703e in FIG. 7G. In FIG. 7H, the hands 703f and 705d are optionally no longer maintaining the interaction input. For example, the computer system 101a detects that the hands 703f and 705d are no longer holding the pinch hand shape after the computer system 101a has moved the virtual objects 707a and 709a and the avatar 706a toward the viewpoint of the user 726 in the three-dimensional environment 702. As similarly discussed above, after detecting a threshold amount of time has elapsed since detecting the end of the interaction input, the computer system 101a displays the three-dimensional environment 702 with the first visual appearance, as shown in FIG. 7H. Examples of the threshold amount of time are included below in the description of method 800.

In some embodiments, as mentioned above, while the computer system 101a and the second computer system 101b are in a communication session, changes to (e.g., in positions of) the virtual objects 707a and/or 709a and the avatar 706a corresponding to the second user within the three-dimensional environment 702 and/or the three-dimensional environment 702 made in response to inputs from the user 726 of the computer system 101a are reflected in the display of the virtual objects 707a and/or 709a and the avatar corresponding to the user 726 within the three-dimensional environment 702 and/or the display of the three-dimensional environment 702 by the second computer system 101b. In some embodiments, reflecting changes in the positions and/or orientations of shared virtual objects at both computer systems 101a and 101b in response to inputs received at one of the computer systems 101a or 101b enables the computer systems 101a and 101b to maintain a shared spatial truth while in the communication session. In FIG. 7H, the computer system 101a receives an indication that the second computer system 101b has received an input corresponding to a request to manipulate virtual objects 709a and 709b, such as an input similar to one or more inputs described above with reference to FIGS. 7A, 7B, 7D, 7F and/or 7G. In some embodiments, in response to receiving the indication, the computer system 101a visually deemphasizes the avatar 706a corresponding to the second user relative to the viewpoint of the user 726, as shown in FIG. 7H while the second computer system 101b is receiving the interaction input. For example, the computer system 101a alters one or more characteristics of lighting, translucency, shading, coloration, and/or clarity of the avatar 706a in the three-dimensional environment 702 compared with that of the avatar 706a before receiving the indication (e.g., in FIG. 7G). In some embodiments, the visual deemphasis of the avatar 706a indicates that the second user is providing input manipulating the portion of the three-dimensional environment at the second computer system 101b relative to the second viewpoint of the second user.

In some embodiments, when the second computer system 101b detects an end of the interaction input provided by the second user of the second computer system 101b, the computer system 101a moves the avatar 706a corresponding to the second user based on the interaction input provided by the second user at the second computer system 101b so that computer systems 101a and 101b maintain shared spatial truth with respect to shared virtual objects 709a and 707a. For example, as shown in FIG. 7I, the computer system 101a moves the avatar 706a within the three-dimensional environment 702 relative to the viewpoint of the user 726, without moving the virtual objects 707a and 709a. As shown in FIG. 7I, when the second computer system 101b detects an end of the interaction input provided by the second user (e.g., and/or after detecting the threshold amount of time described above has elapsed since the second computer system 101b detected the end of the interaction input), the computer system 101a optionally moves the avatar 706a in accordance with the manipulation the second computer system 101b performed on the virtual objects 709a and 707a displayed in the three-dimensional environment 702 at the second computer system 101b. For example, the computer system 101a moves the avatar 706a toward the viewpoint of the user 726 and displays the avatar 706a with a fourth orientation, different from the first, second, and third orientations discussed above. For example, the front-facing portion of the avatar 706a is tilted/slightly angled leftward and facing away from the user 726 in the three-dimensional environment 702 relative to the viewpoint of the user 726, as shown by 706b in the overhead view of FIG. 7I, to reflect the shift in the second viewpoint of the second user relative to the viewpoint of the user 726 as a result of the manipulation of the portion of the three-dimensional environment 702 displayed at the second computer system 101b. In some embodiments, the updated position and/or orientation of the avatar 706a displayed at the first computer system 101a has the same spatial orientation relative to the virtual objects 707a and 709a as the spatial orientation of the viewpoint of the user of the second computer system 101b in response to the interaction input received at the second computer system 101b for manipulating the virtual objects 707a and 709a.

In some embodiments, while the computer system 101a and the second computer system 101b are in the communication session, while the computer system 101a detects interaction input provided by the user 726 corresponding to a request to manipulate the three-dimensional environment 702 (e.g., such as the interaction inputs describe above with reference to FIGS. 7A-7G), the second computer system 101b visually deemphasizes the avatar corresponding to the user 726 relative to the three-dimensional environment displayed at the second computer system 101b. For example, while the computer system 101a is moving the virtual objects 707a and 709a and the avatar 706a in accordance with the interaction input (e.g., as similarly shown in FIGS. 7B, 7C, 7E, and/or 7H), the second computer system 101b alters one or more characteristics of lighting, translucency, shading, coloration, and/or clarity of the avatar corresponding to the user 726 in the portion of the three-dimensional environment 702 displayed at the second computer system 101b relative to the viewpoint of the second user, in the manner similarly shown in FIG. 7H.

In some embodiments, when the computer system 101a detects an end of the interaction input provided by the user 726 of the computer system 101a, the second computer system 101b moves the avatar corresponding to the user based on the interaction input provided by the user 726. For example, when the computer system 101a detects an end of the interaction input provided by the user 726 (e.g., and/or after detecting the threshold amount of time described above has elapsed since detecting the end of the interaction input, as similarly shown previously in FIG. 7F), the second computer system 101b moves the avatar corresponding to the user 726 within the portion of the three-dimensional environment 702 displayed at the second computer system 101b relative to the second viewpoint of the second user, without moving the virtual objects 707a and 709a, in the manner similarly shown in FIG. 7H. In some embodiments, the movement of the avatar corresponding to the user 726 within the portion of the three-dimensional environment 702 displayed at the second computer system 101b reflects the shift in the viewpoint of the user 726 relative to the second viewpoint of the second user as a result of the manipulation of the three-dimensional environment 702 at the computer system 101a.

FIGS. 8A-8I is a flowchart illustrating an exemplary method 800 of facilitating interactions with a plurality of objects in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., 101a) in communication with a display generation component (e.g., 120) and one or more input devices (e.g., 314). For example, the computer system is or includes a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input, and/or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device and/or a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the computer system displays (802a), via the display generation component, an environment (e.g., three-dimensional environment 702 in FIG. 7A) including a first object (e.g., virtual object 707a in FIG. 7A) and a second object (e.g., virtual object 709a in FIG. 7A). For example, an environment that corresponds to a physical environment surrounding the display generation component and/or the computer system or a virtual environment. In some embodiments, the environment is a three-dimensional environment. In some embodiments, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, the physical environment is visible through a transparent portion of the display generation component (e.g., true or real passthrough). In some embodiments, a representation of the physical environment is displayed in the three-dimensional environment via the display generation component (e.g., virtual or video passthrough). In some embodiments, the first object and/or the second object is or includes content, such as a window of a web browsing application displaying content (e.g., text, images, or video), a window displaying a photograph or video clip, a media player window for controlling playback of content items on the computer system, a contact card in a contacts application displaying contact information (e.g., phone number email address and/or birthday) and/or a virtual boardgame of a gaming application. In some embodiments, the first object is displayed at a first location in the three-dimensional environment, and the second object is displayed at a second location, different from the first location, in the three-dimensional environment. In some embodiments, as discussed in more detail below, the computer system is in a communication session with one or more secondary computer systems. For example, objects within the three-dimensional environment and/or the three-dimensional environment are being displayed by both the computer system and the one or more secondary computer systems, concurrently, but from different viewpoints associated with their respective users. In some embodiments, in the communication session, the user of the computer system has a first viewpoint of the three-dimensional environment, and the one or more users of the one or more secondary computer systems have one or more second viewpoints of the three-dimensional environment. For example, a field of view of the three-dimensional environment from the first viewpoint of the user of the computer system includes a first portion of the three-dimensional environment (including the first object and the second object), and a field of view of the three-dimensional environment from the second viewpoint of a second user of a secondary computer system includes a second portion of the three-dimensional environment. In some embodiments, the second portion of the three-dimensional environment includes the first object and/or the second object, or neither the first object nor the second object. In some embodiments, the computer system and the one or more secondary computer systems are in the same physical environment (e.g., at different locations in the same room). In some embodiments, the computer system and the one or more secondary computer systems are located in different physical environments (e.g., different cities, different rooms, different states and/or different countries). In some embodiments, the computer system and the one or more secondary computer systems are in communication with each other such that the display of the objects within the three-dimensional environment and/or the three-dimensional environment by the computer systems is coordinated (e.g., changes to the objects within the three-dimensional environment and/or the three-dimensional environment made in response to inputs from the user of the computer system are reflected in the display of the objects within the three-dimensional environment and/or the three-dimensional environment by the one or more secondary computer systems). Additionally, the three-dimensional environment optionally includes virtual representations of (e.g., avatars corresponding to) users of the one or more secondary computer systems.

In some embodiments, while displaying the environment including the first object and the second object, the computer system detects (802b), via the one or more input devices, a first interaction input (e.g., an air gesture or interaction with a hardware input device) associated with a first predefined portion of a user (e.g., user 726) of the computer system, such as movement of hand 703a as shown in FIG. 7A. For example, the first predefined portion of the user is a first hand of the user. In some embodiments, the computer system detects an air pinch gesture performed by the first hand of the user of the computer system—such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the computer system. In some embodiments, after detecting the air pinch gesture, the computer system detects movement of the hand of the user in space, such as a movement while the hand is holding the pinch hand shape (e.g., the tips of the thumb and index finger remain touching) such as an air drag gesture. In some embodiments, the movement of the hand of the user is in a respective direction (e.g., in a vertical direction, a horizontal direction, or a diagonal direction) in space. In some embodiments, the computer system detects the first interaction input via a hardware input device (e.g., a controller operable with six degrees of freedom of movement, or a touchpad or mouse) in communication with the computer system. For example, the computer system detects a selection input (e.g., a tap, touch, or click) via the input device provided by one or more fingers of the first hand of the user. In some embodiments, after detecting the selection input, the computer system detects movement via the input device, such as movement of the controller in space, movement of a mouse across a surface (e.g., a tabletop), or movement of a finger of the first hand across the touchpad.

In some embodiments, in response to detecting the first interaction input (802c), in accordance with a determination that a second predefined portion (e.g., hand 705a in FIG. 7A), different from the first predefined portion, of the user (e.g., a second hand of the user) is associated with a second interaction input (e.g., has a first pose or is performing a respective type of interaction with an input device) when the first interaction input is detected, such as detecting hand 705a in an engaged state as described with reference to FIG. 7A, (e.g., while the air pinch gesture provided by the first hand of the user is being detected and/or before the air pinch gesture provided by the first hand of the user is detected, the second hand of the user is engaged. In some embodiments, the computer system detects an air pinch gesture (e.g., in which the tip of the index finger of the second hand of the user come into contact with the thumb of the second hand), and/or detects the first pose (e.g., a pinch pose in which the tip of the index finger of the second hand is touching the thumb of the second hand). In some embodiments, the computer system detects the first hand of the user providing the air pinch gesture while the second hand of the user is in the first pose (e.g., while the second hand is in the pinch hand shape and/or is in a raised/elevated state with respect to a surface on which the user is positioned). In some embodiments, the computer system detects the first hand and the second hand of the user at least partially concurrently provide air pinch gestures. In some embodiments, the first pose includes the hand of the user in a ready state configuration before, after and/or during the air pinch gesture is detected. In some embodiments, the computer system detects the first interaction input while the second hand of the user is associated with the second interaction input via a second input device (e.g., a controller operable with six degrees of freed of movement, or a touchpad or mouse) in communication with the computer system. For example, the computer system detects the first interaction input while a finger of the second hand of the user is selecting a button on the second input device and/or is holding the second input in a raised/elevated state with respect to the surface on which the user is positioned), the computer system performs (802d) a first operation, including concurrently repositioning the first object and the second object within the environment relative to a viewpoint of the user of the computer system in accordance with the first interaction input, such as movement of the virtual objects 707a and 709a relative to the viewpoint of the user 726 as shown in FIG. 7B. For example, the first operation includes movement/translation and/or rotation of the first object and the second object in the environment relative to the viewpoint of the user of the computer system. In some embodiments, a magnitude and/or direction of the repositioning of the first object and the second object in the three-dimensional environment corresponds to a magnitude and/or direction of movement/rotation of the first hand of the user. For example, movement of the first or second hand of the user with a first magnitude moves the first object and the second object a first amount in the three-dimensional environment relative to the viewpoint of the user, and rotation of the first or second hand of the user with a first angular magnitude rotates the first object and the second object a first angular amount in the three-dimensional environment relative to the viewpoint of the user. Similarly, movement of the first or second hand of the user in a first direction (e.g., in a leftward direction) optionally moves the first object and the second object in the first direction (e.g., leftward) in the three-dimensional environment relative to the viewpoint of the user, and rotation of the first or second hand of the user in a counterclockwise direction optionally rotates the first object and the second object in the counterclockwise direction relative to the viewpoint of the user.

In some embodiments, in accordance with a determination that the second predefined portion of the user is not associated with the second interaction input (e.g., does not have the first pose or is not performing the respective type of interaction with the input device) when the first interaction input is detected, such as detecting hand 705b in a disengaged state as described with reference to FIG. 7F, the computer system performs (802e) a second operation, different from the first operation, as described with reference to FIG. 7G. For example, while the air pinch gesture provided by the first hand of the user is being detected and/or before the air pinch gesture provided by the first hand of the user is detected, the second hand of the user is disengaged. In some embodiments, the computer system detects the second hand of the user is in a lowered or relaxed state with respect to the surface on which the user is positioned (e.g., the hand of the user is placed/rested at a side of the user's torso and/or is not in the ready state configuration). In some embodiments, the computer system detects that the second hand of the user is not in a pinch hand shape (e.g., the index finger and thumb of the hand of the user are not in contact). In some embodiments, the computer system detects that the second hand of the user is not selecting a button on the second input device and/or is not holding the second input device in a raised/elevated state with respect to the surface on which the user is positioned. In some embodiments, the second operation does not include movement/translation and/or rotation of the first object and the second object relative to the viewpoint of the user of the computer system. In some embodiments, as discussed in detail below, the second operation includes selection/activation of an option displayed in the three-dimensional environment (e.g., displayed in the first object or the second object), or movement of either the first object or the second object within the three-dimensional environment in accordance with the movement of the first hand of the user. Repositioning a plurality of objects in the three-dimensional environment based on whether both hands of a user of the computer system are in an engaged pose enables the plurality of objects to be simultaneously repositioned relative to a viewpoint of the user without displaying additional controls, thereby improving user-device interaction.

In some embodiments, performing the second operation includes activating a selectable option that is displayed in the environment (804), such as activation of selectable option 711 as shown in FIGS. 7F-7G. For example, in accordance with the determination that the second predefined portion of the user is not associated with the second interaction input when the first interaction input is detected, the computer system selects an option that is displayed in the first object, the second object, or in a third object in the three-dimensional environment. In some embodiments, the selectable option is targeted based on the attention of the user of the computer system. For example, the gaze of the user is directed toward the selectable option when the air pinch gesture and/or selection input on the hardware input device is received. Selecting a button displayed in the three-dimensional environment in response to receiving input from a hand of a user of the computer system enables the button to be selected relative to a viewpoint of the user without displaying additional controls, thereby improving user-device interaction.

In some embodiments, performing the second operation includes repositioning one of the first object and the second object within the environment relative to the viewpoint of the user in accordance with the first interaction input (806), such as repositioning of virtual object 709a relative to the viewpoint of the user 726 as shown in FIG. 7G. For example, in accordance with the determination that the second predefined portion of the user is not associated with the second interaction input when the first interaction input is detected, the computer system moves the first object or the second object, but not both objects, within the three-dimensional environment in accordance with the first interaction input because the first interaction input includes movement of the first hand of the user. In some embodiments, the first object or the second object is targeted based on the attention of the user of the computer system. For example, if the attention of the user is directed toward the first object, the computer system moves the first object in accordance with the first interaction input. If the attention of the user is directed toward the second object, the computer system optionally moves the second object in accordance with the first interaction input. In some embodiments, the first interaction input is directed to a repositioning element (e.g., a handlebar or grabber element) associated with (e.g., displayed with) the first object or the second object that is selectable to initiate movement of the first object or the second object within the three-dimensional environment relative to the viewpoint of the user. Repositioning an object in the three-dimensional environment in response to receiving input from a hand of a user of the computer system enables the object to be repositioned relative to a viewpoint of the user without displaying additional controls, thereby improving user-device interaction.

In some embodiments, the user of the computer system is in a communication session with a second user of a second computer system (e.g., computer system 101b in FIG. 7A) while displaying the environment (808a) (e.g., the computer system is in a communication session with a second computer system when the first interaction input was received, as described above), as described with reference to FIGS. 7A-7I. In some embodiments, the environment includes a virtual representation (e.g., avatar 706a in FIG. 7A) of the second user of the second computer system (808b) (e.g., the three-dimensional environment includes an avatar corresponding to the second user, as described above). In some embodiments, in response to detecting the first interaction input, in accordance with the determination that the second predefined portion of the user is associated with the second interaction input when the first interaction input is detected, the first operation includes concurrently repositioning the virtual representation of the second user with the first object and the second object within the environment relative to the viewpoint of the user of the computer system in accordance with the first interaction input (808c), such as repositioning of the virtual objects 707a and 709a and the avatar 706a relative to the viewpoint of the user 726 as shown in FIG. 7B. For example, if the second hand of the user is associated with the second interaction input when the first interaction input is detected, the computer system concurrently repositions the first object, the second object, and the avatar corresponding to the second user relative to the viewpoint of the user of the computer system in accordance with the first interaction input in one or more of the ways described above and below.

In some embodiments, in response to detecting the first interaction input (808d), in accordance with the determination that the second predefined portion of the user is not associated with the second interaction input when the first interaction input is detected and in accordance with a determination that the first interaction input is directed to the virtual representation of the second user (e.g., while the gaze of the user is directed toward the virtual representation of the second user, the computer system detects the first hand of the user provide an air pinch gesture and/or a selection input on the hardware input device, followed by movement of the first hand), the computer system forgoes (808e) repositioning the virtual representation of the second user (and forgoing repositioning the first object and/or the second object) within the environment, such as forgoing repositioning of the avatar 706a as shown in FIG. 7G. For example, in accordance with the determination that the second predefined portion of the user is not associated with the second interaction input when the first interaction input is detected, the computer system forgoes repositioning the avatar corresponding to the second user. In some embodiments, the computer system is able to reposition the avatar corresponding to the second user concurrently with repositioning the first object and the second object in the three-dimensional environment, and/or if the second user causes the avatar corresponding to the second user to move within the three-dimensional environment. In some embodiments, the computer system is not able to reposition the virtual representation of the second user without concurrently repositioning one or more other objects in the environment (e.g., the first object and second object). In some such embodiments, in response to the first interaction input described above, the computer system performs an alternative action, such as activating a selectable option and/or moving the first object or the second object in the three-dimensional environment, as described above. Forgoing repositioning of virtual representations of other users individually in the three-dimensional environment while in a communication session based on input provided by the user of the computer system maintains spatial truth between the user and the other users in the communication session, thereby improving user-device interaction.

In some embodiments, the user of the computer system is in a communication session with a second user of a second computer system (e.g., computer system 101b in FIG. 7A) while displaying the environment (810a) (e.g., the computer system is in a communication session with a second computer system when the first interaction input was received, as described above). In some embodiments, the environment includes a virtual representation (e.g., avatar 706a in FIG. 7A) of the second user of the second computer system (810b) (e.g., the three-dimensional environment includes an avatar corresponding to the second user, as described above).

In some embodiments, in response to detecting the first interaction input (810c), in accordance with the determination that the second predefined portion of the user is associated with the second interaction input when the first interaction input is detected, performing the first operation includes concurrently repositioning the first object, the second object, and the virtual representation of the second user within the environment relative to the viewpoint of the user in accordance with the first interaction input (810d), such as repositioning of the virtual objects 707a and 709a and the avatar 706a relative to the viewpoint of the user 726 as shown in FIG. 7B. For example, if the second hand of the user is associated with the second interaction input when the first interaction input is detected, the computer system concurrently repositions the first object, the second object, and the avatar corresponding to the second user relative to the viewpoint of the user of the computer system in accordance with the first interaction input. In some embodiments, the first object and the second object are shared with the second user of the second computer system. For example, the second computer system presents the contents of the first object and the second object in the three-dimensional environment relative to the viewpoint of the second user. In some embodiments, the computer system concurrently repositions all shared objects within the three-dimensional environment relative to the viewpoint of the user in accordance with the first interaction input. In some embodiments, if the computer system detects a third interaction input provided by a first hand of the user and directed to a shared object in the three-dimensional environment (e.g., the gaze of the user is directed toward the shared object), if the third interaction input is detected while a second hand of the user is engaged, the computer system concurrently repositions the shared object and any other shared objects within the three-dimensional environment relative to the viewpoint of the user in accordance with the third interaction input. In some embodiments, if the third interaction input is detected while the second hand of the user is not engaged, if the shared object is a virtual representation of another user, the computer system forgoes repositioning the shared object within the three-dimensional environment in accordance with the third interaction input, and if the shared object is not a virtual representation of another user (e.g., is a shared application window), the computer system repositions the shared object within the three-dimensional environment in accordance with the third input. Repositioning a plurality of objects, including representations of other users, in the three-dimensional environment while in a communication session based on whether both hands of a user of the computer system are in an engaged pose enables the plurality of objects to be simultaneously repositioned relative to a viewpoint of the user without displaying additional controls, thereby improving user-device interaction.

In some embodiments, the first interaction input includes movement of the first predefined portion of the user of the computer system in a first direction and with a first magnitude (812a), such as movement of the hand 703a in a rightward direction as shown in FIG. 7A. For example, the movement of the first hand of the user is in a first direction (e.g., in a vertical direction, a horizontal direction, a diagonal direction, and/or a rotational direction) in space with a first magnitude (e.g., of a first speed, of a first duration, and/or of a first distance of movement) while the first hand is in a pinch hand shape and/or is engaging the hardware input device, as described above.

In some embodiments, the first operation includes concurrently repositioning the first object and the second object in a second direction, based on the first direction within the environment and with a second magnitude (e.g., of a second speed, of a second duration, and/or of a second distance of movement), based on the first magnitude, relative to the viewpoint of the user in accordance with the first interaction input (812b), such as concurrent repositioning of the virtual objects 707a and 709a in the rightward direction relative to the viewpoint of the user 1126 as shown in FIG. 7B. For example, the computer system moves the first object and the second object in the second direction, which is optionally the same as the first direction, within the three-dimensional environment. In some embodiments, the first object and the second object are moved respective distances, for respective durations, and/or with respective speeds in the three-dimensional environment that are based on the first magnitude. For example, the second magnitude is equal to the first magnitude, is less than the first magnitude (but proportional to the first magnitude), or is greater than the first magnitude (but proportional to the first magnitude). In some embodiments, if the second magnitude is equal to the first magnitude, when the first hand of the user moves a first distance in space relative to the viewpoint of the user, the computer system moves the first object and the second object the first distance in the three-dimensional environment. If the second magnitude is less than the first magnitude, when the hand of the user moves the first distance in space relative to the viewpoint of the user, the computer system moves the first object and the second object a second distance, smaller than the first distance, in the three-dimensional environment. Repositioning a plurality of objects in the three-dimensional environment based on the movement of one of the hands of the user enables the plurality of objects to be simultaneously repositioned in a respective direction with a respective magnitude relative to a viewpoint of the user without displaying additional controls, thereby improving user-device interaction.

In some embodiments, concurrently repositioning the first object and the second object in the second direction within the environment and with the second magnitude includes (814a), in accordance with the movement of the first predefined portion (e.g., hand 703a in FIG. 7A) of the user relative to the second predefined portion (e.g., hand 705a) of the user being a first relative movement, concurrently repositioning the first object and the second object in a first relative direction within the environment and with a second relative magnitude (814b), as described with reference to FIG. 7B. For example, the direction of the movement of the first object and the second object within the three-dimensional environment is based on the movement of the first hand of the user relative to a location of the second hand of the user in space. In some embodiments, if the first hand of the user moves in a first respective direction relative to (e.g., clockwise away from) the location of the second hand of the user (e.g., when the first interaction input was detected), the computer system determines that the second direction is the first relative direction (e.g., which is based on the first respective direction, which is in a clockwise direction), and concurrently moves (e.g., rotates) the first object and the second object in the first relative direction (e.g., clockwise direction) in the three-dimensional environment relative to the viewpoint of the user in accordance with the first interaction input. In some embodiments, the second direction of the movement of the first predefined portion of the user is relative to the second predefined portion of the user because the second predefined portion of the user was associated with the second interaction input when the first interaction input was detected. In some embodiments, the magnitude of the movement of the first object and the second object is based on the movement of the first hand of the user relative to the location of the second hand of the user in space. In some embodiments, if the first hand of the user moves with a first magnitude (e.g., of speed, distance, and/or duration) relative to (e.g., away from or toward) the location of the second hand of the user (e.g., when the first interaction input was detected), the computer system determines that the second magnitude is the first relative magnitude (e.g., which is based on the first magnitude), and concurrently moves (e.g., rotates) the first object and the second object with the first relative magnitude in the three-dimensional environment relative to the viewpoint of the user in accordance with the first interaction input. In some embodiments, the first magnitude of the movement of the first predefined portion of the user is relative to the second predefined portion of the user because the second predefined portion of the user was associated with the second interaction input when the first interaction input was detected.

In some embodiments, concurrently repositioning the first object and the second object in the second direction within the environment and with the second magnitude includes, in accordance with the movement of the first predefined portion of the user relative to the second predefined portion of the user being a second relative movement, different from the first relative movement, concurrently repositioning the first object (e.g., virtual object 707a) and the second object (e.g., virtual object 709a) in a second relative direction, different from the first relative direction, within the environment and with a second relative magnitude, different from the first relative magnitude (814c), as described with reference to FIG. 7B. If the first hand of the user moves in a second respective direction relative to (e.g., counterclockwise toward) the location of the second hand of the user in space, the computer system optionally determines that the second direction is the second relative direction (e.g., a counterclockwise direction), and concurrently moves (e.g., rotates) the first object and the second object in the second relative direction (e.g., counterclockwise direction) in the three-dimensional environment relative to the viewpoint of the user in accordance with the first interaction input. If the first hand of the user moves with a third magnitude, different from the first magnitude, relative to (e.g., away from or toward) the location of the second hand of the user in space, the computer system optionally determines that the second magnitude is the second relative magnitude (e.g., which is based on the third magnitude), and optionally concurrently moves (e.g., rotates) the first object and the second object with the second relative magnitude in the three-dimensional environment relative to viewpoint of the user in accordance with the first interaction input. Repositioning a plurality of objects in the three-dimensional environment based on a direction and magnitude of the movement of one of the hands of the user relative to the other hand enables the plurality of objects to be simultaneously repositioned in a respective direction with a respective magnitude relative to a viewpoint of the user without displaying additional controls, thereby improving user-device interaction.

In some embodiments, concurrently repositioning the first object and the second object in the second direction within the environment and with the second magnitude includes (816a), in accordance with the movement of the first predefined portion of the user relative to a third predefined portion (e.g., an upper body of the user 1126), different from the first predefined portion and the second predefined portion of the user, being a first relative movement, concurrently repositioning the first object (e.g., virtual object 707a) and the second object (e.g., virtual object 709a) in a first relative direction within the environment and with a second relative magnitude (816b), as described with reference to FIG. 7B. For example, the direction of the movement of the first object and the second object within the three-dimensional environment is based on movement of the first hand of the user relative to a location of a portion of the upper body of the user in space, such as a location of a head of the user or of a shoulder of the user. In some embodiments, if the first hand of the user moves in a first respective direction relative to the location of the portion of the upper body of the user (e.g., toward the upper body of the user when the first interaction input was detected), the computer system determines that the second direction is the first relative direction (e.g., which is based on the first respective direction) relative to the viewpoint of the user, and concurrently moves (e.g., shifts or translates) the first object and the second in the second relative direction (e.g., toward the user) in the three-dimensional environment relative to the viewpoint of the user in accordance with the first interaction input. In some embodiments, the magnitude of the movement of the first object and the second object is based on movement of the first hand of the user relative to a location of a portion of the upper body of the user in space, such as a location of a head of the user or of a shoulder of the user. For example, if the first hand of the user moves with a first magnitude relative to (e.g., away from or toward) the location of the portion of the upper body of the user (e.g., when the first interaction input was detected), the computer system determines that the second magnitude is the first relative magnitude (e.g., which is based on the first magnitude), and concurrently moves the first object and the second object with the first relative magnitude in the three-dimensional environment relative to the viewpoint of the user in accordance with the first interaction input.

In some embodiments, concurrently repositioning the first object and the second object in the second direction within the environment and with the second magnitude includes, in accordance with the movement of the first predefined portion of the user relative to the third predefined portion of the user being a second relative movement, different from the first relative movement, concurrently repositioning the first object (e.g., virtual object 707a) and the second object (e.g., virtual object 709a) in a second relative direction, different from the first relative direction, within the environment and with a second relative magnitude, different from the first relative magnitude (816c), as described with reference to FIG. 7B. If the first hand of the user moves in a second respective direction relative to (e.g., away from) the location of the portion of the upper body of the user in space, the computer system optionally determines that the second direction is the second relative direction (e.g., which is based on the second respective direction) relative to the viewpoint of the user, and concurrently moves (e.g., shifts or translates) the first object and the second object in the second relative direction (e.g., away from the user) in the three-dimensional environment relative to the viewpoint of the user in accordance with the first interaction input. If the first hand of the user moves with a third magnitude, different from the first magnitude, relative to (e.g., away from or toward) the location of the portion of the upper body of the user in space, the computer system optionally determines that the second magnitude is the second relative magnitude (e.g., which is based on the third magnitude), and concurrently moves (e.g., shifts or translates) the first object and the second object with the second relative magnitude in the three-dimensional environment relative to viewpoint of the user in accordance with the first interaction input. Repositioning a plurality of objects in the three-dimensional environment based on a direction and magnitude of the movement of one of the hands of the user relative to a different portion of the body of the user enables the plurality of objects to be simultaneously repositioned in a respective direction with a respective magnitude relative to a viewpoint of the user without displaying additional controls, thereby improving user-device interaction.

In some embodiments, the environment is displayed with a first visual characteristic having a second value when the first interaction input is detected (818a), such as display of the three-dimensional environment 702 as shown in FIG. 7A. In some embodiments, while detecting the first interaction input (818b), in accordance with the determination that the second predefined portion of the user is associated with the second interaction input when the first interaction input is detected, the computer system displays (818c) the environment with the first visual characteristic having a first value, different from the second value, such as display of the three-dimensional environment 702 as shown in FIG. 7B. For example, if the second hand of the user is associated with the second interaction input when the first interaction input is detected, the computer system changes an appearance of the three-dimensional environment surrounding the first object and the second object relative to the viewpoint of the user of the computer system using the first visual characteristic. In some embodiments, the first visual characteristic includes a darkening effect, and the first value includes a level of darkness of the three-dimensional environment. In some embodiments, the first visual characteristic includes a blurring effect, and the first value includes a level of blur of the three-dimensional environment. In some embodiments, the first visual characteristic is not applied to the first object and the second object.

In some embodiments, in accordance with the determination that the second predefined portion of the user is not associated with the second interaction input when the first interaction input is detected, the computer system maintains (818d) display of the environment with the first visual characteristic having the second value, such as the appearance of three-dimensional environment 702 as shown in FIG. 7G. For example, if the second hand of the user is not associated with the second interaction input when the first interaction input is detected, the computer system forgoes changing an appearance of the three-dimensional environment surrounding the first object and the second object relative to the viewpoint of the user of the computer system using the first visual characteristic. In some embodiments, the three-dimensional environment is displayed with the first visual characteristic having the second value before the computer system receives the first interaction input. In some embodiments, if the first visual characteristic includes the darkening effect, the second value is smaller than the first value, such that the level of darkness of the three-dimensional environment remains unchanged. In some embodiments, if the first visual characteristic includes the blurring effect, the second value is smaller than the first value, such that the level of blur of the three-dimensional environment remains unchanged. In some embodiments, the change in the first visual characteristic is not applied to the first object and the second object. Selectively changing an appearance of the three-dimensional environment surrounding a plurality of objects based on whether both hands of a user of the computer system are in an engaged pose facilitates discovery that the plurality of objects can be simultaneously repositioned relative to a viewpoint of the user, thereby improving user-device interaction.

In some embodiments, while displaying the environment with the first visual characteristic having the first value (e.g., the appearance of three-dimensional environment 702 as shown in FIG. 7B) (e.g., because the second hand of the user was associated with the second interaction input when the first interaction input was detected), the computer system detects (820a), via the one or more input devices, an indication that the first predefined portion of the user is no longer associated with the first interaction input (e.g., detecting hand 703c release the pinch as shown in FIG. 7C) and the second predefined portion of the user is no longer associated with the second interaction input (e.g., detecting hand 705b remain in the disengaged state as shown in FIG. 7C). For example, the computer system detects the first hand of the user is no longer providing a pinch gesture, and/or is no longer providing input via the input device described above. Additionally and/or concurrently, in some embodiments, the computer system detects the second hand of the user is no longer providing a pinch gesture, is no longer in the predefined pose (e.g., the second hand of the user is in a relaxed state with respect to the surface on which the user is positioned), and/or is no longer providing input via the second input device described above.

In some embodiments, in response to detecting the indication, the computer system maintains (820b) display of the environment with the first visual characteristic having the first value for a threshold amount of time, such as maintaining display of the appearance of three-dimensional environment 702 as shown in FIG. 7D. For example, the computer system maintains display of the environment with the darkening effect and/or the blurring effect for 0.5, 1, 1.5, 2, 2.5, 3, 4, 5, or 10 seconds after detecting that the first hand and the second hand of the user are no longer engaged. In some embodiments, as described below, if the computer system detects a subsequent input, such as a pinch gesture or an engagement of the input device in the manners described above or below, provided by the first hand and/or the second hand of the user within the threshold amount of time, the computer system will concurrently perform a repositioning operation on the first object and the second object within the three-dimensional environment and continue to display the environment with the first visual characteristic having the first value. If the computer system detects the subsequent input provided by the first hand or the second hand after the threshold amount of time elapses, the computer system will optionally forgo concurrently performing a repositioning operation on the first object and the second object within the three-dimensional environment and will update display of the three-dimensional environment to be displayed with the first visual characteristic having the second value, as described below. In some embodiments, if the computer system does not detect a subsequent input, and the threshold amount of time elapses, the computer system will update display of the three-dimensional environment to be displayed with the first visual characteristic having the second value. Maintaining display of the change in appearance of the three-dimensional environment surrounding a plurality of objects for a threshold amount of time in response to detecting that the hands of the user of the computer system are no longer in an engaged pose facilitates discovery that the plurality of objects can be further simultaneously repositioned relative to a viewpoint of the user within the threshold amount of time, thereby improving user-device interaction.

In some embodiments, after detecting an end of the first interaction input, the computer system detects (822a), via the one or more input devices, a third interaction input, such as movement of hand 703d as shown in FIG. 7D or movement of hand 713a as shown in FIG. 7F. For example, the computer system detects an air pinch gesture performed by the first hand and/or the second hand of the user of the computer system, as similarly described above. In some embodiments, after detecting the air pinch gesture, the computer system detects movement of the hand of the user in space, such as an air drag gesture, as described above. In some embodiments, the computer system detects a selection input (e.g., a tap, touch, and/or click) via a hardware input device provided by one or more fingers of the hand of the user, as described above.

In some embodiments, in response to detecting the third interaction input (822b), in accordance with a determination that the third interaction input is not associated with one of the first predefined portion of the user or the second predefined portion of the user, such as movement of the hand 713a as shown in FIG. 7F, the computer system displays (822c) the environment with the first visual characteristic having the second value, such as the appearance of three-dimensional environment 702 as shown in FIG. 7G. For example, before detecting the third interaction input, the three-dimensional environment is displayed with the first visual characteristic having the second value (e.g., the three-dimensional environment is displayed with less of the darkening or blurring effect, compared to when the three-dimensional environment is displayed with the first visual characteristic having the first value). In some embodiments, in response to detecting the third interaction input, if the third interaction input is not provided concurrently by the first hand and the second hand of the user, the computer system maintains display of the three-dimensional environment with the first visual characteristic having the second value. For example, the computer system forgoes changing the appearance of the three-dimensional environment surrounding the first object and the second object in response to detecting the third interaction input, which optionally indicates that, the computer system will forgo concurrently repositioning the first object and the second object within the three-dimensional environment relative to the viewpoint of the user in accordance with the third interaction input (e.g., if the third interaction input includes movement of one or both hands of the user).

In some embodiments, in accordance with a determination that the third interaction input is associated with the first predefined portion of the user and the second predefined portion of the user, such as movement of the hand 703d as shown in FIG. 7D, the computer system displays (822d) the environment with the first visual characteristic having the first value, such as the appearance of the three-dimensional environment 702 in FIG. 7E. For example, if the third interaction input is provided concurrently by the first hand and the second hand of the user, the computer system changes the appearance of the three-dimensional environment surrounding the first object and the second object (e.g., the three-dimensional environment is displayed with increased darkening and/or blurring effect compared to when the three-dimensional environment is displayed with the first visual characteristic having the second value). In some embodiments, in response to detecting the third interaction input, the computer system will concurrently reposition the first object and the second object within the three-dimensional environment relative to the viewpoint of the user in accordance with the third interaction input (e.g., if the third interaction input includes movement of one or both hands of the user). Selectively changing an appearance of the three-dimensional environment surrounding a plurality of objects based on whether both hands of the user concurrently engage provides feedback about whether the plurality of objects can be further simultaneously repositioned relative to a viewpoint of the user, thereby improving user-device interaction.

In some embodiments, the environment includes one or more portions of a physical environment of the display generation component (e.g., physical table 722a, physical sofa 724a, and/or physical walls in the field of view of display generation component 120 in FIG. 7A), displaying the environment with the first visual characteristic having the first value includes displaying the one or more portions of the physical environment with a first visual emphasis relative to the first object and the second object (e.g., the appearances of the physical table 722a, physical sofa 724a, and/or physical walls in FIG. 7B) and displaying the environment with the first visual characteristic having the second value includes displaying the one or more portions of the physical environment with a second visual emphasis, different from the first visual emphasis, relative to the first object and the second object (824) (e.g., the appearances of the physical table 722a, physical sofa 724a, and/or physical walls in FIG. 7F). For example, as described above, displaying the three-dimensional environment with the first visual characteristic having the first value is independent of the display of the first object and the second object. In some embodiments, when the computer system displays the three-dimensional environment with increased dimming and/or blurring (e.g., in response to detecting the first interaction input while the second hand of the user is providing the second interaction input), the computer system forgoes displaying the first object and the second object with increased dimming and/or blurring. In some embodiments, when the computer system is in a communication session with a second computer system, as described above, and while the three-dimensional environment includes the virtual representation of a second user of the second computer system, the computer system forgoes displaying the virtual representation of the second user with the increased dimming and/or blurring in response to detecting the first interaction input while the second hand of the user is providing the second interaction input. Forgoing changing an appearance of a plurality of objects in the three-dimensional environment when the computer system changes the appearance of the three-dimensional environment facilitates discovery that the plurality of objects can be simultaneously repositioned relative to a viewpoint of the user, thereby improving user-device interaction.

In some embodiments, in accordance with the determination that the second predefined portion of the user was associated with the second interaction input when the first interaction input was detected and while the first predefined portion of the user remains engaged (826a), as described with reference to FIG. 7A, after detecting an end of the first interaction input, the computer system detects (826b), via the one or more input devices, an indication that the second predefined portion of the user is no longer associated with the second interaction input, such as detecting hand 705b is no longer in an engaged state as described with reference to FIG. 7B. For example, the computer system detects the second hand of the user is no longer providing a pinch gesture, is no longer in the predefined pose (e.g., the second hand of the user is in a relaxed state with respect to the surface on which the user is positioned), and/or is no longer providing input via the second input device described above. In some embodiments, the first hand of the user remains in an engaged pose (e.g., is holding the pinch gesture and/or is maintaining selection via the input device) when the indication is detected.

In some embodiments, after detecting the indication, the computer system detects (826c), via the one or more input devices, a third interaction input associated with the first predefined portion of the user, such as movement of hand 703b as shown in FIG. 7B. For example, the computer system detects, while the first hand of the user of the computer system remains engaged (e.g., maintains the pinch hand shape and/or providing selection input on the hardware input device), the computer system detects subsequent movement of the first hand of the user in space, such as an air drag gesture and/or while engaging the hardware input device, as similarly described above.

In some embodiments, in response to detecting the third interaction input, the computer system performs (826d) a third operation, including concurrently repositioning the first object and the second object within the environment relative to the viewpoint of the user in accordance with the third interaction input, such as concurrent rotation of the virtual objects 707a and 709a relative to the viewpoint of the user 726 as shown in FIG. 7C. For example, the third operation includes concurrent movement/translation and/or rotation of the first object and the second object in the three-dimensional environment relative to the viewpoint of the user of the computer system. In some embodiments, a magnitude and/or direction of the repositioning of the first object and the second object in the three-dimensional environment corresponds to a magnitude and/or direction of movement/rotation of the first hand of the user, as similarly described above. In some embodiments, the movement/translation and/or rotation of the first object and the second object caused by the third interaction input and the second object is in addition to the movement/translation and/or rotation of the first object and the second object caused by the first interaction input. Performing an additional operation including further repositioning a plurality of objects in the three-dimensional environment in response to detecting a single-handed input based on whether both hands of a user of the computer system are initially in an engaged pose reduces the number of inputs needed to further reposition the plurality of objects relative to a viewpoint of the user, thereby improving user-device interaction.

In some embodiments, after detecting an end of the first interaction input, wherein the second predefined portion of the user was associated with the second interaction input when the first interaction input was detected, as described with reference to FIG. 7A, the computer system detects (828a), via the one or more input devices, an indication that the first predefined portion (e.g., hand 703C in FIG. 7C) of the user is no longer associated with the first interaction input and the second predefined portion (e.g., hand 705b in FIG. 7C) of the user is no longer associated with the second interaction input, as described with reference to FIG. 7C. For example, the computer system detects the first hand of the user is no longer providing a pinch gesture, and/or is no longer providing input via the input device described above. Additionally and/or concurrently, in some embodiments, the computer system detects the second hand of the user is no longer providing a pinch gesture, is no longer in the predefined pose (e.g., the second hand of the user is in a relaxed state with respect to the surface on which the user is positioned), and/or is no longer providing input via the second input device described above.

In some embodiments, after detecting the indication, the computer system detects (828b), via the one or more input devices, a third interaction input associated with the first predefined portion of the user, such as movement of hand 703d as shown in FIG. 7D. For example, the computer system detects an air pinch gesture performed by the first hand of the user of the computer system, as similarly described above. In some embodiments, after detecting the air pinch gesture, the computer system detects movement of the hand of the user in space, such as an air drag gesture, as described above. In some embodiments, the computer system detects a selection input (e.g., a tap, touch, or click) via a hardware input device provided by one or more fingers of the hand of the user, as described above. In some embodiments, the second hand of the user remains disengaged when the third interaction input is provided.

In some embodiments, in response to detecting the third interaction input (828c), in accordance with a determination that the third interaction input was detected within a threshold amount of time (e.g., 0.5, 1, 1.5, 2, 2.5, 3, 4, 5, or 10 seconds) of detecting the indication, as described with reference to FIG. 7D, the computer system performs (828d) a third operation, including concurrently repositioning the first object and the second object within the environment relative to the viewpoint of the user in accordance with the third interaction input, such as concurrently rotating the virtual objects 707a and 709a relative to the viewpoint of the user 726 as shown in FIG. 7E. For example, the third operation includes movement/translation and/or rotation of the first object and the second object in the three-dimensional environment relative to the viewpoint of the user of the computer system. In some embodiments, a magnitude and/or direction of the repositioning of the first object and the second object in the three-dimensional environment corresponds to a magnitude and/or direction of movement/rotation of the first hand of the user, as similarly described above. In some embodiments, the movement/translation and/or rotation of the first object and the second object caused by the third interaction input and the second object is in addition to the movement/translation and/or rotation of the first object and the second object caused by the first interaction input because the third interaction input is detected within the threshold amount of time of detecting that the second hand is no longer in the engaged pose. Performing an additional operation including further repositioning a plurality of objects in the three-dimensional environment in response to detecting a single-handed input based on whether the single-handed input is detected within a threshold amount of time of detecting both hands of a user of the computer system disengage reduces the number of inputs needed to further reposition the plurality of objects relative to a viewpoint of the user, thereby improving user-device interaction.

In some embodiments, in response to detecting the third interaction input (830a), in accordance with a determination that the third interaction input was detected after the threshold amount of time (e.g., 0.5, 1, 1.5, 2, 2.5, 3, 4, 5, or 10 seconds) of detecting the indication, such as movement of hand 713a as shown in FIG. 7F, the computer system forgoes (830b) performing the third operation, as described with reference to FIG. 7G. For example, the computer system performs a fourth operation, different from the third operation. In some embodiments, because the computer system detects the first hand of the user provide the third interaction input after the threshold amount of time has elapsed, the computer system activates a selectable affordance or moves the first object or the second object within the three-dimensional environment in accordance with the third interaction input, as similarly described above with respect to the second operation performed in response to detecting the first interaction input. Forgoing repositioning a plurality of objects in a three-dimensional environment in response to detecting a single-handed input after a threshold amount of time has elapsed since detecting both hands of a user of the computer system disengage enables alternative operations to be performed without displaying additional controls, thereby improving user-device interaction.

In some embodiments, the user of the computer system is in a communication session with a second user of a second computer system (e.g., computer system 101b) while displaying the environment (832a) (e.g., the computer system is in a communication session with a second computer system when the first interaction input was received, as described above). In some embodiments, the environment includes a virtual representation (e.g., avatar 706a in FIG. 7A) of the second user of the second computer system (832b) (e.g., the three-dimensional environment includes an avatar corresponding to the second user, as described above).

In some embodiments, in response to detecting the first interaction input (832c), in accordance with the determination that the second predefined portion of the user is associated with the second interaction input when the first interaction input is detected (e.g., as described with reference to FIG. 7A) and that the first object (and/or the second object) is shared with the second user of the second computer system, performing the first operation includes concurrently repositioning the first object (and/or the second object), and the virtual representation of the second user within the environment relative to the viewpoint of the user in accordance with the first interaction input (832d), such as the concurrent movement of the virtual objects 707a and 709a and the avatar 706a relative to the viewpoint of user 726 as shown in FIG. 7B. For example, if the second hand of the user is associated with the second interaction input when the first interaction input is detected, and if the first object and the second object are shared between the computer system and the second computer system, as described above, the computer system concurrently repositions the first object, the second object, and the avatar corresponding to the second user within the three-dimensional environment relative to the viewpoint of the user of the computer system in accordance with the first interaction input. In some embodiments, if the first object and the second object are not shared between the computer system and the second computer system, the computer system forgoes concurrently repositioning the first object, the second object, and the avatar corresponding to the second user within the three-dimensional environment. For example, the computer system performs an alternative operation (e.g., such as the second operation discussed above). Repositioning a plurality of shared objects, including representations of other users, in the three-dimensional environment while in a communication session based on whether both hands of a user of the computer system are in an engaged pose enables the plurality of shared objects to be simultaneously repositioned relative to a viewpoint of the user without displaying additional controls, thereby improving user-device interaction.

In some embodiments, a virtual representation (e.g., similar to avatar 706a) of the user of the computer system (e.g., 101a) is displayed in an environment at the second computer system (e.g., 101b) (834a), as described with reference to FIGS. 7A-7I. For example, the second computer system is displaying a three-dimensional environment that includes an avatar corresponding to the user of the computer system. In some embodiments, if the first object and the second object are shared between the computer system and the second computer system in the communication session, the three-dimensional environment displayed at the second computer system also includes the first object and the second object. In some embodiments, if the first object and/or the second object are not shared with the second computer system, the three-dimensional environment displayed at the second computer system does not include the first object and/or the second object, or includes the first object and/or second object without the content of the first object and/or second object. In some embodiments, the three-dimensional environment displayed at the second computer system includes one or more characteristics of the three-dimensional environment displayed at the computer system. For example, the three-dimensional environment at the second computer system is generated, displayed, or otherwise caused to be viewable by the second computer system (e.g., an extended reality (XR) environment such as a virtual reality (VR) environment, a mixed reality (MR) environment, or an augmented reality (AR) environment). In some embodiments, as described above, the three-dimensional environment displayed at the second computer system includes at least portions of the physical environment surrounding the second computer system, different from the physical environment surrounding the computer system.

In some embodiments, when the computer system performs the first operation, the virtual representation of the user of the computer system is repositioned in the environment at the second computer system relative to a viewpoint of the second user based on the first operation (834b), similar to the movement of the avatar 706a as shown in FIG. 7I. For example, when the computer system concurrently repositions the first object, the second object, and the avatar corresponding to the second user of the second computer system because the first object and the second object are shared between the computer system and the second computer system, the second computer system repositions the avatar corresponding to the user of the computer system within the three-dimensional environment at the second computer system relative to the viewpoint of the second user based on the first operation. For example, the second computer system moves the avatar corresponding to the user of the computer system within the three-dimensional environment at the second computer system based on the movement of the first object, the second object, and the avatar corresponding to the user of the computer system without moving the first object and the second object so that the environments displayed at the computer system and the second computer system maintain a common spatial arrangement of shared objects and visual representations/viewpoints of the users. In some embodiments, if the second computer system detects an interaction input directed to the portion of the three-dimensional environment that is displayed at the second computer system, and the second computer system concurrently repositions the first object, the second object, and the virtual representation of the user of the computer system within the three-dimensional environment relative to the viewpoint of the second user, the computer system will move the virtual representation (e.g., the avatar) of the second user in the three-dimensional environment displayed at the computer system relative to the viewpoint of the user of the computer system without moving the first object and the second object. In some embodiments, the virtual representations of the second user of the second computer system and the user of the computer system are moved within the environments displayed at the computer system and the second computer system, respectively, to maintain a common spatial arrangement of shared objects and visual representations/viewpoints of the users. Repositioning a virtual representation of a user of a computer system in a three-dimensional environment displayed at a second computer system, while the computer system and the second computer system are in a communication session, based on input detected at the second computer system maintains spatial truth between the user of the computer system, the second user, and the other objects in the communication session, thereby improving user-device interaction.

In some embodiments, while the first interaction input is being detected, the virtual representation of the user is visually deemphasized in the environment at the second computer system (836), such as the visual deemphasis of the avatar 706a as shown in FIG. 7H. For example, while the computer system detects the first hand of the user is associated with the first interaction input, the second computer system visually deemphasizes the avatar corresponding to the user of the computer system in the three-dimensional environment at the second computer system. In some embodiments, the second computer system dims, blurs, fades, and/or darkens the virtual representation of the user in the three-dimensional environment at the second computer system relative to the viewpoint of the second user and/or relative to other portions of the environment displayed at the second computer system. In some embodiments, when the computer system detects an end of the first interaction input, the second computer system ceases visually deemphasizing the virtual representation of the user of the computer system in the three-dimensional environment at the second computer system relative to the viewpoint of the second user and/or relative to other portions of the environment displayed at the second computer system. Visually deemphasizing a virtual representation of a user of a computer system in a three-dimensional environment displayed at a second computer system, when the computer system and the second computer system are in a communication session, while the second computer system detects input corresponding to a request to reposition a plurality of objects provides feedback that the computer system is detecting input corresponding to repositioning of the plurality of objects, thereby improving user-device interaction.

In some embodiments, while no virtual objects are displayed in the environment relative to the viewpoint of the user (e.g., the first object and the second object are displayed in the three-dimensional environment outside of the user's field of view and no virtual (and/or physical) objects are displayed from the user's current field of view from the user's current viewpoint of the three-dimensional environment. In some embodiments, one or more physical objects of the physical environment surrounding the display generation component are caused to be visible in the user's current field of view), as described below in method 1400, the computer system detects (838a), via the one or more input devices, a third interaction input associated with the first predefined portion of the user (e.g., hand 703a) and the second predefined portion (e.g., hand 705a) of the user. For example, the computer system detects an air pinch gesture performed by (each of) the first hand and the second hand of the user of the computer system, as similarly described above, while the attention of the user is directed to a respective location in the three-dimensional environment (e.g., a location that does not include the first object and the second object). In some embodiments, after detecting the air pinch gestures, the computer system detects movement of the hands of the user in space, such as an air drag gesture, as described above. In some embodiments, the computer system detects a selection input (e.g., a tap, touch, and/or click) via a hardware input device provided by one or more fingers of (each of) the first hand and the second hand of the user, as described above. In some embodiments, the movement includes translation or rotation of the first hand and/or the second hand of the user. In some embodiments, the reference point is determined based on the location of the attention of the user in the three-dimensional environment.

In some embodiments, in response to detecting the third interaction input (838b), in accordance with a determination that the third interaction input corresponds to a request to perform a third operation of a first type, the third operation of the first type including concurrently repositioning the first object and the second object within the environment in a first manner relative to the viewpoint of the user, the computer system performs (838c) the third operation in accordance with the third interaction input, as described below in method 1400. For example, the third operation of the first type includes movement/translation and/or rotation of the first object and the second object in the three-dimensional environment relative to the viewpoint of the user of the computer system. In some embodiments, the computer system concurrently repositions the first object and the second object within the three-dimensional environment relative to the viewpoint of the user in accordance with the third interaction input. For example, the computer system concurrently moves the first object and the second or concurrently rotates the first object and the second object (e.g., while the first object and the second object are optionally outside of the field of view of the user) in accordance with the third interaction input.

In some embodiments, in accordance with a determination that the third interaction input corresponds to a request to perform the third operation of a second type, different from the first type, the third operation of the second type including concurrently repositioning the first object and the second object within the environment in a second manner relative to a reference point other than the viewpoint of the user, the computer system forgoes (838d) performing the third operation, as described below in method 1400. For example, the third operation of the second type includes rotation of the first object and the second object in the three-dimensional environment relative to a reference point determined based on the location of the gaze of the user in the three-dimensional environment. In some embodiments, because the first object and the second object are outside the field of view of the user, the computer system forgoes concurrently repositioning the first object and the second object relative to the reference point. In some embodiments, the computer system performs an alternative operation. For example, the computer system concurrently repositions the first object and the second object relative to the viewpoint of the user of the computer system (e.g., irrespective of the location of the attention of the user). In some embodiments, the computer system does not perform the third operation of the second type including concurrently repositioning the first object and the second object within the environment relative to the reference point because only the third operation of the first type is allowed when there are no virtual objects in the user's current field of view. Limiting the repositioning of a plurality of objects to be relative to a viewpoint of a user of the computer system when the plurality of objects are outside of a field of view of the user avoids situations in which the plurality of objects are moved unintentionally and/or further outside the field of view of the user, thereby improving user-device interaction.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9I illustrate examples of a computer system facilitating manipulation of virtual objects in a virtual environment in accordance with some embodiments.

FIG. 9A illustrates a computer system (e.g., an electronic device) 101a displaying, via a display generation component (e.g., display generation component 120 of FIG. 1), a three-dimensional environment 901 from a viewpoint of the user 905a illustrated in the overhead view (e.g., facing the back wall of the physical environment in which computer system 101 is located). In some embodiments, computer system 101a includes a display generation component (e.g., a touch screen 120) and a plurality of image sensors (e.g., image sensors 314 of FIG. 3). The image sensors optionally include one or more of a visible light camera, an infrared camera, a depth sensor, or any other sensor the computer system 101a would be able to use to capture one or more images of a user or a part of the user (e.g., one or more hands of the user) while the user interacts with the computer system 101a. In some embodiments, the user interfaces illustrated and described below could also be implemented on a head-mounted display that includes a display generation component that displays the user interface or three-dimensional environment 901 to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 9A, computer system 101a captures one or more images of the physical environment around computer system 101a (e.g., operating environment 100), including one or more objects in the physical environment around computer system 101a. In some embodiments, computer system 101a displays representations of the physical environment in three-dimensional environment 901. For example, three-dimensional environment 901 includes a representation 922 of a coffee table, which is optionally a representation of a physical coffee table in the physical environment, and three-dimensional environment 901 includes a representation 924 of sofa, which is optionally a representation of a physical sofa in the physical environment.

In FIG. 9A, three-dimensional environment 901 also includes virtual objects including App A user interface 902 and App B user interface 904. App A user interface 902 and App B user interface 904 are optionally at different distances from the viewpoint of user 905a in three-dimensional environment 901. For example, in FIG. 9A, App A user interface 902 is located at a first location that is further from the viewpoint of user 905a than a second location at which App B user interface 904 is located in three-dimensional environment 901, as reflected in the overhead view. In some embodiments, App A user interface 902 and App B user interface 904 are optionally one or more of user interfaces of applications containing content (e.g., quick look windows displaying photographs), three-dimensional objects (e.g., virtual clocks, virtual balls, and/or virtual cars) or any other element displayed by computer system 101a that is not included in the physical environment of display generation component 120.

In some embodiments, the computer system 101a is in a communication session with a second computer system 101b (shown in the overhead view). For example, App A user interface 902 and App B user interface 904 within the three-dimensional environment 901 are being displayed by both the computer system 101a and the second computer system 101b, concurrently, but from different viewpoints associated with their respective users. In some embodiments, in the communication session, the user 905a of the computer system 101a has a first viewpoint of the three-dimensional environment 901, and a second user 905b of the second computer system 101b has a second viewpoint of the three-dimensional environment 901. For example, a field of view of the three-dimensional environment 901 from the first viewpoint of the user 905a of the computer system 101a, as shown in FIG. 9A, includes a first portion of the three-dimensional environment 901 (including App A user interface 902 and App B user interface 904), and a field of view of the three-dimensional environment 901 from the second viewpoint of the second user 905b of the second computer system 101b includes a second portion of the three-dimensional environment 901 displayed via display generation component of the second computer system 101b. In some embodiments, the second portion of the three-dimensional environment 901 includes App A user interface 902 and/or App B user interface 904, or neither the App A user interface 902 nor App B user interface 904. In some embodiments, the computer system 101a and the second computer system 101b are in the same physical environment (e.g., at different locations in the same room of FIG. 9A). In some embodiments, the computer system 101a and the second computer system 101b are located in different physical environments (e.g., different cities, different rooms, different states and/or different countries).

In some embodiments, while the computer system 101a is in the communication session with the second computer system 101b, the three-dimensional environment 901 includes a virtual representation of the second user 905b of the second computer system 101b and, optionally, a virtual representation of the second computer system 101b. For example, as shown in FIG. 9A, the three-dimensional environment 901 includes an avatar corresponding to the second user 905b of the second computer system 101b. In FIG. 9A, the avatar corresponding to the second user 905b is optionally displayed at a third location in the three-dimensional environment 901, as illustrated in the overhead view. In some embodiments, the avatar corresponding to the second user 905b includes a three-dimensional representation (e.g., rendering) of the second user 905b. In some embodiments, the avatar corresponding to the second user 905b includes a representation of the second computer system 101b of which the second user is a user. In some embodiments, the second portion of the three-dimensional environment 901 from the second viewpoint of the second user 905b displayed at the second computer system 101b includes a virtual representation of the user 905a of the computer system 101a.

In some embodiments, virtual objects are displayed in three-dimensional environment 901 with respective orientations relative to the viewpoint of user 905a (e.g., prior to receiving one or more input(s) interacting with the virtual objects, which will be described later, in three-dimensional environment 901). As shown in FIG. 9A, App A user interface 902, App B user interface 904 and the avatar corresponding to the second user 905b of the second computer system 101b have first orientations in three-dimensional environment 901, as shown via the display generation component 120 and in the top-down view of the three-dimensional environment 901. It should be understood that the orientations of the virtual objects in FIG. 9A are merely exemplary and that other orientations are possible; for example, the virtual objects are optionally displayed with different orientations in three-dimensional environment 901.

In some embodiments, App A user interface 902 and/or App B user interface 904 are shared between the user 905a of the computer system 101a and the second user 905b of the second computer system 101b (e.g., while the computer system 101a and the second computer system 101b are in a communication session). For example, the user interfaces and/or contents (e.g., text, images, video, files, icons, and/or control elements) of App A user interface 902 and/or App B user interface 904 are displayed in the first portion and/or the second portion of the three-dimensional environment 901, such that the user interfaces and/or contents of App A user interface 902 and/or App B user interface 904 are accessible by (e.g., viewable by and/or interactable (e.g., selectable or scrollable) by) the user 905a of the computer system 101a and the second user 905b of the second computer system 101b. In some embodiments, as described below, when the App A user interface 902 and App B user interface 904 are shared between the user 905a and the second user 905b, changes in relative positions of the App A user interface 902 and/or App B user interface 904 in three-dimensional environment 901 due to user input received at the computer system 101a are reflected in the second portion of the three-dimensional environment 901 at the second computer system 101b relative to the second viewpoint of the second user 905b. In some embodiments, the App A user interface 902 and/or App B user interface 904 are not shared between the user 905a of the computer system 101a and the second user 905b of the second computer system 101b. For example, the computer system 101a displays the App A user interface 902 and App B user interface 904 in three-dimensional environment 901 and/or provides the user 905a access to the contents of the App A user interface 902 and App B user interface 904, and the second computer system 101b forgoes displaying App A user interface 902 and/or App B user interface 904 in the portion of the three-dimensional environment 901 at the second computer system 101b and/or forgoes providing the second user 905b access to the contents of the App A user interface 902 and/or App B user interface 904. In some embodiments, when the App A user interface 902 and/or App B user interface 904 are not shared between the user 905a and the second user 905b, changes in relative positions of the App A user interface 902 and/or App B user interface 904 in three-dimensional environment 901 due to user input received at the computer system 101a are not reflected in the second portion of the three-dimensional environment 901 at the second computer system 101b relative to the second viewpoint of the second user 905b.

In some embodiments, the computer system 101a and the second computer system 101b are in communication with each other such that the display of the App A user interface 902 and App B user interface 904 within the three-dimensional environment 901 and/or the three-dimensional environment 901 by the computer systems 101a and 101b is coordinated. For example, as described below, changes to (e.g., in positions of) the App A user interface 902, App B user interface 904 and the avatar corresponding to the second user 905b within the three-dimensional environment 901 and/or the three-dimensional environment 901 itself made in response to inputs from the user 905a of the computer system 101a are reflected in the display of the App A user interface 902 and/or App B user interface 904 and the avatar 905b within the portion of the three-dimensional environment 901 and/or the three-dimensional environment 901 by the second computer system 101b.

In FIG. 9A, while the computer system 101a displays the three-dimensional environment 901 as described above, the computer system 101a detects an interaction input provided by the hands 903a and 90b of the user 905a while attention of the user 905a, optionally including gaze 907a, is directed to the App A user interface 902 in the three-dimensional environment 901. In some embodiments, the interaction input corresponds to a request to manipulate the virtual objects in the three-dimensional environment 901. The interaction input includes movement of the hands 903a and 903b in a movement pattern corresponding to rotation of the virtual objects in the three-dimensional environment 901. In some embodiments, the interaction input includes the hands 903a and 903b in predefined hand shapes (e.g., pinch hand shapes) while performing the movement. In some embodiments, additional or alternative input devices are used to detect inputs for manipulating virtual objects in the three-dimensional environment 901, as described in more detail below with reference to method 1000. In some embodiments, because the attention, optionally including gaze 907a, of the user 905a is directed to the App A user interface 902, the computer system 101 will rotate the virtual objects; including the App A user interface 902, the App B user interface 904, and the avatar corresponding to the second user 905b; around a reference point 908a corresponding to the App A user interface 902. For example, the reference point 908a is the middle of the App A user interface 902, as shown in the top-down view of the three-dimensional environment 901. In some embodiments, the computer system 101a maintains the spatial arrangement of the App A user interface 902, App B user interface 904, and avatar corresponding to the second user 905b relative to each other when rotating these virtual objects in accordance with the input illustrated in FIG. 9A.

In some embodiments, the computer system 101a rotates the virtual objects in response to the interaction input by an amount and in a direction that corresponds to (e.g., depends on) the amount and direction of movement of the hands 903a and 903b of the user 905a included in the interaction input. In response to detecting the input illustrated in FIG. 9A, the computer system 101a manipulates the App A user interface 902, App B user interface 904, and avatar corresponding to the second user 905b relative to the viewpoint of the user 905a and/or relative to one or more representations 922 and/or 924 of physical objects in the environment 901 in accordance with the input illustrated in FIG. 9A, as shown in FIG. 9B.

FIG. 9B illustrates the computer system 101a displaying the three-dimensional environment 901 after manipulating the App A user interface 902, App B user interface 904, and avatar corresponding to the second user 905b in accordance with the input illustrated in FIG. 9A. For example, because the movement of hands 903a and 903b in FIG. 9A corresponded to counterclockwise rotation while providing the input in FIG. 9A, the computer system 101a rotates the App A user interface 902, App B user interface 904, and avatar corresponding to the second user 905b counterclockwise. Also in this example, because the attention (e.g., including gaze 907a) was directed to the App A user interface 902 while providing the input in FIG. 9A, the computer system 101a rotates the App A user interface 902, App B user interface 904, and avatar corresponding to the second user 905b around the reference point 908a corresponding to the center of App A user interface 902. In some embodiments, the amount of rotation of the App A user interface 902, App B user interface 904, and avatar corresponding to the second user 905b in response to the input illustrated in FIG. 9A corresponds to (e.g., depends on) the amount of movement of the hands 903a and 903b while providing the input in FIG. 9A.

As shown in FIG. 9B, rotating the App A user interface 902, App B user interface 904, and avatar corresponding to the second user 905b around the reference point 908a associated with the App A user interface 902 includes rotating the locations and orientations of these objects counterclockwise around the reference point 908a. For example, the App B user interface 904 rotates counterclockwise and changes position to be further from the viewpoint of the user 905a in the environment 901, the avatar of the second user 905b rotates clockwise and moves towards the viewpoint of the user 905a and to the right in the environment 901, and the App A user interface 902 rotates counterclockwise. In some embodiments, the center of the App A user interface 902 remains in the same position in response to the input in FIG. 9A because the center of App A user interface 902 is the reference point around which the objects rotate, so rotation without translation does not cause the center of the App A user interface 902 to change positions. As shown in FIG. 9B, rotating the App A user interface 902 causes the left edge of the App A user interface 902 to move towards the viewpoint of the user 905a and the right edge of the App A user interface 902 to move away from the viewpoint of the user 905a.

The spatial arrangement of the App A user interface 902, the App B user interface 904, and the avatar of the second user 905b does not change in response to the input illustrated in FIG. 9A, as shown in FIG. 9B. In some embodiments, updating the portion of the three-dimensional environment 901 relative to the viewpoint of the user 905a displayed at the second computer system 101b in response to the user input illustrated in FIG. 9A includes updating the position and/or orientation of the avatar of the user 905a of the computer system 101a displayed at the second computer system 101b without updating the positions and/or orientations of App A user interface 902 or App B user interface 904. This is optionally because the spatial arrangement of the viewpoint of the second user 905b relative to the App A user interface 902 and the App B user interface 904 is unchanged by the input in FIG. 9A, but the spatial arrangement of the viewpoint of the user 905a of the computer system 101a relative to the App A user interface 902, the App B user interface 904, and the avatar of the second user 905b is changed by the input in FIG. 9A. In some embodiments, while the input in FIG. 9A is being detected by the computer system 101a, computer system 101b displays the avatar of the user 905a of the computer system 101a visually de-emphasized relative to the three-dimensional environment 901, as described in more detail above with reference to method 800.

FIG. 9B also illustrates the user provide another interaction input with hands 903a and 903b while the attention, optionally including gaze 907b, of the user 905a is directed to the App B user interface 904. The interaction input includes movement of the hands 903a and 903b in a movement pattern corresponding to clockwise rotation, optionally while the hands 903a and 903b are in the pinch hand shape. In response to the input illustrated in FIG. 9B, the computer system 101a manipulates the App A user interface 902, the App B user interface 904, and the avatar of the second user 905b to rotate these objects around the center of the App B user interface 904 at reference point 908b clockwise, as shown in FIG. 9C.

FIG. 9C illustrates the updated view of the three-dimensional environment 901 relative to the viewpoint of the user 905a in response to the input illustrated in FIG. 9B. In some embodiments, updating the view of the three-dimensional environment 901 includes updating positions of App A user interface 902 and the avatar of the second user 905b to rotate these objects around the center of App B user interface 904 at reference point 908b shown in FIG. 9B and rotating these objects and the app B user interface 904 counterclockwise. In some embodiments, the amount of manipulation corresponds to (e.g., depends on) the amount of movement of the hands 903a and 903b in the input illustrated in FIG. 9B. For example, if the amount of movement of hands 903a and 903b had been greater, the amount of manipulation of the virtual objects would have been greater and if the amount of movement of hands 903a and 903b had been less, the amount of manipulation of the virtual objects would have been less. In some embodiments, the reference point 908b for the manipulation in response to the input illustrated in FIG. 9B is associated with App B user interface 904 because the attention, optionally including gaze 907b, of the user 905a is directed to the App B user interface 904 when the input in FIG. 9B is provided. In some embodiments, while the computer system 101a detects the input illustrated in FIG. 9B, the second computer system 101b displays the avatar of the first user 905a de-emphasized relative to the three-dimensional environment 901 and, in response to the input, updates the position and/or orientation of the avatar of the user 905a without updating the positions and orientations of the App A user interface 902 and App B user interface 904 in the manner described above with reference to method 800.

In FIG. 9C, the user 905a provides an interaction input corresponding to a request to translate the App A user interface 902, App B user interface 904, and avatar of the second user 905b. The interaction input includes attention, optionally including gaze 907c, of the user 905a directed to the App B user interface 904 and movement of hands 903a and 903b in a movement pattern that corresponds to translating the virtual objects in the three-dimensional environment 901. For example, the movement of the hands 903a and 903b is the to right, so translation of the App A user interface 902, App B user interface 904, and avatar of the second user 905b in response to the input will be to the right, as shown in FIG. 9D.

FIG. 9D illustrates the result of the interaction input illustrated in FIG. 9C. As shown in FIG. 9D, the computer system 101a updates display of the three-dimensional environment 901 to translate the App A user interface 902, App B user interface 904, and avatar of the second user 905b to the right with respect to the viewpoint of the user 905a in accordance with the input illustrated in FIG. 9C. As described above with reference to the other inputs to manipulate virtual objects in the three-dimensional environment 901, the amount of manipulation of the objects corresponds to (e.g., depends on) the amount of movement of the hands 903a and 903b of the user 905a while providing the interaction input, in some embodiments. In some embodiments, the second computer system 101b updates the three-dimensional environment 901 in response to the input illustrated in FIG. 9C to update the position and/or orientation of the avatar of the user 905a without updating the positions and orientations of the App A user interface 902 and the App B user interface 904, as described above with reference to method 800.

FIGS. 9A-9C illustrate examples of interaction inputs to rotate the virtual objects in the three-dimensional environment 901 and FIGS. 9C-9D illustrate and example of an interaction input to translate the virtual objects in the three-dimensional environment 901. In some embodiments, the computer system 101a performs only translation or rotation in response to an interaction input. For example, even if the interaction input includes movement of hands 903a and 903b corresponding to both translation or rotation, the computer system 101a performs only one of translation or rotation in response to the input based on which movement pattern was detected first and/or which movement pattern is more prominent. In some embodiments, the computer system 101a performs both rotation and translation in response to an interaction input that includes both the rotation movement pattern and the translation movement pattern, as will be described below with reference to FIGS. 9D-9F. In some embodiments, the relative amounts of translation and rotation performed by the computer system 101a in response to an interaction input including a translation movement pattern and a rotation movement pattern are adjusted according to adjustment functions described below. In some embodiments, “amounts” of various movement patterns include speeds, durations, and/or distances of the movement of hands 903a and 903b in the various movement patterns.

In FIG. 9D, the computer system 101a detects an interaction input including movement of hands 903a and 903b in a movement pattern that includes a translation movement pattern and a rotation movement pattern. For example, the movement pattern initially includes more translation than rotation at points 930a and 932a and transitions to including more rotation than translation at points 930b and 932b. In some embodiments, because the attention, optionally including gaze 907d, of the user 905a is directed to the App B user interface 904 in FIG. 9D, the portion of the manipulation of the objects in response to the input in FIG. 9D that includes rotation is rotation around a reference point associated with App B user interface 904, such as the center of App B user interface 904.

In some embodiments, the computer system 101a adjusts the amounts of translation performed in response to the input according to adjustment function 926a as the interaction input is detected. In some embodiments, the adjustment function 926a illustrates how the amount of translation performed changes as the input includes more movement in the rotation pattern. For example, the y-axis represents the amount of translation performed relative to the amount of rotation performed and the x-axis represents the amount of rotation movement detected relative to the relative amount of translation movement detected. For example, point 928a of adjustment function 926a corresponds to points 930a and 932a of the movement of hands 903a and 903b. In this example, at point 928a, the movement pattern of hands 903a and 903b has a smaller amount of rotation movement than translation movement, and the resulting movement pattern has more translation than rotation. As another example, point 928b of adjustment function 926a corresponds to points 930b and 932b of the movement of hands 903a and 903b. In this example, at point 928b, the movement pattern of hands 903a and 903b has a greater amount of rotation movement than translation movement, and the resulting manipulation of virtual objects has less translation than rotation. In some embodiments, the computer system 101a updates the positions of App A user interface 902, App B user interface 904, and the avatar of the second user 905b while detecting the interaction input illustrated in FIG. 9D. For example, while detecting the portion of the interaction input including movement of the hands 903a and 903b at points 930a and 932a, the computer system 101a performs more translation than rotation and while detecting the portion of the interaction input including movement of the hands 903a and 903b at points 930b and 932b, the computer system 101a performs more rotation than translation. In some embodiments, the amounts of translation and rotation are inversely proportional to each other. The transition from performing more translation at points 930a and 932a represented by point 928a of adjustment function 926a to performing more rotation at points 930b and 932b represented by point 928b of adjustment function 926a is illustrated by the curve of adjustment function 926a, for example.

Although points 928a and 928b are described in detail as examples, the illustration of adjustment function 926a showing the relative amount of translation as a function of the relative amount of rotational input shows the amounts of adjustment for a plurality of points along the adjustment function 926a. For example, as shown in FIG. 9D, adjustment function 926a is non-linear such that changing the amount of movement corresponding to rotation when the input includes a small amount of movement corresponding to rotation changes the amount of translation by a smaller amount than is the case for inputs including relatively equal amounts of movement corresponding to translation and movement corresponding to rotation. As another example, as shown in FIG. 9D, adjustment function 926a is non-linear such that changing the amount of movement corresponding to rotation when the input includes a large amount of movement corresponding to rotation changes the amount of translation by a smaller amount than is the case for inputs including relatively equal amounts of movement corresponding to translation and movement corresponding to rotation. In some embodiments, as described in more detail below with reference to FIG. 9E, the adjustment function for adjusting the relative amount of rotation as a function of the relative amount of translational input is different from adjustment function 926a illustrated in FIG. 9D.

In response to the input illustrated in FIG. 9D, the computer system 101a updates the three-dimensional environment 901 to translate and rotate that App A user interface 902, the App B user interface 904, and the avatar of the second user 905b, as shown in FIG. 9E. For example, in FIG. 9E, the computer system 101a displays the App A user interface 902, the App B user interface 904 translated towards the viewpoint of the user 905a in the three-dimensional environment 901 and rotated counterclockwise in response to the input illustrated in FIG. 9D. In some embodiments, while the computer system 101a detects the input illustrated in FIG. 9D, the second computer system 101b displays the avatar of the user 905a of the computer system 101a with reduced visual emphasis relative to the rest of the environment 901, as described above.

In FIG. 9E, the computer system 101a detects an interaction input including movement of hands 903a and 903b optionally while the hands 903a and 903b are in pinch hand shapes and the attention, optionally including gaze 907e, of the user 905a directed to the App A user interface 902. The movement of hands 903a and 903b includes the translation movement pattern and the rotation movement pattern. For example, the movement pattern initially includes more rotation than translation at points 930c and 932c and transitions to including more translation than rotation at points 930d and 932d. In some embodiments, because the attention, optionally including gaze 907e, of the user 905a is directed to the App A user interface 902 in FIG. 9E, the portion of the manipulation of the objects in response to the input in FIG. 9E that includes rotation is rotation around a reference point associated with App A user interface 902, such as the center of App A user interface 902.

In some embodiments, the computer system 101a adjusts the amounts of rotation performed in response to the input according to adjustment function 926b as the interaction input is detected. Adjustment function 926b is optionally similar to adjustment function 926a described above with reference to FIG. 9E, but is optionally a different function, as shown in FIGS. 9D and 9E. In some embodiments, the adjustment function 926b illustrates how the amount of rotation performed changes as the input includes more movement in the translation pattern. For example, the y-axis represents the amount of rotation performed relative to the amount of translation performed and the x-axis represents the amount of translation movement detected relative to the relative amount of rotation movement detected. For example, point 928c of adjustment function 926b corresponds to points 930c and 932c of the movement of hands 903a and 903b. In this example, at point 928c, the movement pattern of hands 903a and 903b has a smaller amount of translation movement than rotation movement, and the resulting manipulation of virtual objects has more rotation than translation. As another example, point 928d of adjustment function 926b corresponds to points 930d and 932d of the movement of hands 903a and 903b. In this example, at point 928d, the movement pattern of hands 903a and 903b has a greater amount of translation movement than rotation movement, and the resulting movement pattern has less rotation than translation. In some embodiments, the computer system 101a updates the positions of App A user interface 902, App B user interface 904, and the avatar of the second user 905b while detecting the interaction input illustrated in FIG. 9E. For example, while detecting the portion of the interaction input including movement of the hands 903a and 903b at points 930c and 932c, the computer system 101a performs more rotation than translation and while detecting the portion of the interaction input including movement of the hands 903a and 903b at points 930d and 932d, the computer system 101a performs more translation than rotation. In some embodiments, the amounts of translation and rotation are inversely proportional to each other. The transition from performing more rotation at points 930c and 932c represented by point 928c of adjustment function 926b to performing more translation at points 930d and 932d represented by point 928d of adjustment function 926b is illustrated by the curve of adjustment function 926b, for example.

Although points 928c and 928d are described in detail as examples, the illustration of adjustment function 926b showing the relative amount of rotation as a function of the relative amount of translational input shows the amounts of adjustment for a plurality of points along the adjustment function 926b. In some embodiments, as described in more detail above with reference to FIG. 9D, the adjustment function for adjusting the relative amount of translation as a function of the relative amount of rotational input is different from adjustment function 926b illustrated in FIG. 9E. In response to the input in FIG. 9E, the computer system rotates and translates the App A user interface 902, the App B user interface 904, and the representation of the second user 905b in accordance with the input in FIG. 9E, as shown in FIG. 9F.

FIG. 9F illustrates the computer system 101a displaying the updated environment 901 in accordance with the input in FIG. 9E. For example, the App A user interface 902, the App B user interface 904, and the representation of the second user 905b are rotated counterclockwise and translated to the left in FIG. 9F relative to the positions of these objects in FIG. 9E, and relative to the viewpoint of the user 905a. In some embodiments, as described above, while the computer system 101a detects the input illustrated in FIG. 9E, the second computer system 101b displays the avatar of the user 905a of the computer system 101a visually de-emphasized relative to the rest of the environment 901 at the second computer system 101b.

In some embodiments, the computer system 101a is able to manipulate the virtual objects in additional or alternative manners in response to detecting interaction inputs including additional or alternative movement patterns of the hands 903a and 903b, as will be described in more detail below with reference to FIGS. 9F-9I. In some embodiments, the computer system 101a is able to detect interaction inputs that include a combination of these additional or alternative movement patterns, rotation movement patterns similar to those illustrated in FIGS. 9A and 9B, and/or translation movement patterns similar to that illustrated in FIG. 9C. It should be understood that the associations between various inputs illustrated in FIGS. 9F-9H and manipulations illustrated in FIGS. 9G-9I are exemplary. In some embodiments, the computer system 101a associates the respective manipulations illustrated in FIGS. 9G-9I with different inputs illustrated in FIGS. 9F-9H than the respective inputs provided as examples for causing the respective manipulations in the descriptions below. For example, although the manipulation shown in FIG. 9G is described as being performed in response to the input shown in FIG. 9F, in some embodiments, the computer system 101a performs the manipulation shown in FIG. 9G in response to a different input.

For example, in FIG. 9F, the computer system detects an interaction input that includes one of the hands 903a holding a respective hand shape, such as a pinch hand shape, while the other hand 903b moves in a rotational movement shape relative to the hand 903a. In some embodiments, the hand 903b that moves in the rotational movement shape is in a predetermined hand shape, such as a pinch hand shape, while moving in the rotational movement shape as part of the interaction input. In some embodiments, as shown in FIG. 9G, in response to the input illustrated in FIG. 9F, the computer system rotates the virtual objects around a reference point 908c that is associated with the viewpoint of the user 905a and/or the location of the head and/or torso of the user 905a in accordance with movement of hand 903b. For example, the objects will rotate clockwise by an amount that corresponds to (e.g., depends on) the amount of movement of hand 903b clockwise relative to the torso/viewpoint of the user 905a and/or relative to hand 903a. In some embodiments, because the movement pattern of hand 903a and 903b corresponds to rotation around reference point 908c, which is not associated with one of the App A user interface 902, the App B user interface 904, or the avatar of the second user 905b in particular, the computer system 101a uses point 907c as the reference point irrespective of where in the environment 901 the user is paying attention to. For example, regardless of whether the attention, optionally including gaze 907f, of the user 905a is directed to the App A user interface 902 or whether the attention, optionally including gaze 907g, of the user 905a is directed to the App B user interface 904, the computer system 101a updates the environment 901 as shown in FIG. 9G in response to receiving the input illustrated in FIG. 9F. In some embodiments, while the computer system 101a detects the input in FIG. 9F, the second computer system 101b displays the avatar of the user 905a of the computer system 101a visually de-emphasized relative to the rest of the environment 901 at the second computer system 101b, as described above.

FIG. 9G illustrates the computer system 101a presenting the environment 901 updated in accordance with the input illustrated in FIG. 9F. The App A user interface 902, App B user interface 904, and representation of the second user 905b in FIG. 9G are rotated clockwise around reference point 908c in FIG. 9F relative to the positions of these objects in FIG. 9F.

As shown in FIG. 9G, the computer system 101a detects an interaction input that includes movement of hands 903a and 903b in the manner illustrated in FIG. 9G. In some embodiments, detecting the movement of hands 903a and 903b includes detecting the user make pinch hand shapes with hands 903a and 903b then move the hands 903a and 903b in a rotational movement around the torso of the user while maintaining the pinch hand shapes. For example, in FIG. 9G, both hands 903a and 903b move in a counterclockwise direction relative to the torso of the user. In some embodiments, in response to detecting an interaction input including the hand movement illustrated in FIG. 9G, the computer system 101a rotates the App A user interface 902, App B user interface 904, and the representation of the user 905b of the second computer system 101b around a reference point 908d that is between the hands 903a and 903b and the torso/viewpoint of the user 905a. In some embodiments, the reference point 908d is selected irrespective of a location in the environment 901 to which the user is paying attention (e.g., and looking). Thus, in some embodiments, the computer system 101a updates the environment 901 in response to the input illustrated in FIG. 9G as shown in FIG. 9H irrespective of whether the attention, optionally including gaze 907h, is directed to the App A user interface 902 or whether the attention, optionally including gaze 907i, is directed to the App B user interface 904, or anywhere else in the environment 901. In some embodiments, while the computer system 101a receives the interaction input illustrated in FIG. 9G, the second computer system 101b displays the avatar of the user 905a of the computer system 101a visually de-emphasized relative to the rest of the environment 901, as described above.

FIG. 9H illustrates an example of the computer system 101a displaying the environment 901 updated in response to the interaction input described above with reference to FIG. 9G. For example, the App A user interface 902, App B user interface 904, and representation of the second user 905b in FIG. 9H are rotated counterclockwise around reference point 908d in FIG. 9G relative to the positions of these virtual objects in FIG. 9G. In some embodiments, the amount and direction of rotation of the virtual objects corresponds to the amount and direction of movement of the hands 903a and 903b included in the interaction input illustrated in FIG. 9G. For example, the amount and direction of rotation performed is based on the amount of movement of a midpoint between hands 903a and 903b relative to the torso/viewpoint of the user 905a.

In FIG. 9H, the computer system 101a detects the user provide an interaction input that includes movement of hands 903a and 903b while attention of the user, optionally including gaze 907g, is directed to the App A user interface 902. In some embodiments, the movement of hands 903a and 903b is the same as or similar to the movement of hands 903a and 903b in FIG. 9G. For example, hands 903a and 903b make a pinch hand shape and then move in a rotational shape relative to the torso and/or viewpoint of the user 905a. As described above, in some embodiments, in response to this input, the computer system rotates the virtual objects relative to a reference point 908d that is between the hands and torso/viewpoint of the user 905a. In some embodiments, in response to the input illustrated in FIG. 9G or 9H, the computer system rotates the App A user interface 902, App B user interface 904, and representation of the second user 904b relative to the reference point 908d between the hands 903a and 903b and the torso/viewpoint of the user 905a and rotates the objects around reference point 908e associated with the App A user interface 902, as shown in FIG. 9I. In some embodiments, the manipulation of the virtual objects with respect to the viewpoint of the user 905a includes rotation around reference point 908e associated with the App A user interface 902 because the attention, optionally including gaze 907g, of the user is directed to the App A user interface 902 while the interaction input is being provided. In some embodiments, if the attention, optionally including gaze, of the user were directed to a different virtual object—such as the app B user interface 904 or the representation of the second user 905b—while the interaction input was being provided, then the manipulation relative to the viewpoint of the user 905a would include rotation around a reference point associated with the other virtual object the user was paying attention to while providing the interaction input, in addition to the rotation around reference point 908d. In some embodiments, the manipulation further includes translation of the virtual objects relative to the viewpoint of the user 905a in accordance with movement of the hands 903a and 903b while providing the interaction input. In some embodiments, while the computer system 101a receives the interaction input, the second computer system 101b displays the representation of the user 905a of the computer system 101a with decreased visual emphasis relative to the rest of the environment, as described in more detail above.

FIG. 9I illustrates an example of the computer system 101a displaying the environment 901 updated in response to the input illustrated in FIG. 9H. The positions and orientations of the app A user interface 902, app B user interface 904, and representation of the second user 905b in FIG. 9I are rotated around reference points 907d and 907e in FIG. 9H, relative to the positions and orientations of these objects in FIG. 9H.

In some embodiments, in response to detecting a combination of movement patterns, the computer system 101a performs a combination of manipulations of the virtual objects in the environment 901 relative to the viewpoint of the user 905a. For example, in response to detecting an interaction input that includes both a movement pattern similar to one or more of the movement patterns described below with reference to one or more of FIGS. 9F, 9G, and/or 9H and a translation movement pattern, the computer system 101a performs a manipulation relative to the viewpoint of the user 905a similar to one or more manipulations shown in FIGS. 9G, 9H, and/or 9I and translation of the virtual objects. In some embodiments, the amount of manipulation relative to the viewpoint of the user 905a similar to one or more manipulations shown in FIGS. 9G, 9H, and/or 9I is independent from the amount of translation. As another example, in response to detecting an interaction input that includes both a movement pattern similar to one or more of the movement patterns described below with reference to one or more of FIGS. 9F, 9G, and/or 9H and a rotation movement pattern, the computer system 101a performs a manipulation relative to the viewpoint of the user 905a similar to one or more manipulations shown in FIGS. 9G, 9H, and/or 9I and rotation of the virtual objects (e.g., around a reference point associated with a virtual object to which the user pays attention while providing the interaction input). As another example, in response to detecting an interaction input that includes a movement pattern similar to one or more of the movement patterns described below with reference to one or more of FIGS. 9F, 9G, and/or 9H, a rotation movement pattern, and a translation movement pattern, the computer system 101a performs a manipulation similar to one or more manipulations shown in FIGS. 9G, 9H, and/or 9I, rotation of the virtual objects (e.g., around a reference point associated with a virtual object to which the user pays attention while providing the interaction input), and translation of the virtual objects.

FIGS. 10A-10H is a flowchart illustrating a method 1000 of facilitating manipulation of virtual objects in a virtual environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system (e.g., 101a) in communication with a display generation component (e.g., 120) and one or more input devices (e.g., 120 and/or 314), such as in FIG. 9A. In some embodiments, the computer system is or includes an electronic device. In some embodiments, the computer system has one or more of the characteristics of the computer system(s) in methods 800, 1200, and/or 1400. In some embodiments, the display generation component has one or more of the characteristics of the display generation component(s) in methods 800, 1200, and/or 1400. In some embodiments, the one or more input devices have one or more of the characteristics of the one or more input devices in methods 800, 1200, and/or 1400.

In some embodiments, the computer system (e.g., 101a) displays (1002a), via the display generation component (e.g., 120), an object (e.g., 902) in an environment (e.g., 901), such as in FIG. 9A. In some embodiments, the environment corresponds to a physical environment surrounding the display generation component and/or the computer system and/or a virtual environment. In some embodiments, the computer system displays a three-dimensional environment, such as a three-dimensional environment as described with reference to methods 800, 1200, and/or 1400. In some embodiments, the object is located at a respective location in the three-dimensional environment. In some embodiments, the object is or includes content (e.g., one or more images, video, and/or audio content). In some embodiments, the object has one or more of the characteristics of the objects in methods 800, 1200, and/or 1400. In some embodiments, as discussed in more detail below, the computer system is in a communication session with one or more secondary computer systems. For example, objects within the three-dimensional environment, and/or the three-dimensional environment are being displayed by both the computer system and the one or more secondary computer systems, concurrently, but from different viewpoints associated with their respective users. In some embodiments, in the communication session, the user of the computer system has a first viewpoint of the three-dimensional environment associated with a first location in the three-dimensional environment, and the one or more users of the one or more secondary computer systems have second viewpoints, different from the first viewpoint, of the three-dimensional environment that are associated with second locations in the three-dimensional environment, as described with reference to methods 800, 1200, and/or 1400. In some embodiments, the computer system and the one or more secondary computer systems are in the same physical environment (e.g., at different locations in the same room). In some embodiments, the computer system and the one or more secondary computer systems are located in different physical environments (e.g., different cities, different rooms, different states and/or different countries). In some embodiments, the computer system and the one or more secondary computer systems are in communication with each other such that the display of the objects within the three-dimensional environment and/or the three-dimensional environment by the computer systems is coordinated (e.g., changes to the objects within the three-dimensional environment and/or the three-dimensional environment made in response to inputs from the user of the computer system are reflected in the display of the objects within the three-dimensional environment and/or the three-dimensional environment by the one or more secondary computer systems). Additionally, the three-dimensional environment optionally includes virtual representations of (e.g., avatars corresponding to) users of the one or more secondary computer systems.

In some embodiments, while displaying the object in the environment (1002b), the computer system (e.g., 101a) receives (1002c), via the one or more input devices, a first interaction input (e.g., an air gesture, a hardware input device input) that includes movement of a predefined portion (e.g., 903a and/or 903B) (e.g., one or more hands and/or arms and/or a head) of a user of the computer system (e.g., 101a), such as in FIG. 9A. In some embodiments, the first interaction input corresponds to a request to update a pose (e.g., position and/or orientation) of the object in the environment, such as translating and/or rotating the object in the environment relative to the viewpoint of the user in accordance with movement of the predefined portion of the user.

In some embodiments, while displaying the object (e.g., 902) in the environment (1002b), in response to receiving the first interaction input, the computer system (e.g., 101a) manipulates (1002d) the object (e.g., 902) in the environment (e.g., 901), such as in FIG. 9B.

In some embodiments, in accordance with a determination that the movement of the predefined portion (e.g., 903a and/or 903b) of the user is part of a first movement pattern, such as in FIG. 9A, manipulating the object (e.g., 902) in the environment (e.g., 901) includes manipulating the object in a first manner in accordance with a first amount (e.g., of speed, distance, and/or duration of the) of movement of the predefined portion (e.g., 903a and/or 903b) of the user in the first movement pattern (1002e), such as in FIG. 9B. In some embodiments, detecting the first movement pattern of the predefined portion of the user includes detecting movement of the hands of the user relative to the torso of the user. In some embodiments, detecting the first movement pattern includes detecting the hands of the user in predefined hand shapes, such as in air pinch hand shapes. In some embodiments, detecting the first movement pattern of the predefined portion of the user includes detecting the hands moving relative to the torso with or without the hands moving relative to each other (e.g., both hands moving in the same direction or hands moving in the same direction in one dimension and different directions in another dimension). In some embodiments, the hands of the user move towards, away from, and/or laterally with respect to the torso of the user. In some embodiments, two hands of the user move concurrently. In some embodiments, detecting the first interaction input includes detecting an input provided via a hardware input device. For example, the first interaction input includes detecting movement of one or more conductive objects touching and/or hovering within a threshold distance (e.g., 1, 2, 3, 4, 5, or 10 centimeters) of a touch-sensitive surface, such as a touch screen or trackpad. In some embodiments, the first interaction input includes detecting the objects moving in the first movement pattern. For example, the first movement pattern is movement of two or more contacts that move relative to the touch sensitive surface more than they move relative to each other. As another example, the first movement pattern includes movement of one or more objects in a straight direction along the touch-sensitive surface. In some embodiments, manipulating the object in the first manner in the environment includes translating the object in the environment relative to the viewpoint of the user, such as updating a position of the object relative to the viewpoint of the user in accordance with an amount and direction of the movement of the predefined portion of the user. For example, in response to detecting the first movement pattern of the predefined portion of the user in a first direction by a first amount, the computer system translates the object in the first direction by a second amount relative to the viewpoint of the user that is proportional to the first amount. As another example, in response to detecting the first movement pattern of the predefined portion of the user in a second direction by a third amount, the computer system translates the object in the second direction by a fourth amount relative to the viewpoint of the user that is proportional to the second amount.

In some embodiments, in accordance with a determination that the movement of the predefined portion (e.g., 903a and/or 903b) of the user is part of a second movement pattern, such as in FIG. 9C, different from the first movement pattern, manipulating the object (e.g., 902) in the environment (e.g., 901) includes manipulating the object (e.g., 902) in a second manner in accordance with a second amount (e.g., of speed, distance, and/or duration) of movement of the predefined portion (e.g., 903a and/or 903b) of the user in the second movement pattern and in accordance with a third amount (e.g., of speed, distance, and/or duration) of movement of the predefined portion (e.g., 903a and/or 903b) of the user in the first movement pattern (10020, such as in FIG. 9D. In some embodiments, the third amount of movement in the first movement pattern is the same as the first amount. In some embodiments, the third amount of movement in the first movement pattern is different from the first amount. In some embodiments, detecting the second movement pattern of the predefined portion of the user includes detecting movement of the hands of the user relative to each other. In some embodiments, detecting the second movement pattern includes detecting the hands of the user in predefined hand shapes, such as in air pinch hand shapes. In some embodiments, detecting the second movement pattern of the predefined portion of the user includes detecting the hands moving relative to each other with or without the hands moving relative to the torso of the user (e.g., hands moving in opposite directions or hands moving in the same direction in one dimension and different directions in another dimension). In some embodiments, the second movement pattern is movement of the hands around a space between the hands, such as along the perimeter of a circle, oval, or other shape. In some embodiments, detecting the second movement pattern includes detecting one or more objects proximate to a hardware input device including a touch-sensitive surface (e.g., a trackpad, or a touchscreen), as described above. In some embodiments, the hardware input device detects the one or more objects moving in the second movement pattern, such as detecting two or more contacts moving away from each other and/or around a circle, oval, or other shaped region of the touch-sensitive surface of the hardware input device. In some embodiments, the first movement pattern and second movement pattern differ in that the first movement pattern includes movement of two or more objects and/or portions of the user relative to a respective reference (e.g., the user's torso, or a touch-sensitive surface of a hardware input device) by a larger magnitude than movement of the two or more objects and/or portions of the user relative to each other, whereas the second movement pattern includes movement of the two or more objects and/or portions of the user relative to each other by an amount greater than or equal to movement of the two or more objects and/or portions of the user relative to the respective reference. In some embodiments, the amount of movement of the objects and/or portions of the user relative to each other is less for the first movement pattern than is the case for the second movement pattern. In some embodiments, manipulating the object in the second manner in the environment includes rotating the object in the environment, such as updating an orientation of the object in accordance with an amount and direction of the movement of the predefined portion of the user. In some embodiments, the first movement pattern corresponds to a request to translate one or more objects in the environment, whereas the second movement pattern corresponds to a request to rotate the one or more objects in the environment. For example, in response to detecting the second movement pattern of the predefined portion of the user in first directions by a first amount, the computer system rotates the object in a second direction corresponding to the first directions by a second amount that is proportional to the first amount. As another example, in response to detecting the second movement pattern of the predefined portion of the user in third directions by a third amount, the computer system rotates the object in a fourth direction corresponding to the third directions by a fourth amount that is proportional to the third amount. In some embodiments, additionally or alternatively, the computer system moves the object in the second manner in accordance with the first amount of movement of the predefined portion of the user in the first movement pattern as described in more detail below. In some embodiments, additionally or alternatively, the computer system moves the object in the second manner in accordance with an amount of movement of the object in the first manner in one or more of the ways described in more detail below. In some embodiments, in response to detecting the predefined portion of the user concurrently moving in both the first movement pattern and the second movement pattern, the computer system manipulates the object in the first and second manner by corresponding amounts. In some embodiments, if the movement of the predefined portion of the user is in the first movement pattern more than the second movement pattern, the computer system manipulates the object in the first manner more than in the second manner. In some embodiments, if the movement of the predefined portion of the user is in the second movement pattern more than the first movement pattern, the computer system manipulates the object in the second manner more than in the first manner. Manipulating the object in a respective manner in accordance with one or more respective movement patterns of the predefined portion of the user enhances user interactions with the computer system by reducing the number of displayed controls.

In some embodiments, such as in FIG. 9A, in accordance with a determination that an attention of the user (e.g., including the gaze 907a of the user) is directed to the object (e.g., 902) while the first interaction input is detected, manipulating the object (e.g., 902) includes manipulating the object and a second object (e.g., 904) displayed in the environment (e.g., 901)(relative to a first reference point (e.g., 908a) associated with the object (e.g., 902) (1004a), such as in FIG. 9B. In some embodiments, the first reference point is a point that is coincident with the object, such as the midpoint of the object. In some embodiments, the computer system manipulates a plurality of objects in the environment in response to the first interaction input relative to the first reference point. In some embodiments, the computer system manipulates the object relative to the first reference point without manipulating one or more other objects of the plurality of objects in response to the first interaction input in accordance with the determination that the attention of the user is directed to the object while the first interaction input is detected.

In some embodiments, such as in FIG. 9B, in accordance with a determination that the attention (e.g., including the gaze 907b of the user) of the user is directed to the second object (e.g., 904) while the first interaction input is detected, manipulating the object (e.g., 902) includes manipulating the object (e.g., 902) and the second object (e.g., 904) relative to a second reference point (e.g., 908b) associated with the second object (e.g., 904), different from the first reference point (e.g., 908a) associated with the first object (e.g., 902) (1004b), such as in FIG. 9C. In some embodiments, the second reference point is a point that is coincident with the second object, such as the midpoint of the second object. In some embodiments, the computer system manipulates a plurality of objects in the environment in response to the first interaction input relative to the second reference point. In some embodiments, the computer system manipulates the second object relative to the second reference point without manipulating one or more other objects of the plurality of objects in response to the first interaction input in accordance with the determination that the attention of the user is directed to the object while the first interaction input is detected. Selecting the reference point for the manipulation of the objects based on the attention of the user enhances user interactions with the computer system by reducing the number of displayed controls for selecting a reference point for the manipulation.

In some embodiments, the computer system (e.g., 101a) is in a communication session with a second computer system (e.g., 101b) while displaying the environment (e.g., 901) (1006a), such as in FIG. 9A. In some embodiments, the communication session includes displaying one or more objects in environments of the computer system and the second computer system in a coordinated manner with shared spatial truth. For example, if a first object and second object are shared with both computer systems, the spatial arrangement of the first object and second object relative to each other is the same in the environments of both computer systems.

In some embodiments, such as in FIG. 9A, the object (e.g., 902) is shared between the computer system (e.g., 101a) and the second computer system (e.g., 101b) (1006b). In some embodiments, the second computer system also displays the object in the environment of the second computer system. In some embodiments, sharing the object includes synchronizing the presentation of manipulation and/or other interactions and/or updates to the object at both the computer system and the second computer system.

In some embodiments, such as in FIG. 9A, the environment (e.g., 901) includes a virtual representation of a second user (e.g., 905b) of the second computer system (e.g., 101b) (1006c). In some embodiments, the second computer system displays a virtual representation of the user of the computer system in the environment of the second computer system. In some embodiments, the virtual representation of the second user of the second computer system is displayed at a location in the environment that corresponds to the viewpoint of the second user in the environment at the second computer system. In some embodiments, the virtual representation is an avatar of the second user.

In some embodiments, such as in FIG. 9B, manipulating the object (e.g., 902) in the environment (e.g., 901) in response to receiving the first interaction input includes manipulating the virtual representation of the second user (e.g., 905b) (1006d). In some embodiments, the computer system manipulates a plurality of objects in the environment in response to the first interaction input while maintaining a spatial arrangement of the plurality of objects relative to each other, including manipulating the virtual representation of the second user, the object, and optionally one or more additional virtual objects shared with the second user in the environment. Manipulating the virtual representation of the second user and the object in response to the first interaction input enhances user interactions with the computer system by reducing the number of inputs needed to maintain a spatial relationship between the object and a viewpoint of the second user when manipulating objects while in a communication session with the second computer system.

In some embodiments, a virtual representation of the user (e.g., 905) of the computer system (e.g., 101a) is displayed in an environment at the second computer system (e.g., 101b), similar to the display of the virtual representation of the second user (e.g., 905b) at the computer system (e.g., 101a) in FIG. 9A (1008a). In some embodiments, the second computer system displays the representation of the user of the computer system in the environment at the second computer system at a location corresponding to the viewpoint of the user. In some embodiments, the virtual representation is an avatar of the user.

In some embodiments, in response to the computer system (e.g., 101a) receiving the first interaction input, the second computer system (e.g., 101b) repositions (1008b) the virtual representation of the user (e.g., 905a) of the computer system (e.g., 101a) in the environment (e.g., 901) at the second computer system (e.g., 101b) in accordance with the computer system (e.g., 101a) manipulating the object (e.g., 902) in the environment (e.g., 901) in response to receiving the first interaction input, similar to how the computer system (e.g., 101a) re-positions the virtual representation of the second user (e.g., 706a) in environment (e.g., 702) in FIG. 7I (1008b). In some embodiments, manipulating the object in the environment in response to the first interaction input updates the spatial relationship between the viewpoint of the user and the object. In some embodiments, the second computer system manipulates the virtual representation of the user to reflect the updated spatial relationship of the viewpoint of the user, which optionally corresponds to the virtual representation of the user, and the object. In some embodiments, the second computer system forgoes manipulating the object in response to the computer system detecting the first interaction input. Repositioning the virtual representation of the user enhances interactions with the second computer system by maintaining the position of the object relative to the viewpoint of the second user while maintaining a shared spatial truth with the computer system without requiring additional inputs to do so.

In some embodiments, such as in FIG. 7H, while the computer system (e.g., 101b) detects the first interaction input, the second computer system (e.g., 101a) displays the virtual representation (e.g., 706A) of the user of the computer system (e.g., 101b) with decreased visual emphasis relative to the environment (e.g., 702) at the second computer system (e.g., 101a) (1010). In some embodiments, the second computer system displays the visual representation of the user of the computer system with a blurred and/or darkened and/or smaller appearance compared to the display of the visual representation of the user of the computer system while the first interaction input is not being detected. In some embodiments, the second computer system displays the environment with a visually emphasized appearance (e.g., brightened, and/or increased contrast) compared to the display of the virtual representation of the user of the computer system while the first interaction input is not being detected. Displaying the virtual representation of the user of the computer system with decreased visual emphasis relative to the environment at the second computer system while the first interaction input is being detected by the computer system enhances user interactions with the second computer system by providing visual feedback to the user of the second computer system while the user of the computer system is manipulating objects in the environment.

In some embodiments, such as in FIGS. 9C-9D, manipulating the object (e.g., 902) in the first manner includes translating the object (e.g., 902) relative to the environment (e.g., 901) (1012) (e.g., and/or relative to the viewpoint of the user). In some embodiments, translating the object includes updating a position of the object in the environment. In some embodiments, translating the object includes rotating the object around a reference location in the environment. In some embodiments, translating the object does not include rotating the object. Translating the object enhances user interactions with the computer system by allowing the user to change the position of the object to a position that is easier to see and/or interact with.

In some embodiments, such as in FIGS. 9C-9D, manipulating the object (e.g., 902) in the first manner in accordance with the first amount of movement of the predefined portion (e.g., 903a and/or 903b) of the user in the first movement pattern includes (1014a) translating (1014b) the object by a third amount (e.g., of speed, distance, and/or duration) in accordance with the first amount of (e.g., speed, distance, and/or duration of) movement of the predefined portion (e.g., 903a and/or 903b) of the user in the first movement pattern and translating the object (e.g., 902) in a first direction in accordance with the first direction of movement of the predefined portion (e.g., 903a and/or 903b) of the user in the first movement pattern. In some embodiments, the third amount of movement of the object corresponds to the first amount of movement of the predefined portion of the user. For example, in response to a relatively small amount of movement of the predefined portion of the user in the first movement pattern, the computer system translates the object by a relatively small amount and in response to a relatively large amount of movement of the predefined portion of the user in the first movement pattern, the computer system translates the object by a relatively large amount. In some embodiments, the computer system translates the object in the same direction as the direction of movement of the predefined portion of the user in the first movement pattern. For example, in response to the first movement pattern including movement in a first direction, the computer system translates the object in the first direction and in response to the first movement pattern including movement in a second direction, the computer system translates the object in the second direction. Translating the object by an amount and direction based on the amount and direction of movement of the predefined portion of the user in the first movement pattern enhances user interactions with the computer system by enabling the user to customize the translation of the object without additional displayed controls that clutter the user interface.

In some embodiments, such as in FIGS. 9A-9B, manipulating the object (e.g., 902) in the second manner includes rotating the object (e.g., 902) around a reference point (e.g., 908a) associated with the object (1016). In some embodiments, the reference point is the centroid of the object in two or more dimensions. For example, the reference point is the centroid of the object in three-dimensions corresponding to a location in three-dimensional space in the environment. As another example, the reference point is the centroid of the object in two dimensions corresponding to a location on the floor and/or ground of the environment at which the centroid of the object appears in a bird's-eye view. In some embodiments, manipulating the object in the second manner includes rotating one or more additional objects in the environment around the reference point. In some embodiments, if the first interaction input is directed to a second object, the reference point is associated with the second object. For example, if the first interaction input is directed to the second object, the reference point is the centroid of the second object. Rotating the object around the reference point associated with the object in response to the first interaction input enhances user interactions with the computer system by enabling the user to rotate the object without displaying additional controls that clutter the user interface.

In some embodiments, such as in FIGS. 9A-9B, manipulating the object (e.g., 902) in the second manner in accordance with the second amount of movement of the predefined portion (e.g., 903a or 903b) of the user in the second movement pattern includes (1018a) rotating (1018b) the object (e.g., 902) by a third amount in accordance with the second amount of movement of the predefined portion (e.g., 903a and/or 903b) of the user in the second movement pattern relative to a second predefined portion (e.g., 903b or 903a) of the user and rotating the object (e.g., 902) in a first direction in accordance with a second direction of movement of the predefined portion (e.g., 903a or 903b) of the user relative to the second predefined portion of the user (e.g., 903b or 903a), such as in FIGS. 9A-9B. In some embodiments, the second amount of movement of the predefined portion of the user relative to the second predefined portion of the user is movement of one hand of the user relative to the other hand of the user. For example, the hands of the user move in one or more of the movement patterns described above in the description of the second movement pattern. In some embodiments, the third amount is one of a speed, duration, and/or distance of movement. In some embodiments, the direction of rotation of the object depends on the rotational direction of movement of the predefined portion of the user relative to the second predefined portion of the user. For example, if one hand of the user moves in a counterclockwise direction relative to the other hand of the user, the computer system rotates the object counterclockwise, and if one hand of the user moves in a clockwise direction relative to the other hand of the user, the computer system rotates the object clockwise. Rotating the object by an amount and direction in accordance with the amount and direction of movement of the predefined portion of the user relative to the second predefined portion of the user in the second movement pattern enhances user interactions with the computer system by enabling the user to control the amount and direction of the rotation of the object without cluttering the user interface with additional displayed controls.

In some embodiments, such as in FIG. 9E, manipulating the object (e.g., 902) in the environment (e.g., 901) in response to receiving the first interaction input includes, in accordance with a determination that the movement of the predefined portion (e.g., 903a and/or 903b) of the user is part of the first movement pattern and the movement of the predefined portion (e.g., 903a and/or 903b) of the user is part of the second movement pattern (1020a) manipulating the object (e.g., 902) in the first manner by a third amount (1020b).

In some embodiments, such as in FIG. 9E, manipulating the object (e.g., 902) in the environment (e.g., 901) in response to receiving the first interaction input includes, in accordance with a determination that the movement of the predefined portion (e.g., 903a and/or 903b) of the user is part of the first movement pattern and the movement of the predefined portion (e.g., 903a and/or 903b) of the user is part of the second movement pattern (1020a) manipulating the object (e.g., 902) in the second manner by a fourth amount that is based on (e.g., inversely proportional to) the third amount of movement of the object (e.g., 902) in the first manner (1020c). In some embodiments, the predefined portion of the user moves in the first and second movement patterns concurrently. In some embodiments, the computer system concurrently manipulates the object in the first and second manners. In some embodiments, the predefined portion of the user moves in the first movement pattern and second movement pattern sequentially. In some embodiments, the computer system sequentially manipulates the object in the first and second manners. In some embodiments, the third amount by which the computer system manipulates the object in the first manner is based on the first amount of movement of the predefined portion of the user in the first movement pattern. In some embodiments, the fourth amount by which the computer system manipulates the object in the second manner is based on the third amount by which the computer system manipulates the object in the first manner and the second amount of movement of the predefined portion of the user in the second movement pattern. In some embodiments, in accordance with manipulating the object in the first manner by a first amount, the computer system manipulates the object in the second manner by a second amount and in accordance with manipulating the object in the second manner by a relatively third amount that is less than the first amount, the computer system manipulates the object in the second manner by a fourth amount that is greater than the second amount. Manipulating the object in the second manner by an amount that is based on the amount by which the computer system manipulates the object in the first manner in response to receiving the first interaction input enhances user interactions with the computer system by reducing the number of inputs needed to customize the amounts of manipulation of the object in the first and second manners.

In some embodiments, such as in FIG. 9D, the first amount of movement of the predefined portion (e.g., 903a and/or 903b) of the user in the first movement pattern is a rate of movement of the predefined portion of the user (e.g., 903a and/or 903b) in the first movement pattern (1022). In some embodiments, in accordance with the rate of movement of the predefined portion of the user being a first rate of movement, the computer system manipulates the object in the first manner by a third amount, and in accordance with the rate of movement of the predefined portion of the user being a second rate of movement greater than the first rate of movement, the computer system manipulates the object in the first manner by a fourth amount greater than the third amount. In some embodiments, the amount of manipulation of the object in the first manner is a rate, distance, and/or duration of manipulation of the object in the first manner. Manipulating the object in the first manner in accordance with a rate of movement of the predefined portion of the user in the first movement pattern enhances user interactions with the computer system by enabling the user to customize the amount of manipulation of the object while reducing the number of displayed controls cluttering the user interface.

In some embodiments, such as in FIG. 9D, manipulating the object (e.g., 902) in the environment in response to receiving the first interaction input includes, in accordance with a determination that the movement of the predefined portion (e.g., 903a and/or 903b) of the user is part of the first movement pattern and the movement of the predefined portion (e.g., 903a and/or 903b) of the user is part of the second movement pattern (1024a), manipulating the object (e.g., 902) in the second manner by a third amount (e.g., duration, distance, and/or speed) (1024b). In some embodiments, the third amount is based on the second amount of movement of the predefined portion of the user in the second movement pattern.

In some embodiments, such as in FIG. 9D, manipulating the object (e.g., 902) in the environment in response to receiving the first interaction input includes, in accordance with a determination that the movement of the predefined portion (e.g., 903a and/or 903b) of the user is part of the first movement pattern and the movement of the predefined portion (e.g., 903a and/or 903b) of the user is part of the second movement pattern (1024a), manipulating the object (e.g., 902) in the first manner by a fourth amount based on the third amount of manipulation of the object (e.g., 902) in the second manner (1024c). In some embodiments, a magnitude, speed and/or direction of the manipulation of the object in the first manner is proportional to, inversely proportional to, or mathematically related in another way to a magnitude, speed and/or direction of the manipulation of the object in the second manner. In some embodiments, the fourth amount is based on the third amount of manipulation of the object in the second manner and the first amount of movement of the predefined portion user in the first movement pattern, such as described above and below. In some embodiments, the computer system manipulates the object in the first and second matters currently. In some embodiments, the computer system manipulates the object in the first and second matters sequentially. Manipulating the object in the second manner by third amount and in the first manner by the fourth amount based on the third amount enhances user interactions with the computer system by providing control options for manipulating the object in the first and second manners without cluttering the user interface with additional displayed controls.

In some embodiments, such as in FIG. 9E, the fourth amount of manipulation of the object (e.g., 902) in the first manner is inversely related to the third amount of manipulation of the object (e.g., 902) in the second manner (1026). In some embodiments, the fourth amount is inversely proportional to the third amount. In some embodiments, the fourth amount is inversely related to the third amount in a linear manner. In some embodiments, the fourth amount is inversely related to the third amount in a non-linear manner. Manipulating the object in the first manner by an amount that is inversely related to the amount of manipulation of the object in the second manner enhances user interactions with the computer system by reducing the likelihood of user error and thereby reducing the number of inputs needed to accurately manipulate the object.

In some embodiments, such as in FIG. 9D, the first amount of movement of the predefined portion (e.g., 903a and/or 903b) of the user corresponds to a fifth amount of manipulating the object (e.g., 902) in the first manner, and the fourth amount of manipulating the object (e.g., 902) in the first manner is based on a first adjustment (e.g., 926a) of the fifth amount of manipulating the object (e.g., 902) in the first manner in accordance with detecting movement of the predefined portion (e.g., 903a and/or 903b) of the user in the first movement pattern and the second movement pattern (1028a). In some embodiments, the first adjustment is a first adjustment function that modifies the fifth amount of manipulation in the first manner based on the third amount of manipulation in the second manner. In some embodiments, the first adjustment function is also based on the first amount of movement of the predefined portion of the user in the first manner and the second amount of movement of the predefined portion of the user in the second manner.

In some embodiments, such as in FIG. 9E, the second amount of movement of the predefined portion (e.g., 903a and/or 903b) of the user corresponds to a sixth amount of manipulating the object (e.g., 902) in the second manner, and the third amount of manipulating the object (e.g., 902) in the second manner is based on a second adjustment (e.g., 926b) of the sixth amount of manipulating the object (e.g., 902) in the second manner in accordance with detecting the movement of the predefined (e.g., 903a and/or 903b) portion of the user in the first movement pattern and the second movement pattern (1028b). In some embodiments, the second adjustment is a second adjustment function that modifies the sixth amount of manipulation in the second manner based on the fourth amount of manipulation in the first manner using calculations different from those in the first adjustment function described above. In some embodiments, the second adjustment function is also based on the first amount of movement of the predefined portion of the user in the first manner and the second amount of movement of the predefined portion of the user in the second manner. In some embodiments, the adjustment functions differ by scaling factors, operations, and/or exponents applied to one or more terms in the adjustment functions. Applying different adjustments to the fifth amount of manipulating the object in the first manner and the sixth amount of manipulating the object in the second manner enhance user interactions with the computer system by manipulating the object in an intuitive way in response to the first interaction input, which reduces the number of inputs needed to accurately manipulate the object.

In some embodiments, such as in FIG. 9A, the second amount of movement of the predefined portion (e.g., 903a and/or 903b) of the user in the second movement pattern is a rate of movement of the predefined portion (e.g., 903a and/or 903b) of the user in the second movement pattern (1030). In some embodiments, in accordance with the rate of movement of the predefined portion of the user being a first rate of movement, the computer system manipulates the object in the second manner by a third amount, and in accordance with the rate of movement of the predefined portion of the user being a second rate of movement greater than the first rate of movement, the computer system manipulates the object in the second manner by a fourth amount greater than the third amount. In some embodiments, the amount of manipulation of the object in the second manner is a rate, distance, and/or duration of manipulation of the object in the second manner. Manipulating the object in the second manner in accordance with a rate of movement of the predefined portion of the user in the second movement pattern enhances user interactions with the computer system by enabling the user to customize the amount of manipulation of the object while reducing the number of displayed controls cluttering the user interface.

In some embodiments, such as in FIG. 9D, the second amount of movement of the predefined portion (e.g., 903a and/or 903b) of the user in the second movement pattern corresponds to a third amount of manipulating the object in the second manner (1032a).

In some embodiments, such as in FIG. 9D, manipulating the object (e.g., 902) in the environment (e.g., 901) in response to receiving the first interaction input includes, in accordance with a determination that the movement of the predefined portion (e.g., 903a and/or 903b) of the user is part of the first movement pattern and the movement of the predefined portion of the user (e.g., 903a and/or 903b) is part of the second movement pattern (1032b), manipulating the object (e.g., 902) in the second manner by a fourth amount that is based on a first adjustment (e.g., 926a) of the third amount of manipulation of the object (e.g., 902) in the second manner in accordance with the determination that the movement of the predefined portion (e.g., 903a and/or 903b) of the user is part of the first movement pattern and the movement of the predefined portion (e.g., 903a and/or 903b) of the user is part of the second movement pattern (1032c). In some embodiments, the first adjustment is an adjustment function, as described in more detail above. In some embodiments, the computer system manipulates the object in the first manner and in the second manner in response to the first interaction input. In some embodiments, the computer system manipulates the object in the second manner without manipulating the object in the first manner. Manipulating the object in the second manner by a fourth amount that is based on a first adjustment of the third amount of manipulation of the object in the second manner enhances user interactions with the computer system by making manipulation of the object more intuitive and reducing the number of inputs needed to accurately manipulate the object.

In some embodiments, such as in FIG. 9D, the movement of the predefined portion (e.g., 903a and/or 903b) of the user is concurrently part of the first movement pattern and the second movement pattern (1034). In some embodiments, the computer system detects the first and second movement patterns of the predefined portion of the user while detecting the first interaction input. In some embodiments, the first and second movement patterns are detected concurrently. In some embodiments, the first and second movement patterns are detected sequentially. For example, the computer system detects movement of the user's hands while in pinch hand shapes that includes movement of the hands relative to the torso of the user (e.g., the first movement pattern) and movement of the hands relative to each other in a rotating motion (e.g., the second movement pattern). As another example, the computer system detects movement of two proximate objects via a touch-sensitive surface (e.g., a touch screen or trackpad) of a hardware input device that includes coordinated movement (e.g., movement including movement components in the same direction) of the proximate objects relative to the touch-sensitive surface (e.g., the first movement pattern) and movement of the proximate objects relative to each other in a rotating motion (e.g., the second movement pattern). Detecting the first movement pattern and the second movement pattern in the movement of the predefined portion of the user providing the first interaction input enhances user interactions with the computer system by enabling the user to control the manipulation of the object in the first and second manners with fewer user inputs.

In some embodiments, such as in FIG. 9E, manipulating the object (e.g., 902) in the environment (e.g., 901) in response to receiving the first interaction input includes, in accordance with a determination that movement of the predefined portion (e.g., 903a and/or 903b) of the user is part of the first movement pattern and movement of the predefined portion (e.g., 903a and/or 903b) of the user is part of the second movement pattern, such as in FIG. 9D, concurrently manipulating the object (e.g., 902) in the first manner and in the second manner (1036), such as in FIG. 9E. In some embodiments, the computer system manipulates the object in the first manner and the second manner sequentially in response to detecting the movement of the predefined portion of the user in the first movement pattern and second movement pattern sequentially. In some embodiments, the relative amounts of manipulation of the object in the first and second manners are adjusted based on one or more adjustment functions described above. Manipulating the object in the first and second manners in response to detecting the first interaction input enhances user interactions with the computer system by reducing the number of user inputs needed to manipulate the object in the first and second manners.

In some embodiments, manipulating the object (e.g., 902) in the environment (e.g., 901) in response to receiving the first interaction input includes, in accordance with a determination that the movement of the predefined portion (e.g., 903a and/or 903b) of the user is part of a third movement pattern different from the first movement pattern and different from the second movement pattern, such as in FIG. 9F, manipulating the object (e.g., 902) in a third manner different from the first manner and different from the second manner in accordance with a third amount of movement of the predefined portion (e.g., 903a and/or 903b) of the user in the third movement pattern (1038), such as in FIG. 9G. In some embodiments, detecting movement of the predefined portion of the user in the third movement pattern includes detecting the user perform a pinch gesture, maintain a pinch hand shape, and then move the hand(s). As another example, detecting movement of the predefined portion of the user in the third movement pattern includes detecting the predefined portion of the user proximate to and/or touching a touch-sensitive surface of a hardware input device while moving in the movement pattern. In some embodiments, the movement pattern is a curved movement corresponding to rotation. In some embodiments, detecting movement of the predefined portion of the user in the third movement pattern includes detecting an object proximate to and/or touching a touch-sensitive surface of a hardware input device, maintaining a location of the object proximate to and/or touching the touch-sensitive surface, and then movement of the object along the touch-sensitive surface. In some embodiments, manipulating the object in the third movement pattern includes rotation the object around an axis associated with the viewpoint of the user, as described in more detail below. Manipulating the object in the third manner in response to detecting movement of the predefined portion of the user in the third movement pattern while providing the first interaction input enhances user interactions with the computer system by providing additional types of object manipulation in response to the first interaction input, providing more options for controlling the computer system without cluttering the user interface with additional displayed controls.

In some embodiments, such as in FIG. 9G, an amount of manipulation of the object (902) in the third manner is independent from an amount of manipulation of the object (902) in the first manner (1040). In some embodiments, the computer system manipulates the object in the third manner and first manner concurrently. In some embodiments, the computer system manipulates the object in the third manner and the first manner sequentially. In some embodiments, movement of one or more predefined portions of the user in a first direction (e.g., while maintaining a pinch hand shape as part of an air gesture or along a touch-sensitive surface of a hardware input device) corresponds to the first movement pattern and lack of movement in a second direction followed by movement in the second direction (e.g., while maintaining a pinch hand shape as part of an air gesture or along a touch-sensitive surface of a hardware input device) corresponds to the third movement pattern. Manipulating the object in the third manner independent from the amount of manipulation of the object in the first manner enhances user interactions with the computer system by providing the user with customizable control over the first and third manipulations of the object while providing the first interaction input, which reduces the number of inputs needed to manipulate the object in the first and third manners.

In some embodiments, such as in FIG. 9H, manipulating the object (e.g., 902) in the third manner includes rotating the object (e.g., 902) around a reference point (e.g., 905a) in the environment (e.g., 901) associated with a viewpoint of the user of the computer system in the environment (1042). In some embodiments, the reference point is the viewpoint of the user. In some embodiments, the reference point is the centroid of the user's torso. In some embodiments, the reference point is a midpoint between the user's torso and the predefined portion of the user (e.g., the user's hand(s)). Rotating the object around the reference point associated with the viewpoint of the user in response to movement of the predefined portion of the user in the first interaction input including the third movement pattern enhances user interactions with the computer system by providing additional controls for manipulating the object without cluttering the user interface with additional displayed elements.

In some embodiments, such as in FIG. 9H, the third movement pattern of the predefined portion (e.g., 903a and/or 903b) of the user includes movement of the predefined portion (e.g., 903a and/or 903b) of the user in a first direction relative to the viewpoint of the user (e.g., 903a and/or 903b) in the environment (e.g., 901) (1044a) (e.g., and/or the user's torso), In some embodiments, the third movement pattern includes movement of the predefined portion of the user relative to a hardware input device, such as a hardware input device that includes a touch-sensitive surface, as described in more detail above. In some embodiments, the third movement pattern includes movement of two predefined portions (e.g., hands) of the user in the first direction relative to the viewpoint of the user (e.g., and/or the user's torso).

In some embodiments, such as in FIG. 9I, manipulating the object (e.g., 902) in the third manner includes manipulating the object (e.g., 902) by a fourth amount (e.g., of speed, distance, and/or duration) in accordance with the third amount (e.g., of speed, distance, and/or duration) of movement of the predefined portion (e.g., 903a and/or 903b) of the user in the third movement pattern (1044b). In some embodiments, if the third amount is relatively high, the fourth amount is relatively high and if the third amount is relatively low, the fourth amount is relatively low. In some embodiments, the characteristics of the amounts are the same, such as the speed, distance, and/or duration of the movement of the predefined portion of the user corresponding to the speed, distance, and/or duration, respectively, of the amount of manipulation. In some embodiments, the characteristics of the amounts are different, such as the speed, distance, and/or duration of the movement of the predefined portion of the user corresponding to a different one of the speed, distance, and/or duration of the amount of manipulation.

In some embodiments, such as in FIG. 9I, manipulating the object (e.g., 902) in the third manner includes manipulating the object (e.g., 902) in a second direction in accordance with the first direction of movement of the predefined portion (e.g., 903a and/or 903b) of the user in the third movement pattern. In some embodiments, the second and third directions are the same (e.g., the same translational directions, and/or the same rotational directions). In some embodiments, the second and third directions are different, but related by a function that converts the direction of movement of the predefined portion of the user to the direction of manipulation of the object. For example, movement of the predefined portion in a downwards direction causes manipulation of the object upwards and vice-versa. Manipulating the object in the third manner by an amount and direction corresponding to the amount and direction of movement of the predefined portion of the user in the third movement pattern.

In some embodiments, such as in FIG. 9G, in accordance with a determination that the third movement pattern of the predefined portion (e.g., 903a) of the user includes movement the predefined portion (e.g., 903a) of the user and a second predefined portion (e.g., 903b) of the user, manipulating the object (e.g., 902) in the third manner is based on movement of a midpoint between the predefined portion (e.g., 903a) of the user and a second predefined portion (e.g., 903b) of the user relative to the viewpoint of the user (e.g., 905a) in the environment (1046) (e.g., and/or the user's torso, and/or a hardware input device). In some embodiments, as the predefined portion of the user and the second predefined portion of the user (e.g., the user's hands) move relative to the viewpoint of the user in the environment, the midpoint between the predefined portion of the user and the second predefined portion of the user relative to the viewpoint of the user also moves. In some embodiments, manipulation of the object based on the midpoint between the predefined portion of the user and the second predefined portion of the user relative to the viewpoint of the user is in accordance with a determination that the predefined portion of the user and the second predefined portion of the user are move in the third movement pattern. As described in more detail below, in some embodiments, in accordance with a determination that the predefined portion of the user moves in the third movement pattern and the second predefined portion of the user does not move in the third movement pattern, the manipulation of the object is based on movement of the predefined portion of the user relative to the viewpoint of the user (e.g., independent from a position of the second predefined portion of the user relative to the predefined portion of the user and/or the viewpoint of the user). Manipulating the object in the third manner in accordance with movement of the midpoint between the predefined portion of the user and the second predefined portion of the user relative to the viewpoint of the user in response to the first interaction input including the third movement pattern enhances user interactions with the computer system by simplifying control of the manipulation of the object in response to the first interaction input, thereby reducing the number of inputs needed to accurately manipulate the object.

In some embodiments, such as in FIG. 9F, in accordance with a determination that the third movement pattern of the predefined portion (e.g., 903b) of the user includes movement the predefined portion (e.g., 903b) of the user (e.g., one of the user's hands) without movement of a second predefined portion (e.g., 903b) of the user (e.g., the user's other hand), manipulating the object (e.g., 902) in the third manner is based on movement the predefined portion (e.g., 903b) of the user relative to the viewpoint of the user (e.g., 905a) in the environment (e.g., 901) (1048) (e.g., and/or the user's torso, and/or a hardware input device). In some embodiments, manipulation of the object based on the movement of the predefined portion of the user relative to the viewpoint of the user is in accordance with a determination that the predefined portion of the user moves in the third movement pattern without the second predefined portion of the user moving in the third movement pattern, optionally while the second predefined portion of the user is engaged in an input (e.g., making an air pinch gesture, and/or interacting with a hardware input device), optionally while the second predefined portion of the user is not engaged. In some embodiments, detecting the third movement pattern includes detecting that the second predefined portion of the user is moving. In some embodiments, detecting the third movement pattern includes detecting that the second predefined portion of the user is not moving. As described in more detail above, in some embodiments, in accordance with a determination that the predefined portion of the user and the second predefined portion of the user is move in the third movement pattern, the manipulation of the object is based on movement of the midpoint of the predefined portion of the user and the second predefined portion of the user relative to the viewpoint of the user. In some embodiments, detecting the third movement pattern includes detecting the second predefined portion of the user in a predefined hand shape (e.g., a pinch hand shape). Manipulating the object in the third manner in accordance with movement of the predefined portion of the user relative to the viewpoint of the user in response to the first interaction input including the third movement pattern enhances user interactions with the computer system by simplifying control of the manipulation of the object in response to the first interaction input, thereby reducing the number of inputs needed to accurately manipulate the object.

In some embodiments, such as in FIG. 9H, the movement of the predefined portion (e.g., 903a or 903b) of the user is part of the first movement pattern and the third movement pattern concurrently (1050). In some embodiments, the first interaction input includes concurrent movement of the predefined portion of the user in the first movement pattern and the third movement pattern. In some embodiments, the first interaction input includes sequential movement of the predefined portion of the user in the first movement pattern and the third movement pattern. Examples of movement patterns that include the first and third movement patterns are provided above. Detecting the first and third movement patterns in the movement of the predefined portion of the user included in the first interaction input enhances user interactions with the computer system by providing additional controls for manipulating the object without cluttering the user interface with additional displayed controls.

In some embodiments, such as in FIGS. 9H-9I, manipulating the object (e.g., 902) in the environment (e.g., 901) in response to receiving the first interaction input includes, in accordance with a determination that the movement of the predefined portion (e.g., 903a and/or 903b) of the user is part of the first movement pattern and the third movement pattern concurrently, the computer system (e.g., 101a) concurrently manipulating the object in the first manner and manipulating the object (e.g., 902) in the third manner (1052). In some embodiments, in accordance with the determination that the movement of the predefined portion of the user is part of the first movement pattern and the third movement pattern, the computer system sequentially manipulates the object in the first manner and the third manner. In some embodiments, manipulating the object in the first manner and the third manner concurrently includes rotating the object around a reference point and translating the object concurrently. In some embodiments, the reference point is an arbitrary reference point. In some embodiments, the reference point is associated with the viewpoint of the user, as described above. In some embodiments, the amount of movement of the predefined portion of the user in the third movement pattern is independent of the amount of movement of the predefined portion of the user in the first movement pattern. Manipulating the object in the first manner and third manner in response to the first interaction input enhances user interactions with the computer system by providing additional control options for manipulating the object without cluttering the user interface with additional displayed controls.

In some embodiments, such as in FIG. 9H, the movement of the predefined portion (e.g., 903a and/or 903b) of the user is part of the second movement pattern and the third movement pattern concurrently (1054). In some embodiments, the first interaction input includes concurrent movement of the predefined portion of the user in the second movement pattern and the third movement pattern. In some embodiments, the first interaction input includes sequential movement of the predefined portion of the user in the second movement pattern and the third movement pattern. In some embodiments, rotational movement of the predefined portion of the user relative to a second predefined portion of the user (e.g., while maintaining a pinch hand shape as part of an air gesture and/or along a touch-sensitive surface of a hardware input device) corresponds to the second movement pattern and lack of movement in a second rotational manner relative to the viewpoint of the user followed by movement in the second rotational manner (e.g., while maintaining a pinch hand shape as part of an air gesture and/or along a touch-sensitive surface of a hardware input device) corresponds to the third movement pattern. Detecting the second and third movement patterns in the movement of the predefined portion of the user included in the first interaction input enhances user interactions with the computer system by providing additional controls for manipulating the object without cluttering the user interface with additional displayed controls.

In some embodiments, such as in FIGS. 9H-9I, manipulating the object (e.g., 902) in the environment in response to receiving the first interaction input includes, in accordance with a determination that the movement of the predefined portion (e.g., 903a and/or 903b) of the user is part of the second movement pattern and the third movement pattern concurrently, concurrently manipulating the object (e.g., 902) in the second manner and manipulating the object (e.g., 902) in the third manner (1056). In some embodiments, in accordance with the determination that the movement of the predefined portion of the user is part of the second movement pattern and the third movement pattern, the computer system sequentially manipulates the object in the second manner and the third manner. In some embodiments, manipulating the object in the second manner and the third manner concurrently includes rotating the object around a first reference point and rotating the object around a second reference point concurrently. In some embodiments, the reference point is an arbitrary reference point. In some embodiments, the reference point is associated with the viewpoint of the user, as described above. In some embodiments, the second reference point is associated with the object, as described above. In some embodiments, the amount of movement of the predefined portion of the user in the third movement pattern is independent of the amount of movement of the predefined portion of the user in the second movement pattern. Manipulating the object in the second manner and third manner in response to the first interaction input enhances user interactions with the computer system by providing additional control options for manipulating the object without cluttering the user interface with additional displayed controls.

In some embodiments, such as in FIG. 9H, the movement of the predefined portion (e.g., 903a and/or 903b) of the user is part of the first movement pattern, the movement of the predefined portion (e.g., 903a and/or 903b) of the user is part of the second movement pattern and the movement of the predefined portion (e.g., 903a and/or 903b) of the user is part of the third movement pattern concurrently (1058). In some embodiments, the first interaction input includes concurrent movement of the predefined portion of the user in the first movement pattern, the second movement pattern, and the third movement pattern. In some embodiments, the first interaction input includes sequential movement of the predefined portion of the user in the first movement pattern, the second movement pattern, and the third movement pattern. Examples of the first, second, and third movement patterns are described above. Detecting the first, second and third movement patterns in the movement of the predefined portion of the user included in the first interaction input enhances user interactions with the computer system by providing additional controls for manipulating the object without cluttering the user interface with additional displayed controls.

In some embodiments, such as in FIGS. 9H-9I, manipulating the object (e.g., 902) in the environment (e.g., 901) in response to receiving the first interaction input includes, in accordance with a determination that the movement of the predefined portion (e.g., 903a and/or 903b) of the user is part of the second movement pattern and the movement of the predefined portion (e.g., 903a and/or 903b) of the user is part of the third movement pattern concurrently, concurrently manipulating the object (e.g., 902) in the first manner, manipulating the object (e.g., 902) in the second manner, and manipulating the object (e.g., 902) in the third manner (1060). In some embodiments, in accordance with the determination that the movement of the predefined portion of the user is part of the first movement pattern, the second movement pattern, and the third movement pattern, the computer system sequentially manipulates the object in the first manner, the second manner, and the third manner. In some embodiments, manipulating the object in the first manner, the second manner, and the third manner concurrently includes rotating the object around a first reference point, rotating the object around a second reference point, and translating the object concurrently or sequentially. In some embodiments, the first reference point is an arbitrary reference point. In some embodiments, the first reference point is associated with the viewpoint of the user, as described above. In some embodiments, the second reference point is associated with the object. In some embodiments, the amount of movement of the predefined portion of the user in the third movement pattern is independent of the amount of movement of the predefined portion of the user in the first movement pattern and/or the second movement pattern. Manipulating the object in the first manner, the second manner, and the third manner in response to the first interaction input enhances user interactions with the computer system by providing additional control options for manipulating the object without cluttering the user interface with additional displayed controls.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIGS. 11A-11G illustrate examples of a computer system facilitating interactions with a plurality of objects relative to a reference point in a three-dimensional environment in accordance with some embodiments.

FIG. 11A illustrates a computer system (e.g., an electronic device) 101a displaying, via a display generation component (e.g., display generation component 120 of FIG. 1), a three-dimensional environment 1102 from a viewpoint of the user 1126 illustrated in the overhead view (e.g., facing the back wall of the physical environment in which computer system 101a is located). In some embodiments, computer system 101a includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101a would be able to use to capture one or more images of a user or a part of the user (e.g., one or more hands of the user) while the user interacts with the computer system 101a. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 11A, computer system 101a captures one or more images of the physical environment around computer system 101a (e.g., operating environment 100), including one or more objects in the physical environment around computer system 101a. In some embodiments, computer system 101a displays representations of the physical environment in three-dimensional environment 1102. For example, three-dimensional environment 1102 includes a representation 1122a of a coffee table (corresponding to table 1122b in the overhead view), which is optionally a representation of a physical coffee table in the physical environment, and three-dimensional environment 1102 includes a representation 1124a of sofa (corresponding to sofa 1124b in the overhead view), which is optionally a representation of a physical sofa in the physical environment.

In FIG. 11A, three-dimensional environment 1102 also includes virtual objects 1107a (“Window 1,” corresponding to object 1107b in the overhead view), and 1109a (“Window 2,” corresponding to object 1109b in the overhead view). Virtual objects 1107a and 1109a are optionally at different distances from the viewpoint of user 1126 in three-dimensional environment 1102. For example, in FIG. 11A, virtual object 1107a is located at a first location that is closer to the viewpoint of user 1126 than a second location at which virtual object 1109a is located in three-dimensional environment 1102, as reflected in the overhead view. In some embodiments, virtual objects 1107a and 1109a are optionally one or more of user interfaces of applications containing content (e.g., quick look windows displaying photographs), three-dimensional objects (e.g., virtual clocks, virtual balls, and/or virtual cars) or any other element displayed by computer system 101a that is not included in the physical environment of display generation component 120.

In some embodiments, the computer system 101a is in a copresence communication session with a second computer system 101b (shown in the overhead view). For example, the virtual objects 1107a and 1109a within the three-dimensional environment 1102 and/or the three-dimensional environment 1102 are being displayed by both the computer system 101a and the second computer system 101b, concurrently, but from different viewpoints associated with their respective users. In some embodiments, in the communication session, the user 1126 of the computer system 101a has a first viewpoint of the three-dimensional environment 1102, and a second user of the second computer system 101b has a second viewpoint of the three-dimensional environment 1102. For example, a field of view of the three-dimensional environment 1102 from the first viewpoint of the user 1126 of the computer system 101a, as shown in FIG. 11A, includes a first portion of the three-dimensional environment 1102 (including the virtual objects 1107a and 1109a), and a field of view of the three-dimensional environment 1102 from the second viewpoint of the second user of the second computer system 101b includes a second portion of the three-dimensional environment 1102. In some embodiments, the second portion of the three-dimensional environment 1102 includes the virtual object 1107a and/or the virtual object 1109a, or neither the virtual object 1107a nor the virtual object 1109a. In some embodiments, the computer system 101a and the second computer system 101b are in the same physical environment (e.g., at different locations in the same room of FIG. 11A). In some embodiments, the computer system 101a and the second computer system 101b are located in different physical environments (e.g., different cities, different rooms, different states and/or different countries).

In some embodiments, while the computer system 101a is in a copresence communication session with the second computer system 101b, the three-dimensional environment 1102 includes a virtual representation of the second user of the second computer system 101b. For example, as shown in FIG. 11A, the three-dimensional environment 1102 includes an avatar 1106a (corresponding to avatar 1106b in the overhead view) corresponding to the second user of the second computer system 101b. In FIG. 11A, the avatar 1106a corresponding to the second user is optionally displayed at a third location in the three-dimensional environment 1102 that is furthest (e.g., among the locations of virtual objects 1107a and 1109a) from the viewpoint of the user 1126, as illustrated in the overhead view. In some embodiments, the avatar 1106a includes a three-dimensional representation (e.g., rendering) of the second user. In some embodiments, the avatar 1106a corresponding to the second user includes a representation of the second computer system 101b of which the second user is a user. In some embodiments, the second portion of the three-dimensional environment 1102 from the second viewpoint of the second user displayed at the second computer system 101b includes a virtual representation of the user 1126 of the computer system 101a.

In some embodiments, virtual objects are displayed in three-dimensional environment 1102 with respective orientations relative to the viewpoint of user 1126 (e.g., prior to receiving input interacting with the virtual objects, which will be described later, in three-dimensional environment 1102). As shown in FIG. 11A, virtual objects 1107a and 1109a and the avatar 1106a corresponding to the second user of the second computer system 101b have first orientations in three-dimensional environment 1102. For example, the front-facing surfaces/portions of virtual objects 1107a and 1109a and the avatar 1106a that face the viewpoint of user 1126 are flat/level (or parallel to each other) relative to the viewpoint of user 1126, as shown by 1107b, 1109b, and 1106b, respectively, in the overhead view of FIG. 11A. It should be understood that the orientations of the virtual objects in FIG. 11A are merely exemplary and that other orientations are possible; for example, the virtual objects are optionally displayed with different orientations in three-dimensional environment 1102.

In some embodiments, the virtual object 1107a and/or the virtual object 1109a are shared between the user 1126 of the computer system 101a and the second user of the second computer system 101b (e.g., while the computer system 101a and the second computer system 101b are in a communication session). For example, the user interfaces and/or contents (e.g., text, images, video, files, icons, and/or control elements) of the virtual objects 1107a and/or 1109a are displayed in the first portion and/or the second portion of the three-dimensional environment 1102, such that the user interfaces and/or contents of the virtual objects 1107a and/or 1109a are accessible by (e.g., viewable by and/or interactable (e.g., selectable or scrollable) by) the user 1126 of the computer system 101a and the second user of the second computer system 101b. In some embodiments, as described below, when the virtual objects 1107a and 1109a are shared between the user 1126 and the second user, changes in relative positions of the virtual objects 1107a and/or 1109a in three-dimensional environment 1102 due to user input received at the computer system 101a are reflected in the display of the second portion of the three-dimensional environment at the second computer system 101b relative to the second viewpoint of the second user. In some embodiments, the virtual object 1107a and the virtual object 1109a are not shared between the user 1126 of the computer system 101a and the second user of the second computer system 101b. For example, the computer system 101a displays the virtual object 1107a and the virtual object 1109a in three-dimensional environment 1102 and/or provides the user 1126 access to the contents of the virtual object 1107a and the virtual object 1109a, and the second computer system 101b forgoes displaying the virtual object 1107a and the virtual object 1109a in the portion of the three-dimensional environment 1102 at the second computer system 101b and/or forgoes providing the second user access to the contents of the virtual object 1107a and the virtual objects 1109a. In some embodiments, when the virtual objects 1107a and 1109a are not shared between the user 1126 and the second user, changes in relative positions of the virtual objects 1107a and/or 1109a in three-dimensional environment 1102 due to user input received at the computer system 101a are not reflected in the second portion of the three-dimensional environment at the second computer system 101b relative to the second viewpoint of the second user.

In some embodiments, the computer system 101a and the second computer system 101b are in communication with each other (e.g., while in the copresence communication session) such that the display of the virtual objects 1107a and 1109a within the three-dimensional environment 1102 and/or the display of the three-dimensional environment 1102 by the computer systems 101a and 101b is coordinated. For example, as described below, changes to (e.g., in positions of) the virtual objects 1107a and/or 1109a and the avatar 1106a corresponding to the second user within the three-dimensional environment 1102 and/or the three-dimensional environment 1102 made in response to inputs from the user 1126 of the computer system 101a are reflected in the display of the virtual objects 1107a and/or 1109a and the avatar 1106a within the portion of the three-dimensional environment 1102 and/or the three-dimensional environment 1102 by the second computer system 101b. In some embodiments, as described below, if the computer system 101a detects an interaction input while attention of the user is directed to a first object in the three-dimensional environment 1102, the computer system 101a performs a first operation, including concurrently repositioning the virtual objects 1107a and 1109a and the avatar 1106a corresponding to the second user within the three-dimensional environment 1102 relative to a location of the first object in the three-dimensional environment 1102, in accordance with the interaction input. If the computer system 101a detects an interaction input while the attention of the user is directed to a second object in the three-dimensional environment 1102, the computer system 101a performs a second operation, including concurrently repositioning the virtual objects 1107a and 1109a and the avatar 1106a corresponding to the second user within the three-dimensional environment 1102 relative to a location of the second object in the three-dimensional environment 1102, in accordance with the interaction input.

In FIG. 11A, the computer system 101a detects hand 1103a (“Hand 1”) provide a first interaction input corresponding to a request to move one or more virtual objects displayed in three-dimensional environment 1102. For example, from FIGS. 11A-11B, the computer system 101a detects hand 1103a provide a selection input while attention (e.g., gaze 1121) of the user 1126 is directed to virtual object 1109a in the three-dimensional environment 1102, followed by movement of the hand 1103a. In some embodiments, computer system 101a detects hand 1103a move away from the body of the user 1126 and perform a pinch while the attention, including gaze 1121, is directed to the virtual object 1109a, followed by movement of the hand 1103a in a first direction (e.g., toward the user 1126) with a first magnitude (e.g., of speed or distance) while maintaining the pinch hand shape.

In some embodiments, in response to detecting the first interaction input in FIG. 11A, the computer system 101a manipulates the three-dimensional environment 1102 relative to a reference point determined based on the location of the attention (e.g., gaze 1121) of the user 1126 in accordance with the first interaction input. For example, as shown in FIG. 11B, in response to detecting the movement of the hand 1103a in a direction toward the viewpoint of the user 1126 while the gaze 1121 was directed toward the virtual object 1109a, the computer system 101a concurrently moves (e.g., translates) the virtual objects 1107a and 1109a and the avatar 1106a toward the viewpoint of the user 1126 in the three-dimensional environment 1102 relative to a location associated with the virtual object 1109a (e.g., the reference point labeled in the overhead view of FIG. 11B) in accordance with the movement of the hand 1103a. In some embodiments, because the manipulation of the three-dimensional environment 1102 is performed relative to the location associated with the virtual object 1109a in the three-dimensional environment (e.g., as determined based on the location of the gaze 1121), the computer system 101a moves the virtual object 1107a, the virtual object 1109a and the avatar 1106a corresponding to the second user of the second computer system 101b within the three-dimensional environment 1102 while maintaining a spatial relationship among the virtual object 1107a, the virtual object 1109a and the avatar 1106a during the movement. For example, before detecting the first interaction input in FIG. 11A, the computer system 101a displays the virtual object 1107a at a first distance from the virtual object 1109a in three-dimensional environment 1102, and displays the avatar 1106a a second distance from the virtual object 1109a. In response to detecting the first interaction input while the gaze 1121 is directed to the virtual object 1109a, the computer system 101a concurrently moves the virtual object 1107a, the virtual object 1109a and the avatar 1106a within the three-dimensional environment 1102, while maintaining the first distance between the virtual object 1107a and the virtual object 1109a and the second distance between the avatar 1106a and the virtual object 1109a during the movement, as shown in FIG. 11B.

In some embodiments, while the user 1126 of the computer system 101a is in the communication session with the second user of the second computer system 101b, when the computer system 101a detects the first interaction input provided by the hand 1103a in FIG. 11A, the second computer system 101b changes an appearance of the avatar corresponding to the user 1126 in the portion of the three-dimensional environment 1102 displayed at the second computer system 101b. Additionally, if the virtual objects 1107a and 1109a are shared between the user 1126 and the second user of the second computer system 101b, when the computer system 101a moves the virtual objects 1107a and 1109a and the avatar 1106a within the three-dimensional environment 1102 relative to the viewpoint of the user 1126 in accordance with the movement of hand 1103a, as shown in FIG. 11B, the second computer system 101b moves the avatar corresponding to the user 1126 in the portion of the three-dimensional environment 1102 displayed at the second computer system 101b, without moving the virtual objects 1107a and 1109a in the portion of the three-dimensional environment 1102 displayed at the second computer system 101b. Additional details regarding the movement of shared objects and the change of appearance of avatars in a communication session are provided with reference to FIGS. 7A-7I and/or method 800.

In some embodiments, the computer system 101a scales a magnitude of the movement of one or more virtual objects displayed in the three-dimensional environment 1102 based on corresponding locations of the one or more virtual objects in the three-dimensional environment 1102 relative to the viewpoint of the user 1126. For example, in response to receiving an interaction input including movement of the hand 1103b of the user by a respective amount (e.g., of speed, distance, and/or duration), the computer system 101a moves the virtual objects by a first amount if the virtual objects were first distances from the viewpoint of the user 1126 when the interaction input was received, and moves the virtual objects by a second amount greater than the first amount if the virtual objects were second distances, greater than the first distances, from the viewpoint of the user 1126 when the interaction input was received. As described above with reference to FIG. 11A, prior to detecting the first interaction input, the computer system 101a optionally displays the virtual object 1107a at a first location, the virtual object 1109a at a second location, and the avatar 1106a at a third location in the three-dimensional environment 1102. As shown in the overhead view in FIG. 11A, the first location, the second location, and the third location are optionally relatively far from the viewpoint of the user 1126 (e.g., are more than 4, 5, 8, 10, 12, 15, or 20 m from the viewpoint of the user 1126) in the three-dimensional environment 1102. In some embodiments, in response to detecting the movement of the hand 1103a with the first magnitude in FIG. 11A, the computer system 101a moves the virtual object 1107a, the virtual object 1109a, and the avatar 1106a within the three-dimensional environment 1102 with a second magnitude, based on the first magnitude, relative to the viewpoint of the user 1126. For example, because the virtual object 1107a, the virtual object 1109a, and the avatar 1106a were located relatively far from the viewpoint of the user 1126, the computer system 101a moves the virtual object 1107a, the virtual object 1109a, and the avatar 1106a within the three-dimensional environment 1102 with the second magnitude (e.g., of speed and/or distance), which is greater than the first magnitude. Accordingly, in FIG. 11B, the virtual object 1107a, the virtual object 1109a, and the avatar 1106a have moved a greater distance (e.g., and/or with a greater speed) in the three-dimensional environment 1102 relative to the viewpoint of the user 1126 in accordance with the movement of the hand 1103a than if the virtual object 1107a, the virtual object 1109a, and the avatar 1106a were located relatively close to the viewpoint of the user 1126 (e.g., less than 4, 5, 8, 10, 12, 15, or 20 m from the viewpoint of the user 1126) when the first interaction input was detected.

In some embodiments, the computer system 101a restricts movement of one or more virtual objects displayed in the three-dimensional environment 1102 to movement outside of a threshold distance from the viewpoint of the user 1126. Examples of the threshold distance are discussed below with reference to method 1200. In some embodiments, in response to detecting one or more movement inputs directed to a virtual object in the three-dimensional environment, the computer system 101a restricts movement of the virtual object to movement outside of the threshold distance (e.g., labeled in the overhead view in FIG. 11B) from the viewpoint of the user 1126 if the gaze of the user is directed toward the virtual object in the three-dimensional environment 1102, irrespective of whether the movement input corresponds to movement to within the threshold distance from the viewpoint of the user 1126. In some embodiments, as described below, one or more virtual objects to which the gaze of the user is not directed are able to be moved to within the threshold distance of the viewpoint of the user 1126 in accordance with movement input. For example, in FIG. 11B, the computer system 101a detects the hand 1103b continue to provide movement input directed toward the three-dimensional environment 1102. In FIG. 11B, the computer system 101a optionally detects the hand 1103b continue moving in the first direction (e.g., toward the viewpoint of the user 1126) while maintaining the pinch hand shape and while the attention (e.g., gaze 1121) of the user 1126 is directed toward the virtual object 1109a in the three-dimensional environment 1102.

In some embodiments, in response to detecting the movement of the hand 1103b while the attention (e.g., gaze 1121) is directed toward the virtual object 1109a in FIG. 11B, the computer system 101a manipulates the three-dimensional environment 1102 in accordance with the movement of the hand 1103b. For example, as shown in FIG. 11C, in response to detecting the movement of the hand 1103b toward the viewpoint of the user 1126, the computer system 101a concurrently repositions (e.g., translates) the virtual objects 1107a and 1109a and the avatar 1106a in three-dimensional environment 1102 toward the viewpoint of the user 1126 relative to the reference point determined based on the location of the virtual object 1109a, as illustrated in the overhead view in FIG. 11C, in accordance with the movement of the hand 1103b. In some embodiments, the movement of the hand 1103b detected in FIG. 11B corresponds to movement of the virtual object 1107a, the virtual object 1109a and the avatar 1106a within the threshold distance (labeled in the overhead view in FIG. 11B) from the viewpoint of the user 1126. In some embodiments, as mentioned above, the computer system 101a restricts the movement of the virtual object 1109b to which the attention (e.g., gaze 1121) was directed when the movement of the hand 1103b was detected to movement outside of the threshold distance from the viewpoint of the user 1126, as shown in the overhead view in FIG. 11C. For example, the computer system 101a stops moving the virtual object 1109b at a location in the three-dimensional environment 1102 that is at or is outside of the threshold distance from the viewpoint of the user 1126 even though the movement of the hand 1103b corresponds to movement to within the threshold distance from the viewpoint of the user 1126.

Further, in some embodiments, as mentioned above, virtual objects to which the attention (e.g., gaze 1121) of the user 1126 are not directed are able to be moved to within the threshold distance from the viewpoint of the user 1126 based on the movement of the hand 1103b. For example, as shown in the overhead view in FIG. 11C, in response to detecting the movement of the hand 1103b while the gaze 1121 is directed to the virtual object 1109a in FIG. 11B, the computer system 101a moves the virtual object 1107b in the three-dimensional environment 1102 to within the threshold distance from the viewpoint of the user 1126 in accordance with the movement of the hand 1103b. As mentioned above with reference to FIG. 11A, the virtual object 1107a is optionally located closer to the viewpoint of the user 1126 than the virtual object 1109a in the three-dimensional environment 1102. Accordingly, when the computer system 101a stops moving the virtual object 1107a in the three-dimensional environment 1102 when the virtual object 1109a is stopped outside of the threshold distance from the viewpoint of the user 1126, the virtual object 1107a is displayed at a location that is within the threshold distance from the viewpoint of the user 1126 in the three-dimensional environment 1102, as shown in the overhead view in FIG. 11C. It should be understood that, if the avatar 1106a were also located closer to the viewpoint of the user 1126 than the virtual object 1109b, in some embodiments, the computer system 101a would also allow the avatar 1106a to be moved to within the threshold distance from the viewpoint of the user 1126 based on the movement of the hand 1103b while the attention (e.g., gaze 1121) is directed toward the virtual object 1109b.

In some embodiments, after detecting an end of the movement input provided by the hand 1103b illustrated in FIG. 11B, the user 1126 is able to further manipulate the three-dimensional environment 1102 by providing a two-handed interaction input. For example, as shown in FIG. 11C, the computer system 101a detects hand 1103c and hand 1105a (“Hand 2”) provide movement inputs directed to the three-dimensional environment 1102. In FIG. 11C, the computer system 101a detects the hands 1103c and 1105a concurrently perform a pinch, followed by concurrent movement of the hands 1103c and 1105a in a clockwise direction relative to the viewpoint of the user 1126 while holding the pinch hand shape. In some embodiments, the movement inputs concurrently provided by the hands 1103c and 1105a are optionally detected while the attention (e.g., gaze 1121) of the user 1126 is directed toward the virtual object 1107a in the three-dimensional environment 1102, as shown in FIG. 11C. It should be understood that while multiple hands and corresponding inputs are illustrated in FIGS. 11C-11G, such hands and inputs need not be detected by computer system 101a concurrently; rather, in some embodiments, computer system 101a independently responds to the hands and/or inputs illustrated and described in response to detecting such hands and/or inputs independently.

In some embodiments, in response to detecting the movement of the hands 1103c and 1105a in FIG. 11C, the computer system 101a manipulates the three-dimensional environment 1102 relative to the viewpoint of the user 1126 in accordance with the movement. For example, as shown in FIG. 11D, the computer system 101a repositions (e.g., rotates) the virtual object 1107a, the virtual object 1109a, and the avatar 1106a in a clockwise direction within the three-dimensional environment 1102 relative to the viewpoint of the user 1126 (e.g., about an axis selected based on the viewpoint of the user 1126, as illustrated by the reference point labeled in the overhead view in FIG. 11D) in accordance with the counterclockwise movement of the hands 1103c and 1105a. As shown, in response to detecting the movement of the hands 1103c and 1105a, the computer system 101a optionally displays the virtual objects 1107a and 1109a and the avatar 1106a with second orientations, different from the first orientations discussed above. For example, the front-facing surfaces/portions of the virtual objects 1107a and 1109a and the avatar 1106a are tilted/slightly angled leftward relative to the viewpoint of the user 1126, as shown by 1107b, 1109b, and 1106b, respectively, in the overhead view of FIG. 11D.

After detecting an end of the movement input provided by the hand 1103d and 1105b in FIG. 11D, the computer system 101a optionally detects the attention of the user 1126 is directed away from the virtual object 1109a in the three-dimensional environment 1102. For example, the computer system 101a detects the gaze 1121 directed toward the avatar 1106a in the three-dimensional environment 1102 after the hands 1103d and 1105b stop moving (e.g., but while remaining in the pinch hand shape associated with the movement inputs detected in FIG. 11C). In some embodiments, in response to detecting the movement of the gaze 1121 away from the virtual object 1109a in FIG. 11D, the computer system 101a determines a new reference point based on the new location of the attention (e.g., gaze 1121) in the three-dimensional environment 1102. For example, as shown in the overhead view in FIG. 11E, in response to detecting the gaze 1121 of the user 1126 directed toward the avatar 1106a in the three-dimensional environment 1102, the computer system 101a determines a new reference point (e.g., to which subsequent object manipulation will be relatively performed) based on the location of the avatar 1106a in the three-dimensional environment 1102.

In some embodiments, the reference point determined based on the location of the attention (e.g., gaze 1121) of the user 1126 remains unchanged in response to movement of a respective object located at the reference point. For example, as mentioned above, while the computer system 101a and the second computer system 101b are in a communication session, changes to (e.g., in positions of) the virtual objects 1107a and/or 1109a and the avatar 1106a corresponding to the second user within the three-dimensional environment 1102 and/or changes to the three-dimensional environment 1102 made in response to inputs from the user 1126 of the computer system 101a are reflected in the display of the virtual objects 1107a and/or 1109a and the avatar corresponding to the user 1126 within the three-dimensional environment 1102 and/or the display of the three-dimensional environment 1102 by the second computer system 101b. In FIG. 11E, the computer system 101a receives an indication that the second computer system 101b has detected or is detecting interaction input (e.g., selection input and/or movement input) provided by the second user corresponding to a request to manipulate the portion of the three-dimensional environment 1102 displayed at the second computer system 101b relative to the second viewpoint of the second user. In some embodiments, in response to receiving the indication, the computer system 101a visually deemphasizes the avatar 1106a corresponding to the second user relative to the three-dimensional environment 1102, as shown in FIG. 11E, while the attention (e.g., gaze 1121) of the user 1126 remains directed toward the avatar 1106a. For example, the computer system 101a alters one or more characteristics of lighting, translucency, shading, coloration, and/or clarity of the avatar 1106a in the three-dimensional environment 1102 compared with that of the avatar 1106a before receiving the indication (e.g., in FIG. 11D). In some embodiments, the visual deemphasis of the avatar 1106a indicates that the second user is providing input manipulating the portion of the three-dimensional environment 1102 at the second computer system 101b relative to the second viewpoint of the second user.

In some embodiments, when the second computer system 101b detects an end of the interaction input provided by the second user of the second computer system 101b, the computer system 101a moves the avatar 1106a corresponding to the second user based on the interaction input provided by the second user at the second computer system 101b. For example, as shown in FIG. 11F, the computer system 101a moves the avatar 1106a within the three-dimensional environment 1102 relative to the viewpoint of the user 1126, without moving the virtual objects 1107a and 1109a. As shown, when the second computer system 101b detects an end of the interaction input provided by the second user, the computer system 101a optionally moves the avatar 1106a toward the viewpoint of the user 1126 and displays the avatar 1106a with a third orientation, different from the first and the second orientations discussed above. For example, the front-facing portion of the avatar 1106a is tilted/slightly angled rightward in the three-dimensional environment 1102 relative to the viewpoint of the user 1126, as shown by 1106b in the overhead view of FIG. 11F, to reflect the shift in the second viewpoint of the second user relative to the viewpoint of the user 1126 as a result of the manipulation of the portion of the three-dimensional environment 1102 displayed at the second computer system 101b.

In some embodiments, after the avatar 1106a corresponding to the second user is moved in the three-dimensional environment 1102 due to action by the user at the second computer system 101b as discussed above, the computer system 101a forgoes changing the reference point in the three-dimensional environment 1102 in accordance with the movement of the avatar 1106a. For example, as shown in the overhead view in FIG. 11F, the computer system 101a does not move the reference point to be based on the new location of the avatar 1106a in the three-dimensional environment 1102 when the avatar 1106a moves. The computer system 101a optionally maintains the reference point to be based on the location of the avatar 1106a (e.g., to which the gaze 1121 was directed) prior to receiving the indication that the second user is providing input at the second computer system 101b manipulating the portion of the three-dimensional environment 1102 displayed at the second computer system 101b. Accordingly, interaction input provided by the user 1126 of the computer system 101a optionally causes the computer system 101a to manipulate the three-dimensional environment 1102 relative to the same reference point, rather than the new location of the avatar 1106a in the three-dimensional environment 1102, as described below.

In FIG. 11F, the computer system 101a detects hand 1103d provide movement input directed to the three-dimensional environment 1102. For example, the computer system 101a detects the hand 1103d move in a counterclockwise direction relative to the viewpoint of the user 1126 while the hand 1105b remains in the pinch hand shape. In some embodiments, in response to detecting the movement of the hand 1103d in FIG. 11F, the computer system 101a manipulates the three-dimensional environment 1102 in accordance with the movement. For example, as shown in FIG. 11G, in response to detecting the hand 1103e move in a counterclockwise direction relative to the viewpoint of the user 1126 while the hand 1105b remains in the pinch hand shape, the computer system 101a concurrently repositions (e.g., rotates) the virtual objects 1107a and 1109a and the avatar 1106a in a counterclockwise direction within the three-dimensional environment 1102 relative to the reference point (labeled in the overhead view in FIG. 11G) in accordance with the movement of the hand 1103d (e.g., about an axis selected based on the reference point). As shown, in response to detecting the movement of the hand 1103d, the computer system 101a optionally displays the virtual objects 1107a and 1109a with the first orientations discussed above, and displays the avatar 1106a with a fourth orientation, different from the first, second, and third orientations discussed above. For example, the front-facing surfaces of virtual objects 1107a and 1109a that face the viewpoint of user 1126 are flat/level relative to the viewpoint of the user 1126, as shown by 1107b and 1109b, respectively, in the overhead view of FIG. 11G, and the front-facing portion of the avatar 1106a is angled rightward relative to the viewpoint of the user 1126, as shown by 1106b in the overhead view. Thus, the movement input provided by the user 1126 of the computer system 101a optionally causes the computer system 101a to manipulate the three-dimensional environment 1102 relative to a reference point defined based on the attention (e.g., gaze 1121) of the user 1126, irrespective of whether an object at a location of the reference point moves in the three-dimensional environment 1102 due to user action at the second computer system 101b.

FIGS. 12A-12J is a flowchart illustrating an exemplary method 1200 of facilitating interactions with a plurality of objects relative to a reference point in a three-dimensional environment in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed at a computer system (e.g., 101a) in communication with a display generation component (e.g., 120) and one or more input devices (e.g., 314). In some embodiments, the computer system is or includes an electronic device. In some embodiments, the computer system has one or more of the characteristics of the computer system(s) in methods 800, 1000, and/or 1400. In some embodiments, the display generation component has one or more of the characteristics of the display generation component(s) in methods 800, 1000, and/or 1400. In some embodiments, the one or more input devices have one or more of the characteristics of the one or more input devices in methods 800, 1000, and/or 1400.

In some embodiments, the computer system displays (1202a), via the display generation component, an environment (e.g., three-dimensional environment 1102 in FIG. 11A) from a first viewpoint of a user (e.g., user 1126 in FIG. 11A) of the computer system, the environment including a first object (e.g., virtual object 1107a in FIG. 11A) at a first location and a second object (e.g., virtual object 1109a in FIG. 11A) at a second location, different from the first location. For example, an environment that corresponds to a physical environment surrounding the display generation component and/or the computer system or a virtual environment. In some embodiments, the computer system displays a three-dimensional environment, such as a three-dimensional environment as described with reference to methods 800, 1000, and/or 1400. In some embodiments, the first object and the second object are in a field of view of the three-dimensional environment from the first viewpoint of the user. For example, the first object is located at a first location in the three-dimensional environment, and the second object is located at a second location, different from the first location, in the three-dimensional environment from the first viewpoint of the user. In some embodiments, the first object and/or the second object is or includes content. In some embodiments, the first object and/or the second object has one or more of the characteristics of the objects in methods 800, 1000, and/or 1400. In some embodiments, as discussed in more detail below, the computer system is in a communication session with one or more secondary computer systems. For example, objects within the three-dimensional environment and/or the three-dimensional environment are being displayed by both the computer system and the one or more secondary computer systems, concurrently, but from different viewpoints associated with their respective users. In some embodiments, in the communication session, the user of the computer system has the first viewpoint of the three-dimensional environment, and the one or more users of the one or more secondary computer systems have second viewpoints, different from the first viewpoint, of the three-dimensional environment, as described with reference to methods 800, 1000, and/or 1400. In some embodiments, the computer system and the one or more secondary computer systems are in communication with each other such that the display of the objects within the three-dimensional environment and/or the three-dimensional environment by the computer systems is coordinated. Additionally, the three-dimensional environment optionally includes virtual representations of (e.g., avatars corresponding to) users of the one or more secondary computer systems.

In some embodiments, while displaying the environment including the first object and the second object, the computer system detects (1202b), via the one or more input devices, a first interaction input (e.g., an air gesture or interaction with an input device) (e.g., provided by a predefined portion of the user of the computer system), including movement, such as the movement of hand 1103a as shown in FIG. 11A. For example, movement of the predefined portion of the user or movement of an input device or movement detected by an input device. In some embodiments, the predefined portion of the user is a hand of the user. In some embodiments, the computer system detects an air pinch gesture performed by the hand of the user of the computer system that is detected by the one or more input devices (e.g., a hand tracking device) in communication with the computer system. In some embodiments, the first interaction input has one or more characteristics of the interaction inputs in methods 800, 1000, and/or 1400. In some embodiments, after detecting the air pinch gesture, the computer system detects movement of the hand of the user with a respective magnitude and/or in a respective direction. In some embodiments, the computer system detects the hand of the user move while the hand is in the pinch hand shape. In some embodiments, the computer system detects the first interaction input via an input device (e.g., a controller operable with six degrees of freedom of movement, or a touchpad or mouse) in communication with the computer system. In some embodiments, the input device has one or more characteristics of the input devices in methods 800, 1000, and/or 1400. In some embodiments, the movement of the input device or movement detected by the input device has one or more characteristics of movements of input devices in methods 800, 1000, and/or 1400.

In some embodiments, in response to detecting the first interaction input (1202c), in accordance with a determination that attention (e.g., a gaze) of the user of the computer system is directed to the first object when the first interaction input is detected (1202d), such as gaze 1121 directed toward the virtual object 1109a as shown in FIG. 11A, the computer system performs (1202e) a first operation involving manipulating the environment relative to a first reference point that is based on the first location of the first object in the environment in accordance with the movement, such as movement of the virtual objects 1107a and 1109a relative to the reference point as shown in FIG. 11B (e.g., the first operation has a direction based on a direction of the movement, the first operation has a magnitude based on a magnitude of the movement, and/or the first operation has a speed based on a speed of the movement). For example, the gaze of the user is directed to at least a portion of the first object when the first interaction input is detected. In some embodiments, the computer system detects the attention of the user directed to a selectable option associated with the first object that, when selected, causes the computer system to perform a movement and/or translation and/or rotation operation relative to the first object in the three-dimensional environment while the first interaction input is detected. In some embodiments, the first reference point is at the first location in the three-dimensional environment. In some embodiments, while the gaze remains directed toward the first object in the three-dimensional environment, the first reference point is fixed at the first location in the three-dimensional environment. One or more operations involving the first object and/or the second object are optionally performed with respect to the first reference point in the three-dimensional environment. For example, the first operation includes movement/translation and/or rotation of the first object and/or the second object in the three-dimensional environment. In some embodiments, the first operation is performed relative to the first reference point based on the first location of the first object in the three-dimensional environment. For example, as described in more detail below, the first operation includes movement/translation of the first object closer to or farther from the viewpoint of the user of the computer system, which, relative to the first reference point, includes movement/translation of the viewpoint (e.g., from the first viewpoint to a new viewpoint) of the user of the computer system to a location that is closer to or farther from the first object. In some embodiments, the first operation includes rotation of the viewpoint of the user and/or the second object about an axis through the first reference point and defined by a portion of the first object or by a viewpoint of the user relative to the first object. In some embodiments, a magnitude and/or direction of movement/rotation of the first object and/or the second object in the three-dimensional environment is based on a magnitude and/or direction of movement/rotation of the hand of the user, and/or a relative distance between the first object and the first viewpoint of the user. For example, rotation of the hand of the user in a first (e.g., clockwise) direction with a first magnitude causes the viewpoint of the user and/or the second object in the three-dimensional environment to be rotated in the first direction with the first magnitude to a new viewpoint and/or a new location, respectively, relative to the first object, about the axis defined by the portion of the first object or by the viewpoint of the user. In some embodiments, the first operation has one or more characteristics of the operations in method 800.

In some embodiments, in accordance with a determination that the attention of the user of the computer system is directed to the second object when the first interaction input is detected (12020, such as the gaze 1121 directed toward the avatar 1106a as shown in FIG. 11D, the computer system performs (1202g) a second operation involving manipulating the environment relative to a second reference point, different from the first reference point, that is based on the second location of the second object in the environment in accordance with the movement, such as movement of the virtual objects 1107a and 1109a relative to the reference point as shown in FIG. 11G. For example, the second operation has a direction based on a direction of the movement, the second operation has a magnitude based on a magnitude of the movement, and/or the second operation has a speed based on a speed of the movement. For example, the gaze of the user is directed to at least a portion of the second object when the first interaction input is detected. In some embodiments, the computer system detects the attention of the user directed to a selectable option associated with the second object that, when selected, causes the computer system to perform a movement and/or translation and/or rotation operation relative to the second object in the three-dimensional environment while the second interaction input is detected. In some embodiments, the second reference point is at the second location in the three-dimensional environment. In some embodiments, while the gaze remains directed toward the second object in the three-dimensional environment, the second reference point is fixed at the second location in the three-dimensional environment. One or more operations involving the first object and/or the second object are optionally performed with respect to the second reference point in the three-dimensional environment. In some embodiments, the second operation is the same type of operation as the first operation. For example, the second operation includes movement/translation and/or rotation of the first object and/or the second object in the three-dimensional environment. In some embodiments, the second operation is performed relative to the second reference point based on the second location of the second object in the three-dimensional environment. For example, as described in more detail below, the second operation includes movement/translation of the second object closer to or farther from the viewpoint of the user of the computer system, which, relative to the second reference point, includes movement/translation of the viewpoint (e.g., from the first viewpoint to a new viewpoint) of the user of the computer system to a location that is closer to or farther from the second object. In some embodiments, the second operation includes rotation of the viewpoint of the user and/or the first object about an axis through the second reference point and defined by a portion of the second object or by a viewpoint of the user relative to the second object. In some embodiments, a magnitude and/or direction of movement/rotation of the first object and/or the second object in the three-dimensional environment is based on a magnitude and/or direction of movement/rotation of the hand of the user, and/or a relative distance between the second object and the first viewpoint of the user. For example, rotation of the hand of the user in a first (e.g., clockwise) direction with a first magnitude causes the viewpoint of the user and/or the first object in the three-dimensional environment to be rotated in the first direction with the first magnitude to a new viewpoint and/or a new location, respectively, relative to the second reference point, about the axis defined by the portion of the second object or by the viewpoint of the user. In some embodiments, the second operation has one or more characteristics of the operations in method 800. Performing an operation relative to a reference point based on attention of a user of the computer system reduces the number of inputs needed to reposition objects relative to the reference point in the three-dimensional environment, thereby improving user-device interaction.

In some embodiments, the determination that the attention of the user is directed to the first object when the first interaction input is detected is based on a determination that a gaze of the user is directed to the first object when the first interaction input is detected, such as gaze 1121 directed toward virtual object 1107a as shown in FIG. 11C. For example, the gaze of the user is directed to at least a portion of the first object when the first interaction input is detected. In some embodiments, the determination that the attention of the user is directed to the first object is based on additional or alternative criteria described in more detail above. In some embodiments, the determination that the attention of the user is directed to the second object when the first interaction input is detected is based on a determination that a gaze of the user is directed to the second object when the first interaction input is detected (1204), such as gaze 1121 directed toward virtual object 1109a as shown in FIG. 11A. For example, the gaze of the user is directed to at least a portion of the second object when the first interaction input is detected. In some embodiments, the determination that the attention of the user is directed to the second object is based on additional or alternative criteria described in more detail above. Performing an operation relative to a reference point based on the gaze of a user of the computer system reduces the number of inputs needed to reposition objects relative to the reference point in the three-dimensional environment, thereby improving user-device interaction.

In some embodiments, the user of the computer system is in a communication session with a second user of a second computer system (e.g., computer system 101b) while displaying the environment (1206a) (e.g., the computer system is in a communication session with a second computer system when the first interaction input was received, as described above), as described with reference to FIGS. 11A-11G. In some embodiments, the environment includes a virtual representation of the second user (1206b) (e.g., the three-dimensional environment includes an avatar corresponding to the second user, as described above), such as avatar 1106a in FIG. 11A.

In some embodiments, in response to detecting the first interaction input (1206c), in accordance with the determination that the attention of the user of the computer system is directed to the first object when the first interaction input is detected and that the first object and/or the second object are shared with the second user of the second computer system, as described with reference to FIGS. 11A-11G, performing the first operation includes concurrently repositioning the first object and/or the second object, and the virtual representation of the second user within the environment relative to the first reference point in accordance with the movement (1206d), such as repositioning of the virtual objects 1107a and 1109a and the avatar 1106a relative to the “Reference point” (in the overhead view) as shown in FIG. 11B. For example, if the gaze of the user is directed to the first object when the first interaction input is detected, and if the first object and/or the second object are shared between the computer system and the second computer system (e.g., the contents of the first object and the second object are displayed in the three-dimensional environment with respect to the viewpoint of the second user), the computer system concurrently repositions the first object and/or the second object, and the avatar corresponding to the second user within the three-dimensional environment relative to the location of the first object in the three-dimensional environment in accordance with the first interaction input. In some embodiments, if the first object and the second object are not shared between the computer system and the second computer system, the computer system forgoes concurrently repositioning the first object, the second object, and the avatar corresponding to the second user within the three-dimensional environment. For example, the computer system performs an alternative operation involving the first object (e.g., such as the alternative operations discussed in method 800). In some embodiments, if the first object is shared with the second user of the second computer system, and the second object is not shared, and if the gaze of the user is directed to the first object, the computer system concurrently repositions the first object, the second object, and the virtual representation of the second user within the three-dimensional environment relative to the location of the first object in accordance with the first interaction input. Alternatively, in some embodiments, if the first object is not shared with the second user of the second computer system, and the second object is shared, and if the gaze of the user is directed to the first object, the computer system concurrently repositions the first object, the second object, and the virtual representation of the second user within the three-dimensional environment relative to the location of the first object in accordance with the first interaction input.

In some embodiments, in accordance with the determination that the attention of the user of the computer system is directed to the second object when the first interaction input is detected and that the first object and/or the second object are shared with the second user, performing the second operation includes concurrently repositioning the first object and/or the second object, and the virtual representation of the second user within the environment relative to the second reference point in accordance with the movement (1206e), such as repositioning of the virtual objects 1107a and 1109a and the avatar 1106a relative to the “Reference point” (in the overhead view) as shown in FIG. 11G. For example, if the gaze of the user is directed to the second object when the first interaction input is detected, and if the first object and/or the second object are shared between the computer system and the second computer system, the computer system concurrently repositions the first object and/or the second object, and the avatar corresponding to the second user within the three-dimensional environment relative to the location of the first object in the three-dimensional environment in accordance with the first interaction input. In some embodiments, if the first object and the second object are not shared between the computer system and the second computer system, the computer system forgoes concurrently repositioning the first object, the second object, and the avatar corresponding to the second user within the three-dimensional environment. For example, the computer system performs an alternative operation involving the second object. In some embodiments, if the second object is shared with the second user of the second computer system, and the first object is not shared, and if the gaze of the user is directed to the second object, the computer system concurrently repositions the first object, the second object, and the virtual representation of the second user within the three-dimensional environment relative to the location of the second object in accordance with the first interaction input. Alternatively, in some embodiments, if the second object is not shared with the second user of the second computer system, and the first object is shared, and if the gaze of the user is directed to the second object, the computer system concurrently repositions the first object, the second object, and the virtual representation of the second user within the three-dimensional environment relative to the location of the second object in accordance with the first interaction input. In some embodiments, the movement of the shared objects has one or more characteristics of movement of shared objects in methods 800, 1000, and/or 1400. In some embodiments, input received at the computer system for repositioning the first object, the second object, and/or the virtual representation of the second user within the three-dimensional environment at the second computer system that is analogously received at the second computer system also causes the first object, the second object, and/or the virtual representation of the second user to be repositioned within the three-dimensional environment at the computer system. Repositioning a plurality of objects, including representations of other users, in the three-dimensional environment while in a communication session relative to a reference point that is based on attention of the user of the computer system enables the plurality of objects to be simultaneously repositioned relative to the reference point without displaying additional controls, thereby improving user-device interaction.

In some embodiments, a virtual representation of the user (e.g., similar to avatar 1106a) of the computer system is displayed in an environment at the second computer system (e.g., computer system 101b) (1208a), as described with reference to FIGS. 11A-11G. For example, the second computer system is displaying a three-dimensional environment that includes an avatar corresponding to the user of the computer system. In some embodiments, if the first object and/or the second object are shared between the computer system and the second computer system in the communication session, the three-dimensional environment displayed at the second computer system also includes the first object and/or the second object. In some embodiments, if the first object and/or the second object are not shared, the three-dimensional environment displayed at the second computer system does not include the first object and/or the second object. In some embodiments, the three-dimensional environment displayed at the second computer system includes one or more characteristics of the three-dimensional environment displayed at the computer system.

In some embodiments, when the computer system performs the first operation or the second operation, the virtual representation of the user of the computer system is repositioned in the environment at the second computer system relative to a viewpoint of the second user based on the movement (1208b), such as repositioning of the avatar 1106a as shown in FIG. 11F. For example, when the computer system concurrently repositions the first object and/or the second object, and the avatar corresponding to the second user of the second computer system because the first object and/or the second object are shared between the computer system and the second computer system, the second computer system repositions the avatar corresponding to the user of the computer system within the three-dimensional environment at the second computer system relative to the viewpoint of the second user based on the first operation or the second operation. For example, the second computer system moves the avatar corresponding to the user of the computer system within the three-dimensional environment at the second computer system based on the movement of the first object, the second object, and the avatar corresponding to the user of the computer system without moving the first object and the second object. In some embodiments, if the second computer system concurrently repositions the first object, the second object, and the virtual representation of the user of the computer system within the three-dimensional environment relative to the viewpoint of the second user (e.g., in response to receiving interaction input), the computer system will move the virtual representation of the second user in the three-dimensional environment at the computer system relative to the viewpoint of the user of the computer system without moving the first object and the second object. Repositioning a virtual representation of a second user of a second computer system in a three-dimensional environment displayed at a computer system, while the computer system and the second computer system are in a communication session, based on input detected at the second computer system without moving other objects in the three-dimensional environment maintains spatial truth between the user of the computer system, the second user, and the other objects in the communication session, thereby improving user-device interaction.

In some embodiments, while the first interaction input is being detected, the virtual representation of the user of the computer system is visually deemphasized in the environment at the second computer system (1210), such as visual deemphasis of the avatar 1106a as shown in FIG. 11E. For example, while the computer system detects the hand of the user is associated with the first interaction input, the second computer system visually deemphasizes the avatar corresponding to the user of the computer system in the three-dimensional environment at the second computer system compared to the amount of visual emphasis of the representation of the user when the first interaction input is not being detected. In some embodiments, the second computer system dims, blurs, fades, and/or darkens the virtual representation of the user in the three-dimensional environment at the second computer system relative to the viewpoint of the second user. In some embodiments, the second computer system visually emphasizes the three-dimensional environment surrounding the virtual representation of the user while maintaining display of the virtual representation of the user relative to the viewpoint of the second user. For example, the second computer system increases (e.g., brightens) a lighting characteristic of the three-dimensional environment, reduces translucency of the three-dimensional environment, and/or increases a sharpening characteristic of the three-dimensional environment relative to the viewpoint of the second user. In some embodiments, when the computer system detects an end of the first interaction input, the second computer system ceases visually deemphasizing the virtual representation of the user of the computer system in the three-dimensional environment at the second computer system relative to the viewpoint of the second user. For example, the second computer system redisplays the virtual representation of the user of the computer system in the three-dimensional environment at the second computer system with the visual emphasis with which the virtual representation of the user was displayed before the computer system detected the first interaction input. Visually deemphasizing a virtual representation of a second user of a second computer system in a three-dimensional environment displayed at a computer system, while the computer system and the second computer system are in a communication session, when the second computer system detects input corresponding to a request to reposition a plurality of objects provides feedback that the second computer system is detecting input corresponding to repositioning of the plurality of objects, thereby improving user-device interaction.

In some embodiments, in response to detecting the first interaction input (1212a), in accordance with the determination that the attention of the user of the computer system is directed to the first object when the first interaction input is detected (1212b), such as gaze 1121 directed toward the virtual object 1107a as shown in FIG. 11C, performing the first operation includes repositioning the first object within the environment relative to (e.g., closer to or further from) a viewpoint of the user of the computer system in accordance with the movement (1212c), such as repositioning of the virtual object 1107a relative to the viewpoint of the user 1126 as shown in FIG. 11D. For example, if the attention of the user is directed toward the first object when the first interaction input is detected, and the first interaction input includes movement of the hand of the user (e.g., while holding the input device) toward or away from the user, the computer system moves the first object closer to or further from the viewpoint of the user in the three-dimensional environment relative to the viewpoint of the user in accordance with the first interaction input.

In some embodiments, in accordance with the determination that the attention of the user of the computer system is directed to the second object when the first interaction input is detected (1212d), such as gaze 1121 directed toward the virtual object 1109a as shown in FIG. 11A, the computer system performs the second operation includes repositioning the second object within the environment relative to (e.g., closer to or further from) the viewpoint of the user in accordance with the movement (1212e), such as repositioning of the virtual object 1109a relative to the viewpoint of the user 1126 as shown in FIG. 11D. For example, if the attention of the user is directed toward the second object when the first interaction input is detected, and the first interaction input includes movement of the hand of the user (e.g., while holding the input device) toward or away from the user, the computer system moves the second object closer to or further from the viewpoint of the user in the three-dimensional environment relative to the viewpoint of the user in accordance with the first interaction input. In some embodiments, the movements of the first object and/or the second object has one or more characteristics of the movements of the first object and the second object in methods 800, 1000, and/or 1400. Repositioning an object relative to a viewpoint of a user of the computer system when attention of the user is directed to the object reduces the number of inputs needed to reposition the object relative to the viewpoint of the user in the three-dimensional environment, thereby improving user-device interaction.

In some embodiments, in response to detecting the first interaction input (1214a), in accordance with a determination that the movement includes movement towards the viewpoint of the user (e.g., movement of the hand of the user (e.g., while holding the input device) toward the user), such as movement of the hand 1103b toward the viewpoint of the user 1126 as shown in FIG. 11A, and that the attention of the user of the computer system is directed to the first object when the first interaction input is detected, such as gaze 1121 directed toward virtual object 1107a as shown in FIG. 11C, performing the first operation includes concurrently repositioning the first object and the second object towards the viewpoint of the user within the environment in accordance with the movement (1214b), such as concurrent repositioning of the virtual objects 1107a and 1109a toward the viewpoint of the user 1126 as shown in FIG. 11B. For example, if the attention of the user is directed toward the first object when the first interaction input is detected, the computer system moves the first object and the second object closer to the viewpoint of the user in the three-dimensional environment relative to the viewpoint of the user in accordance with the first interaction input.

In some embodiments, in accordance with a determination that the movement includes movement towards the viewpoint of the user and that the attention of the user of the computer system is directed to the second object when the first interaction input is detected, such as gaze 1121 directed toward virtual object 1109a as shown in FIG. 11A, performing the second operation includes concurrently repositioning the first object and the second object towards the viewpoint of the user within the environment in accordance with the movement (1214c), such as concurrent repositioning of the virtual objects 1107a and 1109a toward the viewpoint of the user 1126 as shown in FIG. 11B. For example, if the attention of the user is directed toward the second object when the first interaction input is detected, the computer system concurrently moves the first object and the second object closer to the viewpoint of the user in the three-dimensional environment relative to the viewpoint of the user in accordance with the first interaction input.

In some embodiments, in accordance with a determination that the movement includes movement away from the viewpoint of the user (e.g., movement of the hand of the user (e.g., while holding the input device) away from the user) and that the attention of the user of the computer system is directed to the first object when the first interaction input is detected, such as gaze 1121 directed toward the virtual object 1107a as shown in FIG. 11C, performing the first operation includes concurrently repositioning the first object and the second object away from the viewpoint of the user within the environment in accordance with the movement (1214d), as described with reference to FIGS. 11A-11B. For example, if the attention of the user is directed toward the first object when the first interaction input is detected, the computer system moves concurrently the first object and the second object farther from the viewpoint of the user in the three-dimensional environment relative to the viewpoint of the user in accordance with the first interaction input.

In some embodiments, in accordance with a determination that the movement includes movement towards the viewpoint of the user and that the attention of the user of the computer system is directed to the second object when the first interaction input is detected, such as gaze 1121 directed toward virtual object 1109a as shown in FIG. 11A, performing the second operation includes concurrently repositioning the first object and the second object away from the viewpoint of the user within the environment in accordance with the movement (1214e), as described with reference to FIGS. 11A-11B. For example, if the attention of the user is directed toward the second object when the first interaction input is detected, the computer system concurrently moves the first object and the second object farther from the viewpoint of the user in the three-dimensional environment relative to the viewpoint of the user in accordance with the first interaction input. In some embodiments, the concurrent movement of the first object and the second object has one or more characteristics of the concurrent movement of the first object and the second object in methods 800, 1000, and/or 1400. Repositioning a plurality of objects relative to a viewpoint of a user of the computer system when attention of the user is directed to one of the objects reduces the number of inputs needed to reposition the plurality of objects relative to the viewpoint of the user in the three-dimensional environment, thereby improving user-device interaction.

In some embodiments, before detecting the first interaction input (1216a), the first location (e.g., of the first object), such as the location of virtual object 1107a, is a first distance from the viewpoint of the user (1216b), as shown in the overhead view in FIG. 11A. In some embodiments, the second location (e.g., of the second object), such as the location of virtual object 1109a, is a second distance, smaller than the first distance, from the viewpoint of the user (1216c), as shown in the overhead view in FIG. 11A. For example, the second object is closer to the viewpoint of the user than the first object in the three-dimensional environment. In some embodiments, the movement (e.g., of the hand of the user (e.g., while holding the input device)) has a first magnitude (1216d) (e.g., in a direction toward the viewpoint of the user), such as the magnitude of movement of the hand 1103a in FIG. 11A.

In some embodiments, in response to detecting the first interaction input (1216e), in accordance with the determination that the attention (e.g., gaze 1121) of the user of the computer system is directed to the first object when the first interaction input is detected (12160, performing the first operation includes moving the first object from the first location to a third location in the environment relative to the viewpoint of the user in accordance with the movement, such as movement of virtual object 1107a as shown in FIG. 11B, wherein the third location is a third distance from the first location (1216g). For example, if the attention of the user is directed toward the first object when the first interaction input is detected, the computer system moves the first object the third distance closer to the viewpoint of the user in the three-dimensional environment relative to the viewpoint of the user in accordance with the first interaction input.

In some embodiments, in accordance with the determination that the attention of the user of the computer system is directed to the second object when the first interaction input is detected (1216h), performing the second operation includes moving the second object from the second location to a fourth location in the environment relative to the viewpoint of the user in accordance with the movement, such as movement of virtual object 1109b as shown in FIG. 11B, wherein the fourth location is a fourth distance, different from (e.g., smaller than or greater than) the third distance, from the second location (1216i), as described with reference to FIGS. 11A-11B. For example, if the attention of the user is directed toward the second object when the first interaction input is detected, the computer system moves the second object the fourth distance closer to the viewpoint of the user in the three-dimensional environment relative to the viewpoint of the user in accordance with the first interaction input. In some embodiments, in response to detecting the movement of the hand of the user with the first magnitude, the first object is moved a greater distance relative to the viewpoint of the user than the second object in the three-dimensional environment. Accordingly, an object is moved a greater distance in response to a given hand movement the further the object is from the viewpoint of the user in the three-dimensional environment. In some embodiments, when the computer system concurrently repositions the first object (e.g., to which the gaze of the user is directed) and other objects displayed with the first object (e.g., avatars and/or application windows) in the three-dimensional environment, the other objects are also moved the greater distance relative to the viewpoint of the user than the second object in the three-dimensional environment. In some embodiments, the movement of objects relative to the movement of the hand of the user is dynamic based on an increasing or decreasing distance between the objects and the viewpoint of the user. For example, if an object is initially displayed relatively close to the viewpoint of the user, in response to detecting input moving the object away from the viewpoint of the user, the computer system moves the object a greater distance relative to the movement of the hand of the user the than the distance the object was moved when the object was displayed relatively close to the viewpoint of the user in the three-dimensional environment. Scaling an amount of movement of an object relative to a viewpoint of a user of the computer system based on a distance of the object from the viewpoint of the user reduces the number of inputs needed to reposition objects that are farther from the viewpoint of the user in the three-dimensional environment, thereby improving user-device interaction.

In some embodiments, in response to detecting the first interaction input (1218a), in accordance with the determination that the attention of the user of the computer system is directed to the first object when the first interaction input is detected (1218b), performing the first operation includes restricting movement of the first object to movement outside of a threshold distance from the viewpoint of the user (1218c), such as the “Threshold Distance” in the overhead view in FIG. 11B. For example, if the attention of the user is directed toward the first object when the first interaction input is detected, the computer system restricts movement of the first object closer than 0.25, 0.5, 0.75, 1, 1.25, 1.5, 2, or 3 m from the viewpoint of the user, irrespective of whether the movement of the hand of the user corresponds to movement of the first object within the threshold distance from the viewpoint of the user. In some embodiments, if the movement of the hand of the user corresponds to movement of the first object within the threshold distance from the viewpoint of the user, the computer system moves the first object within the three-dimensional environment to a location that is the threshold distance from the viewpoint of the user relative to the viewpoint of the user. For example, the computer system ceases movement of the first object once the first object reaches the location that is the threshold distance from the viewpoint of the user. In some embodiments, if other objects are displayed with the first object (e.g., adjacent to and/or behind the first object) in the three-dimensional environment prior to receiving the first interaction input, when the computer system moves the first object and subsequently ceases movement of the first object once the first object reaches the location that is the threshold distance from the viewpoint of the user, the computer system also ceases movement of the other objects displayed with the first object in the three-dimensional environment.

In some embodiments, in accordance with the determination that the attention of the user of the computer system is directed to the second object when the first interaction input is detected (1218d), performing the second operation includes restricting movement of the second object to movement outside of the threshold distance from the viewpoint of the user (1218e), such as the “Threshold Distance” in the overhead view in FIG. 11B. For example, if the attention of the user is directed toward the second object when the first interaction input is detected, the computer system restricts movement of the second object closer than 0.25, 0.5, 0.75, 1, 1.25, 1.5, 2, or 3 m from the viewpoint of the user, irrespective of whether the movement of the hand of the user corresponds to movement of the second object within the threshold distance from the viewpoint of the user. In some embodiments, if the movement of the hand of the user corresponds to movement of the second object within the threshold distance from the viewpoint of the user, the computer system moves the second object within the three-dimensional environment to a location that is the threshold distance from the viewpoint of the user relative to the viewpoint of the user. For example, the computer system ceases movement of the second object once the second object reaches the location that is the threshold distance from the viewpoint of the user. In some embodiments, if other objects are displayed with the second object (e.g., adjacent to and/or behind the second object) in the three-dimensional environment prior to receiving the first interaction input, when the computer system moves the second object and subsequently ceases movement of the second object once the second object reaches the location that is the threshold distance from the viewpoint of the user, the computer system also ceases movement of the other objects displayed with the second object in the three-dimensional environment. Restricting movement of an object in the three-dimensional environment relative to a viewpoint of a user of the computer system within a threshold distance from the viewpoint of the user when attention of the user is directed to the object prevents movement of the object to a location that is behind the viewpoint of the user in the three-dimensional environment, thereby improving user-device interaction.

In some embodiments, in response to detecting the first interaction input (1220a), in accordance with the determination that the attention (e.g., gaze 1121) of the user of the computer system is directed to the first object (e.g., virtual object 1109a in FIG. 11B) when the first interaction input is detected (1220b), performing the first operation includes moving the second object to within a first distance, less than the threshold distance, from the viewpoint of the user in accordance with the movement (1220c), such as movement of virtual object 1107b to within the “Threshold Distance” as shown in the overhead view in FIG. 11C. For example, if the attention of the user is directed toward the first object when the first interaction input is detected, the computer system restricts movement of the first object closer than 0.25, 0.5, 0.75, 1, 1.25, 1.5, 2, or 3 m from the viewpoint of the user, without restricting movement of the second object within the three-dimensional environment. In some embodiments, if the second object is closer to the viewpoint of the user than the first object in the three-dimensional environment, and if the movement of the hand of the user corresponds to movement of the first object within the threshold distance from the viewpoint of the user, the computer system moves the first object within the three-dimensional environment to a location that is the threshold distance from the viewpoint of the user relative to the viewpoint of the user, and moves the second object to a location that is within the threshold distance from the viewpoint of the user. In some embodiments, if the second object is farther from the viewpoint of the user than the first object in the three-dimensional environment, and if the movement of the hand of the user corresponds to movement of the first object within the threshold distance from the viewpoint of the user, the computer system moves the first object within the three-dimensional environment to the location that is the threshold distance from the viewpoint of the user relative to the viewpoint of the user and stops moving the second object at a location that is outside the threshold distance from the viewpoint of the user. Restricting movement of an object in the three-dimensional environment relative to a viewpoint of a user of the computer system to movement outside a threshold distance from the viewpoint of the user when attention of the user is directed to the object prevents movement of the object to a location that is behind the viewpoint of the user in the three-dimensional environment, thereby improving user-device interaction.

In some embodiments, in response to detecting the first interaction input (1222a), in accordance with the determination that the attention of the user of the computer system is directed to the second object when the first interaction input is detected (1222b), performing the second operation includes moving the first object to within a second distance, less than the threshold distance, from the viewpoint of the user in accordance with the movement (1222c), as described with reference to FIGS. 11B-11C. For example, if the attention of the user is directed toward the second object when the first interaction input is detected, the computer system restricts movement of the second object closer than 0.25, 0.5, 0.75, 1, 1.25, 1.5, 2, or 3 m from the viewpoint of the user, without restricting movement of the first object within the three-dimensional environment. In some embodiments, if the first object is closer to the viewpoint of the user than the second object in the three-dimensional environment, and if the movement of the hand of the user corresponds to movement of the second object within the threshold distance from the viewpoint of the user, the computer system moves the second object within the three-dimensional environment to a location that is the threshold distance from the viewpoint of the user relative to the viewpoint of the user, and moves the first object to a location that is within the threshold distance from the viewpoint of the user. In some embodiments, if the first object is farther from the viewpoint of the user than the second object in the three-dimensional environment, and if the movement of the hand of the user corresponds to movement of the second object within the threshold distance from the viewpoint of the user, the computer system moves the second object within the three-dimensional environment to the location that is the threshold distance from the viewpoint of the user relative to the viewpoint of the user and stops moving the first object at a location that is outside the threshold distance from the viewpoint of the user. Allowing movement of one or more first objects in the three-dimensional environment relative to a viewpoint of a user of the computer system to within a threshold distance from the viewpoint of the user when attention of the user is directed to a second object, different from the one or more first objects, facilitates movement of the second within the three-dimensional environment outside of the threshold distance from the viewpoint of the user, thereby improving user-device interaction.

In some embodiments, in response to detecting the first interaction input (1224a), in accordance with the determination that the attention of the user of the computer system is directed to the first object when the first interaction input is detected (1224b), performing the first operation includes rotating the first object within the environment relative to the first reference point in accordance with the movement (1224c), such as rotating the virtual object 1107a relative to the “Reference point” (in the overhead view) as shown in FIG. 11G. For example, if the attention of the user is directed toward the first object when the first interaction input is detected, and the first interaction input includes rotation of the hand of the user (e.g., while holding the input device) in a clockwise or counterclockwise direction, the computer system rotates the first object relative to the location of the first object in the three-dimensional environment in accordance with the first interaction input. In some embodiments, the first object is rotated clockwise or counterclockwise about an axis that passes through a portion of (e.g., a center of) the first object in the three-dimensional environment in accordance with the first interaction input.

In some embodiments, in accordance with the determination that the attention of the user of the computer system is directed to the second object when the first interaction input is detected (1224d), performing the second operation includes rotating the second object within the environment relative to the second reference point in accordance with the movement (1224e), such as rotating the virtual object 1109a relative to the “Reference point” (in the overhead view) as shown in FIG. 11G. For example, if the attention of the user is directed toward the second object when the first interaction input is detected, and the first interaction input includes rotation of the hand of the user (e.g., while holding the input device) in a clockwise or counterclockwise direction, the computer system rotates the second object relative to the location of the second object in the three-dimensional environment in accordance with the first interaction input. In some embodiments, the second object is rotated clockwise or counterclockwise about an axis that passes through a portion of (e.g., a center of) the second object in the three-dimensional environment in accordance with the first interaction input. In some embodiments, the rotation of the first object and/or the second object in the three-dimensional environment has one or more characteristics of the rotation of objects in methods 800, 1000, and/or 1400. Rotating an object relative to a location of the object in the three-dimensional environment when attention of a user of the computer system is directed to the object reduces the number of inputs needed to rotate the object relative to the location of the attention of the user in the three-dimensional environment, thereby improving user-device interaction.

In some embodiments, in response to detecting the first interaction input (1226a), in accordance with the determination that the attention of the user of the computer system is directed to the first object when the first interaction input is detected (1226b), such as gaze 1121 directed toward virtual object 1107a as shown in FIG. 11C, performing the first operation includes concurrently rotating the first object and the second object within the environment relative to the first reference point in accordance with the movement (1226c), such as concurrently rotating the virtual objects 1107a and 1109a relative to the “Reference point” (in the overhead view) as shown in FIG. 11G. For example, if the attention of the user is directed toward the first object when the first interaction input is detected, and the first interaction input includes rotation of the hand of the user (e.g., while holding the input device) in a clockwise or counterclockwise direction, the computer system concurrently rotates the first object and the second object relative to the location of the first object in the three-dimensional environment in accordance with the first interaction input. In some embodiments, the first object and the second object are concurrently rotated clockwise or counterclockwise about an axis that passes through a portion of (e.g., a center of) the first object in the three-dimensional environment in accordance with the first interaction input. For example, the computer system concurrently rotates the first object and the second object clockwise or counterclockwise about a first axis (e.g., a vertical axis) that passes through the portion of the first object in the three-dimensional environment in accordance with the first interaction input. Alternatively, the computer system optionally concurrently rotates the first object and the second object clockwise or counterclockwise about a second axis (e.g., a horizontal axis) that passes through the portion of the first object in the three-dimensional environment in accordance with the first interaction input.

In some embodiments, in accordance with the determination that the attention of the user of the computer system is directed to the second object when the first interaction input is detected (1226d), performing the second operation includes concurrently rotating the first object and the second object within the environment relative to the second reference point in accordance with the movement (1226e), such as concurrently rotating the virtual objects 1107a and 1109a relative to the “Reference point” (in the overhead view) as shown in FIG. 11G. For example, if the attention of the user is directed toward the second object when the first interaction input is detected, and the first interaction input includes rotation of the hand of the user (e.g., while holding the input device) in a clockwise or counterclockwise direction, the computer system concurrently rotates the first object and the second object relative to the location of the second object in the three-dimensional environment in accordance with the first interaction input. In some embodiments, the first object and the second object are concurrently rotated clockwise or counterclockwise about an axis that passes through a portion of (e.g., a center of) the second object in the three-dimensional environment in accordance with the first interaction input. For example, the computer system concurrently rotates the first object and the second object clockwise or counterclockwise about a first axis (e.g., a vertical axis) that passes through the portion of the second object in the three-dimensional environment in accordance with the first interaction input. Alternatively, the computer system optionally concurrently rotates the first object and the second object clockwise or counterclockwise about a second axis (e.g., a horizontal axis) that passes through the portion of the second object in the three-dimensional environment in accordance with the first interaction input. In some embodiments, the concurrent rotation of the first object and the second object in the three-dimensional environment has one or more characteristics of the concurrent rotation of the objects in methods 800, 1000, and/or 1400. Rotating a plurality of objects relative to a location of one of the objects in the three-dimensional environment when attention of a user of the computer system is directed to the object reduces the number of inputs needed to rotate the plurality of objects relative to the location of the attention of the user in the three-dimensional environment, thereby improving user-device interaction.

In some embodiments, in response to detecting the first interaction input (1228a), in accordance with the determination that the attention (e.g., gaze 1121 in FIG. 11C) of the user of the computer system is directed to the first object when the first interaction input is detected (1228b), such as gaze 1121 directed toward virtual object 1107a as shown in FIG. 11C, performing the first operation includes rotating the first object within the environment relative to a viewpoint of the user of the computer system in accordance with the movement (1228c), such as rotation of the virtual object 1107a relative to the viewpoint of the user 1126 as shown in FIG. 11D. For example, if the attention of the user is directed toward the first object when the first interaction input is detected, and the first interaction input includes rotation of the hand of the user (e.g., while holding the input device) in a clockwise or counterclockwise direction, the computer system rotates the first object in the three-dimensional environment relative to the viewpoint of the user of the computer system in accordance with the first interaction input. In some embodiments, the first object is rotated clockwise or counterclockwise about an axis that passes through a location associated with (e.g., the viewpoint of) the user in the three-dimensional environment in accordance with the first interaction input.

In some embodiments, in accordance with the determination that the attention (e.g., gaze 1121 in FIG. 11C) of the user of the computer system is directed to the second object when the first interaction input is detected (1228d), such as gaze 1121 directed toward virtual object 1109a as shown in FIG. 11B, performing the second operation includes rotating the second object within the environment relative to the viewpoint of the user in accordance with the movement (1228e), such as rotating the virtual object 1109a relative to the viewpoint of the user 1126 as shown in FIG. 11D. For example, if the attention of the user is directed toward the second object when the first interaction input is detected, and the first interaction input includes rotation of the hand of the user (e.g., while holding the input device) in a clockwise or counterclockwise direction, the computer system rotates the second object in the three-dimensional environment relative to the viewpoint of the user of the computer system in accordance with the first interaction input. In some embodiments, the second object is rotated clockwise or counterclockwise about an axis that passes through a location associated with (e.g., the viewpoint of) the user in the three-dimensional environment in accordance with the first interaction input. In some embodiments, the rotation of the first object and/or the second object in the three-dimensional environment relative to the viewpoint of the user has one or more characteristics of the rotation of objects in methods 800, 1000, and/or 1400. Rotating an object in the three-dimensional environment relative to a viewpoint of a user of the computer system when attention of the user is directed to the object reduces the number of inputs needed to rotate the object relative to the viewpoint of the user in the three-dimensional environment, thereby improving user-device interaction.

In some embodiments, in response to detecting the first interaction input (1230a), in accordance with the determination that the attention of the user of the computer system is directed to the first object when the first interaction input is detected (1230b), such as gaze 1121 directed toward virtual object 1107a as shown in FIG. 11C, performing the first operation includes concurrently rotating the first object and the second object within the environment relative to the viewpoint of the user in accordance with the movement (1230c), such as concurrently rotating the virtual objects 1107a and 1109a relative to the viewpoint of the user 1126 as shown in FIG. 11D. For example, if the attention of the user is directed toward the first object when the first interaction input is detected, and the first interaction input includes rotation of the hand of the user (e.g., while holding the input device) in a clockwise or counterclockwise direction, the computer system concurrently rotates the first object and the second object within the three-dimensional environment relative to the viewpoint of the user of the computer system in accordance with the first interaction input. In some embodiments, the first object and the second object are concurrently rotated clockwise or counterclockwise about an axis that passes through a location associated with (e.g., the viewpoint of) the user in the three-dimensional environment in accordance with the first interaction input.

In some embodiments, in accordance with the determination that the attention of the user of the computer system is directed to the second object when the first interaction input is detected (1230d), such as gaze 1121 directed toward virtual object 1109a as shown in FIG. 11B, performing the second operation includes concurrently rotating the first object and the second object within the environment relative to the viewpoint of the user in accordance with the movement (1230e), such as concurrently rotating the virtual objects 1107a and 1109a relative to the viewpoint of the user 1126 as shown in FIG. 11D. For example, if the attention of the user is directed toward the first object when the first interaction input is detected, and the first interaction input includes rotation of the hand of the user (e.g., while holding the input device) in a clockwise or counterclockwise direction, the computer system concurrently rotates the first object and the second object within the three-dimensional environment relative to the viewpoint of the user of the computer system in accordance with the first interaction input. In some embodiments, the first object and the second object are concurrently rotated clockwise or counterclockwise about an axis that passes through a location associated with (e.g., the viewpoint of) the user in the three-dimensional environment in accordance with the first interaction input. In some embodiments, the concurrent rotation of the first object and the second object in the three-dimensional environment relative to the viewpoint of the user has one or more characteristics of concurrent rotation of the objects in methods 800, 1000, and/or 1200. Rotating a plurality of objects in the three-dimensional environment relative to a viewpoint of a user of the computer system when attention of the user is directed to one of the objects reduces the number of inputs needed to rotate the plurality of objects relative to the viewpoint of the user in the three-dimensional environment, thereby improving user-device interaction.

In some embodiments, the first interaction input is concurrently associated with (e.g., provided by) a first predefined portion of the user and a second predefined portion of the user (1232a), such as the hands 1103c and 1105a of the user 1126 in FIG. 11C. For example, the computer system detects a first hand of the user and a second hand of the user concurrently provide a pinch gesture (e.g., in which an index finger and thumb of each hand make contact, as described above) and/or engage a first input device and a second input device, respectively (e.g., provide a selection input via a button on each of the first input device and the second input device, as described above).

In some embodiments, the movement includes movement associated with the first predefined portion of the user and movement associated with the second predefined portion of the user (1232b), such as movement (e.g., rotation) of the hands 1103c and 1105a as shown in FIG. 11C. For example, after the computer system detects the first hand of the user and the second hand of the user concurrently provide the pinch gesture and/or engage the first input device and the second input device, respectively, the computer system detects movement of the first hand of the user and the second hand of the user (e.g., in some embodiments, while engaging with the first input device and the second input device), as similarly described above. In some embodiments, the movement of the first hand is detected concurrently with the movement of the second hand. In some embodiments, the movement of the first hand and the movement of the second hand are relative to the viewpoint of the user. In some embodiments, the interaction input and/or the movement of the two hands of the user has one or more characteristics of the two-handed inputs in methods 800, 1000, and/or 1400. Performing an operation relative to a reference point based on attention of a user of the computer system and movement of the hands of the user reduces the number of inputs needed to reposition objects relative to the reference point in the three-dimensional environment, thereby improving user-device interaction.

In some embodiments, while displaying the environment including respective virtual content (e.g., a shared object, such as the first object or the second object, or a virtual representation of a second user of a second computer system), such as avatar 1106a in FIG. 11D, at a third location in the environment, the computer system detects (1234a), via the one or more input devices, a third interaction input (e.g., a pinch gesture and/or a selection input via an input device provided by the hand of the user, as described above) that includes the attention of the user of the computer system directed toward the respective virtual content (1234b) (e.g., the gaze of the user directed toward at least a portion of the avatar corresponding to the second user, the first object, or the second object), such as gaze 1121 directed toward the avatar 1106a as shown in FIG. 11D, and movement of the first predefined portion of the user (1234c) (e.g., movement of the hand of the user while the hand maintains the pinch gesture and/or the selection input on the input device, as described above), such as movement of the hand 1103d as shown in FIG. 11F. In some embodiments, while detecting the third interaction input, the computer system receives (1234d), via the one or more input devices, an indication corresponding to a request to move the respective virtual content within the environment, as described with reference to FIG. 11E. For example, the computer system is in a communication session with a second computer system when the first interaction input was received, as described above. In some embodiments, the second computer system receives input corresponding to repositioning of one or more objects (e.g., the first object and/or the second object) in a three-dimensional environment displayed at the second computer system. In some embodiments, the second user of the second computer system is providing an interaction input concurrently moving the first object and the second object within the three-dimensional environment displayed at the second computer system relative to the viewpoint of the second user and/or moving a single shared object within the three-dimensional environment displayed at the second computer system relative to the viewpoint of the second user.

In some embodiments, in response to receiving the indication, the computer system moves (1234e) the respective virtual content to a fourth location, different from the third location, in the environment, such as movement of the avatar 1106a as shown in FIG. 11F. For example, the computer system moves the shared object or the virtual representation of the second user within the three-dimensional environment relative to the viewpoint of the user of the computer system based on the interaction input received at the second computer system. In some embodiments, if the interaction input corresponds to concurrent movement of the first object and the second object within the three-dimensional environment at the second computer system, the computer system moves the virtual representation of the second user in accordance with the movement and forgoes moving the first object and the second object within the three-dimensional environment relative to the viewpoint of the user. If the interaction input corresponds to movement of a single shared object within the three-dimensional environment at the second computer system, the computer system moves the single shared object within the three-dimensional environment relative to the viewpoint of the user in accordance with the movement.

In some embodiments, in response to detecting the third interaction input (12340, the computer system performs (1234g) a third operation involving manipulating the environment relative to a third reference point, different from the first reference point and the second reference point, that is based on the third location of the respective virtual content in the environment in accordance with the movement, such as rotation of the virtual objects 1107a and 1109a and the avatar 1106a relative to the “Reference point” (in the overhead view) as shown in FIG. 11G. For example, the computer system concurrently repositions the first object, the second object, and the virtual representation of the second user within the three-dimensional environment relative to the third location in accordance with the third interaction input. In some embodiments, because the attention of the user was directed to the respective virtual content at the third location when the third interaction was received, the computer system manipulates the three-dimensional environment relative to the third location despite the respective virtual content moving from the third location to the fourth location in the three-dimensional environment while detecting the third interaction input. Accordingly, the computer system maintains the reference point based on the location of the attention of the user in the three-dimensional environment when the interaction input is received, irrespective of whether the virtual object at that location is moved in the three-dimensional environment due to action of another user in the communication session. Fixing a reference point to a location of a virtual object when the attention of a user of the computer system is directed to the object and irrespective of whether the object is moved in the three-dimensional environment enables objects to be repositioned relative to the same reference point in the three-dimensional environment without displaying additional controls, thereby improving user-device interaction.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

FIGS. 13A-13G illustrate examples of a computer system facilitating manipulation of virtual objects in a virtual environment in accordance with some embodiments.

FIG. 13A illustrates a computer system (e.g., an electronic device) 101a displaying, via a display generation component (e.g., display generation component 120 of FIG. 1), a three-dimensional environment 1301 from a viewpoint of the user 1305a illustrated in the overhead view (e.g., facing the back wall of the physical environment in which computer system 101a is located). In some embodiments, computer system 101a includes a display generation component (e.g., a touch screen 120) and a plurality of image sensors (e.g., image sensors 314 of FIG. 3). The image sensors optionally include one or more of a visible light camera, an infrared camera, a depth sensor, or any other sensor the computer system 101a would be able to use to capture one or more images of a user or a part of the user (e.g., one or more hands of the user) while the user interacts with the computer system 101a. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 13A, computer system 101a captures one or more images of the physical environment around computer system 101a (e.g., operating environment 100), including one or more objects in the physical environment around computer system 101a. In some embodiments, computer system 101a displays representations of the physical environment in three-dimensional environment 1301. For example, three-dimensional environment 1301 includes a representation 1322 of a coffee table, which is optionally a representation of a physical coffee table in the physical environment, and three-dimensional environment 1301 includes a representation 1324 of sofa, which is optionally a representation of a physical sofa in the physical environment.

In FIG. 13A, three-dimensional environment 1301 also includes virtual objects including App A user interface 1302 and App B user interface 1304. App A user interface 1302 and App B user interface 1304 are optionally at different distances from the viewpoint of user 1305a in three-dimensional environment 1301. For example, in FIG. 13A, App A user interface 1302 is located at a first location that is further from the viewpoint of user 1305a than a second location at which App B user interface 1304 is located in three-dimensional environment 1301, as reflected in the overhead view. In some embodiments, App A user interface 1302 and App B user interface 1304 are optionally one or more of user interfaces of applications containing content (e.g., quick look windows displaying photographs), three-dimensional objects (e.g., virtual clocks, virtual balls, and/or virtual cars) or any other element displayed by computer system 101a that is not included in the physical environment of display generation component 120.

In some embodiments, the computer system 101a is in a communication session with a second computer system 101b (shown in the overhead view). For example, App A user interface 1302 and App B user interface 1304 within the three-dimensional environment 1301 are being displayed by both the computer system 101a and the second computer system 101b, concurrently, but from different viewpoints associated with their respective users. In some embodiments, in the communication session, the user 1305a of the computer system 101a has a first viewpoint of the three-dimensional environment 1301, and a second user 1305b of the second computer system 101b has a second viewpoint of the three-dimensional environment 1301. For example, a field of view of the three-dimensional environment 1301 from the first viewpoint of the user 1305a of the computer system 101a, as shown in FIG. 13A, includes a first portion of the three-dimensional environment 1301 (including App A user interface 1302 and App B user interface 1304), and a field of view of the three-dimensional environment 1301 from the second viewpoint of the second user 1305b of the second computer system 101b includes a second portion of the three-dimensional environment 1301 displayed via display generation component of the second computer system 101b. In some embodiments, the second portion of the three-dimensional environment 1301 includes App A user interface 1302 and/or App B user interface 1304, or neither the App A user interface 1302 nor App B user interface 1304. In some embodiments, the computer system 101a and the second computer system 101b are in the same physical environment (e.g., at different locations in the same room of FIG. 13A). In some embodiments, the computer system 101a and the second computer system 101b are located in different physical environments (e.g., different cities, different rooms, different states and/or different countries).

In some embodiments, while the computer system 101a is in the communication session with the second computer system 101b, the three-dimensional environment 1301 includes a virtual representation of the second user 1305b of the second computer system 101b and, optionally, a virtual representation of the second computer system 101b. For example, as shown in FIG. 13A, the three-dimensional environment 1301 includes an avatar corresponding to the second user 1305b of the second computer system 101b. In FIG. 13A, the avatar corresponding to the second user 1305b is optionally displayed at a third location in the three-dimensional environment 1301, as illustrated in the overhead view. In some embodiments, the avatar corresponding to the second user 1305b includes a three-dimensional representation (e.g., rendering) of the second user 1305b. In some embodiments, the avatar corresponding to the second user 1305b includes a representation of the second computer system 101b of which the second user is a user. In some embodiments, the second portion of the three-dimensional environment 1301 from the second viewpoint of the second user 1305b displayed at the second computer system 101b includes a virtual representation of the user 1305a of the computer system 101a.

In some embodiments, virtual objects are displayed in three-dimensional environment 1301 with respective orientations relative to the viewpoint of user 1305a (e.g., prior to receiving one or more input(s) interacting with the virtual objects, which will be described later, in three-dimensional environment 1301). As shown in FIG. 13A, App A user interface 1302, App B user interface 1304 and the avatar corresponding to the second user 1305b of the second computer system 101b have first orientations in three-dimensional environment 1301, as shown via the display generation component 120 and in the top-down view of the three-dimensional environment 1301. It should be understood that the orientations of the virtual objects in FIG. 13A are merely exemplary and that other orientations are possible; for example, the virtual objects are optionally displayed with different orientations in three-dimensional environment 1301.

In some embodiments, App A user interface 1302 and/or App B user interface 1304 are shared between the user 1305a of the computer system 101a and the second user 1305b of the second computer system 101b (e.g., while the computer system 101a and the second computer system 101b are in a communication session). For example, the user interfaces and/or contents (e.g., text, images, video, files, icons, and/or control elements) of App A user interface 1302 and/or App B user interface 1304 are displayed in the first portion and/or the second portion of the three-dimensional environment 1301, such that the user interfaces and/or contents of App A user interface 1302 and/or App B user interface 1304 are accessible by (e.g., viewable by and/or interactable (e.g., selectable or scrollable) by) the user 1305a of the computer system 101a and the second user 1305b of the second computer system 101b. In some embodiments, as described below, when the App A user interface 1302 and App B user interface 1304 are shared between the user 1305a and the second user 1305b, changes in relative positions of the App A user interface 1302 and/or App B user interface 1304 in three-dimensional environment 1301 due to user input received at the computer system 101a are reflected in the second portion of the three-dimensional environment 1301 at the second computer system 101b relative to the second viewpoint of the second user 1305b. In some embodiments, the App A user interface 1302 and/or App B user interface 1304 are not shared between the user 1305a of the computer system 101a and the second user 1305b of the second computer system 101b. For example, the computer system 101a displays the App A user interface 1302 and App B user interface 1304 in three-dimensional environment 1301 and/or provides the user 1305a access to the contents of the App A user interface 1302 and App B user interface 1304, and the second computer system 101b forgoes displaying App A user interface 1302 and/or App B user interface 1304 in the portion of the three-dimensional environment 1301 at the second computer system 101b and/or forgoes providing the second user 1305b access to the contents of the App A user interface 1302 and/or App B user interface 1304. In some embodiments, when the App A user interface 1302 and/or App B user interface 1304 are not shared between the user 1305a and the second user 1305b, changes in relative positions of the App A user interface 1302 and/or App B user interface 1304 in three-dimensional environment 1301 due to user input received at the computer system 101a are not reflected in the second portion of the three-dimensional environment 1301 at the second computer system 101b relative to the second viewpoint of the second user 1305b.

In some embodiments, the computer system 101a and the second computer system 101b are in communication with each other such that the display of the App A user interface 1302 and App B user interface 1304 within the three-dimensional environment 1301 and/or the three-dimensional environment 1301 by the computer systems 101a and 101b is coordinated. For example, as described below, changes to (e.g., in positions of) the App A user interface 1302, App B user interface 1304 and the avatar corresponding to the second user 1305b within the three-dimensional environment 1301 and/or the three-dimensional environment 1301 itself made in response to inputs from the user 1305a of the computer system 101a are reflected in the display of the App A user interface 1302 and/or App B user interface 1304 and the avatar 1305b within the portion of the three-dimensional environment 1301 and/or the three-dimensional environment 1301 by the second computer system 101b. As described above with reference to methods 800, 1000, and 1200, the computer system 101a uses various techniques to manipulate one or more objects displayed in a virtual environment, such as three-dimensional environment 1301. In some embodiments, the computer system 101a manipulates the virtual objects relative to a reference point selected based on a characteristic of the interaction input corresponding to the request to manipulate the objects, such as an object within the environment 1301 to which the attention, optionally including gaze, of the user is directed while the interaction input is being detected. As will be described below with reference to FIGS. 13A-13G, in some embodiments, the computer system manipulates the objects relative to a reference point associated with a plurality of objects in response to detecting an interaction input while the attention, including gaze, of the user is directed to a location in the three-dimensional environment 1301 that is not coincident with one of the virtual objects.

In FIG. 13A, the computer system displays the App A user interface 1302, App B user interface 1304, representation 1305b of the user of the second computer system 101b, representation 1322 of a coffee table, and representation 1324 of a sofa in the three-dimensional environment 1301 as described above. In some embodiments, the environment 1301 further includes App C user interface 1306 that is currently outside of the field of view of the display generation component 120 and thus not displayed via the display generation component 120. In some embodiments, the App A user interface 1302, App B user interface 1304, and App C user interface 1306 are shared with the second computer system 101b, so the second computer system 101b displays one or more of the App A user interface 1302, App B user interface 1304, and/or App C user interface 1306 in a portion of the three-dimensional environment 1301 displayed at the second computer system 101b if and when one or more of these elements are in the field of view of the display generation component of the second computer system 101b.

In some embodiments, the second computer system 101b and/or the display generation component of the second computer system 101b are located in a different room from the room in which the computer system 101a and display generation component 120 are located, so the second computer system 101b forgoes display of the representation 1322 of the coffee table and the representation 1324 of the sofa. In some embodiments, the second computer system 101b displays representations of one or more real objects in the physical environment of the second computer system 101b and/or the display generation component of the second computer system 101b.

In FIG. 13A, the computer system 101a detects an interaction input provided via hands 1303a and 1303b of the user 1305a while the attention of the user, optionally including gaze 1307a or 1307b, is directed to a location in the three-dimensional environment 1301 that does not include one of the virtual objects. In some embodiments, the interaction input is an air gesture as described above. In some embodiments, detecting the interaction input includes detecting the user make a pinch hand shape with hands 1303a and 1303b and move hands 1303a and 1303b while maintaining the pinch hand shape. In some embodiments, in response to the interaction input illustrated in FIG. 13A, the computer system 101a manipulates the virtual objects, including App A user interface 1302, App B user interface 1304, App C user interface 1306, and the representation of the second user 1305b of the second computer system 101b in accordance with the movement of hands 1303a and 1303b, as shown in FIG. 13B.

Referring to FIG. 13A, because attention of the user, including gaze 1307a or 1307b, is directed to a portion of the three-dimensional environment 1301 that does not include one of the virtual objects, the computer system 101a performs the manipulation of the objects in response to the input with respect to a reference point 1310 that is positioned in the three-dimensional environment 1301 at a distance from the viewpoint of the user 1305a that is the average of the distances between the viewpoint of the user 1305a and each of the virtual objects in the field of view of the display generation component 120. For example, reference point 1310 in FIG. 13A is positioned at an average of the distance between the viewpoint of the user 1305a and each of the representation of the second user 1305b, the app A user interface 1302, and the App B user interface 1304 because these objects are in the field of view of the display generation component 120 (e.g., displayed via the display generation component 120). In some embodiments, the position of reference point 1310 is independent of the location of one or more virtual objects outside of the field of view of the display generation component 120, such as App C user interface 1306 in FIG. 13A.

In some embodiments, reference point 1310 is positioned in the three-dimensional environment 1301 at the position illustrated in FIG. 13A irrespective of whether the user pays attention to gaze point 1307a or whether the user pays attention to gaze point 1307b while providing the interaction input with hands 1303a and 1303b. In some embodiments, the amount of translation of the virtual objects is based on the distance between reference point 1310 and the viewpoint of the user 1305a in the three-dimensional environment 1301 and the amount of (e.g., speed, distance, or duration of) movement of hands 1303a and 1303b. In some embodiments, the amount of translation performed in response to the input illustrated in FIG. 13A is the same regardless of whether the user pays attention to gaze point 1307a or gaze point 1307b while providing the interaction input with hands 1303a and 1303b.

As described above with reference to method 1000, if instead of paying attention to a portion of the three-dimensional environment 1301 that does not include a virtual object, the user pays attention to one of the virtual objects, the computer system 101a uses a location associated with the virtual object to which the user pays attention as the reference point for performing translation or rotation in response to an interaction input, irrespective of the locations of the other virtual objects in the three-dimensional environment 1301. In some embodiments, the reference point is a representative location of the object, such as the center of the virtual object to which the user 1305a is paying attention while providing the interaction input. In some embodiments, the computer system 101a uses the representative location of the object to which the user 1305a pays attention while providing the interaction input as the reference point for the locomotion operation irrespective of a portion of the virtual object to which the user pays attention. For example, regardless of whether the user pays attention to a left or right side of the App B user interface 1304a while providing the interaction input, the computer system 101a uses the center of the App B user interface 1304a as the reference point for performing locomotion in response to the interaction input.

As another example, if, instead of directing their attention to one of gaze points 1307a or 1307b, the user of the computer system 101a directs their attention to the representation of the second user 1305b while providing the interaction input in FIG. 13A with hands 1303a and 1303b, the computer system 101a would use a reference point associated with the location of the representation of the second user 1305b to perform the translation input. As another example, if, instead of directing their attention to one of gaze points 1307a or 1307b, the user of the computer system 101a directs their attention to the App A user interface 1302 while providing the interaction input in FIG. 13A with hands 1303a and 1303b, the computer system 101a would use a reference point associated with the location of the App A user interface 1302 to perform the translation input. In some embodiments, because the representation 1305b of the second user is closer to the viewpoint of user 1305a than the app A user interface 1302 is to the viewpoint of the user 1305a, the computer system 101a would perform less translation in response to the input illustrated in FIG. 13A if the attention of the user 1305a was directed to the representation of the second user 1305b while providing the input than would be the case if attention of the user 1305a was directed to the App A user interface 1302 while providing the input. In some embodiments, because the representation 1305b of the second user is closer to the viewpoint of user 1305a than the app A user interface 1302 is to the viewpoint of the user 1305a, the computer system 101a would perform more translation in response to the input illustrated in FIG. 13A if the attention of the user 1305a was directed to the representation of the second user 1305b while providing the input than would be the case if attention of the user 1305a was directed to the App A user interface 1302 while providing the input.

FIG. 13B illustrates the computer system 101a presenting the three-dimensional environment 1301 in response to the input illustrated in FIG. 13A. In some embodiments, in response to the input illustrated in FIG. 13A, the computer system 101a translates the App A user interface 1302, the App B user interface 1304, the App C user interface 1306, and the representation of the second user 1305b with respect to the viewpoint of the user 1305a and/or representations 1322 and/or 1324 in accordance with the movement of the hands 1303a and 1303b in FIG. 13A. For example, the virtual objects are translated to the left from the viewpoint of the user 1305a because the hands 1303a and 1303b move to the left relative to the viewpoint of the user 1305a in FIG. 13A. In some embodiments, the amount of translation depends on the amount of (e.g., speed, distance, and/or duration of) movement of the hands 1303a and 1303b in FIG. 13A and the location of reference point 1310 in FIG. 13A. In some embodiments, although reference point 1310 is based on the locations of App A user interface 1302, the App B user interface 1304, and the representation of the second user 1305b without being based on the location of App C user interface 1306, in response to the input in FIG. 13A, the computer system 101a manipulates the app C user interface 1306 in addition to App A user interface 1302, the App B user interface 1304, and the representation of the second user 1305b.

In some embodiments, while the computer system 101a detects the input illustrated in FIG. 13A and for a predetermined threshold time after detecting the input, the second computer system 101b displays a representation of the user 1305a with visual de-emphasis relative to the rest of the three-dimensional environment 1301 from the viewpoint of the second user 1305b, as described above with reference to method 800. The description of method 800 includes example techniques of visual de-emphasis and example threshold times for which the visual de-emphasis is applied after detecting the end of the input. In some embodiments, after the threshold time has passed since the computer system 101a detects the input illustrated in FIG. 13A, the second computer system 101b displays the representation of the user 1305a at an updated location in accordance with the input illustrated in FIG. 13A without updating the positions of App A user interface 1302, the App B user interface 1304, or the App C user interface 1306 to reflect the updated spatial relationship between the viewpoint of the user 1305a and App A user interface 1302, the App B user interface 1304, the App C user interface 1306, and the representation of the second user 1305b. For example, because the App A user interface 1302, the App B user interface 1304, the App C user interface 1306, and the representation of the second user 1305b shift to the left from the viewpoint of user 1305a, the second computer system 101b shifts the representation of the user 1305a to the right.

In FIG. 13B, the computer system 101a detects the user perform an interaction input with hands 1303a and 1303b while the attention of the user is directed to one of gaze point 1307c or gaze point 1307d. As shown in FIG. 13B, gaze points 1307c and 1307d each correspond to locations in the three-dimensional environment 1301 that do not include virtual objects. Thus, in some embodiments, irrespective of whether the attention of the user 1305a is directed to gaze point 1307c or gaze point 1307d while providing the interaction input in FIG. 13B, the computer system performs locomotion with reference to reference point 1310 in response to the interaction input in FIG. 13B, as described in more detail below with reference to FIG. 13C. In some embodiments, the movement of hands 1303a and 1303b in FIG. 13B correspond to counterclockwise rotation, so, in response to the interaction input in FIG. 13B, the computer system 101a rotates App A user interface 1302, the App B user interface 1304, the App C user interface 1306, and the representation of the second user 1305b counterclockwise around reference point 1310 relative to the viewpoint of the user 1305a, as shown in FIG. 13C.

FIG. 13C illustrates the computer system 101a displaying the three-dimensional environment 1301 updated in response to the input illustrated in FIG. 13B. As described above, the computer system 101a rotates App A user interface 1302, the App B user interface 1304, the App C user interface 1306, and the representation of the second user 1305b counterclockwise around reference point 1310 in FIG. 13B relative to the viewpoint of the user 1305a. In some embodiments, while the computer system 101a detects the input illustrated in FIG. 13B, the second computer system 101b displays the representation of the user 1305a with visual de-emphasis relative to the rest of the three-dimensional environment 1301, as described above. In some embodiments, in response to detecting the threshold time pass after the computer system 101a receives the input in FIG. 13B, the second computer system 101b updates the location of the representation of the user 1305a in accordance with the input in FIG. 13B, as described above.

In some embodiments, the computer system 101a detects a second interaction input as shown in FIG. 13C that includes movement of hand 1303a while hand 1303a maintains the pinch hand shape while hand 1303b maintains the pinch hand shape without moving above a threshold amount (e.g., of speed, distance, or duration). For example, the threshold amount of speed is 0.01, 0.05, 0.1, 0.5, 1, 2, or 3 meters per second. As another example, the threshold amount of distance is 0.5, 1, 2, 3, or 5 centimeters. As another example, the threshold duration is 0.01, 0.05, 0.1, 0.5, 1, or 2 seconds. In some embodiments, hand 1303b maintains the pinch hand shape from FIG. 13B while providing the second interaction input in FIG. 13C. In some embodiments, hand 1303a unpinches from the pinch hand shape in FIG. 13B, then moves into the pinch hand shape, then moves as shown in FIG. 13C while maintaining the pinch hand shape. Thus, in some embodiments, the interaction input includes multiple pinch air gestures of at least one hand 1303a or 1303b in a manner similar to the manner described above with reference to method 800.

As shown in FIG. 13C, while the computer system 101a detects the movement of hand 1303a illustrated in FIG. 13C, the computer system 101a detects the attention of the user directed to gaze point 1307f or gaze point 1307e, which are different from the locations of gaze point 1307c and gaze point 1307d, one of which the user paid attention to while the computer system 101a detected the interaction input in FIG. 13B. In some embodiments, the computer system 101a updates the reference point 1310, as shown in FIG. 13C in response to detecting the hand 1303a move out of the pinch hand shape after the movement shown in FIG. 13B. In some embodiments, the computer system 101a updates the reference point 1310, as shown in FIG. 13C in response to detecting the hand 1303a move into the pinch hand shape in FIG. 13C. For example, reference point 1310 in FIG. 13C is based on the locations of the App A user interface 1302, the App B user interface 1304, and the representation of the second user 1305b shown in FIG. 13C because these are the locations of these objects while hand 1303a unpinches after the movement in FIG. 13B or while hand 1303a pinches before the movement in FIG. 13C.

In some embodiments, updating the reference point 1310 location in response to the hand 1303a pinch or unpinch as described above includes updating the reference point 1310 in accordance with a location in the three-dimensional environment 1301 to which the user is paying attention while the computer system 101a detects the hand pinch or unpinch, respectively. Because gaze points 1307e and 1307f are both at locations in the three-dimensional environment 1301 that do not include virtual objects, the computer system 101a will use the reference point 1310 illustrated in FIG. 13C irrespective of the location of the user's attention, optionally including gaze 1307e or 1307f. For example, reference point 1310 is based on locations of the App A user interface 1302, the App B user interface 1304, and the representation of the second user 1305b independent of whether the attention of the user is directed to gaze point 1307e or gaze point 1307f, as described above with reference to FIGS. 13A-13B. In some embodiments, if the user 1305a were to direct their attention to one of the virtual objects while unpinching hand 1303a, the computer system 101a would use a location associated with the virtual object to which the user was paying attention while unpinching hand 1303a as the reference point for locomotion, as described above, in response to subsequent movement of hand 1303a once hand 1303a makes the pinch hand shape again. In some embodiments, if the user 1305a were to direct their attention to one of the virtual objects while pinching hand 1303a after unpinching the hand 1303a, the computer system 101a would use a location associated with the virtual object to which the user was paying attention while pinching hand 1303a as the reference point for locomotion, as described above, in response to subsequent movement of hand 1303a while hand 1303a maintains the pinch hand shape again. In some embodiments, hand 1303b maintains the pinch hand shape while hand 1303a unpinches and makes the pinch hand shape again.

In some embodiments, while the computer system 101a detects the input illustrated in FIG. 13C, the second computer system 101b displays the representation of the user 1305a with visual de-emphasis relative to the rest of the three-dimensional environment 1301, as described above. In some embodiments, the second computer system 101b continuously displays the representation of the user 1305a with visual de-emphasis relative to the rest of the three-dimensional environment 1301, as described above, while the computer system 101a detects the inputs illustrated in FIG. 13B-13C. In some embodiments, the second computer system 101b displays the representation of the user 1305a with a reduced amount of visual de-emphasis or without visual de-emphasis between the computer system 101a detecting the end of the input illustrated in FIG. 13B (e.g., when hand 1303a unpinches) and the computer system 101a detecting the beginning of the input illustrates in FIG. 13C (e.g., when hand 1303a makes the pinch hand shape after unpinching).

In some embodiments, in response to detecting the threshold time pass after the computer system 101a receives the input in FIG. 13C, the second computer system 101b updates the location of the representation of the user 1305a in accordance with the input in FIG. 13C, as described above. In some embodiments, the second computer system 101b forgoes updating the position of the representation of the user 1305a between the computer system 101a detecting the end of the input illustrated in FIG. 13B (e.g., when hand 1303a unpinches) and the computer system 101a detecting the beginning of the input illustrates in FIG. 13C (e.g., when hand 1303a makes the pinch hand shape after unpinching). In some embodiments, the second computer system 101b updates the position of the representation of the user 1305a in accordance with the input illustrated in FIG. 13B in response to the computer system 101a detecting the end of the input illustrated in FIG. 13B (e.g., when hand 1303a unpinches) or in response to the threshold time described above passing after the computer system 101a detects the end of the input illustrated in FIG. 13B or in response to detecting the beginning of the input illustrates in FIG. 13C (e.g., when hand 1303a makes the pinch hand shape after unpinching). For example, the second computer system 101b updates the position of the representation of the user 1305a relative to the viewpoint of the second user 1305b again in response to the computer system 101a detecting the threshold time described above pass after the end of the input illustrated in FIG. 13C.

In some embodiments, the computer system 101a rotates the App A user interface 1302, the App B user interface 1304, the App C user interface 1306, and the representation of the second user 1305b clockwise around reference point 1310 in FIG. 13C relative to the viewpoint of the user 1305a in response to the interaction input illustrated in FIG. 13C, as shown in FIG. 13D. FIG. 13D illustrates an example of the computer system 101a displaying the three-dimensional environment 1301 updated in response to the input illustrated in FIG. 13C. In some embodiments, after the computer system 101a updates the three-dimensional environment 1301 as shown in FIG. 13D, the computer system 101a detects the user 1305a cease to provide an interaction input. For example, the user 1305a unpinches hand(s) 1303a and/or 1303b and/or lowers hand(s) 1303a and/or 1303b to the lap and/or sides of the body of the user 1305a.

Thus, FIGS. 13A-13D illustrate various examples of the computer system 101a manipulating virtual objects with respect to a reference point based on the location(s) of the one or more virtual objects in the field of view of the display generation component 120 in response to detecting an interaction input while the attention of the user 1305a is directed to a location in the three-dimensional environment 1301 that does not include a virtual object. FIGS. 13E-13G illustrate examples of the computer system 101a manipulating the virtual objects in response to detecting an interaction input while there are no virtual objects in the field of view of the display generation component 120 when the interaction input is detected.

In FIG. 13E, the computer system 101a detects the user provide an interaction input including movement of hands 1303a and 1303b while the hands 1303a and 1303b are in the pinch hand shape and while the attention, optionally including gaze 1307g, of the user 1305a is directed to the three-dimensional environment 1301 while the three-dimensional environment 1301 does not include virtual objects in the field of view of the display generation component 120. Thus, in FIG. 13E, the computer system 101a detects the interaction input while the attention, optionally including gaze 1307g, of the user is directed to a portion of the three-dimensional environment 1301 that does not include a virtual object and while the display generation component 120 does not display any virtual objects. In FIG. 13E, the three-dimensional environment 1301 includes App A user interface 1302 and App C user interface 1306, but these virtual objects are outside of the field of view of the display generation component 120. For example, the computer system 101a would display the App A user interface 1302 and/or the App C user interface 1306 in response to detecting an update of the viewpoint of the user 1305a (e.g., movement of the user, computer system 101a and/or display generation component 120) that orients the viewpoint such that the App A user interface 1302 and/or the App C user interface 1306 are within the field of view of the display generation component 120. As another example, the computer system 101a would display the App A user interface 1302 and/or the App C user interface 1306 in response to detecting an input corresponding to a request to reposition the App A user interface 1302 and/or the App C user interface 1306 within the field of view of the display generation component 120 with automatic positions and orientations and/or in accordance with movement of hand 1303a and/or 1303b while providing the input, such as the input illustrated in FIG. 13E.

In some embodiments, in response to detecting the interaction input in FIG. 13E while there are no virtual objects in the field of view of the display generation component 120, the computer system 101a displays virtual grid 1312 and repositions the App A user interface 1302 and the App C user interface 1306 in accordance with movement of hands 1303a and 1303b. In some embodiments, the computer system 101a displays the virtual grid 1312 until the threshold time described above has passed since detecting the end of the interaction input in FIG. 13E, or the end of another interaction input corresponding to a request to manipulate the objects. In some embodiments, the computer system displays the virtual grid 1312 until one or more of the App A user interface 1302 and/or the App C user interface 1306 are in the field of view of the display generation component 120. In some embodiments, the computer system 101a repositions the virtual grid 1312 in accordance with movement of hand(s) 1303a and/or 1303b while the computer system 101a detects the interaction input.

As shown in FIG. 13E, the movement of hands 1303a and 1303b includes movement corresponding to translating the virtual objects in a direction towards the coffee table 1322 and sofa 1324 and movement corresponding to rotating the virtual objects clockwise relative to the viewpoint of the user 1305a. In some embodiments, the computer system 101a performs translation, but not rotation, of the virtual objects in the three-dimensional environment 1301 relative to the viewpoint of the user 1305a in response to an interaction input received while there are no virtual objects in the field of view of the display generation component 120, as shown in FIG. 13F. In some embodiments, the computer system 101a performs rotation, but not translation, of the virtual objects in the three-dimensional environment 1301 in response to an interaction input received while there are no virtual objects in the field of view of the display generation component 120, as shown in FIG. 13G. In some embodiments, in response to an interaction input, such as the interaction input illustrated in FIG. 13E, that includes movement of hands 1303a and 1303b in a movement pattern that includes movement corresponding to translation of the virtual objects and movement corresponding to rotation of the virtual objects while there are no virtual objects in the field of view of the display generation component 120, the computer system 101a performs one of translation or rotation of the App A user interface 1302 and the App C user interface 1306, but not both translation and rotation. In some embodiments, the manipulation of the App A user interface 1302 and the App C user interface 1306 is relative to a reference point with a default distance and/or location relative to the viewpoint of the user 1305a in the three-dimensional environment 1301 in response to an interaction input received while there are no virtual objects in the field of view of display generation component 120.

FIG. 13F illustrates an example of the computer system 101a displaying the three-dimensional environment 1301 updated in response to the input illustrated in FIG. 13E. In FIG. 13F, the computer system 101a displays the three-dimensional environment 1301 with App C user interface 1306 and App A user interface 1302 translated in accordance with a portion of the movement of hands 1303a and 1303b in FIG. 13E that corresponds to translation without performing rotation corresponding to the portion of the movement of hands 1303a and 1303b in FIG. 13E that corresponds to rotation. As shown in FIG. 13F, updating the three-dimensional environment 1301 includes displaying App C user interface 1306 and App A user interface 1302 in the field of view of display generation component 120. In some embodiments, the amount and direction of translation in FIG. 13F corresponds to the amount and direction of the portion of the movement of hands 1303a and 1303b in FIG. 13E that corresponds to translation.

FIG. 13G illustrates an example of the computer system 101a displaying the three-dimensional environment 1301 updated relative to the viewpoint of the user 1305a in response to the input illustrated in FIG. 13E. In FIG. 13G, the computer system 101a displays the three-dimensional environment 1301 with App C user interface 1306 and App A user interface 1302 rotated in accordance with a portion of the movement of hands 1303a and 1303b in FIG. 13E that corresponds to rotation without performing translation corresponding to the portion of the movement of hands 1303a and 1303b in FIG. 13E that corresponds to translation. As shown in FIG. 13G, updating the three-dimensional environment 1301 relative to the viewpoint of the user 1305a includes displaying App C user interface 1306 in the field of view of display generation component 120. In some embodiments, the amount and direction of rotation in FIG. 13G corresponds to the amount and direction of the portion of the movement of hands 1303a and 1303b in FIG. 13E that corresponds to rotation.

In some embodiments, in response to the input illustrated in FIG. 13E, the computer system performs both rotation and translation corresponding to the movement of hands 1303a and 1303b in FIG. 13E. Although the examples illustrated in FIGS. 13E-13G do not include the computer system 101a in a communication session with a second computer system, it should be understood that these examples optionally occur while the computer system 101a is in a communication session with the second computer system, and would include manipulating the representation of the user of the second computer system. In some embodiments, if the examples in FIGS. 13E-13G occurred while the computer system 101a was in a communication session with a second computer system, the second computer system would modify display of the avatar of the user 1305a, including de-emphasizing the avatar and updating the avatar's position, in a manner similar to the manners described above with reference to FIGS. 13A-13D and method 800.

FIGS. 14A-14K is a flowchart illustrating a method 1400 of facilitating manipulation of virtual objects in a virtual environment in accordance with some embodiments. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, such as in FIG. 13A, method 1400 is performed at a computer system (e.g., 101a) in communication with a display generation component (e.g., 120) and one or more input devices (e.g., 314). In some embodiments, the computer system is or includes an electronic device. In some embodiments, the computer system has one or more of the characteristics of the computer system(s) in methods 800, 1000, and/or 1200. In some embodiments, the display generation component has one or more of the characteristics of the display generation component(s) in methods 800, 1000, and/or 1200. In some embodiments, the one or more input devices have one or more of the characteristics of the one or more input devices in methods 800, 1000, and/or 1200.

In some embodiments, such as in FIG. 13A, the computer system (e.g., 101a) displays (1402a), via the display generation component (e.g., 120), a first virtual object (e.g., 1302) and a second virtual object (e.g., 1304) in an environment (e.g., 1301). In some embodiments, the environment corresponds to a physical environment surrounding the display generation component and/or the computer system or a virtual environment. In some embodiments, the computer system displays a three-dimensional environment, such as a three-dimensional environment as described with reference to methods 800, 1000, and/or 1200. In some embodiments, the first virtual object is located at a first location in the three-dimensional environment, and the second virtual object is located at a second location, different from the first location, in the three-dimensional environment. In some embodiments, the first virtual object and/or the second virtual object is and/or includes content (e.g., one or more images, video content, and/or audio content). In some embodiments, the first virtual object and/or the second virtual object has one or more of the characteristics of the objects in methods 800, 1000, and/or 1200. In some embodiments, as discussed in more detail below, the computer system is in a communication session with one or more secondary computer systems. For example, objects within the three-dimensional environment and/or the three-dimensional environment are being displayed by both the computer system and the one or more secondary computer systems, concurrently, but from different viewpoints associated with their respective users. In some embodiments, in the communication session, the user of the computer system has a first viewpoint of the three-dimensional environment, and the one or more users of the one or more secondary computer systems have second viewpoints, different from the first viewpoint, of the three-dimensional environment, as described with reference to methods 800, 1000, and/or 1200. In some embodiments, the first and second virtual objects are within a field of view of the display generation component from which the environment is visible. In some embodiments, the computer system and the one or more secondary computer systems are in the same physical environment (e.g., at different locations in the same room). In some embodiments, the computer system and the one or more secondary computer systems are located in different physical environments (e.g., different cities, different rooms, different states and/or different countries). In some embodiments, the computer system and the one or more secondary computer systems are in communication with each other such that the display of the objects within the three-dimensional environment and/or the three-dimensional environment by the computer systems is coordinated (e.g., changes to the objects within the three-dimensional environment and/or the three-dimensional environment made in response to inputs from the user of the computer system are reflected in the display of the objects within the three-dimensional environment and/or the three-dimensional environment by the one or more secondary computer systems). Additionally, the three-dimensional environment optionally includes virtual representations of (e.g., avatars corresponding to) users of the one or more secondary computer systems.

In some embodiments, such as in FIG. 13A, while displaying the first virtual object (e.g., 1302) and the second virtual object (e.g., 1304) in the environment (1402b), the computer system (e.g., 101a) detects (1402c), via the one or more input devices (e.g., 314), an interaction input that corresponds to a request to perform a respective type of manipulation (e.g., an object move operation, an object rotate operation, and/or an object resize operation) in the environment (e.g., 1301) (e.g., an input including detecting movement of a predefined portion (e.g., one or more hands, one or more arms, and/or a head) of a user of the computer system) and detects attention (e.g., gaze 1307) of the user directed to a respective location in the environment (e.g., 1301). In some embodiments, the one or more input devices (e.g., a hand tracking device and/or a head tracking device and/or a hardware input device, such as a mouse, trackpad, touchscreen, and/or keyboard) detect movement of the predefined portion of the user. In some embodiments, the one or more input devices (e.g., an eye tracking device) detect the location in the environment to which the user's attention is directed. In some embodiments, detecting the interaction input includes detecting the attention of the user directed to a location in the environment that does not include a virtual object (e.g., the first virtual object, the second virtual object, or another virtual object displayed via the display generation component in the environment). In some embodiments, detecting the interaction input includes detecting one or more movement patterns of a predefined portion of the user according to one or more steps of methods 800, 1000, and/or 1200 described above.

In some embodiments, while displaying the first virtual object (e.g., 1302) and the second virtual object (e.g., 1304) in the environment (1402b), such as in FIG. 13A, in response to detecting the interaction input, in accordance with a determination that the respective location is empty of virtual objects that can be manipulated with the respective type of manipulation (1402d), in accordance with a determination that the first virtual object (e.g., 1302) and second virtual object (e.g., 1304) have a first spatial arrangement relative to a viewpoint of the user (e.g., 1305a) in the environment (e.g., 1301) (e.g., an average of a distance between the first location and a viewpoint of the user in the environment and a distance between the second location and the viewpoint of the user is a first average) (1402e), such as in FIG. 13A, the computer system (e.g., 101a) manipulates (14020 the first virtual object (e.g., 1302) and the second virtual object (e.g., 1304) with the respective type of manipulation relative to a first reference (e.g., 1310) (e.g., a first reference location and/or a first reference point) in the environment (e.g., 1301), such as in FIG. 13B. In some embodiments, the respective location is at least a threshold distance away from any and/or all virtual objects that can be manipulated with the respective type of manipulation. In some embodiments, the respective location is different from a location of the first virtual object and a location of the second virtual object and different from locations associated with other user-manipulable objects in the environment. In some embodiments, the respective location is empty of virtual objects that can be manipulated with the respective type of manipulation when there are no virtual objects displayed at the respective location, even if there is a representation of a physical object at the respective location. For example, the environment includes representations of real objects in the physical environment of the computer system and/or the display generation component, such as representations displayed via the display generation component (e.g., virtual or video passthrough) and/or views of the physical objects through a transparent portion of the display generation component (e.g., true or real passthrough). In some embodiments, the respective location is empty of virtual objects that can be manipulated with the respective type of manipulation when the respective location includes one or more virtual objects that cannot be manipulated with the respective type of manipulation, such as user interface elements that are body-locked and/or world-locked, as described in more detail above.

In some embodiments, the respective location is empty of virtual objects that can be manipulated with the respective type of manipulation when there are no virtual and/or real objects at the respective location. In some embodiments, the respective location is a three-dimensional location. For example, in accordance with a determination that there are no virtual objects that can be manipulated with the respective type of manipulation at the three-dimensional respective location, but there are one or more virtual objects that can be manipulated with the respective type of manipulation at one or more locations behind the respective location along a straight line between the viewpoint of the user and the three-dimensional respective location, the computer system determines that there are no virtual objects that can be manipulated with the respective type of manipulation at the respective location. In some embodiments, the respective location includes one or more locations along the straight line between the viewpoint of the user and the three-dimensional respective location to which the user is paying attention, and the computer system determines that the respective location is empty of virtual objects that can be manipulated with the respective type of manipulation when there are no objects that can be manipulated with the respective type of manipulation along the straight line.

In some embodiments, the viewpoint of the user is a location in the environment from which the display generation component displays the environment. In some embodiments, the viewpoint of the user corresponds to a location of the computer system and/or the display generation component in a physical environment of the computer system and/or display generation component. In some embodiments, the first spatial arrangement relative to the viewpoint of the user includes an average of the distance between the location of the first virtual object and the viewpoint of the user and the distance between the location of the second virtual object and the viewpoint of the user. In some embodiments, the average is an arithmetic average of the three-dimensional locations of the first and second virtual objects (and any other virtual objects in the environment and/or displayed via the display generation component while the interaction input is received). In some embodiments, the average is a geometric average of the three-dimensional locations of the first and second virtual objects (and any other virtual objects in the environment and/or displayed via the display generation component while the interaction input is received). In some embodiments, the average is an arithmetic average of the two-dimensional locations of the first and second virtual objects (and any other virtual objects in the environment and/or displayed via the display generation component while the interaction input is received). In some embodiments, the average is a geometric average of the two-dimensional locations of the first and second virtual objects (and any other virtual objects in the environment and/or displayed via the display generation component while the interaction input is received).

In some embodiments, the operation is a locomotion operation (e.g., translation and/or rotation) performed on the first virtual object and the second virtual object relative to the first reference. For example, the operation is translating the first virtual object and second virtual object and/or one or more additional objects in the environment relative to the environment (e.g., but not relative to each other) by an amount based on the location of the first reference, as described in more detail below. As another example, the operation is rotating the first virtual object and second virtual object and/or one or more additional objects in the environment around the first reference. In some embodiments, the first reference is based on the first location and the second location in the environment and/or the first average of the distance between the first location and the viewpoint of the user and the distance between the second location and the viewpoint of the user. In some embodiments, in response to detecting the interaction input while detecting the attention of the user directed to a different location that is different from the locations of the virtual objects in the environment, in response to detecting the interaction input, in accordance with the determination that the average of the distance between the first location and the viewpoint of the user in the environment and the distance between the second location and the viewpoint of the user is the first average, the computer system performs the operation on the first virtual object and the second virtual object relative to the first reference.

In some embodiments, while displaying the first virtual object (e.g., 1302) and the second virtual object (e.g., 1304) in the environment (e.g., 1301) (1402b), such as in FIG. 13B, in response to detecting the interaction input, in accordance with a determination that the respective location is empty of virtual objects that can be manipulated with the respective type of manipulation (1402d), such as in FIG. 13B, in accordance with a determination that the first virtual object (e.g., 1302) and the second virtual object (e.g., 1304) have a second spatial arrangement different from the first spatial arrangement relative to the viewpoint of the user (e.g., 1305a) in the environment (e.g., 1301) (1402g), such as in FIG. 13B, (e.g., the average of the distance between the first location and the viewpoint of the user in the environment and the distance between the second location and the viewpoint of the user is a second average different from the first average), the computer system (e.g., 101a) manipulates (1402h) the first virtual object (e.g., 1302) and the second virtual object (e.g., 1304) relative to a second reference (e.g., 1310) (e.g., a second reference location and/or a second reference point) different from the first reference in the environment (e.g., 1301), such as in FIG. 13C. In some embodiments, the operation is a locomotion operation (e.g., translation and/or rotation) performed on the first virtual object and the second virtual object relative to the second reference. For example, the operation is translating the first virtual object and second virtual object and/or one or more additional objects in the environment relative to the environment (e.g., but not relative to each other) by an amount based on the location of the second reference, as described in more detail below. As another example, the operation is rotating the first virtual object and second virtual object and/or one or more additional objects in the environment around the second reference. In some embodiments, the second reference is based on the first location and the second location in the environment and/or the first average of the distance between the first location and the viewpoint of the user and the distance between the second location and the viewpoint of the user. In some embodiments, in response to detecting the interaction input while detecting the attention of the user directed to a different location that is different from the locations of the virtual objects in the environment, in response to detecting the interaction input, in accordance with the determination that the average of the distance between the first location and the viewpoint of the user in the environment and the distance between the second location and the viewpoint of the user is the second average, the computer system performs the operation on the first virtual object and the second virtual object relative to the second reference. In some embodiments, the computer system manipulates the first virtual object and second virtual object relative to a respective reference that is based on the spatial relationship of the first location of the first virtual object and the second location of the second virtual object irrespective of the location in the environment to which the attention of the user is directed (e.g., the respective reference is independent from the third location to which attention of the user is directed). Performing the operation on the first and second virtual objects based on a respective reference that is based on the average of the distance between the first location and the viewpoint of the user and the distance between the second location and the viewpoint of the user enhances user interactions with the computer system by reducing the number of displayed controls.

In some embodiments, such as in FIG. 13A, the determination that the attention of the user (e.g., 1305a) is directed to the respective location in the environment (e.g., 1301) includes a determination that a gaze (e.g., 1307a or 1307b) of the user is directed to the respective location in the environment (e.g., 1301) (1404). In some embodiments, the computer system uses additional criteria to determine user attention as described in more detail above. In some embodiments, in accordance with a determination the additional criteria, if any, are satisfied and the gaze of the user is directed to a first location, the attention of the user is directed to the first location. In some embodiments, in accordance with a determination the additional criteria, if any, are satisfied and the gaze of the user is directed to a second location different from the first location, the attention of the user is directed to the second location. Determining attention based on gaze as part of the interaction input enhances user interactions with the computer system by providing additional ways of controlling the computer system without additional displayed controls that clutter the user interface.

In some embodiments, such as in FIG. 13A, the computer system is in a communication session with a second computer system (e.g., 101b) while displaying the environment (e.g., 1301) (1406a). In some embodiments, the communication session includes displaying one or more virtual objects in environments of the computer system and the second computer system in a coordinated manner with shared spatial truth, as described above with reference to methods 800, 1000, and 1200. For example, if a third virtual object and fourth virtual object are shared with both computer systems, the spatial arrangement of the third virtual object and fourth virtual object relative to each other is the same in the environments of both computer systems.

In some embodiments, such as in FIG. 13A, the environment (e.g., 1301) includes a virtual representation of a second user (e.g., 1305b) of the second computer system (e.g., 101b) and a third virtual object (e.g., 1302) that is shared between the first computer system (e.g., 101a) and the second computer system (e.g., 101b) (1406b). In some embodiments, the second computer system also displays the third virtual object in the environment of the second computer system. In some embodiments, the second computer system displays a virtual representation of the user of the computer system in the environment of the second computer system as described above with reference to methods 800, 1000, and 1200. In some embodiments, sharing the third virtual object includes synchronizing the presentation of manipulation and/or other interactions and/or updates to the third virtual object at both the computer system and the second computer system. In some embodiments, the virtual representation of the second user of the second computer system is displayed at a location in the environment that corresponds to the viewpoint of the second user in the environment at the second computer system. In some embodiments, the virtual representation is an avatar of the second user.

In some embodiments, such as in FIG. 13B, manipulating the first virtual object (e.g., 1302) and second virtual object (e.g., 1304) with the respective type of manipulation in response to detecting the interaction input includes manipulating the virtual representation of the second user (e.g., 1305b) and the third virtual object (e.g., 1302) (1406c). In some embodiments, the computer system manipulates a plurality of objects in the environment in response to the interaction input while maintaining a spatial arrangement of the plurality of objects relative to each other, including manipulating the virtual representation of the second user and the third virtual object in the environment. In some embodiments, in response to the computer system manipulating the third virtual object and virtual representation of the second user, the second computer system updates the position of a virtual representation of the user of the computer system displayed in the environment via a display generation component in communication with the second computer system, as described in more detail above with reference to method(s) 800, 1000, and/or 1200. Manipulating the virtual representation of the second user and the third virtual object in response to the interaction input enhances user interactions with the computer system by reducing the number of inputs needed to maintain a spatial relationship between the third virtual object and a viewpoint of the second user when manipulating objects while in a communication session with the second computer system.

In some embodiments, a virtual representation of the user of the computer system is displayed in an environment at the second computer system (1408a), similar to the display of the representation of the second user (e.g., 1305b) in FIG. 13A. In some embodiments, the second computer system displays the representation of the user of the computer system in the environment at the second computer system at a location corresponding to the viewpoint of the user as described above with reference to methods 800, 1000, and 1200. In some embodiments, the virtual representation is an avatar of the user.

In some embodiments, in response to the computer system receiving the interaction input, the second computer system repositions the virtual representation of the user of the computer system in the environment at the second computer system in accordance with the computer system manipulating the first virtual object and the second virtual object with the respective type of manipulation in the environment in response to receiving the interaction input (1408b), such as the repositioning of avatar 706a in FIG. 7I. In some embodiments, manipulating the object in the environment in response to the interaction input updates the spatial relationship between the viewpoint of the user and the object. In some embodiments, the second computer system manipulates the virtual representation of the user to reflect the updated spatial relationship of the viewpoint of the user, which optionally corresponds to the virtual representation of the user, and the third virtual object. In some embodiments, the second computer system forgoes manipulating the third virtual object in response to the computer system detecting the interaction input. Repositioning the virtual representation of the user enhances interactions with the second computer system by maintaining the position of the third virtual object relative to the viewpoint of the second user while maintaining a shared spatial truth with the computer system without requiring additional inputs to do so.

In some embodiments, while the computer system detects the interaction input, the second computer system displays the virtual representation of the user of the computer system with decreased visual emphasis relative to the environment at the second computer system (1410), such as the display of avatar 706a in FIG. 7H. In some embodiments, the second computer system displays the virtual representation of the user of the computer system with the decreased visual emphasis relative to the environment as described above with reference to method(s) 800, 1000, and/or 1200. In some embodiments, the second computer system displays the visual representation of the user of the computer system with a blurred and/or darkened and/or smaller appearance compared to the display of the visual representation of the user of the computer system while the interaction input is not being detected. In some embodiments, the second computer system displays the environment with a visually emphasized appearance (e.g., brightened, reduced blur, increased opacity, and/or increased contrast) compared to the display of the virtual representation of the user of the computer system while the interaction input is not being detected. Displaying the virtual representation of the user of the computer system with decreased visual emphasis relative to the environment at the second computer system while the interaction input is being detected by the computer system enhances user interactions with the second computer system by providing visual feedback to the user of the second computer system while the user of the computer system is manipulating objects in the environment.

In some embodiments, such as in FIG. 13A, the environment (e.g., 1301) includes a third virtual object (e.g., 1306) (1412a). In some embodiments, such as in FIG. 13F, in accordance with the determination that the third virtual object (e.g., 1306) is in a field of view of the user while the interaction input is received, the first reference (e.g., 1310) is based on a location of the third virtual object (e.g., 1306) in the three dimensional environment (e.g., 1301) (1412b). In some embodiments, the first reference is an average position relative to the viewpoint of the user of the first virtual object, the second virtual object, and the third virtual object, similar to the manner of determining the first reference based on the locations of the first and second virtual objects described above.

In some embodiments, such as in FIG. 13A, in accordance with the determination that the third virtual object (e.g., 1306) is not in a field of view of the user (e.g., 1305a) while the interaction input is received, the second reference (e.g., 1310) is independent of the location of the third virtual object (e.g., 1306) in the three dimensional environment (e.g., 1301) (1412c). In some embodiments, the display generation component displays a portion of the environment within a field of view of the display generation component from the viewpoint of the user. In some embodiments, the environment includes one or more additional virtual objects, including the third virtual object that are not displayed via the display generation component because they are outside of the field of view. In some embodiments, in response to detecting an update to the location and/or orientation of the field of view of the display generation component due to movement of the user, the display generation component, and/or the electronic device, the computer system updates the portion of the environment displayed via the display generation component. In some situations, updating the field of view of the display generation component causes the display generation component to display one or more of the virtual objects that were not previously displayed due to being outside of the field of view previously. In some embodiments, when performing the manipulation in response to receiving the third interaction input that was detected while the attention of the user was directed to the respective location that is empty of virtual objects that can be manipulated with the respective type of manipulation, the respective manipulation is performed relative to a reference that is based on the locations of one or more objects in the field of view of the display generation component, including the first virtual object and the second virtual object, irrespective of locations of the one or more objects outside of the field of view of the display generation component, including the third virtual object. In some embodiments, the reference is not based on locations and/or the spatial arrangement of the one or more objects outside of the field of view of the display generation component, including the third virtual object. Manipulating the first virtual object and second virtual object relative to the respective reference irrespective of the location of the third virtual object enhances user interactions with the computer system by enabling the user to control the manipulation based on virtual objects visible to the user, thereby reducing user error and the number of inputs needed to accurately manipulate the objects.

In some embodiments, such as in FIG. 13B, manipulating the first virtual object (e.g., 1302) and the second virtual object (e.g., 1304) with the respective type of manipulation in response to detecting the interaction input includes manipulating the third virtual object (e.g., 1306) with the respective type of manipulation (1414). In some embodiments, the reference with which the manipulation of the virtual objects, including virtual objects displayed via the display generation component when the interaction input is detected and virtual objects not displayed via the display generation component when the interaction input is detected, is performed is based on the spatial arrangement of the one or more virtual objects displayed via the display generation component when the interaction input is detected. In some embodiments, the reference with which the manipulation of the virtual objects, including virtual objects within the field of view of display generation component when the interaction input is detected and virtual objects outside of the field of view of the display generation component when the interaction input is detected, is performed is based on the spatial arrangement of the one or more virtual objects within the field of view of the display generation component when the interaction input is detected. Manipulating the third virtual object while manipulating the first virtual object and the second virtual object in response to the interaction input enhances user interactions with the computer system by enabling the user to manipulate the third virtual object such that it is displayed by the display generation component with fewer user inputs.

In some embodiments, such as in FIG. 13E, the computer system (e.g., 101) displays (1416a), via the display generation component (e.g., 120), a portion of the environment (e.g., 1301) without the virtual objects (e.g., 1302 and/or 1306) that can be manipulated with the respective type of manipulation. In some embodiments, the virtual objects that can be manipulated with the respective type of manipulation are outside of the field of view of the display generation component, as described above.

In some embodiments, such as in FIG. 13E, while displaying the portion of the environment (e.g., 1301 without the virtual objects that can be manipulated with the respective type of manipulation (1416b), the computer system (e.g., 101a) detects (1416c) a second interaction input that corresponds to a request to perform the respective type of manipulation in the environment. In some embodiments, the second interaction input includes detecting the attention (e.g., including gaze) of the user directed to a second location in the environment empty of the virtual objects that can be manipulated with the respective type of manipulation. In some embodiments, the second interaction input includes detecting an air gesture and/or input via a hardware input device similar to the air gesture and/or input via a hardware device included in the interaction input described above. In some embodiments, the second interaction input has one or more characteristics of the interaction input described in more detail above.

In some embodiments, such as in FIG. 13E, while displaying the portion of the environment (e.g., 1301) without the virtual objects (e.g., 1302 and/or 1306) that can be manipulated with the respective type of manipulation (1416b), in response to detecting the second interaction input, the computer system (e.g., 101a) manipulates (1416d) the virtual objects (e.g., 1302 and/or 1306) that can be manipulated with the respective type of manipulation relative to a third reference, the third reference independent from locations of the virtual objects (e.g., 1302 and/or 1306) that can be manipulated with the respective type of manipulation. In some embodiments, the third reference is a default reference that is used to manipulate objects with the respective manipulation in response to an interaction input corresponding to a request to manipulate objects with the respective manipulation that is received while the portion of the environment displayed via the display generation component is empty of the virtual objects that can be manipulated with the respective manipulation. In some embodiments, the third reference is based on the attention of the user, such as being the location at which the user is looking and/or a location along a line from the user's gaze that is a predetermined distance from the viewpoint of the user, such as 1, 2, 3, 4, 5, or 10 meters. Manipulating the virtual objects not displayed when the interaction input is received in response to the interaction input enhances user interactions with the computer system by enabling the user to manipulate the virtual objects such they are displayed by the display generation component with fewer user inputs.

In some embodiments, such as in FIG. 13E, while displaying the portion of the environment (e.g., 1301) without the virtual objects (e.g., 1302 and/or 1306) that can be manipulated with the respective type of manipulation, in response to detecting the second interaction input, the computer system (e.g., 101a) displays (1418), via the display generation component (e.g., 120), a third virtual object (e.g., 1312) that was not displayed prior to detecting the second interaction input. In some embodiments, the third virtual object is a visual guide displayed while the interaction input is being provided. For example, the third virtual object is a virtual grid displayed overlaid on the environment, such as being overlaid on representations of physical objects in the environment of the electronic device, display generation component, and/or the user, as described in more detail above. In some embodiments, the virtual grid is parallel to and/or overlaid on a surface in the environment, such as the ground and/or a floor (e.g., a virtual ground and/or floor and/or a representation of the physical ground and/or floor in the physical environment of the computer system and/or display generation component). In some embodiments, the computer system manipulates the third virtual object in accordance with the interaction input while the interaction input is being detected to provide feedback to the user that the manipulation is occurring even when the virtual objects that would otherwise be manipulable are not in the field of view of the environment from the viewpoint of the user. In some embodiments, in response to detecting an end of the second interaction input, the computer system ceases to display the third virtual object. Displaying the third virtual object in response to detecting the interaction input that is detected while the virtual objects that can be manipulated with the respective manipulation enhances user interactions with the computer system by providing a visual guide to the user while detecting the interaction input, thus reducing the number of inputs needed to accurately manipulate the virtual objects.

In some embodiments, such as in FIGS. 13E-13G, manipulating the virtual objects (e.g., 1302 and/or 1306) that can be manipulated with the respective type of manipulation relative to the third reference in response to receiving the second interaction input is in accordance with a determination that the respective type of manipulation is a first type of manipulation (1420a). In some embodiments, the computer system is able to manipulate the virtual objects with the first type of manipulation when the portion of the environment displayed via the display generation component while the second interaction input is detected is empty of virtual objects that can be manipulated with the respective type of manipulation. In some embodiments, the computer system is able to translate the virtual objects in response to the interaction input when the virtual objects are not displayed via the display generation component when the interaction input is detected (e.g., because the virtual objects are outside of the field of view of the display generation component when the interaction input is detected). In some embodiments, the computer system is able to rotate the virtual objects in response to the interaction input when the virtual objects are not displayed via the display generation component when the interaction input is detected (e.g., because the virtual objects are outside of the field of view of the display generation component when the interaction input is detected).

In some embodiments, while displaying the portion of the environment (e.g., 1301) without the virtual objects (e.g., 1302 and/or 1306) that can be manipulated with the respective type of manipulation, such as in FIG. 13E, in response to detecting the second interaction input (1420b), in accordance with a determination that the respective type of manipulation is a second type of manipulation, different from the first type of manipulation, the computer system (e.g., 101a) forgoes (1420c) manipulating the virtual objects that can be manipulated with the respective type of manipulation with the second type of manipulation, such as in FIGS. 13E-13G. In some embodiments, the computer system is not able to manipulate the virtual objects with the second type of manipulation when the portion of the environment displayed via the display generation component while the second interaction input is detected is empty of virtual objects that can be manipulated with the respective type of manipulation. In some embodiments, the computer system is not able to translate the virtual objects in response to the interaction input when the virtual objects are not displayed via the display generation component when the interaction input is detected (e.g., because the virtual objects are outside of the field of view of the display generation component when the interaction input is detected). In some embodiments, the computer system is not able to rotate the virtual objects in response to the interaction input when the virtual objects are not displayed via the display generation component when the interaction input is detected (e.g., because the virtual objects are outside of the field of view of the display generation component when the interaction input is detected). In some embodiments, forgoing manipulating the virtual objects includes maintaining the respective positions and/or orientations prior to detecting the second interaction input. Performing the first type of manipulation in response to the second interaction input received while the virtual objects are not displayed in the environment via the display generation component and forgoing performing the second type of manipulation in response to the second interaction input received while the virtual objects are not displayed in the environment via the display generation component enhances user interactions with the computer system by reducing human error in manipulating objects not displayed via the display generation component, thereby reducing the number of inputs needed to accurately manipulate the virtual objects.

In some embodiments, such as in FIG. 9A, while displaying the first virtual object (e.g., 902) and the second virtual object (e.g., 904) in the environment, in response to detecting the interaction input, in accordance with a determination that the respective location is a first location including the first virtual object (e.g., 902) (1422a), in accordance with the determination that the first virtual object (e.g., 902) and second virtual object (e.g., 904) have the first spatial arrangement, such as in FIG. 9A, the computer system (e.g., 101a) manipulates (1422b) the first virtual object (e.g., 902) and the second virtual object (e.g., 904) with the respective type of manipulation relative to a third reference (e.g., 908a) associated with the first virtual object (e.g., 902) in the environment, such as in FIG. 9B. In some embodiments, the third reference is a location of the first virtual object, such as the centroid of the first virtual object in two and/or three dimensions. For example, in response to detecting the interaction input, in accordance with a determination that the attention of the user is directed to the first virtual object while the interaction input is being provided, the computer system rotates the first virtual object and the second virtual object (and optionally one or more additional virtual objects in the environment) around the center of the first virtual object.

In some embodiments, such as in FIG. 9A, while displaying the first virtual object (e.g., 902) and the second virtual object (e.g., 902) in the environment (e.g., 901), in response to detecting the interaction input, in accordance with a determination that the respective location is a first location including the first virtual object (e.g., 902) (1422a), in accordance with the determination that the first virtual object (e.g., 902) and second virtual object (e.g., 904) have the second spatial arrangement, the computer system (e.g., 101a) manipulates (1422c) the first virtual object (e.g., 902) and the second virtual object (e.g., 904) with the respective type of manipulation relative to the third reference (e.g., 907a), such as in FIG. 9A. In some embodiments, in response to detecting the interaction input, in accordance with a determination that the attention of the user is directed to the first virtual object while the interaction input is being provided, the computer system performs the respective manipulation with respect to the reference point associated with the first virtual object irrespective of the location of the second virtual object. For example, if the first virtual object has a same respective location in the environment while the first virtual object and the second virtual object have the first spatial arrangement as the location of the first virtual object in the virtual environment while the first virtual object and the second virtual object have the second spatial arrangement, the reference point used for the respective type of manipulation is the same irrespective of the location of the second virtual object. Performing the respective spatial arrangement with respect to the third reference associated with the first object in the environment irrespective of the spatial arrangement of the first and second virtual objects enhances user interactions with the computer system by enabling the user to consistently control the reference of the respective type of manipulation based on attention, thereby providing additional control options without additional displayed controls cluttering the user interface.

In some embodiments, such as in FIG. 9A, while displaying the first virtual object (e.g., 902) and the second virtual object (e.g., 904) in the environment (e.g., 901), in response to detecting the interaction input, in accordance with a determination that the respective location is a second location that includes the first virtual object (e.g., 902), the second location different from the first location (1424a), in accordance with the determination that the first virtual object (e.g., 902) and second virtual object (e.g., 904) have the first spatial arrangement, the computer system (e.g., 101a) manipulates (1424b) the first virtual object (e.g., 902) and the second virtual object (e.g., 904) with the respective type of manipulation relative to the third reference (e.g., 907a) associated with the first virtual object (e.g., 902) in the environment (e.g., 901), such as in FIG. 9B. In some embodiments, the first virtual object is located at both the first location and the second location. For example, the first location includes a first portion of the first virtual object and the second location includes a second portion of the first virtual object. In some embodiments, while the first virtual object is at a respective position in the environment that includes being located at the first location and the second location, in response to detecting an interaction input that includes the attention of the user directed to either the first location or the second location, the computer system manipulates the first virtual object and the second virtual object (e.g., and optionally one or more additional virtual objects in the environment) with the respective type of manipulation relative to the third reference, irrespective of whether the attention of the user of the computer system is directed to the first location or the second location.

In some embodiments, such as in FIG. 9A, while displaying the first virtual object (e.g., 902) and the second virtual (e.g., 904) object in the environment (e.g., (01), in response to detecting the interaction input, in accordance with a determination that the respective location is a second location that includes the first virtual object (e.g., 902), the second location different from the first location (1424a), in accordance with the determination that the first virtual object (e.g., 902) and second virtual object (e.g., 904) have the second spatial arrangement, the computer system (e.g., 101a) manipulates (1424c) the first virtual object (e.g., 902) and the second virtual object (e.g., 904) with the respective type of manipulation relative to the third reference (e.g., 907a), such as in FIG. 9A. In some embodiments, the computer system performs the respective type of manipulation relative to the third reference in response to detecting an interaction input that includes the attention of the user directed to either the first location or the second location irrespective of the location of the second virtual object in the environment and/or the spatial relationship between the first virtual object and the second virtual object in the environment. Performing the respective type of manipulation relative to the third reference associated with the first virtual object in the environment irrespective of whether the attention of the user is directed to the first location or the second location including the first virtual object while the interaction input is provided enhances user interactions with the computer system by providing consistent control based on user attention, thereby reducing the number of inputs needed to accurately manipulate the first and second virtual objects in the environment.

In some embodiments, such as in FIG. 9A, the third reference (e.g., 908a) associated with the first virtual object (e.g., 902) in the environment is a representative location associated with the first virtual object (e.g., 902) (1426). In some embodiments, the third reference has a fixed spatial arrangement relative to the first virtual object irrespective of the location and/or orientation of the first virtual object in the environment and/or irrespective of the portion of the first virtual object to which the attention of the user is directed while providing the interaction input. In some embodiments, the representative location is a location such as the centroid of the first virtual object, the front of the first virtual object, and/or a location of a respective displayed feature of the first virtual object. For example, if the first virtual object includes a repositioning option, the third reference is the location of the repositioning option. As another example, if the third virtual object is a user interface of an application that includes multiple windows, the third reference is the centroid of one of the windows, even if that location is not the centroid of the entire first virtual object. Using a representative location associated with the first virtual object as the third reference enhances user interactions with the computer system by providing a predictable reference for the respective manipulation, thereby enabling the user to accurately manipulate the first and second virtual objects with fewer user inputs.

In some embodiments, such as in FIG. 9A, the third reference (e.g., 908a) associated with the first virtual object (e.g., 902) in the environment is a centroid of the first virtual object (e.g., 902) (1428). In some embodiments, the third reference is the centroid of the first virtual object in two dimensions, with a fixed location in the third dimension. In some embodiments, the third reference is the centroid of the first virtual object in three dimensions. Using the centroid of the first virtual object as the third reference enhances user interactions with the computer system by providing a predictable reference for the respective manipulation, thereby enabling the user to accurately manipulate the first and second virtual objects with fewer user inputs.

In some embodiments, such as in FIG. 13A, the first interaction input includes a first amount of (e.g., speed, distance, and/or duration of) movement of a predefined portion (e.g., 1303a and/or 1303b) of the user (1430a). In some embodiments, the first amount of movement is the amount of movement while the predefined portion of the user is in a predefined hand shape (e.g., while providing an air gesture). In some embodiments, the first amount of movement is an amount of movement while a hardware input device detects that one or more additional criteria are satisfied, such as a mouse or stylus button or keyboard key being activated or the predefined portion of the user touching a touch-sensitive surface in communication with the input device.

In some embodiments, such as in FIG. 13B manipulating the first virtual object (e.g., 1302) and the second virtual object (e.g., 1304) with the respective type of manipulation in response to the interaction input includes (1430b), in accordance with a determination that the respective location is a first location (e.g., the first location is empty of virtual objects that can be manipulated with the respective type of manipulation), manipulating the first virtual object (e.g., 1302) and the second virtual object (e.g., 1304) with the respective type of manipulation by a second amount (e.g., of speed, distance, and/or duration) corresponding to the first amount of movement of the predefined portion (e.g., 1303a and/or 1303b) of the user included in the first interaction input (1430c). In some embodiments, the second amount of movement is a speed, distance, and/or duration of movement based on a speed, distance, and/or duration, respectively, of the first amount of movement of the predefined portion of the user. In some embodiments, the speed, distance, and/or duration of the second amount of movement is based on a different one of speed, distance, and/or duration of the first amount. In some embodiments, the larger the first amount of movement of the predefined portion of the user, the larger the second amount of movement of the respective type of manipulation. In some embodiments, the smaller the first amount of movement of the predefined portion of the user, the smaller the second amount of movement of the respective type of manipulation.

In some embodiments, manipulating the first virtual object (e.g., 1302) and the second virtual object (e.g., 1304) with the respective type of manipulation in response to the interaction input includes (1430b), in accordance with a determination that the respective location is a second location different from the first location (e.g., the second location is empty of virtual objects that can be manipulated with the respective type of manipulation), manipulating the first virtual object (e.g., 1302) and the second virtual object (e.g., 1304) with the respective type of manipulation by the second amount (1430d), such as in FIG. 13B. In some embodiments, the second amount of manipulation depends on the first amount of movement, irrespective of the location in the environment to which the user is paying attention while providing the interaction input. For example, the computer system manipulates the first virtual object and the second virtual object by the second amount in response to the interaction input that includes the first amount of movement regardless of whether the user is looking at the first location that is empty of virtual objects that can be manipulated with the respective manipulation or the second location that can be manipulated with the respective manipulation while providing the interaction input. Manipulating the first virtual object and the second virtual object by the second amount irrespective of whether the attention of the user is directed to the first location or second location enhances user interactions with the computer system by providing consistent virtual object manipulation controls, enabling the user to manipulate the virtual objects accurately with fewer user inputs.

In some embodiments, such as in FIG. 9C, while displaying, via the display generation component, the first virtual object (e.g., 904) and the second virtual object (e.g., 902) in the environment (e.g., 901) (1432a), the computer system (e.g., 101a) detects (1432b), via the one or more input devices (e.g., 314), a second interaction input that corresponds to the request to perform the respective type of manipulation in the environment (e.g., 901) and includes the first amount of movement of the predefined portion (e.g., 903a and/or 903b) of the user. In some embodiments, the first amount of movement is the first amount of movement described in more detail above. In some embodiments, the direction(s) of the movement included in the second interaction input are the same as the direction(s) of the movement included in the interaction input described above. In some embodiments, the one or more additional characteristics of the movement included in the second interaction input are the same as one or more characteristics of the movement included in the interaction input described above.

In some embodiments, while displaying, via the display generation component (e.g., 120), the first virtual object (e.g., 904) and the second virtual object (e.g., 902) in the environment (e.g., 901) (1432a), in response to detecting the second interaction input, in accordance with a determination that the second interaction input includes detecting attention (e.g., including gaze 907c) of the user directed to a location of the first virtual object (e.g., 904) in the environment (e.g., 901), such as in FIG. 9C, the computer system (e.g., 101a) manipulates (1432c) the first virtual object (e.g., 904) and the second virtual object (e.g., 902) with the respective type of manipulation by a third amount, different from the second amount, that is based on the first amount and the location of the first virtual object (e.g., 904) in the environment (e.g., 901), such as in FIG. 9D. In some embodiments, the third amount of manipulation of the first virtual object and the second virtual object with the respective manipulation in response to the second interaction input that includes detecting the attention of the user directed to the location of the first virtual object in the environment is different from the second amount of manipulation of the first virtual object and the second virtual object in response to the interaction input that was detected while attention of the user was directed to a respective location in the environment that is empty of the virtual objects that can be manipulated with the respective type of manipulation, even if the amount of movement of the predefined portion of the user is the same for the interaction input and the second interaction input. In some embodiments, the computer system uses a first function to determine the amount of manipulation in response to an interaction input received while attention of the user is directed to a location of a virtual object that can be manipulated with the respective type of manipulation in the environment and uses a second function to determine the amount of manipulation in response to an interaction input received while attention of the user is directed to a location in the environment that is empty of the virtual objects that can be manipulated with the respective type of manipulation. In some embodiments, the third amount is based on the distance between the viewpoint of the user in the environment and the location of the first virtual object. For example, the larger the distance, the larger the third amount and the smaller the distance, the smaller the third amount. In some embodiments, the computer system adjusts the amount of manipulation in response to the second interaction input based on the location of a virtual object to which the user is directing their attention as described with reference to method 1200. Manipulating the first virtual object and the second virtual object by different amounts depending on whether the attention of the user is directed to a location with an object that can be manipulated with the respective type of manipulation while the interaction input is received enhances user interactions with the computer system by providing more controls for manipulating virtual objects without cluttering the user interface with additional displayed controls.

In some embodiments, such as in FIG. 9C, in response to detecting the second interaction input, in accordance with a determination that the second interaction input includes detecting attention (e.g., including gaze 907c) of the user directed to a location of the second virtual object (e.g., 904) in the environment (e.g., 901), the computer system (e.g., 101a) manipulates (1434) the first virtual object (e.g., 902) and the second virtual object (e.g., 904) with the respective type of manipulation by a fourth amount, different from the third amount, that is based on the first amount and the location of the second virtual object (e.g., 904) in the environment. In some embodiments, the fourth amount is based on the distance between the viewpoint of the user in the environment and the location of the second virtual object. For example, the larger the distance, the larger the fourth amount and the smaller the distance, the smaller the fourth amount. In some embodiments, if the first object is closer to the viewpoint of the user than the second object, the third amount of manipulation is smaller than the fourth amount and if the second object is closer to the viewpoint of the user than the first object, the third amount of manipulation is greater than the fourth amount. Manipulating the first virtual object and second virtual object by the fourth amount in response to detecting the interaction input while the attention of the user is directed to the second virtual object and manipulating the first virtual object and the second virtual object by the third amount in response to detecting the interaction input while the attention of the user is directed to the third virtual object enhances user interactions with the computer system by reducing the number of controls needed to manipulate objects to bring them closer to the viewpoint of the user the further the objects are from the viewpoint of the user.

In some embodiments, such as in FIG. 13A, detecting the interaction input that corresponds to the request to perform the respective type of manipulation in the environment includes detecting the user perform a predefined gesture with a predefined portion (e.g., 1303a and/or 1303b) of the user (1436). In some embodiments, detecting the predefined gesture includes detecting a pinch hand shape (e.g., as part of a pinch gesture) as part of an air gesture input. In some embodiments, detecting the predefined gesture includes detecting the user holding an input device (e.g., a stylus) with a predefined hand shape, such as a pinch hand shape. In some embodiments, the interaction input includes detecting one or more pinch inputs, such as detecting one or more hands make a pinch, move while holding the pinch, and releasing the pinch one or more times. Detecting the interaction input based on a predefined gesture performed with a predefined portion of the user enhances user interactions with the computer system by providing additional control options without cluttering the user interface with additional displayed controls.

In some embodiments, manipulating the first virtual object and the second virtual object with the respective type of manipulation relative to the first reference is in response to detecting a first predefined gesture included in the interaction input (1438a).

In some embodiments, in response to detecting a second predefined gesture of the interaction input (1438b), in accordance with a determination that the attention of the user is directed to a first location in the environment at an end of the first predefined gesture, the computer system (e.g., 101a) manipulates (1438c) the first virtual object and the second virtual object with the respective type of manipulation relative to a second reference in the environment. In some embodiments, the reference point of the manipulation changes based on where attention of the user is directed when one of the predefined gestures ends. For example, the reference point of the manipulation changes based on where attention of the user is directed when a depinch motion is detected at the end of a pinch gesture that includes a pinch movement, maintaining a pinch hand shape, and depinching the hand. In some embodiments, as described above, if the attention of the user is directed to a location in the environment empty of virtual objects that can be manipulated with the respective manipulation, the reference is the first reference. In some embodiments, as described above, if the attention of the user is directed to a respective virtual object, the reference is associated with the respective virtual object. For example, the computer system manipulates the first virtual object and the second virtual object with the respective type of manipulation relative to the first reference in response to detecting a pinch gesture while the attention of the user is directed to the respective location and manipulates the first virtual object and the second virtual object with the respective type of manipulation relative to the second reference in response to the second pinch gesture if the end of the first pinch gesture is detected while the attention of the user is directed to the first virtual object.

In some embodiments, in response to detecting a second predefined gesture of the interaction input (1438b), in accordance with a determination that the attention of the user is directed to a second location different from the first location in the environment at the end of the first predefined gesture, the computer system (e.g., 101a) manipulates (1438d) the first virtual object and the second virtual object with the respective type of manipulation relative to a third reference different from the second reference in the environment. For example, the computer system manipulates the first virtual object and the second virtual object with the respective type of manipulation relative to the first reference in response to detecting a pinch gesture while the attention of the user is directed to the respective location and manipulates the first virtual object and the second virtual object with the respective type of manipulation relative to the third reference in response to the second pinch gesture if the end of the first pinch gesture is detected while the attention of the user is directed to the second virtual object. Updating the reference of the respective type of manipulation of the first virtual object and the second virtual object based on the attention of the user during an end of a predefined gesture included in one or more predefined gestures of the interaction input enhances user interactions by providing controls for changing the reference while manipulating the virtual objects without cluttering the user interface with additional displayed controls.

In some embodiments, such as in FIG. 13A, manipulating the first virtual object (e.g., 1302) and the second virtual object (e.g., 1304) with the respective type of manipulation relative to the first reference (e.g., 1310) is in response to detecting a first predefined gesture included in the interaction input (1440a).

In some embodiments, such as in FIG. 13B, in response to detecting a second predefined gesture of the interaction input (1440b), in accordance with a determination that the attention (e.g., including gaze 1307c or 1307d) of the user is directed to a first location in the environment (e.g., 1301) when the second predefined gesture is detected, the computer system (e.g., 101a) manipulates (1440c) the first virtual object (e.g., 1302) and the second virtual object (e.g., 1304) with the respective type of manipulation relative to a second reference (e.g., 1310) in the environment (e.g., 1301). In some embodiments, the reference point of the manipulation changes based on where attention of the user is directed when one of the predefined gestures is detected. For example, the reference point of the manipulation changes based on where attention of the user is directed when a pinch motion is detected at the beginning of a pinch gesture that includes a pinch movement, maintaining a pinch hand shape, and depinching the hand. In some embodiments, as described above, if the attention of the user is directed to a location in the environment empty of virtual objects that can be manipulated with the respective manipulation, the reference is the first reference. In some embodiments, as described above, if the attention of the user is directed to a respective virtual object, the reference is associated with the respective virtual object. For example, the computer system manipulates the first virtual object and the second virtual object with the respective type of manipulation relative to the first reference in response to detecting a pinch gesture while the attention of the user is directed to the respective location and manipulates the first virtual object and the second virtual object with the respective type of manipulation relative to the second reference in response to the second pinch gesture if the second pinch gesture is detected while the attention of the user is directed to the first virtual object.

In some embodiments, such as in FIG. 13B, in response to detecting a second predefined gesture of the interaction input (1440b), in accordance with a determination that the attention (e.g., 1307c or 1307d) of the user is directed to a second location different from the first location in the environment (e.g., 1301) when the second predefined gesture is detected, the computer system (e.g., 101a) manipulates (1440d) the first virtual object (e.g., 1302) and the second virtual object (e.g., 1304) with the respective type of manipulation relative to a third reference different (e.g., 1310) from the second reference in the environment (e.g., 1301). For example, the computer system manipulates the first virtual object and the second virtual object with the respective type of manipulation relative to the first reference in response to detecting a pinch gesture while the attention of the user is directed to the respective location and manipulates the first virtual object and the second virtual object with the respective type of manipulation relative to the third reference in response to the second pinch gesture if the second pinch gesture is detected while the attention of the user is directed to the second virtual object. Updating the reference of the respective type of manipulation of the first virtual object and the second virtual object based on the attention of the user during a predefined gesture included in one or more predefined gestures of the interaction input enhances user interactions by providing controls for changing the reference while manipulating the virtual objects without cluttering the user interface with additional displayed controls.

In some embodiments, such as in FIG. 13A, manipulating the first virtual object (e.g., 1302) and the second virtual object (e.g., 1304) with the respective type of manipulation relative to the first reference (e.g., 131) is in response to detecting a first predefined gesture included in the interaction input (1442a).

In some embodiments, such as in FIG. 13B, in response to detecting a second predefined gesture of the predefined portion (e.g., 1303a) of the user included in the interaction input while detecting a second predefined portion of the user (e.g., 1303b) in a predefined shape (e.g., a pinch hand shape, a pointing hand shape with one or more fingers extended and one or more fingers curled towards the palm) (1442b), in accordance with a determination that the attention (e.g., including gaze 1307e or 13070 of the user is directed to a first location in the environment when the second predefined gesture is detected, such as in FIG. 13C, the computer system (e.g., 101a) manipulates (1442c) the first virtual object (e.g., 1302) and the second virtual object (e.g., 1304) with the respective type of manipulation relative to a second reference (e.g., 1310) in the environment. In some embodiments, the computer system detects the user hold a pinch hand shape with one hand while performing one or more pinch gestures with the other hand. In some embodiments, the reference point of the manipulation changes based on where attention of the user is directed when one of the predefined gestures is detected. For example, the reference point of the manipulation changes based on where attention of the user is directed when a pinch motion is detected at the beginning of a pinch gesture that includes a pinch movement, maintaining a pinch hand shape, and depinching the hand. In some embodiments, as described above, if the attention of the user is directed to a location in the environment empty of virtual objects that can be manipulated with the respective manipulation, the reference is the first reference. In some embodiments, as described above, if the attention of the user is directed to a respective virtual object, the reference is associated with the respective virtual object. For example, the computer system manipulates the first virtual object and the second virtual object with the respective type of manipulation relative to the first reference in response to detecting a pinch gesture while the attention of the user is directed to the respective location and manipulates the first virtual object and the second virtual object with the respective type of manipulation relative to the second reference in response to the second pinch gesture if the second pinch gesture is detected while the attention of the user is directed to the first virtual object.

In some embodiments, such as in FIG. 13C, in response to detecting a second predefined gesture of the predefined portion (e.g., 1303a) of the user included in the interaction input while detecting a second predefined portion (e.g., 1303b) of the user in a predefined shape (e.g., a pinch hand shape, a pointing hand shape with one or more fingers extended and one or more fingers curled towards the palm) (1442b), in accordance with a determination that the attention (e.g., including gaze 1307e or 13070 of the user is directed to a second location different from the first location in the environment (e.g., 1301) when the second predefined gesture is detected, the computer system (e.g., 101a) manipulates (1442d) the first virtual object (e.g., 1302) and the second virtual object (e.g., 1304) with the respective type of manipulation relative to a third reference (e.g., 1310) different from the second reference in the environment (e.g., 1301). For example, the computer system manipulates the first virtual object and the second virtual object with the respective type of manipulation relative to the first reference in response to detecting a pinch gesture while the attention of the user is directed to the respective location and manipulates the first virtual object and the second virtual object with the respective type of manipulation relative to the third reference in response to the second pinch gesture if the second pinch gesture is detected while the attention of the user is directed to the second virtual object. Updating the reference of the respective type of manipulation of the first virtual object and the second virtual object based on the attention of the user during a predefined gesture included in one or more predefined gestures of the interaction input enhances user interactions by providing controls for changing the reference while manipulating the virtual objects without cluttering the user interface with additional displayed controls.

In some embodiments, aspects/operations of methods 800, 1000, 1200 and/or 1400 may be interchanged, substituted, and/or added between these methods. For example, various object manipulation techniques of methods 800, 1000, 1200, and/or 1400 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-61. (canceled)

62. A method, comprising:
at a computer system in communication with a display generation component and one or more input devices:
displaying, via the display generation component, an environment from a first viewpoint of a user of the computer system, the environment including a first object at a first location and a second object at a second location, different from the first location;
while displaying the environment including the first object and the second object, detecting, via the one or more input devices, a first interaction input, including movement; and
in response to detecting the first interaction input:
in accordance with a determination that attention of the user of the computer system is directed to the first object when the first interaction input is detected:
performing a first operation involving manipulating the environment relative to a first reference point that is based on the first location of the first object in the environment in accordance with the movement; and
in accordance with a determination that the attention of the user of the computer system is directed to the second object when the first interaction input is detected:
performing a second operation involving manipulating the environment relative to a second reference point, different from the first reference point, that is based on the second location of the second object in the environment in accordance with the movement.

63. The method of claim 62, wherein:
the determination that the attention of the user is directed to the first object when the first interaction input is detected is based on a determination that a gaze of the user is directed to the first object when the first interaction input is detected, and the determination that the attention of the user is directed to the second object when the first interaction input is detected is based on a determination that a gaze of the user is directed to the second object when the first interaction input is detected.

64. The method of claim 62, wherein:
the user of the computer system is in a communication session with a second user of a second computer system while displaying the environment;
the environment includes a virtual representation of the second user; and
in response to detecting the first interaction input:
in accordance with the determination that the attention of the user of the computer system is directed to the first object when the first interaction input is detected and that the first object and/or the second object are shared with the second user of the second computer system, performing the first operation includes concurrently repositioning the first object and/or the second object, and the virtual representation of the second user within the environment relative to the first reference point in accordance with the movement; and
in accordance with the determination that the attention of the user of the computer system is directed to the second object when the first interaction input is detected and that the first object and/or the second object are shared with the second user, performing the second operation includes concurrently repositioning the first object and/or the second object, and the virtual representation of the second user within the environment relative to the second reference point in accordance with the movement.

65. The method of claim 64, wherein:
a virtual representation of the user of the computer system is displayed in an environment at the second computer system; and
when the computer system performs the first operation or the second operation, the virtual representation of the user of the computer system is repositioned in the environment at the second computer system relative to a viewpoint of the second user based on the movement.

66. The method of claim 64, wherein, while the first interaction input is being detected, the virtual representation of the user of the computer system is visually deemphasized in the environment at the second computer system.

67. The method of claim 62, wherein:
in response to detecting the first interaction input:
in accordance with the determination that the attention of the user of the computer system is directed to the first object when the first interaction input is detected:
performing the first operation includes repositioning the first object within the environment relative to a viewpoint of the user of the computer system in accordance with the movement; and
in accordance with the determination that the attention of the user of the computer system is directed to the second object when the first interaction input is detected:
performing the second operation includes repositioning the second object within the environment relative to the viewpoint of the user in accordance with the movement.

68. The method of claim 67, wherein:
in response to detecting the first interaction input:
in accordance with a determination that the movement includes movement towards the viewpoint of the user and that the attention of the user of the computer system is directed to the first object when the first interaction input is detected, performing the first operation includes concurrently repositioning the first object and the second object towards the viewpoint of the user within the environment in accordance with the movement;
in accordance with a determination that the movement includes movement towards the viewpoint of the user and that the attention of the user of the computer system is directed to the second object when the first interaction input is detected, performing the second operation includes concurrently repositioning the first object and the second object towards the viewpoint of the user within the environment in accordance with the movement;
in accordance with a determination that the movement includes movement away from the viewpoint of the user and that the attention of the user of the computer system is directed to the first object when the first interaction input is detected, performing the first operation includes concurrently repositioning the first object and the second object away from the viewpoint of the user within the environment in accordance with the movement; and
in accordance with a determination that the movement includes movement towards the viewpoint of the user and that the attention of the user of the computer system is directed to the second object when the first interaction input is detected, performing the second operation includes concurrently repositioning the first object and the second object away from the viewpoint of the user within the environment in accordance with the movement.

69. The method of claim 67, wherein:
before detecting the first interaction input:
the first location is a first distance from the viewpoint of the user, and
the second location is a second distance, smaller than the first distance, from the viewpoint of the user;
the movement has a first magnitude; and
in response to detecting the first interaction input:
in accordance with the determination that the attention of the user of the computer system is directed to the first object when the first interaction input is detected:
performing the first operation includes moving the first object from the first location to a third location in the environment relative to the viewpoint of the user in accordance with the movement, wherein the third location is a third distance from the first location; and
in accordance with the determination that the attention of the user of the computer system is directed to the second object when the first interaction input is detected:
performing the second operation includes moving the second object from the second location to a fourth location in the environment relative to the viewpoint of the user in accordance with the movement, wherein the fourth location is a fourth distance, different from the third distance, from the second location.

70. The method of claim 67, wherein:
in response to detecting the first interaction input:
in accordance with the determination that the attention of the user of the computer system is directed to the first object when the first interaction input is detected:
performing the first operation includes restricting movement of the first object to movement outside of a threshold distance from the viewpoint of the user; and
in accordance with the determination that the attention of the user of the computer system is directed to the second object when the first interaction input is detected:
performing the second operation includes restricting movement of the second object to movement outside of the threshold distance from the viewpoint of the user.

71. The method of claim 70, wherein:
in response to detecting the first interaction input:
in accordance with the determination that the attention of the user of the computer system is directed to the first object when the first interaction input is detected:
performing the first operation includes moving the second object to within a first distance, less than the threshold distance, from the viewpoint of the user in accordance with the movement.

72. The method of claim 70, wherein:
in response to detecting the first interaction input:
in accordance with the determination that the attention of the user of the computer system is directed to the second object when the first interaction input is detected:
performing the second operation includes moving the first object to within a second distance, less than the threshold distance, from the viewpoint of the user in accordance with the movement.

73. The method of claim 62, wherein:
in response to detecting the first interaction input:
in accordance with the determination that the attention of the user of the computer system is directed to the first object when the first interaction input is detected:
performing the first operation includes rotating the first object within the environment relative to the first reference point in accordance with the movement; and
in accordance with the determination that the attention of the user of the computer system is directed to the second object when the first interaction input is detected:
performing the second operation includes rotating the second object within the environment relative to the second reference point in accordance with the movement.

74. The method of claim 73, wherein:
in response to detecting the first interaction input:
in accordance with the determination that the attention of the user of the computer system is directed to the first object when the first interaction input is detected:
performing the first operation includes concurrently rotating the first object and the second object within the environment relative to the first reference point in accordance with the movement; and
in accordance with the determination that the attention of the user of the computer system is directed to the second object when the first interaction input is detected:
performing the second operation includes concurrently rotating the first object and the second object within the environment relative to the second reference point in accordance with the movement.

75. The method of claim 62, wherein:
in response to detecting the first interaction input:
in accordance with the determination that the attention of the user of the computer system is directed to the first object when the first interaction input is detected:
performing the first operation includes rotating the first object within the environment relative to a viewpoint of the user of the computer system in accordance with the movement; and
in accordance with the determination that the attention of the user of the computer system is directed to the second object when the first interaction input is detected:
performing the second operation includes rotating the second object within the environment relative to the viewpoint of the user in accordance with the movement.

76. The method of claim 75, wherein:
in response to detecting the first interaction input:
in accordance with the determination that the attention of the user of the computer system is directed to the first object when the first interaction input is detected:
performing the first operation includes concurrently rotating the first object and the second object within the environment relative to the viewpoint of the user in accordance with the movement; and
in accordance with the determination that the attention of the user of the computer system is directed to the second object when the first interaction input is detected:
performing the second operation includes concurrently rotating the first object and the second object within the environment relative to the viewpoint of the user in accordance with the movement.

77. The method of claim 62, wherein:
the first interaction input is concurrently associated with a first predefined portion of the user and a second predefined portion of the user; and
the movement includes movement associated with the first predefined portion of the user and movement associated with the second predefined portion of the user.

78. The method of claim 62, further comprising:
while displaying the environment including respective virtual content at a third location in the environment, detecting, via the one or more input devices, a third interaction input that includes:
the attention of the user of the computer system directed toward the respective virtual content; and
movement of the first predefined portion of the user;
while detecting the third interaction input, receiving, via the one or more input devices, an indication corresponding to a request to move the respective virtual content within the environment;
in response to receiving the indication, moving the respective virtual content to a fourth location, different from the third location, in the environment; and
in response to detecting the third interaction input:
performing a third operation involving manipulating the environment relative to a third reference point, different from the first reference point and the second reference point, that is based on the third location of the respective virtual content in the environment in accordance with the movement.

79. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
displaying, via the display generation component, an environment from a first viewpoint of a user of the computer system, the environment including a first object at a first location and a second object at a second location, different from the first location;
while displaying the environment including the first object and the second object, detecting, via the one or more input devices, a first interaction input, including movement; and
in response to detecting the first interaction input:
in accordance with a determination that attention of the user of the computer system is directed to the first object when the first interaction input is detected:
performing a first operation involving manipulating the environment relative to a first reference point that is based on the first location of the first object in the environment in accordance with the movement; and
in accordance with a determination that the attention of the user of the computer system is directed to the second object when the first interaction input is detected:
performing a second operation involving manipulating the environment relative to a second reference point, different from the first reference point, that is based on the second location of the second object in the environment in accordance with the movement.

80. A non-transitory computer readable storage medium storing one or more programs, the one or more programs comprising instructions, which when executed by one or more processors of a computer system that is in communication with a display generation component and one or more input devices, cause the computer system to perform a method comprising:
displaying, via the display generation component, an environment from a first viewpoint of a user of the computer system, the environment including a first object at a first location and a second object at a second location, different from the first location;
while displaying the environment including the first object and the second object, detecting, via the one or more input devices, a first interaction input, including movement; and
in response to detecting the first interaction input:
in accordance with a determination that attention of the user of the computer system is directed to the first object when the first interaction input is detected:
performing a first operation involving manipulating the environment relative to a first reference point that is based on the first location of the first object in the environment in accordance with the movement; and
in accordance with a determination that the attention of the user of the computer system is directed to the second object when the first interaction input is detected:
performing a second operation involving manipulating the environment relative to a second reference point, different from the first reference point, that is based on the second location of the second object in the environment in accordance with the movement.

81-111. (canceled)
